(19) United States
(12) Patent Application Publication
(10) Pub. No.: US 2020/0195487 A1
(43) Pub. Date: Jun. 18, 2020

(54) COFDMSigbaling Using SCM with Labeling Diversity in Dual Carrier Modulation

(71) Applicant: Allen LeRoy Limberg, Port Charlotte, FL (US)

(72) Inventor: Allen LeRoy Limberg, Port Charlotte, FL (US)

(21) Appl. No.: 16/736,645

(22) Filed: Jan. 7, 2020

Related U.S. Application Data
(63) Continuation-in-part of application No. 16/455,699, filed on Jun. 27, 2019.
Application No. 16/455,699 is a continuation-in-part of application No. 16/217,120, filed on Dec. 12, 2018, now Pat. No. 10,601,624.
Application No. 16/217,120 is a continuation-in-part of application No. 16/276,515, filed on Feb. 14, 2019, now Pat. No. 10,637,711.

(51) Int. Cl. H04L 27/34; H04L 27/36; H04L 27/38

(52) U.S. Cl. CPC H04L 27/3411; H04L 27/364; H04L 27/3818; H04L 27/365

(57) ABSTRACT

Labeling diversity of the superposition coding modulation (SCM) of dual-carrier modulation (DCM) of a coded orthogonal frequency-division multiplexed (COFDM) signal is used to reduce its peak-to-average-power ratio (PAPR). The reduction of data throughput owing to DCM is compensated for by quadrupling the number of lattice points in SCM mappings of the quadrature amplitude modulation (QAM) of the carriers of the COFDM signal. The labeling diversity can be such as to minimize PAPR or such as to reduce PAPR less, but improve signal-to-noise (SNR) for reception of the COFDM signal transmitted via an additive-white-Gaussian-noise (AWGN) channel.

This is a continuation-in-part of U.S. patent application Ser. No. 16/217,120 filed on 12 Dec. 2018 as Ser. No. 16/217,120 and of U.S. patent application Ser. No. 16/276,515 filed on 14 Feb. 2019.

### FIELD OF THE INVENTION

The invention relates to communication systems, such as a digital television (DTV) broadcasting system, that employ coded orthogonal frequency-division multiplexed (COFDM) signal employing dual-carrier modulation (DCM). The invention relates more particularly to applying labeling diversity to such communication systems for reducing peak-to-average-power ratio (PAPR) but also facilitating better reception of DCM COFDM signals transmitted via a channel afflicted with additive white Gaussian noise (AWGN).

### BACKGROUND OF THE INVENTION

First and second sets of quadrature-amplitude-modulation (QAM) symbols transmitted parallelly in time can differ in the respective patterns of labeling lattice points in the two sets of QAM symbol constellations, which constellation rearrangement approach provides “labeling diversity”. Labeling diversity can lessen the error in reception of transmitted data accompanied by noise, as compared to that in which the same pattern is used to label lattice points of the first and second sets of QAM symbols transmitted parallelly in time.

Labeling diversity can be applied to first and second sets of the QAM symbols that convey the same coded digital data in dual-carrier-modulation (DCM) of coded orthogonal frequency-division modulation (COFDM) signal. Labeling diversity can be viewed as a rearrangement of the labeling of lattice points in the mapping of coded data to the first and second sets of QAM symbols. The rearrangement rules focus on changing the location of the rearranged version of the QAM symbol to achieve an averaging effect of the levels of reliability. Such labeling diversity is described in detail in U.S. patent application Ser. No. 16/039,249 filed by Allen LeRoy Limberg on 18 Jul. 2018, titled “COFDM DCM Communication Systems with Preferred Labeling-Diversity Formats”, and published 2 May 2019 as US-2019-0132161-A1. In that patent application the lower-frequency and upper-frequency halves of the frequency spectrum of a DCM COFDM signal convey the same data via first and second sets of QAM symbols respectively, which first and second sets of QAM symbols exhibit labeling diversity. The bits more likely to experience error in the labeling of said first set of QAM symbols correspond to the bits less likely to experience error in the labeling of said second set of QAM symbols, and the bits more likely to experience error in the labeling of said second set of QAM symbols correspond to the bits less likely to experience error in the labeling of said first set of QAM symbols. This facilitates a receiver for such DCM COFDM signal applying bit-reliability averaging (BRA) to each pair of QAM symbols conveying the same coded data. Apparatus for receiving DCM COFDM signals transmitted over the air as digital television broadcast signals is described in detail in U.S. patent application Ser. No. 16/037,747 filed by Allen LeRoy Limberg on 17 Jul. 2018, titled “Receivers for COFDM SIGNALS Conveying the Same Data in Lower- and Upper-Frequency Sidebands”, and published 3 Jan. 2019 as US-2019-0006255-A1. Reference to lower-frequency and upper-frequency “sidebands” in regard to multiple carrier forms of modulation such as COFDM is not precisely accurate, since there is usually no principal carrier wave at a central frequency. It is more accurate to refer to these portions of the frequency spectrum as lower-frequency and upper-frequency “subbands”.

The patent applications referred to supra describe DCM COFDM signals that employ quadrature amplitude modulation (QAM) of COFDM carriers therein. These patent applications also describe DCM COFDM signals that employ amplitude phase-shift keying (APSK) to modulate the COFDM carriers. of COFDM carriers therein. These patent applications also mention that some species of QAM may map coded data to QAM symbol constellations with non-uniform spacing between labeled lattice points in such mapping. QAM with non-uniform spacing between labeled lattice points in the mapping of fragments of coded data to QAM symbol constellations is customarily referred to as non-uniform QAM or “NuQAM”. NuQAM, like ordinary ASPK having circular modulation symbol constellations, is used to reduce the peak-to-average-power ratio (PAPR) of COFDM signals.

COFDM modulating carriers therein using QAM with uniform spacing between labeled lattice points in the mapping of fragments of coded data to QAM symbol constellations tends to have high PAPR at times. Undesirably large peak-to-average-power ratio (PAPR) has long been a well-known problem in regard to over-the-air (OTA) multiple-carrier radio-frequency (RF) signal transmissions, such as the COFDM signals used for digital television (DTV) broadcasting. The average power of the DTV transmissions has to be held back substantially to avoid frequent occurrence of non-linearity and clipping in the amplifiers for COFDM symbols. Each such occurrence causes undesirable spreading of the frequency spectrum of the COFDM signal. Average power has been held back as much as 10 to 15 dB. A variety of techniques to reduce PAPR in OFDM transmissions, so that average power need not be held back as much, have been proposed in the prior art. However, most of these techniques have at least one shortcoming and have not been used very much, if at all, in commercial OTA DTV broadcasting.

Simply clipping peaks of baseband COFDM signals is one technique used in the prior art to limit PAPR, but it introduces bit errors into the baseband COFDM signals recovered by a receiver. These bit errors are corrected insofar as possible during decoding of FEC coding. The need for such correction undesirably reduces the capability of the decoding of FEC coding to correct other errors in the received baseband COFDM signals, such as those attributable to accompanying noise or short-duration diminution in the strength of received signal. The clipping procedures tend to generate out-of-band radiation, which should be taken into consideration in the design of passband filtering for the COFDM transmitter. Also, there tends to be a problem with re-growth of peaks in digital-to-analog conversion, which re-growth taxes subsequent band filtering procedures. If the coded data conveyed by the baseband COFDM signals has been randomized, very large peaks in their power are unlikely to occur as frequently, so clipping of them in the linear power amplifier of a transmitter may be tolerated if adequate band filtering procedures follow.

Selected portions of the transmitted COFDM signals can be transmitted at reduced power to reduce the energy of their peaks. Such schemes require both transmitter and receivers to be of more complex construction; and side information concerning the pattern of reduced power of transmission must be conveyed from the transmitter to the receivers. Such side information undesirably tends to reduce data throughput.

In other schemes the COFDM transmitter switches QAM symbols around in several patterns, the pattern that offers the lowest PAPR being selected for transmission. Such schemes also require both transmitter and receivers to be of more complex construction; and side information concerning the pattern of symbol switching must be conveyed from the transmitter to the receivers. Such side information undesirably tends to reduce data throughput.

To avoid the necessity of transmitting side information, other PAPR reduction techniques have been pursued, in which some of the OFDM carriers are used for PAPR reduction purposes rather than for data transmission. Reserved tones are inserted, the respective modulations of these dummy carriers being calculated so as to reduce PAPR. This comes at the cost of reduced data throughput, however. Typically this reduction in data throughput is of the order of 10% or so.

Newer designs of COFDM transmitters for broadcast television improve power amplifier efficiency using variants of the methods described U.S. Pat. No. 6,625,430 titled “Method and apparatus for attaining higher amplifier efficiencies at lower power levels” granted 23 Sep. 2003 to Peter J. Doherty. Accordingly, the PAPR reduction techniques described supra have become less likely to be resorted to. However, the large PAPR of DSB-COFDM also causes problems in receiver apparatus which are not avoided (and indeed may be exacerbated) by using a Doherty method in the broadcast transmitter. These problems concern maintaining linearity in the radio-frequency (RF) amplifier, in the intermediate-frequency (IF) amplifier (if used) and in the analog-to-digital (A-to-D) converter.

COFDM can use a technique called symmetric cancellation coding (SCC) in which pairs of OFDM carriers conveying like coded digital data (CDD) are arranged next to each other in frequency, the QAM of each of the two OFDM carriers in a pair being antipodal to the QAM of the other. While such SCC has been used principally implementing intercarrier interference (ICI) cancellation, it is reported to reduce PAPR of COFDM in a paper titled “Analysis of Coherent and Non-Coherent Symmetric Cancellation Coding for OFDM Over a Multipath Rayleigh Fading Channel” Abdullah S. Alaraimi and Takeshi Hashimoto presented at the IEEE 64th Vehicular Technology Conference held 25-28 Sep. 2006 in Montreal, Quebec, Canada. Alaraimi and Hashimoto's simulations using 2-dimensional modulation of OFDM carriers found 0.5 dB lowering of the PAPR of COFDM when SCC was employed. The particular size of the COFDM modulation constellations employed in the simulations was not specified in this paper.

Significantly greater lowering of the PAPR of COFDM is obtained from labeling diversity other than that provided by SCC, according to a paper titled “PAPR Performance of Dual Carrier Modulation using Improved Data Allocation Scheme” that Soobum Cho and Sang Kyo Park presented at the 13th International Conference on Advanced Communication Technology (ICACT2011) held 13-16 Feb. 2011 in Seoul, Republic of Korea. FIG. 4 of that paper shows PAPR of OFDM DCM being about 2.5 dB less than PAPR of conventional OFDM, when 16QAM of OFDM carriers is used. Cho and Park spaced the carriers of their DCM COFDM signals N/2 carriers apart to maximize frequency diversity, N being the total number of carriers in the OFDM signal. Such separation improves reliability of reception, especially when there are narrow-band interferences and/or when there is adjacent-channel interference (ACI). The labeling diversity of the two 16QAM mapping patterns Cho and Park used to secure lower PAPR does not support bit-reliability averaging in receivers, so as to optimize soft-bit maximal-ratio combining (SBMRC). The two 16QAM mapping patterns Cho and Park used to secure lower PAPR were described earlier by Martin Geoffrey Leach and Peter Anthony Borowski in a patent application titled “Signal decoding systems” and published 4 Sep. 2008 as US-2008-0212694-A1.

Labeling diversity in DCM COFDM signals can be designed to minimize the peak-to-average-power ratio (PAPR), as described in U.S. patent application Ser. No. 16/037,747 filed by Allen LeRoy Limberg on 12 Dec. 2018, titled “DCM COFDM Signaling That Employs Labeling Diversity to Minimize PAPR”, and published 3 Jan. 2019 as US-2019-0007255-A1. The same coded data is transmitted twice, once via a first set of the DCM COFDM carriers, and once via a second set of the DCM COFDM carriers different from the first set. As much as 6 dB reduction in PAPR can be obtained using uniform 16QAM of the DCM COFDM carriers. More modest reductions in PAPR can be obtained from uniform QAM of DCM COFDM carriers which use some of the types of labeling diversity disclosed in US-2019-0132161-A1. The reductions in PAPR for uniform QAM mapping makes NuQAM and APSK mapping techniques less attractive, particularly since their demapping in a COFDM signal receiver is not as straightforward as demapping uniform QAM.

Owing to the same coded data being transmitted twice in the DCM COFDM signals, for any given form of carrier modulation data throughput is halved compared to conventional COFDM signal that does not use DCM. Accordingly, persons skilled in the art of COFDM communications have tended to eschew using DCM in COFDM signaling in which high data throughput is sought. E.g., DCM has not been used in over-the-air DTV broadcasting.

However, it is here pointed out that labeling diversity technique for DCM COFDM signaling as taught in US-2019-0132161-A1 facilitates the halving of data throughput being compensated for by increasing the number of bits in the labeling of each of the lattice points in square QAM symbol constellations. The 4-bit lattice-point labels of square 16QAM symbol constellations provide for twice the data throughput provided by the 2-bit lattice-point labels quadrature-phase-shift-keying (QPSK) symbol constellations. The 8-bit lattice-point labels of square 256QAM symbol constellations provide for twice the data throughput provided by the 4-bit lattice-point labels of square 16QAM symbol constellations. The 12-bit lattice-point labels of square 4096QAM symbol constellations provide for twice the data throughput provided by the 6-bit lattice-point labels of square 64QAM symbol constellations. Quadrupling the number of lattice points in square QAM symbol constellations supports doubling the number of bits in the labels of the lattice points. For conciseness, the acronyms “LPL” and “LPLs” are used in the rest of this specification instead of the terms “lattice-point label” and “lattice-point labels”, respectively

Quadrupling the number of LPLs in square QAM symbol constellations conveyed by COFDM carriers results in additive white Gaussian noise (AWGN) being 6 dB more likely to cause error in more susceptible bits of QAM map labels recovered by a COFDM signal receiver. This is because the distances between neighboring lattice points in a square QAM symbol constellation are halved. However, this 6 dB disadvantage in signal-to-AWGN ratio can be overcome to some degree when a DCM COFDM signal receiver combines complex demodulation results from COFDM carriers conveying the same coded digital data (CDD).

Supposing the components of DCM COFDM signal were not to employ labeling diversity, a DCM COFDM signal receiver that linearly combines complex demodulation results from COFDM carriers conveying the same coded digital data (CDD) will recover CDD with a 3 dB greater signal-to-AWGN ratio than that of the CDD recovered from only half of the COFDM carriers. This is owing to the respective CDD conveyed by two sets of COFDM carriers being correlated, while the AWGN is not.

Maximal-ratio combining soft bits of corresponding QAM-LPLs improves signal-to-noise ratio (SNR) of reception over an AWGN channel by an additional 2.5 dB, irrespective of shaping gain. This 2.5 dB better signal-to-AWGN ratio is in line with observations concerning multiple-in/multiple-out (MIMO) reception of COFDM modulation signals from plural-antenna arrays, as reported in U.S. Pat. No. 7,236,548 titled “Bit level diversity combining for COFDM system” issued 26 Jun. 2007 to Monisha Ghosh, Joseph P. Meehan and Xuemei Ouyang.

Labeling diversity in DCM COFDM signals designed to minimize PAPR, as described in US-2019-0007255-A1, exhibits similar signal-to-AWGN ratio in received COFDM signal at similar average power levels. However, the reduced PAPR of DCM with suitable labeling diversity may permit a COFDM signal transmitter to broadcast somewhat more power over the air, while abiding with government regulation to avoid co-channel interference and/or adjacent-channel interference with other broadcasting. This increased power would contribute to overcoming the deleterious effects of AWGN on received COFM DCM signal.

If the components of DCM COFDM signal employ appropriate labeling diversity, a DCM COFDM signal receiver that uses soft-bit maximal-ratio combining (SBMRC) to recover CDD conveyed by two sets of COFDM carriers, rather than just one set, can improves the signal-to-AWGN ratio of the CDD the signal receiver recovers as much as 5.5 dB over CDD that would be recovered from just one set of the OFDM carriers. At the DCM COFDM signal transmitter, CDD is parsed into map labels each having a specified even number of bits. The map labels are mapped to a first set of QAM symbols to be conveyed by respective COFDM carriers in the DCM COFDM signal to be transmitted. The map labels are also mapped to a second set of QAM symbols to be conveyed by respective COFDM carriers in the DCM COFDM signal to be transmitted. The bits more likely to experience AWGN-caused error in the labeling of the first set of QAM symbols correspond to the bits less likely to experience AWGN-caused error in the labeling of the second set of QAM symbols, and the bits more likely to experience AWGN-caused error in the labeling of the second set of QAM symbols correspond to the bits less likely to experience AWGN-caused error in the labeling of the first set of QAM symbols.

A DCM COFDM signal receiver that uses SBMRC to recover CDD conveyed by the two sets of COFDM carriers will respond in the following way to DCM COFDM signal transmitted per the previous paragraph. In the CDD recovered by SBMRC, the bits appearing in the labeling of the first set of QAM symbols that are least likely to experience AWGN-caused error will predominate over the same bits appearing in the labeling of the second set of QAM symbols that are most likely to experience AWGN-caused error. In the CDD recovered by SBMRC, the bits appearing in the labeling of the second set of QAM symbols that are least likely to experience AWGN-caused error will predominate over the same bits appearing in the labeling of the first set of QAM symbols that are most likely to experience AWGN-caused error.

The bits appearing in the labeling of the first and second sets of square QAM symbols that are least likely to experience AWGN-caused error are no more prone to such error than corresponding CDD bits appearing in the labeling of square QAM symbols with one-quarter as many lattice points. Also, the bits appearing in the labeling of the first and second sets of QAM symbols that are about as likely to experience AWGN-caused error are no more prone to such error than corresponding CDD bits appearing in the labeling of square QAM symbols with one-quarter as many lattice points. The DCM COFDM signal can be received with none of the recovered bits of CDD being more susceptible to AWGN-caused error than any of the corresponding bits of CDD recovered from an ordinary COFDM signal without DCM. Indeed, the bits of CDD recovered from that ordinary COFDM signal that are more susceptible to AWGN-caused error can be recovered from the DCM COFDM signal with no more susceptibility to AWGN-caused error than the bits of CDD recovered from that ordinary COFDM signal that are least susceptible to AWGN-caused error.

DCM COFDM signals employing labeling diversity of the type described in the three paragraphs most previous (and in US-2019-0132161-A1) can exhibit reduced PAPR, but PAPR reduction is less than that provided by DCM COFDM signals designed to minimize PAPR, as described in US-2019-0007255-A1. US-2019-0132161-A1 indicates that PAPR reduction is better using square 16QAM symbol constellations with SCM mapping of LPLs than using square 16QAM symbol constellations with Gray mapping of LPLs. SCM mapping allows greater PAPR reduction than Gray mapping in regard to larger-size square QAM symbol constellations, too.

Superposition coded modulation (SCM) was described in detail by Li Peng, Jun Tong, Xiaojun Yuan and Qinghua Guo in their paper “Superposition Coded Modulation and Iterative Linear MMSE Detection”, IEEE Journal on Selected Areas in Communications, Vol. 27, No. 6, August 2009, pp. 995-1004. In SCM the four quadrants of square QAM symbol constellations are each Gray mapped independently from the others and from the pair of bits in the map label specifying that quadrant. Peng et alii studied iterative linear minimum-mean-square-error (LMMSE) detection being used in the reception of SCM and found that SCM offers an attractive solution for highly complicated transmission environments with severe interference. Peng et alii analyzed the impact of signaling schemes on the performance of iterative LMMSE detection to prove that among all possible signaling methods, SCM maximizes the output signal-to-noise/interference ratio (SNIR) in the LMMSE estimates during iterative detection. Their paper describes measurements that were made to demonstrate that SCM outperforms other signaling methods when iterative LMMSE detection is applied to multi-user/multi-antenna/multipath channels.

Jun Tong and Li Peng in a subsequent paper “Performance analysis of superposition coded modulation”, Physical Communication, Vol. 3, September 2010, pp. 147-155, separate SCM into two general classes: single-code superposition coded modulation (SC-SCM) and multi-code superposition coded modulation (MC-SCM). In SC-SCM the bits in the superposed code layers are generated using a single encoder. SC-SCM can be viewed as conveying a special bit-interleaved coded-modulation (BICM) scheme over successive SCM constellations. In MC-SCM the bits in the superposed code layers are generated using a plurality of encoders supplying respective codewords. MC-SCM can be viewed as conveying special-case multi-level coding (MLC) scheme over successive SCM constellations. (Single-carrier modulation is referred to as “SCM” in some texts other than this, but hereafter in this document the acronym “SCM” will be used exclusively to refer to superposition coded modulation.)

US-2019-0132161-A1 describes ways that palindromic LPLs can be disposed along diagonals of square QAM symbol constellation maps, which diagonals extend through the central points of those maps. A palindromic map label exhibits the same bit order whether read in each of two opposing directions. I. e., initial and final halves of a palindromic map label mirror each other in order of bits.

US-2019-0007255-A1 describes a technique for reducing PAPR in a DCM COFDM signal in which technique a first mapping of square QAM symbol constellations in one half of each COFDM symbol differs in the following way from a second mapping of square QAM symbol constellations in the other half. The positions of diagonally opposed quadrants in the first mapping of QAM symbol constellations are interchanged in the second mapping of QAM symbol constellations. This technique can be extended by twisting each of the quadrants around its diagonal extending toward the center of the map. These techniques for reducing PAPR differ from those described in US-2019-0132161-A1.

### SUMMARY OF THE INVENTION

Favorable labeling diversity is provided for superposition coded modulation (SCM) mapping coded digital data (CDD) to two sets of quadrature-amplitude-modulation (QAM) symbol constellations that are used for dual-carrier modulation (DCM) of carriers in coded orthogonal frequency-division modulation (COFDM) signal. More particularly, the invention is directed to increasing the data throughput of DCM COFDM signals that use labeling diversity in dual carrier modulation (DCM) for reducing peak-to-average-power ratio (PAPR) of the COFDM signals. The basic approach to increasing the data throughput is to increase the number of lattice points in the square QAM symbol constellations associated with quadrature-amplitude-modulation (QAM) of the plural carriers of the COFDM signal. Aspects of the invention concern transmitter apparatus for such DCM COFDM signals. Further aspects of the invention concern receiver apparatus for such DCM COFDM signals.

The labeling diversity is designed to constrain the peak-to-average-power ratio (PAPR) of SCM-mapped QAM symbol constellations with uniform spacing of labeled points in square lattices. Accordingly, QAM symbol constellations with lattices that are not square, such as cruciform lattices, are no longer required for their capability to constrain PAPR. QAM symbol constellations with non-uniform spacing of labeled points in square lattices are no longer required for their capability to constrain PAPR. Nor is amplitude-phase-shift keying (APSK). In COFDM receivers the demapping of SCM-mapped QAM symbol constellations is simpler when there is uniform spacing of labeled points in square lattices.

US-2019-0007255-A1 discloses how labeling diversity can significantly reduce the PAPR of COFDM signals that use dual carrier modulation (DCM), but does not address the problem of DCM halving data throughput as compared to COFDM in which segments of data are each conveyed by a single carrier. This halving of data throughput has led persons skilled in the art to dismiss the possibility of using DCM in the reduction of the PAPR of COFDM signals.

Increasing the number of lattice points in the square QAM symbol constellations to compensate for such loss of data throughput tends to increase the likelihood of error in bits of the data conveyed by each carrier of the COFDM signal and demapped therefrom in the COFDM signal receiver. This tendency, possibly together with perceived need for larger demapping circuitry in COFDM signal receivers, can direct persons skilled in the art away from increasing the number of lattice points in QAM symbol constellations to compensate for such loss of data throughput.

The need for larger demapping circuitry in COFDM signal receivers is of less concern in the age of monolithic integrated circuitry, and the reduction of PAPR simplifies the analog-to-digital conversion that precedes demapping. Doubling the number of bits in the labeling of lattice points in square QAM symbol constellations requires a squaring of the number of lattice points in each QAM symbol constellation. Doubling the number of bits in the labeling of lattice points in square QAM symbol constellations from 4 to 8 requires 256QAM to provide the same data throughput for DCM COFDM signal as 16QAM provides for COFDM signal in which data are transmitted only once. Doubling the number of bits in the labeling of lattice points in square QAM symbol constellations from 6 to 12 requires 4096QAM to provide the same data throughput for DCM COFDM signal as 64QAM provides for COFDM signal in which data are transmitted only once. It is impractical to double the number of bits in the labeling of lattice points in square QAM symbol constellations from 8 to 16 to provide the same data throughput for DCM COFDM signal as 256QAM provides for COFDM signal in which data are transmitted only once. Square 1024QAM symbol constellations can provide data throughput for DCM COFDM signal 25% greater than the data throughput 64QAM. provides for COFDM signal in which data are transmitted only once.

The tendency for an increased number of lattice points in the square QAM symbol constellations to increase the likelihood of error in bits of the data after their demapping in a COFDM signal receiver is more marked in certain of the bits used to label lattice points individually than others of the bits. The likelihood of error in bits less prone to error is apt to be comparable to the likelihood of error in bits used in labeling of square QAM symbol constellations having fewer lattice points in them, but providing similar data throughput. It will tend to be somewhat smaller because the bits with greater likelihood of error affect the bits with lesser likelihood of error as a sort of quasi-noise.

US-2019-0132161-A1 teaches that DCM COFDM signals can be designed to convey the same data via first and second sets of similar-size square QAM symbols respectively, which first and second sets of QAM symbols exhibit labeling diversity of the following sort. The square QAM symbols each have the same number of uniformly spaced labeled lattice points therein. The bits more likely to experience error in the labeling of said first set of QAM symbols correspond to the bits less likely to experience error in the labeling of said second set of QAM symbols, and the bits more likely to experience error in the labeling of said second set of QAM symbols correspond to the bits less likely to experience error in the labeling of said first set of QAM symbols. This facilitates a receiver for such DCM COFDM signal applying bit-reliability averaging (BRA) to each pair of QAM symbols conveying the same coded data. The unresolved problem before making the invention disclosed herein was finding constellation rearrangements as between the first and second sets of QAM symbols that best facilitate BRA but yet minimizing the PAPR of the DCM COFDM signal.

While further resolution of this problem might be found through extensive search using a suitably programmed computer, analytical solutions to this problem have been found, used for implementing the invention disclosed herein. US-2019-0132161-A1 does indicate that Gray-mapped first and second sets of square QAM symbols with uniform spacing between adjacent lattice points offer no reduction of the PAPR of the DCM COFDM signal, but that SCM-mapped first and second sets of square QAM symbols with uniform spacing between adjacent lattice points allow some reduction of the PAPR of the DCM COFDM signal. This observation supports narrower search for solution to the problem of how best to facilitate BRA, but yet minimize the PAPR of the DCM COFDM signal.

One can continue analytical procedures by considering each quadrant of a square QAM symbol constellation to be mapped in a complex-number plane with each labeled lattice point having respective in-phase and quadrature-phase coordinates. Next, consider each quadrant of the QAM symbol to consist of a respective set of four sub-quadrants arranged by column and row within that quadrant, an innermost one of which sub-quadrants is closest to the origin point of the complex-number plane, and an outermost one of which sub-quadrants is farthest from that origin point. Minimizing the PAPR of a DCM COFDM signal requires the labels contained in the outermost quadrants of each of the first and second sets of QAM symbol constellations to correspond to the labels contained in innermost quadrants of the other of the first and second sets of QAM symbol constellations.

Positioning the same palindromic map labels in corresponding positions in the diagonal of an outermost sub-quadrant of one of the first and second sets of QAM symbol constellations and in the diagonal of an innermost sub-quadrant of the other of the first and second sets of QAM symbol constellations helps minimize the PAPR of the DCM COFDM signal, providing that the diagonals of those sub-quadrants repose within diagonals of quadrants. The palindromic map labels allow for the mirroring of the other map labels in respective quadrants of the first and second sets of QAM symbol constellations, so BRA in a DCM COFDM signal receiver can be well facilitated.

### BRIEF DESCRIPTION OF THE DRAWINGS

FIG. 1 is a flow chart illustrative of the general method for generating DCM COFDM signaling in accordance with the invention.

FIGS. 2, 3 and 4 together form a schematic diagram of transmitter apparatus for DCM COFDM signal.

FIG. 5 is a detailed schematic diagram of any of a number of cascade connections as can be used in respective physical layer pipes of the FIG. 3 portion of the transmitter apparatus for DCM COFDM signal, each of which cascade connections comprises a parallel pair of mappers to QAM symbol constellations and a subsequent frequency interleaver.

FIG. 6 is an illustration of the preferred response of the frequency interleaver depicted in FIG. 5.

FIGS. 7 and 8 depict first and second SCM maps of square 16QAM symbol constellations, the correspondingly positioned labels of which mirror each other in their orders of bits.

FIG. 9 is a third SCM map of square 16QAM symbol constellations modifying the FIG. 7 first SCM map of 16QAM symbol constellations by (a) exchanging the positions of −I,+Q and +I,−Q quadrants going from the FIG. 7 map to the FIG. 9 map and (b) exchanging the positions of +I,+Q and −I,−Q quadrants going from the FIG. 7 map to the FIG. 9 map.

FIG. 10 is a fourth SCM map of 16QAM symbol constellations modifying the FIG. 9 third SCM map of 16QAM symbol constellations by diagonally twisting the pattern of map labels in each quadrant.

FIG. 11 is a fifth SCM map of square 16QAM symbol constellations modifying the FIG. 8 second SCM map of 16QAM symbol constellations by (a) exchanging the positions of −I,+Q and +I,−Q quadrants going from the FIG. 8 map to the FIG. 11 map and (b) exchanging the positions of +I,+Q and −I,−Q quadrants going from the FIG. 8 map to the FIG. 11 map.

FIG. 12 is a sixth SCM map of 16QAM symbol constellations modifying the FIG. 11 fifth SCM map of 16QAM symbol constellations by diagonally twisting the pattern of map labels in each quadrant.

FIGS. 13, 14, 15, 16, 17 and 18 present decimal labeling for the SCM maps of 16QAM symbol constellations depicted in FIGS. 7, 8, 9, 10, 11 and 12 respectively.

FIGS. 19 and 20 depict first and second SCM maps of square 64QAM symbol constellations, the correspondingly positioned labels of which mirror each other in their orders of bits.

FIG. 21 is a third SCM map of square 64QAM symbol constellations modifying the FIG. 19 first SCM map of 64QAM symbol constellations by (a) exchanging the positions of −I,+Q and +I, −Q quadrants going from the FIG. 19 map to the FIG. 21 map and (b) exchanging the positions of +I,+Q and −I, −Q quadrants going from the FIG. 19 map to the FIG. 21 map.

FIG. 22 is a fourth SCM map of 64QAM symbol constellations modifying the FIG. 21 third SCM map of 64QAM symbol constellations by diagonally twisting the pattern of map labels in each quadrant.

FIG. 23 is a fifth SCM map of square 64QAM symbol constellations modifying the FIG. 20 second SCM map of 64QAM symbol constellations by (a) exchanging the positions of −I,+Q and +I, −Q quadrants going from the FIG. 20 map to the FIG. 23 map and (b) exchanging the positions of +I,+Q and −I, −Q quadrants going from the FIG. 20 map to the FIG. 23 map.

FIG. 24 is a sixth SCM map of 64QAM symbol constellations modifying the FIG. 23 fifth SCM map of 64QAM symbol constellations by diagonally twisting the pattern of map labels in each quadrant.

FIGS. 25, 26, 27, 28, 29 and 30 present decimal labeling for the SCM maps of 64QAM symbol constellations depicted in FIGS. 19, 20, 21, 22, 23 and 24 respectively.

FIG. 31 and FIG. 32 are seventh and eighth SCM maps of 64QAM symbol constellations, respectively, which maps have preferred labeling diversity from each other.

FIGS. 33 and 34 present decimal labeling for the seventh and eighth SCM maps of 64QAM symbol constellations, respectively.

FIG. 35 and FIG. 36 are ninth and tenth SCM maps of 64QAM symbol constellations, respectively, which maps have preferred labeling diversity from each other.

FIGS. 37 and 38 present decimal labeling for the ninth and tenth SCM maps of 64QAM symbol constellations, respectively.

FIG. 39 and FIG. 40 are eleventh and twelfth SCM maps of 64QAM symbol constellations, respectively, which maps have preferred labeling diversity from each other.

FIGS. 41 and 42 present respective decimal labelings for eleventh and twelfth SCM maps of 64QAM symbol constellations, respectively.

FIG. 43 and FIG. 44 are thirteenth and fourteenth SCM maps of 64QAM symbol constellations, respectively, which maps have preferred labeling diversity from each other.

FIGS. 45 and 46 present decimal labelings for thirteenth and fourteenth SCM maps of 64QAM symbol constellations, respectively

FIG. 47 depicts the central portion of a first SCM map of square 256QAM symbol constellations.

FIG. 48 depicts the central portion of a second SCM map of square 256QAM symbol constellations.

FIGS. 49, 50, 51 and 52 depict respective quadrants of the first SCM map of square 256QAM symbol constellations.

FIGS. 53, 54, 55 and 56 depict respective quadrants of the second SCM map of square 256QAM symbol constellations.

FIGS. 57, 58, 59 and 60 depict respective quadrants of a third SCM map of square 256QAM symbol constellations having a preferred labeling diversity from the first SCM map of square 256QAM symbol constellations.

FIGS. 61, 62, 63 and 64 depict respective quadrants of a fourth SCM map of square 256QAM symbol constellations having a preferred labeling diversity from the first SCM map of square 256QAM symbol constellations.

FIGS. 65, 66, 67 and 68 depict respective quadrants of a fifth SCM map of square 256QAM symbol constellations having a preferred labeling diversity from the second SCM map of square 256QAM symbol constellations.

FIGS. 69, 70, 71 and 72 depict respective quadrants of a sixth SCM map of square 256QAM symbol constellations having a preferred labeling diversity from the second SCM map of square 256QAM symbol constellations.

FIG. 73 presents decimal labeling for the first SCM map of 256QAM symbol constellations depicted in FIGS. 49, 50, 51 and 52.

FIG. 74 presents decimal labeling for the second SCM map of 256QAM symbol constellations depicted in FIGS. 53, 54, 55 and 56.

FIG. 75 presents decimal labeling for the third SCM map of 256QAM symbol constellations depicted in FIGS. 57, 58, 59 and 60.

FIG. 76 presents decimal labeling for the fourth SCM map of 256QAM symbol constellations depicted in FIGS. 61, 62, 63 and 64.

FIG. 77 presents decimal labeling for the fifth SCM map of 256QAM symbol constellations depicted in FIGS. 65, 66, 67 and 68.

FIG. 78 presents decimal labeling for the sixth SCM map of 256QAM symbol constellations depicted in FIGS. 65, 66, 67 and 68.

FIGS. 79 and 80 present respective decimal labeling for seventh and eighth SCM maps of 256QAM symbol constellations, which labelings have preferred labeling diversity from each other.

FIGS. 81 and 82 present respective decimal labeling for ninth and tenth SCM maps of 256QAM symbol constellations, which labelings have preferred labeling diversity from each other.

FIGS. 83 and 84 present respective decimal labeling for eleventh and twelfth SCM maps of 256QAM symbol constellations, which labelings have preferred labeling diversity from each other.

FIGS. 85 and 86 present respective decimal labeling for thirteenth and fourteenth SCM maps of 256QAM symbol constellations, which labelings have preferred labeling diversity from each other.

FIG. 87 depicts the central portion of a first SCM map of square 256QAM symbol constellations alternative to the FIG. 31 first SCM map of square 256QAM symbol constellations.

FIG. 88 depicts the central portion of a second SCM map of square 256QAM symbol constellations alternative to the FIG. 32 second SCM map of square 256QAM symbol constellations.

FIG. 89 lists the palindromic map labels in diagonals of the −I,+Q quadrants of first and second SCM maps of 16QAM, 64QAM, 256QAM, 1024QAM and 4096QAM.

FIG. 90 lists the palindromic map labels in diagonals of the +I,+Q quadrants of first and second SCM maps of 16QAM, 64QAM, 256QAM, 1024QAM and 4096QAM.

FIG. 91 lists the palindromic map labels in diagonals of the +I,−Q quadrants of first and second SCM maps of 16QAM, 64QAM, 256QAM, 1024QAM and 4096QAM.

FIG. 92 lists the palindromic map labels in diagonals of the −I,−Q quadrants of first and second SCM maps of 16QAM, 64QAM, 256QAM, 1024QAM and 4096QAM.

FIGS. 93 and 94 together form a schematic diagram of the general structure of single-sideband receiver apparatus adapted for receiving DCM COFDM signals.

FIG. 95 is a detailed schematic diagram of modifications made to the receiver apparatus shown in FIG. 94 to arrange for performing soft-demapping and soft-decoding procedures iteratively in accordance with the “turbo” principle.

FIG. 96 is a schematic diagram of a diversity combiner that can be used for combining the results of dual QAM demapping in either of the configurations depicted in FIGS. 94 and 95, which diversity combiner comprises a maximal-ratio combiner of corresponding soft bits of respective similar labels of each successive pair of QAM symbols from dual QAM-symbol demapping procedures, which maximal-ratio combiner is operative on soft bits at bit level, rather than at symbol level.

FIG. 97 is a schematic diagram of a diversity combiner that can be used for combining the results of dual QAM demapping either of the configurations depicted in FIGS. 94 and 95, which diversity combiner comprises a maximal-ratio combiner operative on soft bits at bit level, rather than at symbol level, the demapping results of the dual QAM demappers being adjusted prior to application to the maximal-ratio combiner thus to implement a degree of selective diversity combining.

FIG. 98 is a schematic diagram of a variant of the FIG. 93 receiver structure.

FIG. 99 is a schematic diagram of COFDM transmitter apparatus that is configured for transmitting DCM COFDM signals using independent-sideband (ISB) amplitude modulation of a center-channel principal carrier frequency.

FIGS. 100 and 94 together form a schematic diagram of the general structure of receiver apparatus for DCM COFDM signals using respective phase-shift methods to respond separately to the concurrent lower-frequency and upper-frequency subbands of those signals.

FIG. 101 is a schematic diagram of a two-phase divide-by-four frequency divider constructed from gated D flip-flops or data latches, which sort of frequency divider is an element in the receiver apparatus depicted in FIGS. 100, 103, 104, 105, 107 and 108.

FIG. 102 is a schematic diagram of double superheterodyne front-end tuner structure suitable for inclusion in any of the apparatuses for demodulating DCM COFDM signals depicted in FIGS. 100, 103, 104 and 105.

FIGS. 103 and 94 together form a schematic diagram of a variant of the receiver apparatus for demodulation of DCM COFDM signal that is depicted in FIGS. 100 and 94, digital circuitry depicted in FIG. 103 replacing some of the analog circuitry depicted in FIG. 100.

FIGS. 104 and 94 together form a schematic diagram of the general structure of receiver apparatus for demodulation of DCM COFDM signals using phase-shift methods modified in a first manner.

FIGS. 105 and 94 together form a schematic diagram of a variant of the receiver apparatus for demodulation of DCM COFDM signals depicted in FIGS. 104 and 94, digital circuitry depicted in FIG. 105 replacing some of the analog circuitry depicted in FIG. 104.

FIG. 106 is a schematic diagram of a modification suitable both for the FIG. 104 receiver structure and for the FIG. 105 receiver structure.

FIGS. 107 and 94 together form a schematic diagram of the general structure of receiver apparatus to process DCM COFDM signals using Weaver methods.

FIGS. 108 and 94 together form a schematic diagram of receiver apparatus for demodulation of DCM COFDM signals using modified phase-shift methods to respond separately to the concurrent lower-frequency and upper-frequency subbands of those signals after discrete Fourier transforms of those subbands are computed.

FIG. 109 is a schematic diagram of a double superheterodyne front-end tuner structure suitable for inclusion in each of the apparatuses for demodulating DCM COFDM signals depicted in FIGS. 107 and 108.

### DETAILED DESCRIPTION

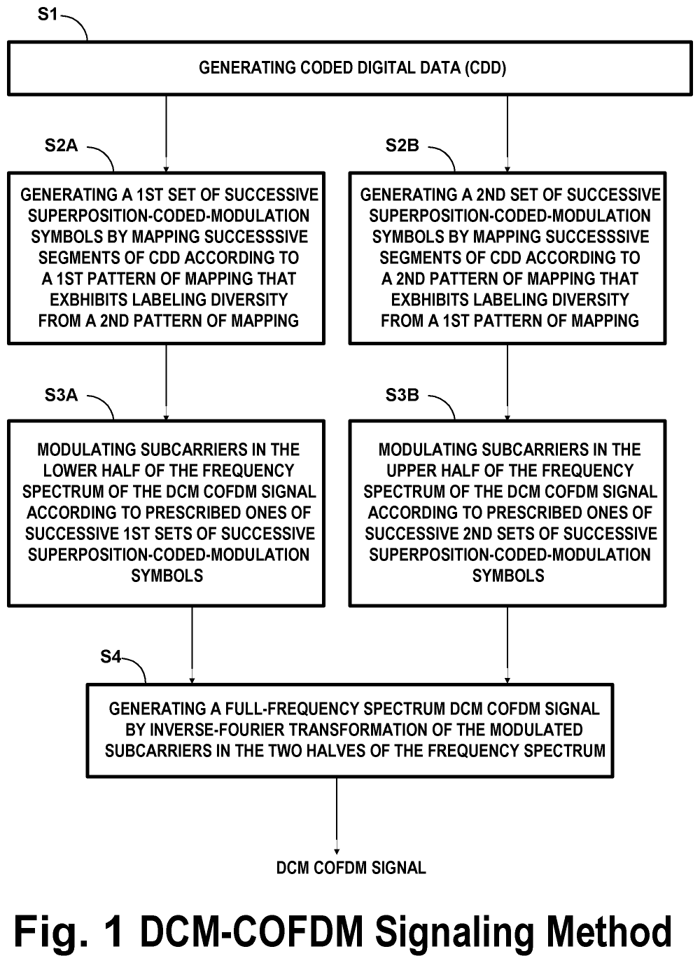

The FIG. 1 flow chart illustrates the general method for generating DCM COFDM signaling in accordance with the invention. Coded digital data (CDD) is generated in an initial step S1 of the method. The coding of digital data in step S1 customarily employs a forward-error-correction (FEC) code. The CDD is utilized by a pair of second steps S2A and S2B of the method, in which successive segments of CDD are mapped to appropriate points of successive complex-amplitude-modulation (CAM) symbol constellations. The CAM symbols can be quadrature-amplitude-modulation (QAM) symbols with non-uniform spacing between lattice points (so-called“NuQAM”), or amplitude-phase-shift-keying (APSK) symbols, or quadrature-phase-keying (QPSK) symbols. Preferably, however, the CAM symbols are square QAM symbols with uniform spacing between lattice points. Such CAM symbols are the easiest to demap in a DCM COFDM signal receiver.

In step S2A a first set of successive complex-amplitude-modulation symbols are generated by mapping successive segments of the CDD to points in respective CAM symbols in accordance with a first pattern of mapping. In step S2B a second set of successive complex-amplitude-modulation symbols are generated by mapping successive segments of the CDD to points in respective CAM symbols in accordance with a second pattern of mapping. The first and second patterns differ from each other to provide labeling diversity between them.

The pair of second steps S2A and S2B of the method are followed by respective ones of third steps S3A and S3B of the method. In step S3A the carriers in the lower half of the frequency spectrum of the DCM COFDM signal are modulated in accordance with prescribed respective ones of each successive first set of successive complex-amplitude-modulation symbols. In step S3B the carriers in the upper half of the frequency spectrum of the DCM COFDM signal are modulated in accordance with prescribed respective ones of each successive second set of successive complex-amplitude-modulation symbols. Preferably, pairs of COFDM carriers conveying the same coded CDD are spaced a uniform distance apart in the lower and upper halves of the frequency spectrum of the DCM COFDM signal.

The pair of third steps S3A and S3B of the method are followed by a fourth step S4 of the method, in which fourth step S4 a full-frequency-spectrum signal DCM COFDM is generated by inverse Fourier transformation of the carriers in the lower and upper halves of the frequency spectrum of the DCM COFDM signal from the time domain to the frequency domain. FIG. 1 does not show some details of how the full-frequency-spectrum signal DCM COFDM is generated, such as the insertion of guard intervals and optional cyclic prefixes.

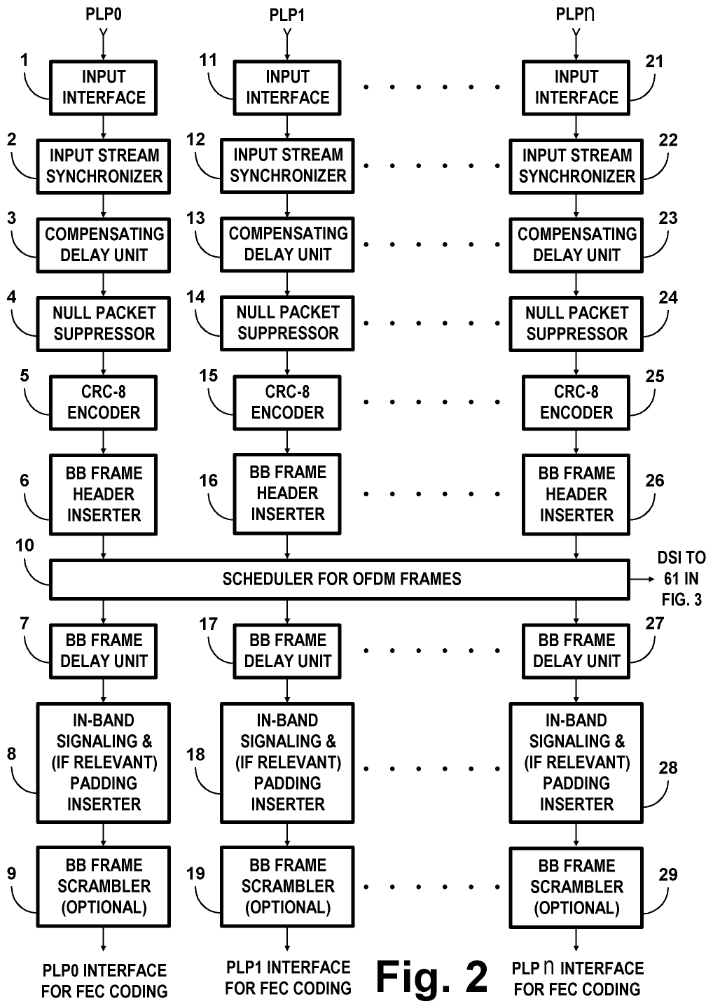

Together, FIGS. 2, 3 and 4 depict in considerable detail a DTV transmitter apparatus generating DCM COFDM signals designed for reception by DTV receivers. FIG. 2 depicts apparatus for generating baseband frames (BBFRAMES) at physical-layer-pipe (PLP) interfaces. FIG. 4 depicts apparatus for generating bit-wise forward-error-correction (FEC) coding and subsequent COFDM symbol blocks responsive to the BBFRAMEs supplied at the PLP interfaces. FIG. 5 depicts apparatus for generating and transmitting radio-frequency COFDM signals. Much of the DTV transmitter apparatus depicted in FIGS. 2, 3 and 4 is similar to that specified in European Telecommunications Standards Institute (ETSI) standard EN 302 755 V1.3.1 published in April 2012, titled “Digital Video Broadcasting (DVB); Frame structure channel coding and modulation for a second-generation digital terrestrial television broadcasting system (DVB-T2)”, and incorporated herein by reference.

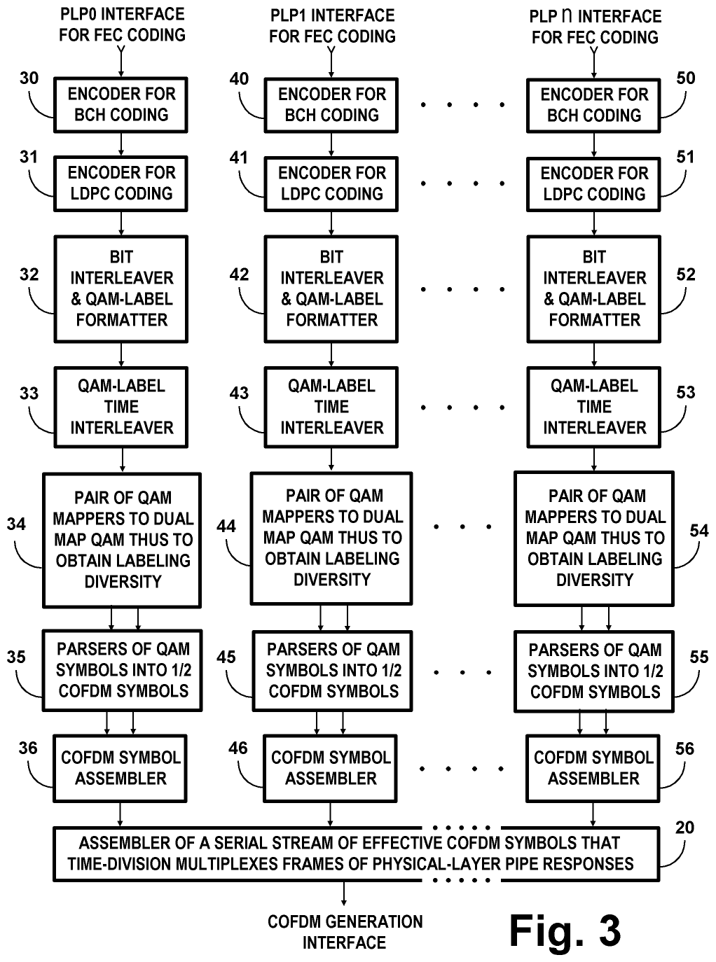

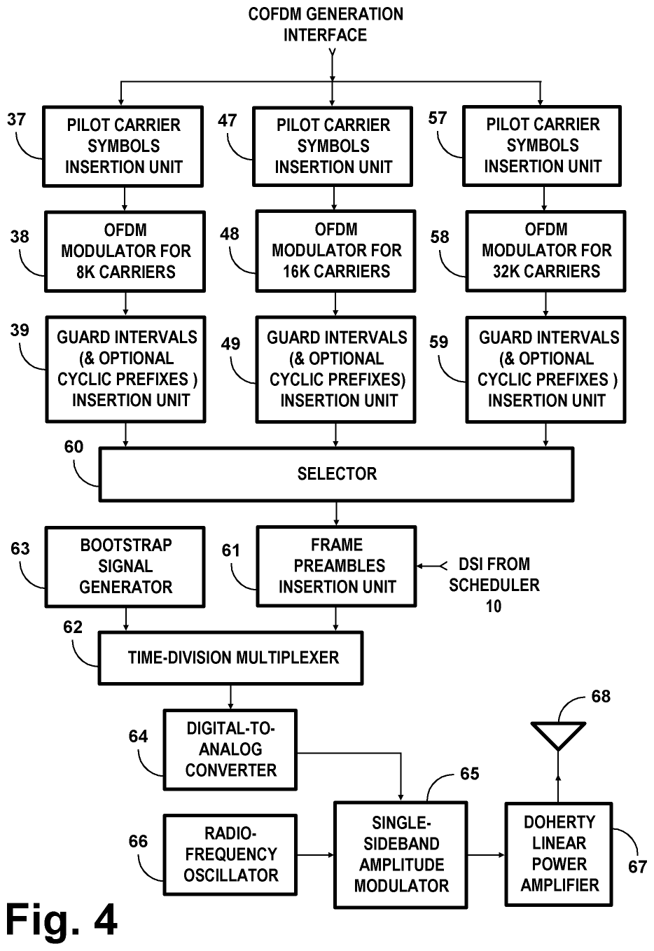

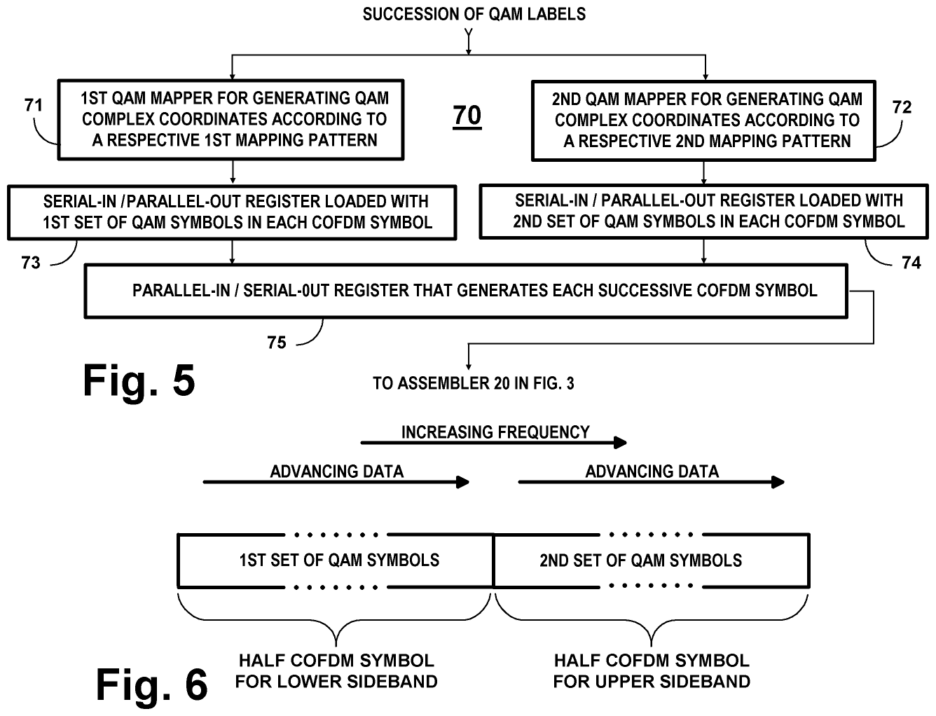

A scheduler 10 for interleaving time-slices of services to be broadcast to stationary DTV receivers is depicted in the middle of FIG. 2. The scheduler 10 schedules transmissions of time slices for a number (n+1) of physical layer pipes (PLPs), n being a positive integer at least zero. FIGS. 2 and 3 identify these PLPs by the letters “PLP” followed respectively by consecutive positive integers of a modulo-(n+1) numbering system. The scheduler 10 also generates and schedules dynamic scheduling information (DSI) for application to an additional PLP depicted in FIG. 5, which additional PLP generates OFDM symbol blocks that convey the DSI and first layer conformation specifications in respective pilot symbols P1 and P2 in preambles of OFDM frames. Recommended practice is that at least the physical layer pipe PLP0 is a so-called “common” PLP used for transmitting data, such as a program guide, relating to the other “data” PLPs. At least one common PLP is transmitted in each OFDM frame following the P1 and P2 symbols, but before the data PLP or PLPs. A data PLP may be of a first type transmitted as a single slice per OFDM frame, or a data PLP may be of a second type transmitted as a plurality of sub-slices disposed in non-contiguous portions of each OFDM frame to achieve greater time diversity.

FIG. 2 depicts the (n+1)th physical layer pipe PLP0 comprising elements 1-6 in cascade connection before the scheduler 10 and further comprising elements 7-9 in cascade connection after the scheduler 10, but before a PLP0 interface for forward-error-correction (FEC) coding. More specifically, FIG. 2 indicates that a PLP0 stream of logical digital data is supplied to the input port of an input interface 1, the output port of which connects to the input port of an input stream synchronizer 2. The output port of the input stream synchronizer 2 connects to the input port of a compensating delay unit 3, the output port of which connects to the input port of a null-packet suppressor 4. The output port of the null-packet suppressor 4 connects to the input port of a CRC-8 encoder 5 operative at user packet level, the output port of which connects to the input port of an inserter 6 of headers for baseband (BB) frames. The output port of the BBFRAME header inserter 6 connects to a respective input port of the scheduler 10. The physical layer pipe PLP0 continues following the scheduler 10, with FIG. 2 showing a respective output port of the scheduler 10 connecting to the input port of a delay unit 7 for delaying baseband (BB) frames. FIG. 1 shows the output port of the BBFRAME delay unit 7 connecting to the input port of an inserter 8 for inserting in-band signaling into BBFRAMEs, which in-band signaling essentially consists of dynamic scheduling information (DSI) generated by the scheduler 10, and/or for inserting padding into the BBFRAME. Padding is inserted in circumstances when the user data available for transmission is insufficient to fill a BBFRAME completely, or when an integer number of user packets is required to be allocated to a BBFRAME. FIG. 2 shows the output port of the inserter 8 connecting to the input port of a BBFRAME scrambler 9, which data randomizes bits of the BBFRAME supplied from the output port of the BBFRAME scrambler 9 as the PLP0 interface for FEC coding. In practice the delay unit 7, the inserter 8 and the BBFRAME scrambler 9 are realized by suitable configuration of a multi-port random-access memory.

FIG. 2 depicts the first physical layer pipe PLP1 comprising elements 11-16 in cascade connection before the scheduler 10 and further comprising elements 17-19 in cascade connection after the scheduler 10, but before a PLP1 interface for forward-error-correction (FEC) coding. More specifically, FIG. 2 indicates that a PLP1 stream of logical digital data is supplied to the input port of an input interface 11, the output port of which connects to the input port of an input stream synchronizer 12. The output port of the input stream synchronizer 12 connects to the input port of a compensating delay unit 13, the output port of which connects to the input port of a null-packet suppressor 14. The output port of the null-packet suppressor 14 connects to the input port of a CRC-8 encoder 15 operative at user packet level, the output port of which connects to the input port of an inserter 16 of headers for BBFRAMEs. The output port of the BBFRAME header inserter 16 connects to a respective input port of the scheduler 10. The physical layer pipe PLP1 continues following the scheduler 10, with FIG. 2 showing a respective output port of the scheduler 10 connecting to the input port of a delay unit 17 for delaying BBFRAMEs. FIG. 2 shows the output port of the BBFRAME delay unit 17 connecting to the input port of an inserter 18 for inserting in-band signaling into BBFRAMEs, which in-band signaling essentially consists of DSI generated by the scheduler 10, and/or for inserting padding into the BBFRAME. FIG. 2 shows the output port of the inserter 18 connecting to the input port of a BBFRAME scrambler 19, which data-randomizes bits of the BBFRAME supplied from the output port of the BBFRAME scrambler 19 as the PLP1 interface for FEC coding. In practice the delay unit 17, the inserter 18 and the BBFRAME scrambler 19 are realized by suitable operation of a multi-port random-access memory.

FIG. 2 depicts the (n)th physical layer pipe PLPn comprising elements 21-26 in cascade connection before the scheduler 10 and further comprising elements 27-29 in cascade connection after the scheduler 10, but before a PLPn interface for forward-error-correction (FEC) coding. More specifically, FIG. 2 indicates that a PLPn stream of logical digital data is supplied to the input port of an input interface 21, the output port of which connects to the input port of an input stream synchronizer 22. The output port of the input stream synchronizer 22 connects to the input port of a compensating delay unit 23, the output port of which connects to the input port of a null-packet suppressor 24. The output port of the null-packet suppressor 24 connects to the input port of a CRC-8 encoder 25 operative at user packet level, the output port of which connects to the input port of an inserter 26 of headers for BBFRAMEs. The output port of the BBFRAME header inserter 26 connects to a respective input port of the scheduler 10. The physical layer pipe PLPn continues following the scheduler 10, with FIG. 2 showing a respective output port of the scheduler 10 connecting to the input port of a delay unit 27 for delaying BBFRAMEs. FIG. 2 shows the output port of the BBFRAME delay unit 27 connecting to the input port of an inserter 28 for inserting in-band signaling into BBFRAMEs, which in-band signaling essentially consists of dynamic scheduling information (DSI) generated by the scheduler 10, and/or for inserting padding into the BBFRAME. FIG. 2 shows the output port of the inserter 28 connecting to the input port of a BBFRAME scrambler 29, which data randomizes bits of the BBFRAME supplied from the output port of the BBFRAME scrambler 29 as the PLPn interface for FEC coding. In practice the delay unit 27, the inserter 28 and the BBFRAME scrambler 29 are apt to be realized by appropriate operation of a multi-port random-access memory.

The input stream synchronizers 2, 12, 22 etc. are operable to guarantee Constant Bit Rate (CBR) and constant end-to-end transmission delay for any input data format when there is more than one input data format. Some transmitters may omit ones of the input stream synchronizers 2, 12, 22 etc. or ones of the compensating delay units 3, 13, 23 etc. For some Transport-Stream (TS) input signals, a large percentage of null-packets may be present in order to accommodate various bit-rate services in a constant bit-rate TS. In such case, to avoid unnecessary transmission overhead, the null-packet suppressors 4, 14, 24 etc. identify TS null-packets from the packet-identification (PID) sequences in their packet headers and remove those TS null-packets from the data streams to be scrambled by the BBFRAME scramblers 9, 19, 29 etc. This removal is done in a way such that the removed null-packets can be re-inserted in the receiver in the exact positions they originally were in, thus guaranteeing constant bit-rate and avoiding the need for updating the Program Clock Reference (PCR) or time-stamp. Further details of the operation of the input stream synchronizers 2, 12, 22 etc.; the compensating delay units 3, 13, 23 etc.; and the null-packet suppressors 4, 14, 24 etc. can be gleaned from ETSI standard EN 302 755 V1.3.1 for DVB-T2.

FIG. 3 specifically indicates FEC coding to be concatenated BCH/LDPC coding composed of Bose-Chaudhuri-Hocquenghem (BCH) outer block coding and low-density parity-check (LDPC) inner block coding, which FEC coding is currently favored in the DVB-T2 broadcasting art. Alternatively, the FEC coding can take any one of a variety of other forms, including concatenated Reed-Solomon (RS) outer coding and turbo inner coding—e.g., as specified by the earlier DVB-T broadcast standard.

FIG. 3 depicts the (n+1)th physical layer pipe PLP0 further comprising elements 30-38 in cascade connection after the PLP0 interface for FEC coding, but before a respective input port of an assembler 20 for assembling a serial stream of effective COFDM symbols. More specifically, FIG. 3 depicts an encoder 30 for BCH coding with its input port connected to receive the PLP0 FEC-coding interface signal from the output port of the BBFRAME scrambler 9 and with its output port connected to the input port of an encoder 31 for LDPC coding. The output port of the encoder 31 connects to the input port of a bit interleaver and QAM-label formatter 32. FIG. 3 depicts the output port of the bit interleaver and QAM-label formatter 32 connected to the input port of a time interleaver 33 for successive QAM labels. The time interleaver 33 shuffles the order of the QAM symbols in each successive FEC block. This shuffling implements cyclic delay diversity (CDD) that helps the FEC coding to overcome fading. The output port of the QAM-label time interleaver 33 connects to the respective input ports of a pair 34 of QAM mappers for dual mapping successive QAM labels to the complex coordinates of respective successions of QAM symbol constellations. The two QAM mappers in the pair 34 of them map same coded data to QAM of their respective OFDM carriers according to respective patterns that differ from each other, thereby to implement labeling diversity.

Conventional practice for over-the-air broadcasting of COFDM television signals without DCM has been to use 16QAM or 64QAM symbol constellations to facilitate reception by mobile DTV receivers and by DTV receivers with indoor antennas. When DCM with labeling diversity is employed 256QAM symbol constellations have to be broadcast to achieve data throughput similar to that when 16QAM symbol constellations is used in COFDM signals without DCM. When DCM with labeling diversity is employed 4096QAM symbol constellations have to be broadcast to achieve data throughput similar to that when 64QAM symbol constellations is used in COFDM signals without DCM.

The respective output ports of the pair 34 of QAM mappers are connected for supplying first and second sets of successive QAM symbol constellations to respective input ports of parsers 35 of the first and second sets of successive of QAM symbols into respective successions of half COFDM symbols. These successions of half COFDM symbols are supplied to first and second input ports of a COFDM symbol assembler 36, which responds to their half COFDM symbols alternately to generate complete COFDM symbols. The output port of the COFDM symbol assembler 36 is connected to a respective input port of the assembler 20 of a serial stream of effective COFDM symbols, in which frames of PLP responses from the various physical layer pipes are time-division multiplexed. Together, the parsers 35 and the COFDM symbol assembler 36 combine to provide a COFDM symbol generator for arranging successive ones of the first set of QAM symbols in first prescribed order in initial halves of successive COFDM symbols and arranging successive ones of the second set of QAM symbols in second prescribed order in final halves of successive COFDM symbols.

FIG. 3 depicts the first physical layer pipe PLP1 further comprising elements 40-46 in cascade connection after the PLP1 interface for FEC coding, but before a respective input port of the assembler 20 for assembling a serial stream of effective COFDM symbols. More specifically, FIG. 3 depicts an encoder 40 for BCH coding with its input port connected to receive the PLP1 FEC-coding interface signal from the output port of the BBFRAME scrambler 19 and with its output port connected to the input port of an encoder 41 for LDPC coding. The output port of the encoder 41 is connected to the input port of a bit interleaver and QAM-label formatter 42. FIG. 3 depicts the output port of the bit interleaver and QAM-label formatter 42 connected to the input port of a time interleaver 43 for successive QAM labels. The time interleaver 43 shuffles the order of the QAM symbols in each successive FEC block. This shuffling implements cyclic delay diversity that helps the FEC coding to overcome fading. The output port of the QAM-label time interleaver 43 connects to the respective input ports of pair 44 of QAM mappers for dual-mapping successive QAM labels to the complex coordinates of respective successions of QAM symbol constellations. The two QAM mappers in the pair 44 of them map same coded data to QAM of their respective OFDM carriers according to respective patterns that differ from each other, thereby to implement labeling diversity.

The respective output ports of the pair 44 of QAM mappers are connected for supplying first and second sets of successive QAM symbol constellations to respective input ports of parsers 45 of the first and second sets of successive of QAM symbols into respective successions of half COFDM symbols. These successions of half COFDM symbols are supplied to first and second input ports of a COFDM symbol assembler 46, which responds to their half COFDM symbols alternately to generate complete COFDM symbols. The output port of the COFDM symbol assembler 46 is connected to a respective input port of the assembler 20 of a serial stream of effective COFDM symbols, in which frames of PLP responses from the various physical layer pipes are time-division multiplexed. Together, the parsers 45 and the COFDM symbol assembler 46 combine to provide a COFDM symbol generator for arranging successive ones of the first set of QAM symbols in first prescribed order in initial halves of successive COFDM symbols and arranging successive ones of the second set of QAM symbols in second prescribed order in final halves of successive COFDM symbols.

FIG. 3 depicts the (n)th physical layer pipe PLPn further comprising elements 50-55 in cascade connection after the PLP0 interface for FEC coding, but before a respective input port of the assembler 20 for assembling a serial stream of effective COFDM symbols. More specifically, FIG. 3 depicts an encoder 50 for BCH coding with its input port connected to receive the PLPn FEC-coding interface signal from the output port of the BBFRAME scrambler 29 and with its output port connected to the input port of an encoder 51 for LDPC coding. The output port of the encoder 51 is connected to the input port of bit interleaver and QAM-label formatter 52. FIG. 3 depicts the output port of the bit interleaver and QAM-label formatter 52 connected to the input port of a time interleaver 53 for successive QAM labels. The time interleaver 53 shuffles the order of the QAM symbols in each successive FEC block. This shuffling implements cyclic delay diversity (CDD) that helps the FEC coding to overcome fading. The output port of the QAM-label time interleaver 53 connects to the respective input ports of a pair 54 of QAM mappers for dual mapping successive QAM labels to the complex coordinates of respective successions of QAM symbol constellations. The two QAM mappers in the pair 54 of them map same coded data to QAM of their respective OFDM carriers according to respective patterns that differ from each other, thereby to implement labeling diversity.

The respective output ports of the pair 54 of QAM mappers are connected for supplying first and second sets of successive QAM symbol constellations to respective input ports of parsers 55 of the first and second sets of successive of QAM symbols into respective successions of half COFDM symbols. These successions of half COFDM symbols are supplied to first and second input ports of a COFDM symbol assembler 46, which responds to their half COFDM symbols alternately to generate complete COFDM symbols. The output port of the COFDM symbol assembler 46 is connected to a respective input port of the assembler 20 of a serial stream of effective COFDM symbols, in which frames of PLP responses from the various physical layer pipes are time-division multiplexed. Together, the parsers 55 and the COFDM symbol assembler 46 combine to provide a COFDM symbol generator for arranging successive ones of the first set of QAM symbols in first prescribed order in initial halves of successive COFDM symbols and arranging successive ones of the second set of QAM symbols in second prescribed order in final halves of successive COFDM symbols.

Customarily there is a number of other physical layer pipes besides PLP0, PLP1 and PLPn, which other physical layer pipes are identified by the prefix PLP followed by respective ones of consecutive numbers two through (n−1). Each of the PLPs, n+1 in number, may differ from the others in at least one aspect. One possible difference between these n+1 PLPs concerns the natures of the FEC coding these PLPs respectively employ. The current trend is to use concatenated BCH coding and LDPC block coding for the FEC coding, but concatenated Reed-Solomon coding and convolutional coding have been used in the past. EN 302 755 V1.3.1 for DVB-T2 specifies a block size of 54,800 bits for normal FEC frames as a first alternative, and a block size of 16,200 bits is specified for short FEC frames as a second alternative. Also, a variety of different LDPC code rates are authorized. PLPs may differ in the number of OFDM carriers involved in each of their spectral samples, which affects the size of the DFT used for demodulating those OFDM carriers. Another possible difference between PLPs concerns the natures of the QAM symbol constellations (or possibly other modulation symbol constellations) they respectively employ.

FIG. 3 indicates that the output port of the assembler 20 of a serial stream of effective COFDM symbols, in which frames of PLP responses from the various physical layer pipes are time-division multiplexed, connects to subsequent elements via a COFDM generation interface depicted in both FIGS. 2 and 3. These subsequent elements are depicted in FIG. 3, which indicates where pilot carrier symbols are inserted into the effective COFDM symbol to generate complete COFDM symbols to be supplied to at least one COFDM modulator. Preferably, the pilot carrier symbols for modulating the OFDM carriers in the upper subband of the DCM COFDM signal are similar to those specified for DSB-COFDM signal in the ATSC 3.0 Standard for DTV Broadcasting and are similarly positioned in each COFDM frame, and the pilot carrier symbols for modulating the OFDM carriers in the lower subband of the DCM COFDM signal mirror those in the upper subband both as to modulation and positioning in each COFDM frame.

FIG. 4 depicts a pilot-carrier symbols insertion unit 37 having an input port connected for receiving the serial stream of effective COFDM symbols supplied from the FIG. 3 assembler 20 thereof via the COFDM generation interface. The pilot-carrier symbols insertion unit 37 introduces pilot symbols for the lower- and upper-frequency edges of a complete COFDM symbol and inserts pilot carrier symbols at suitable intervals between QAM symbols in each effective COFDM symbol to generate the rest of a respective complete COFDM symbol suitable for a subsequent 8K I-FFT. The output port of the pilot-carrier symbols insertion unit 37 is connected for supplying complete COFDM symbols to the input port of an OFDM modulator 38 which performs that subsequent 8K I-FFT. That is, the pilot-carrier symbols insertion unit 37 cooperates with the assembler 20 of a serial stream of effective COFDM symbols to form a COFDM symbol generator for supplying complete COFDM symbols to the OFDM modulator 38 that is the initial element of a subsequent generator of DCM COFDM radio-frequency signal. Preferably, the pilot-carrier symbols insertion units 37 arranges for the insertion of a pilot carrier at midband, to facilitate separation of the lower-frequency and upper-frequency subbands of the DCM COFDM signal in a receiver for such signal. FIG. 4 shows the output port of the OFDM modulator 38 connected for supplying 8K I-FFT results directly to the input port of a guard intervals insertion unit 39. Preferably, the guard intervals insertion unit 39 inserts a respective cyclic prefix within each guard interval.

FIG. 4 depicts a pilot-carrier symbols insertion unit 47 having an input port connected for receiving the serial stream of effective COFDM symbols supplied from the FIG. 3 assembler 20 thereof via the COFDM generation interface. The pilot-carrier symbols insertion unit 47 introduces pilot symbols for the lower- and upper-frequency edges of a complete COFDM symbol and inserts pilot carrier symbols at suitable intervals between QAM symbols in each effective COFDM symbol to generate the rest of a respective complete COFDM symbol suitable for a subsequent 16K I-FFT. The output port of the pilot-carrier symbols insertion unit 47 is connected for supplying complete COFDM symbols to the input port of an OFDM modulator 48 which performs that subsequent 16K I-FFT. That is, the pilot-carrier symbols insertion unit 47 cooperates with the assembler 20 of a serial stream of effective COFDM symbols to form a COFDM symbol generator for supplying complete COFDM symbols to the OFDM modulator 48 that is the initial element of a subsequent generator of DCM COFDM radio-frequency signal. Preferably, the pilot-carrier symbols insertion units 47 arranges for the insertion of a pilot carrier at midband, to facilitate separation of the lower-frequency and upper-frequency subbands of the DCM COFDM signal in a receiver for such signal. FIG. 4 shows the output port of the OFDM modulator 48 connected for supplying 16K I-FFT results directly to the input port of a guard intervals insertion unit 49. Preferably, the guard intervals insertion unit 49 inserts a respective cyclic prefix within each guard interval.

FIG. 4 depicts a pilot-carrier symbols insertion unit 57 having an input port connected for receiving the serial stream of effective COFDM symbols supplied from the FIG. 3 assembler 20 thereof via the COFDM generation interface. The pilot-carrier symbols insertion unit 57 introduces pilot symbols for the lower- and upper-frequency edges of a complete COFDM symbol and inserts pilot carrier symbols at suitable intervals between QAM symbols in each effective COFDM symbol to generate the rest of a respective complete COFDM symbol suitable for a subsequent 32K I-FFT. That is, the pilot-carrier symbols insertion unit 57 cooperates with the assembler 20 of a serial stream of effective COFDM symbols to form a COFDM symbol generator for supplying complete COFDM symbols to the OFDM modulator 58 that is the initial element of a subsequent generator of DCM COFDM radio-frequency signal. Preferably, the pilot-carrier symbols insertion unit 57 arranges for the insertion of a pilot carrier at midband, to facilitate separation of the lower-frequency and upper-frequency subbands of the DCM COFDM signal in a receiver for such signal. FIG. 4 shows the output port of the OFDM modulator 58 is connected for supplying 32K I-FFT results directly to the input port of a guard intervals insertion unit 59. Preferably, the guard intervals insertion unit 59 inserts a respective cyclic prefix within each guard interval.

Clipping methods of PAPR reduction necessarily involve distortion that tends to increase bit errors and thus tax iterative soft decoding of error-correction coding more. Furthermore, the PAPR reduction method using a complementary-power pair of QAM mappers suppresses occasional power peaks, which the various clipping methods of PAPR reduction rely upon to be markedly effective. Even so, most COFDM transmitter apparatus permits some clipping of power peaks that tend to occur infrequently, even where the power amplifier is of Doherty type. This is permitted in recognition of practical limitations on linearity in COFDM receiver apparatuses. However, band-limit filtering designed to suppress widening of the frequency spectrum caused by such clipping should follow the power amplifier for final-radio-frequency COFDM signal.

FIG. 4 further depicts a selector 60 having respective input ports to which the output ports of the guard intervals insertion units 39, 49 and 59 respectively connect. FIG. 4 depicts the output port of the selector 50 connected to the input port of a frame preambles insertion unit 61. The pilot-carrier symbol insertion unit 37, the OFDM modulator 38, any subsequent supplemental PAPR reduction unit and the guard intervals insertion unit 39 may be selectively powered, being powered only when transmissions using close to 8K OFDM carriers are made. Elements 37, 38 and 39 may all be omitted in some transmitters. The pilot-carrier symbols insertion unit 47, the OFDM modulator 48, any subsequent supplemental PAPR reduction unit and the guard intervals insertion unit 49 may be selectively powered, being powered only when transmissions using close to 16K OFDM carriers are made. Elements 47, 48 and 49 may all be omitted in some transmitters. The pilot-carrier symbols insertion unit 57, the OFDM modulator 58, any subsequent supplemental PAPR reduction unit and the guard intervals insertion unit 59 may be selectively powered, being powered only when transmissions using close to 32K OFDM carriers are made. All the elements 57, 58 and 59 may be omitted in some transmitters.

FIG. 4 shows the output port of the frame preambles insertion unit 61 connected to one of the two input ports of a time-division multiplexer 62. The other of the two input ports of the time-division multiplexer 62 is connected for receiving a bootstrap signal that a bootstrap signal generator 63 supplies from its output port. The time-division multiplexer 62 introduces the bootstrap signal before COFDM frames. The bootstrap signal is an innovation introduced by developers of the ATSC 3.0 Digital Television Standards. It conveys metadata descriptive of the transmission standard used for DTV broadcasting and critical information concerning the configuration of receivers for receiving DTV broadcasts made in accordance with that standard. The bootstrap signal is conveyed by an OFDM signal using a set of carriers that are apt to differ in frequencies in a defined way from the set of carriers used for COFDM transmission of DTV signal. The OFDM signal conveying the bootstrap is of narrower bandwidth (typically 4.5 MHz) than the 6 MHz, 7 MHz or 8 MHZ signals currently used for DTV in various countries around the world. The baseband bootstrap signal developed for the ATSC 3.0 Digital Television Standards comprises a Zadoff-Chu sequence, which identifies the basic standard governing the DTV broadcasting, and a set of repetitive pseudo-random-noise sequences that convey further metadata. This is described more fully in ATSC Standard A/321, System Discovery and Signaling (Doc. A/321:2016, approved 23 Mar. 2016). Digital output signal from the time-division multiplexer 62 (or from the frame preambles insertion unit 61 if elements 62 and 63 are not employed) is supplied to the input port of a digital-to-analog converter (or DAC) 64 to be converted to an analog signal applied as input modulating signal to a single-sideband amplitude modulator 65.

(The RF oscillator 66 combines with the SSB amplitude modulator 65 to constitute a generator of DCM COFDM radio-frequency signal. Owing to arrangements of first and second sets of successive QAM symbols in the frequency spectrum carried out by at least one preceding generator of COFDM symbols, the lower-frequency subband of this RF signal conveys the first set of successive QAM symbols and the upper-frequency subband of this RF signal conveys a second set of successive QAM symbols. The amplitude modulator 65 supplies RF analog COFDM signal from an output port thereof to the input port of a linear power amplifier 67, which is preferably of Doherty type to reduce the likelihood of clipping on peaks of RF signal amplitude. FIG. 4 shows the output port of the linear power amplifier 67 connected for driving amplified RF analog COFDM signal power to a transmission antenna 68. FIG. 4 omits showing some DTV transmitter details, such as band-shaping filters for the RF signals.

FIG. 4 shows a single-sideband amplitude modulator 65 connected for modulating an RF carrier wave of the frequency of the ultimate transmissions from the transmission antenna 68. In actual commercial practice the SSB amplitude modulator 65 is apt to be connected for modulating an intermediate frequency (IF) carrier wave. An up-converter converts the analog COFDM carriers in the SSB amplitude modulator 65 response to final radio frequencies and is connected for supplying them from its output port to the input port of the linear power amplifier 67. In some designs for the DTV transmitter the DAC 64 is designed to compensate for non-linear transfer functions of the SSB amplitude modulator 65, of the up-converter (if used), and of the linear power amplifier 67.

The frame preambles inserted by the frame preambles insertion unit 61 convey the conformation of each COFDM frame structure and also convey the dynamic scheduling information (DSI) produced by the scheduler 10. This information is conveyed using at least some of OFDM carriers also used for conveying the baseband OFDM information in the input signals to the frame preambles insertion unit 61. The OFDM carriers supplied by the bootstrap signal generator 63 are apt to have different frequencies than OFDM carriers used for conveying the baseband OFDM information in the input signals to the frame preambles insertion unit 61. The OFDM carriers supplied by the bootstrap signal generator 63 are constrained to a narrower bandwidth than the OFDM carriers used for conveying the baseband OFDM information in the input signals to the frame preambles insertion unit 61. The bootstrap signal conveys basic information as to the standard to which OFDM broadcasts conform, the bandwidth of the RF channel, and the size of the I-FFT used in the broadcasting of groups of OFDM frames, for example. If bootstrap signals are not used in the standard used for COFDM broadcasting, the elements 62 and 63 will be omitted, and the output port of the frame preambles insertion unit 61 will connect directly to the input port of the digital-to-analog converter 64.

FIG. 5 is a detailed schematic diagram of representative structure 70 for any one of a number of cascade connections in respective physical layer pipes of the FIG. 3 portion of COFDM transmitter apparatus, which structure 70 is configured so as to generate separate half COFDM symbols to be transmitted in lower and upper subbands respectively of the COFDM signal. Each of these cascade connections comprises a respective pair of QAM mappers to QAM symbol constellations, followed by a respective COFDM symbol assembler. One of these cascade connections comprises the elements 34, 35 and 36 in PLP0. Another of these cascade connections comprises the elements 44, 45 and 46 in PLP1. Still another of these cascade connections comprises the elements 54, 55 and 56 in PLPn.

FIG. 5 shows any one of the respective pairs 34, 44, 54 etc. of mappers to QAM symbol constellations in the physical layer pipes PLP0, PLP1, PLPn etc. as consisting of a respective first QAM mapper 71 and a respective second QAM mapper 72. The respective input ports of the QAM mappers 71 and 72 are each connected for receiving the same succession of QAM lattice-point labels from a foregoing element, such as one of the QAM-label time interleavers 33, 43, 53 etc. Serial-input/parallel-output registers 73 and 74 correspond to the subsequent one of the pairs of parsers 35, 45, 55 etc. A parallel-input/serial-output (PISO) register 75 is configured as a COFDM symbol assembler of a type that is preferred for the respective COFDM symbol assemblers 36, 46, 46 etc. in the physical layer pipes PLP0, PLP1, PLPn etc.

The output port of the first QAM mapper 71 is connected for serially supplying the complex coordinates of a first set of QAM symbols to the input port of the serial-input/parallel-output register 73, which is capable of storing the complex coordinates of QAM symbols for inclusion in the lower-subband half of each COFDM symbol. The output port of the second QAM mapper 72 is connected for serially supplying the complex coordinates of a second set of QAM symbols to the input port of the serial-input/parallel-output register 74, which is capable of storing the complex coordinates of QAM symbols for inclusion in the upper-subband half of each COFDM symbol. The parallel output ports of the serial-input/parallel-output registers 73 and 74 are connected for delivering complex coordinates of respective first and second sets of QAM symbols as half COFDM symbols to the parallel input ports of the parallel-input/serial-output register 75, the output port of which connects to a respective input port of the assembler 20 in FIG. 3.

FIG. 6 illustrates the serial response that the parallel-input/serial-output register 75 is designed to supply from its serial output port to that one of the input ports of the assembler 20. Such response is obtained by appropriately connecting ones of the parallel output ports of the serial-input/parallel-output registers 73 and 74 to appropriate ones of the parallel input ports of the parallel-input/serial-output register 75. The complete first set of QAM symbols as generated by the first QAM mapper 71 for inclusion in a half COFDM symbol to be transmitted in the lower subband of the DCM COFDM signal is followed by the complete second set of QAM symbols as generated by the second QAM mapper 72 for inclusion in a half COFDM symbol to be transmitted in the upper subband of the DCM COFDM signal. This causes the SSB amplitude modulator 65 depicted in FIG. 4 to generate asymmetric-sideband amplitude modulation, presuming the principal carrier to be completely suppressed. The FIG. 6 frequency interleaving format spreads all the QAM symbols conveying the same information the maximum possible uniform distance in the frequency domain.

Following custom, each labeled lattice point of the QAM symbol constellation maps considered in this specification and its accompanying drawing is plotted respective to an in-phase (I) axis and a quadrature (Q) axis. Each QAM symbol constellation map is composed of four quadrants: a −I,+Q quadrant, a +I,+Q quadrant, a +I,−Q quadrant and a −I,−Q quadrant. In this document each of these four quadrants is considered to consist of four sub-quadrants arranged by column and row within that quadrant. An “innermost” of these sub-quadrants is closest of the four to a point of origin at which the I and Q axes cross, and an “outermost” of these sub-quadrants is furthest of the four from that point of origin. There are two “flanking” sub-quadrants in each quadrant besides the “innermost” and “outermost” sub-quadrants.

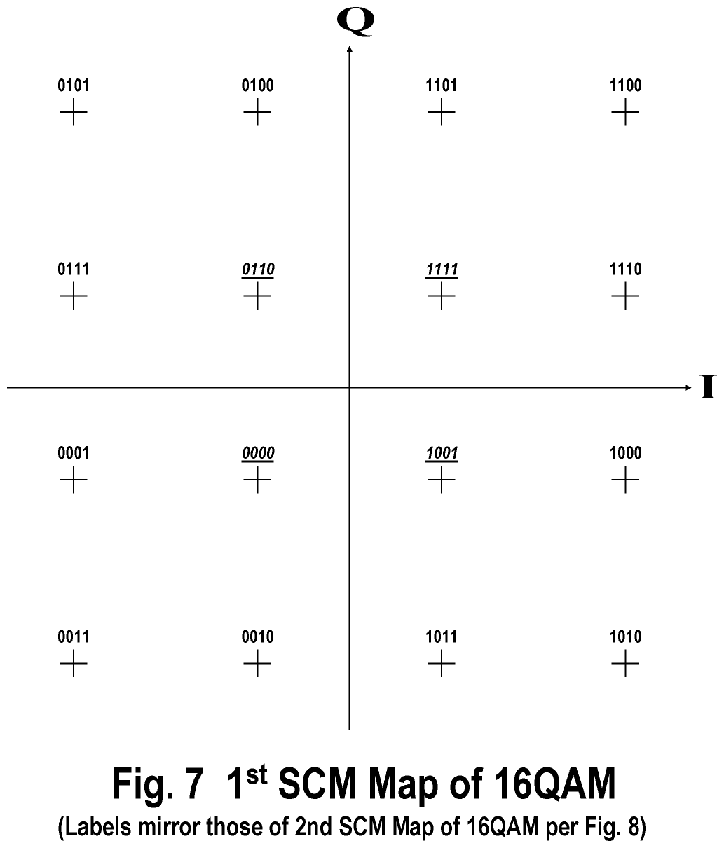

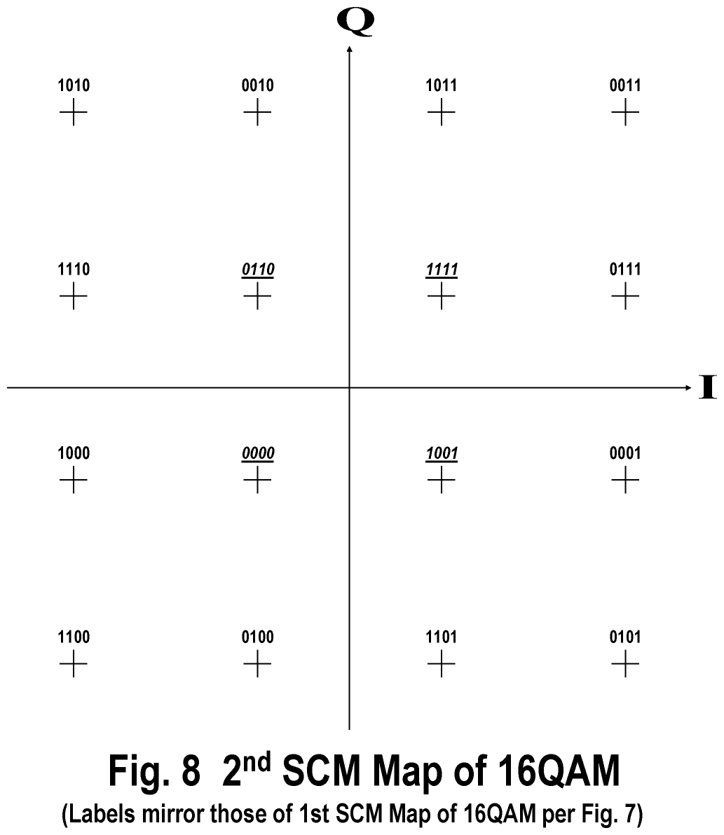

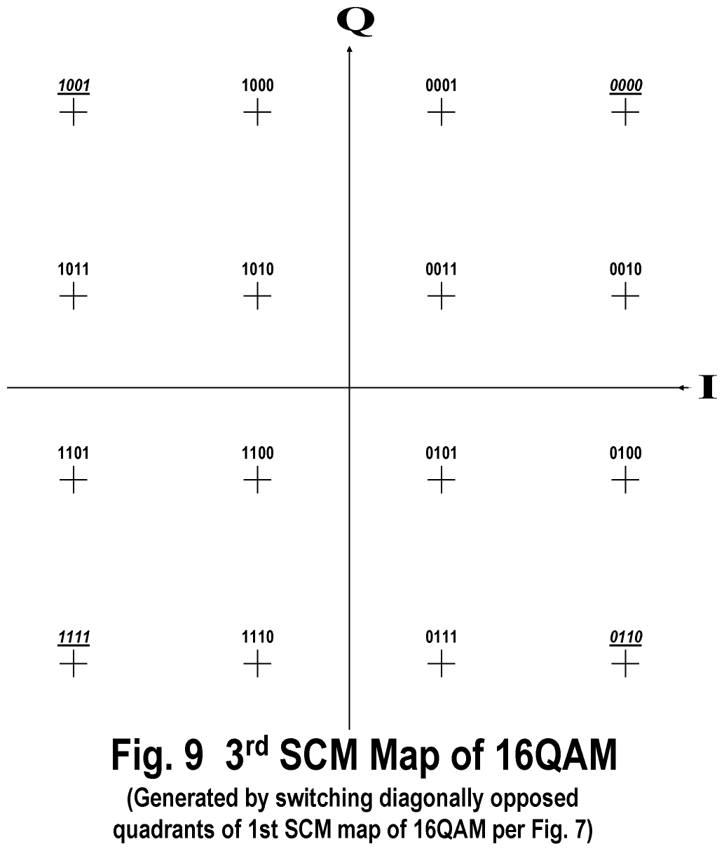

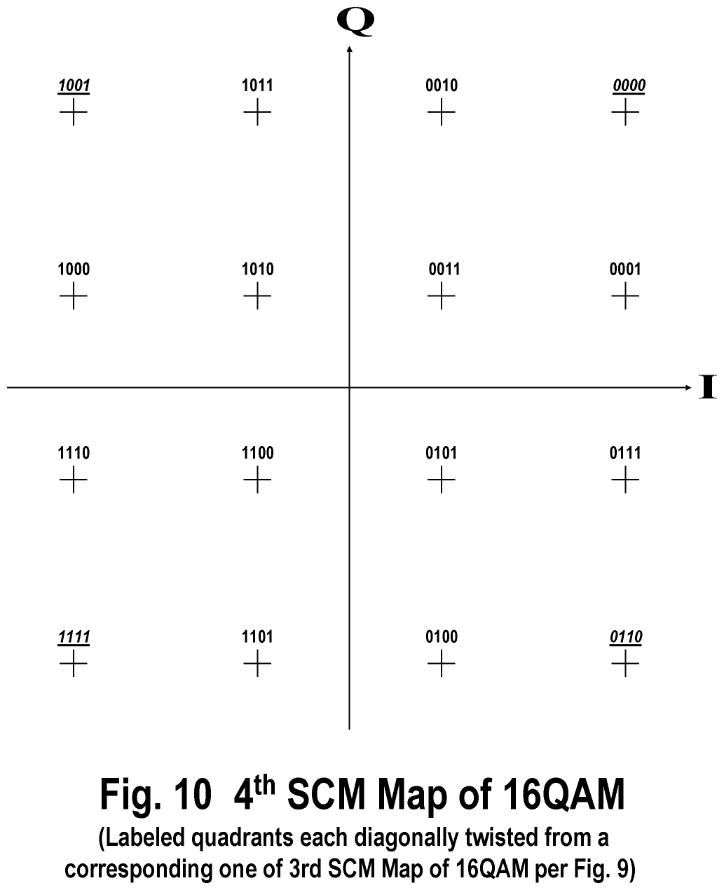

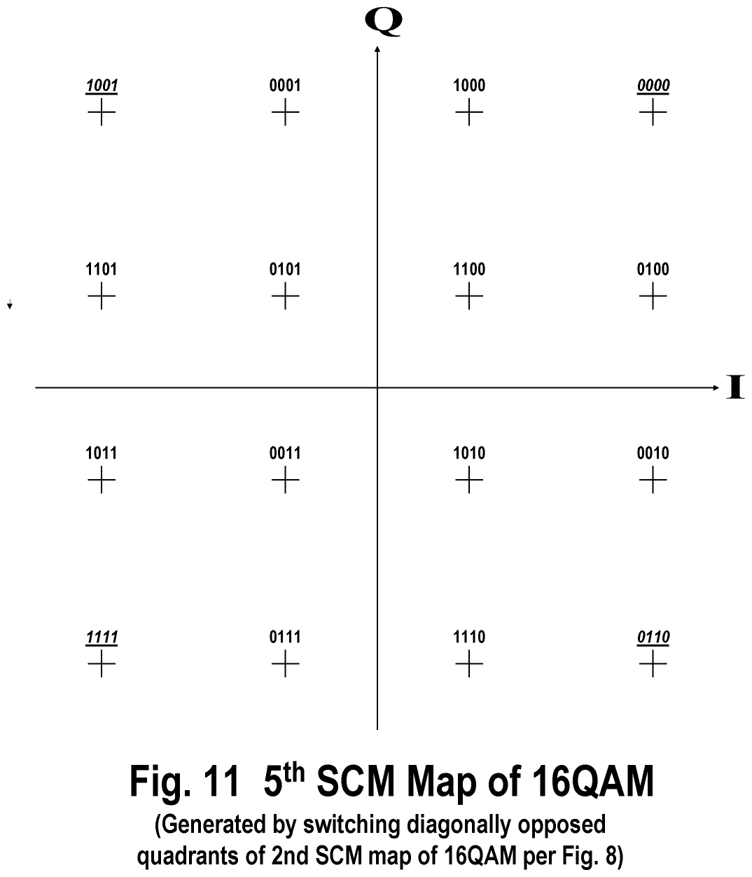

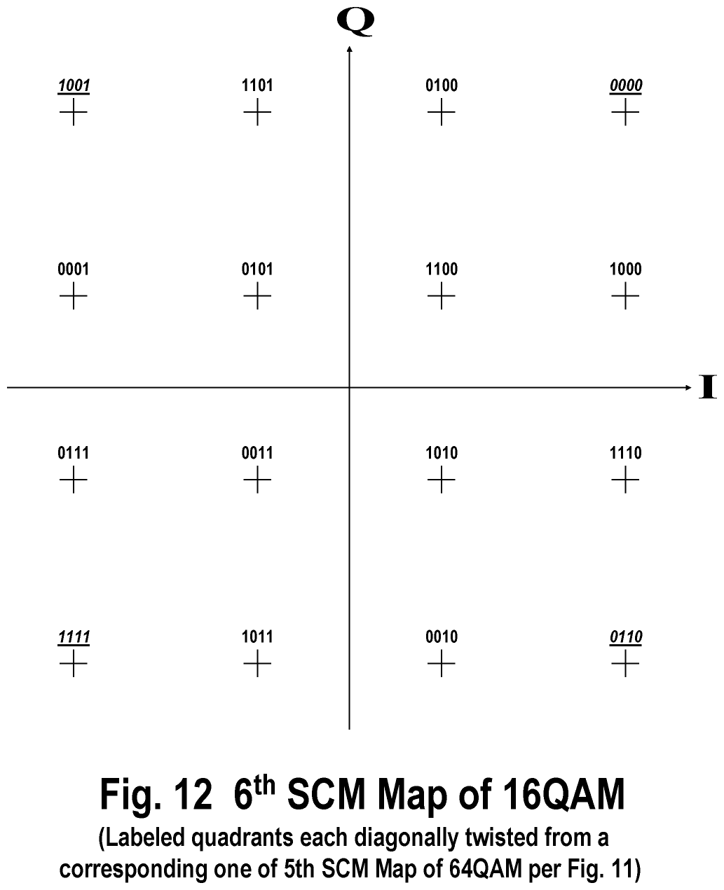

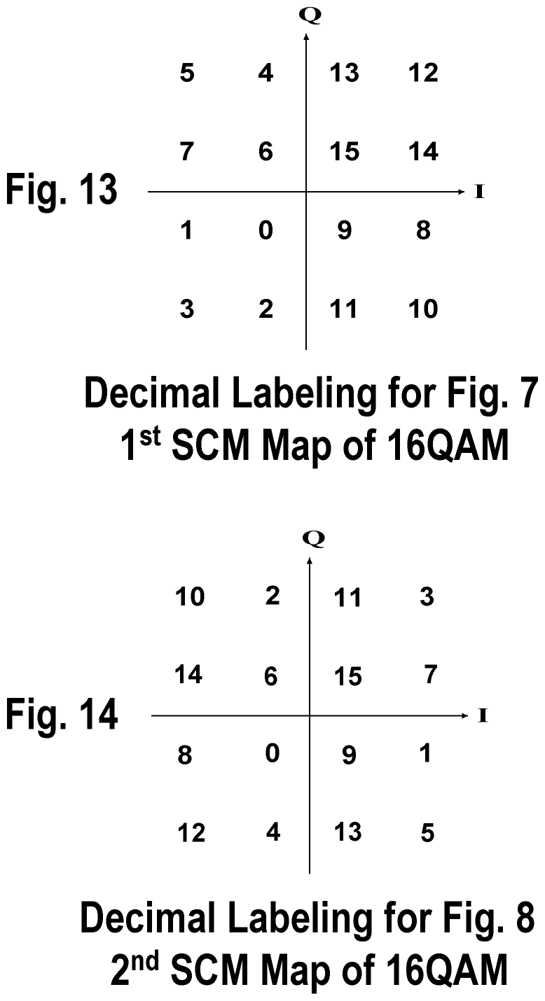

FIGS. 7 and 8 respectively depict first and second SCM maps of lattice points in 16QAM symbol constellations. One of these first and second SCM maps of 16QAM is directly employed by one of the QAM mappers 71 and 72 in a physical layer pipe in some DCM COFDM transmitter apparatuses embodying aspects of the invention. The other of the first and second SCM maps of 16QAM is not directly employed by either of the QAM mappers 71 and 72 QAM mappers 71 and 72, but provides the basis from which a further SCM map of 16QAM is derived. This further SCM map of 16QAM is directly employed by the other of the QAM mappers 71 and 72, the QAM mapper that does not directly employ either of the first and second SCM maps of 16QAM.

In 16QAM there are four palindromic LPLs (i. e., 0000, 0110, 1001, and 1111) which exhibit mirror symmetry in the order of their own bits. The 0000 label is located in the innermost corner of the −I, −Q quadrant in each of the FIG. 7 and FIG. 8 SCM maps. The 0110 label is located in the innermost corner of the −I, +Q quadrant in each of the FIG. 7 and FIG. 8 SCM maps. The 1111 label is located in the innermost corner of the +I, +Q quadrant in each of the FIG. 7 and FIG. 8 SCM maps. The 1001 label is located in the innermost corner of the +I, −Q quadrant in each of the FIG. 7 and FIG. 8 SCM maps.

The initial pairs of bits in the LPLs in the second SCM map of 16QAM are in reverse order from the initial pairs of bits in the labels of correspondingly positioned lattice points in the first SCM map of 16QAM. The final pairs of bits in the LPLs in the second SCM map of 16QAM are in reverse order from the final pairs of bits in the labels of correspondingly positioned lattice points in the first SCM map of 16QAM. These relationships support a tendency for all four bits of the segments of coded digital data (CDD) used for LPLs to have similar reliability in the results of bit-reliability averaging (BRA) carried out during soft-bit maximal-ratio combining the results of demapping DCM in a CODFM DCM signal receiver.

The labels of all four lattice points in the −I, −Q quadrant of the FIG. 7 SCM map have 00 as their leftmost pairs of bits, and the labels of all four lattice points in the −I,−Q quadrant of the FIG. 8 SCM map have 00 as their rightmost pairs of bits. The labels of all four lattice points in the −I, +Q quadrant of the FIG. 7 SCM map have 01 as their leftmost pairs of bits, and the labels of all four lattice points in the +I, −Q quadrant of the FIG. 8 SCM map have 01 as their rightmost pairs of bits. The labels of all four lattice points in the +I, +Q quadrant of the FIG. 7 SCM map have 11 as their leftmost pairs of bits, and the labels of all four lattice points in the +I, +Q quadrant of the FIG. 8 SCM map have 11 as their rightmost pairs of bits. The labels of all four lattice points in the +I, −Q quadrant of the FIG. 7 SCM map have 10 as their leftmost pairs of bits, and the labels of all four lattice points in the −I, +Q quadrant of the FIG. 8 SCM map have 10 as their rightmost pairs of bits. When demapping results are soft-bit maximal ratio combined in a receiver for DCM COFDM signals, during bit-reliability averaging (BRA) the leftmost pairs of bits in the LPLs per the FIG. 7 SCM map tend to be more robust than the leftmost pairs of bits in the LPLs per the FIG. 8 SCM map. However, during BRA the rightmost pairs of bits of those labels in the LPLs per the FIG. 8 SCM map tend to be more robust than the rightmost pairs of bits in the LPLs per the FIG. 7 SCM map.

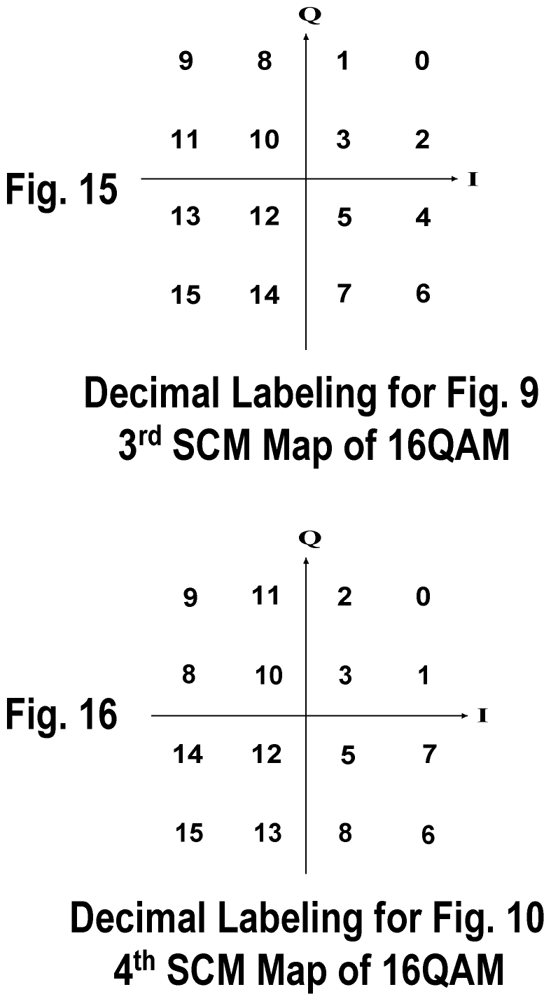

An aspect of the invention is embodied in the physical layer pipe of a DCM COFDM transmitter apparatus in which QAM mappers 71 and 72 respectively employ different ones of the FIG. 8 second SCM map of 16QAM and the FIG. 9 third SCM map of 16QAM. The FIG. 9 third SCM map of square 16QAM symbol constellations results from modifying the FIG. 7 first SCM map of 16QAM symbol constellations by (a) exchanging the positions of −I,+Q and +I,−Q quadrants going from the FIG. 7 map to the FIG. 9 map and (b) exchanging the positions of +I,+Q and −I, −Q quadrants going from the FIG. 7 map to the FIG. 9 map. Despite these exchanges, when demapping results are soft-bit maximal ratio combined in a receiver for DCM COFDM signals, the leftmost pairs of bits in the LPLs per the FIG. 9 third SCM map tend to be more robust than the leftmost pairs of bits in the LPLs per the FIG. 8 second SCM map during BRA. The rightmost pairs of bits in the LPLs per the FIG. 9 third SCM map tend to be less robust than the rightmost pairs of bits in the LPLs per the FIG. 8 second SCM map during BRA.

The map labels in the outermost corners of the quadrants of the FIG. 9 third SCM map correspond to map labels in the innermost corners of the FIG. 8 second SCM map, which constrains the peak voltage of the DCM COFDM signal for any of these map labels to being proportional to twice the square root of two times the voltage between adjoining lattice points of a square 16QAM symbol constellation. (The constant of proportionality in calculations of this sort is determined by the number of OFDM carriers in the COFDM signal.) The map labels in the innermost corners of the quadrants of the FIG. 9 third SCM map correspond to map labels in the outermost corners of the FIG. 8 second SCM map, which constrains the peak voltage of the DCM COFDM signal for any of these map labels to being proportional to twice the square root of two times larger than the voltage between adjoining lattice points of a square 16QAM symbol constellation—i. e., 2.828 times that voltage. This voltage is representative of a 3.52 dB reduction in PAPR over COFDM with square 16QAM symbols and without DCM. (The peak voltage of the DCM COFDM signal for any of the remaining map labels in the FIG. 8 second SCM map and the FIG. 9 third SCM map is no larger than being proportional to one-half the square root of ten times the voltage between adjoining lattice points of a square 16QAM symbol constellation—i. e., 1.581 times that voltage.)

The FIG. 10 fourth SCM map of square 16QAM symbol constellations results from diagonally twisting the pattern of map labels in each quadrant of the FIG. 9 third SCM map of 16QAM symbol constellations. Despite such twisting of the quadrants, the leftmost pairs of bits in the LPLs per the FIG. 10 fourth SCM map of 16QAM tend to be more robust than the rightmost pairs of bits. An aspect of the invention is embodied in the physical layer pipe of a DCM COFDM transmitter apparatus in which QAM mappers 71 and 72 respectively employ different ones of the FIG. 8 second SCM map of 16QAM and the FIG. 10 fourth SCM map of 16QAM. Employing different ones of the FIG. 8 second SCM map of 16QAM and the FIG. 10 fourth SCM map of 16QAM in the QAM mappers 71 and 72 respectively apparently provides no appreciable advantage nor disadvantage compared to employing different ones of the FIG. 8 second SCM map of 16QAM and the FIG. 9 third SCM map of 16QAM in the QAM mappers 71 and 72.

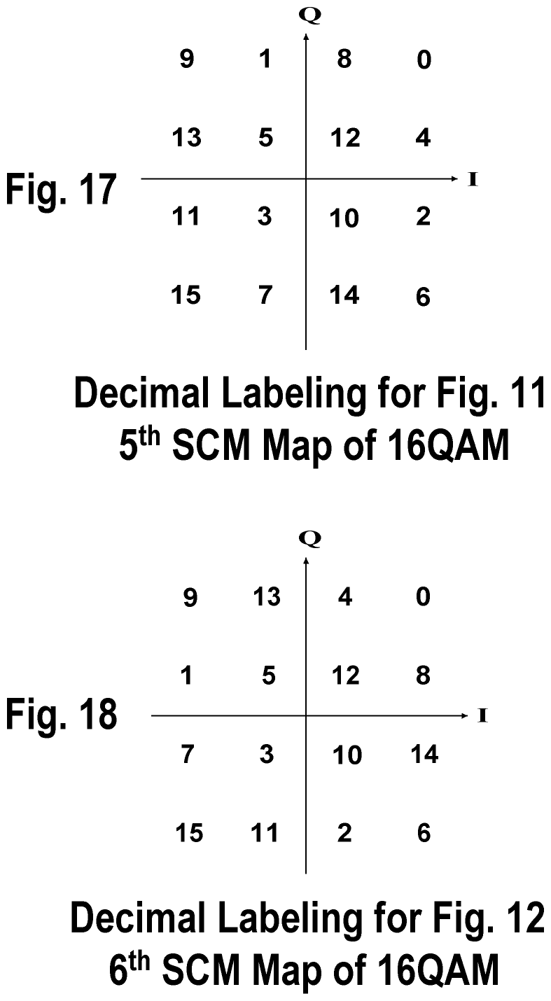

An aspect of the invention is embodied in the physical layer pipe of a DCM COFDM transmitter apparatus in which QAM mappers 71 and 72 respectively employ different ones of the FIG. 7 first SCM map of 16QAM and the FIG. 11 fifth SCM map of 16QAM. FIG. 11 is a fifth SCM map of square 16QAM symbol constellations modifying the FIG. 8 second SCM map of 16QAM symbol constellations by (a) exchanging the positions of −I,+Q and +I,−Q quadrants going from the FIG. 8 map to the FIG. 11 map and (b) exchanging the positions of +I,+Q and −I,−Q quadrants going from the FIG. 8 map to the FIG. 11 map. Despite these exchanges, when demapping results are soft-bit maximal ratio combined in a receiver for DCM COFDM signals, the rightmost pairs of bits in the LPLs per the FIG. 11 fifth SCM map tend to be more robust than the rightmost pairs of bits in the LPLs per the FIG. 7 first SCM map during BRA. The leftmost pairs of bits in the LPLs per the FIG. 11 fifth SCM map tend to be less robust than the leftmost pairs of bits in the LPLs per the FIG. 7 first SCM map during BRA. The constraints on the peak voltage of the DCM COFDM signal when the QAM mappers 71 and 72 employ different ones of the FIG. 7 first SCM map of 16QAM and the FIG. 11 fifth SCM map of 16QAM in the QAM mappers 71 and 72 are similar to the constraints when those demappers those employ different ones of the FIG. 8 second SCM map of 16QAM and the FIG. 9 third SCM map of 16QAM.

The FIG. 12 sixth SCM map of square 16QAM symbol constellations results from diagonally twisting the pattern of map labels in each quadrant of the FIG. 11 fifth SCM map of 16QAM symbol constellations. Despite such twisting of the quadrants, the rightmost pairs of bits in the LPLs per the FIG. 12 sixth SCM map of 16QAM tend to be more robust than the leftmost pairs of bits. An aspect of the invention is embodied in the physical layer pipe of a DCM COFDM transmitter apparatus in which QAM mappers 71 and 72 respectively employ different ones of the FIG. 7 first SCM map of 16QAM and the FIG. 12 sixth SCM map of 16QAM. Employing different ones of the FIG. 7 first SCM map of 16QAM and the FIG. 12 sixth SCM map of 16QAM in the QAM mappers 71 and 72 respectively apparently provides no appreciable advantage nor disadvantage compared to employing different ones of the FIG. 7 first SCM map of 16QAM and the FIG. 11 fifth SCM map of 16QAM in the QAM mappers 71 and 72.

FIGS. 13, 14, 15, 16, 17 and 18 present decimal labeling for the SCM maps of 16QAM symbol constellations depicted in FIGS. 7, 8, 9, 10, 11 and 12 respectively.

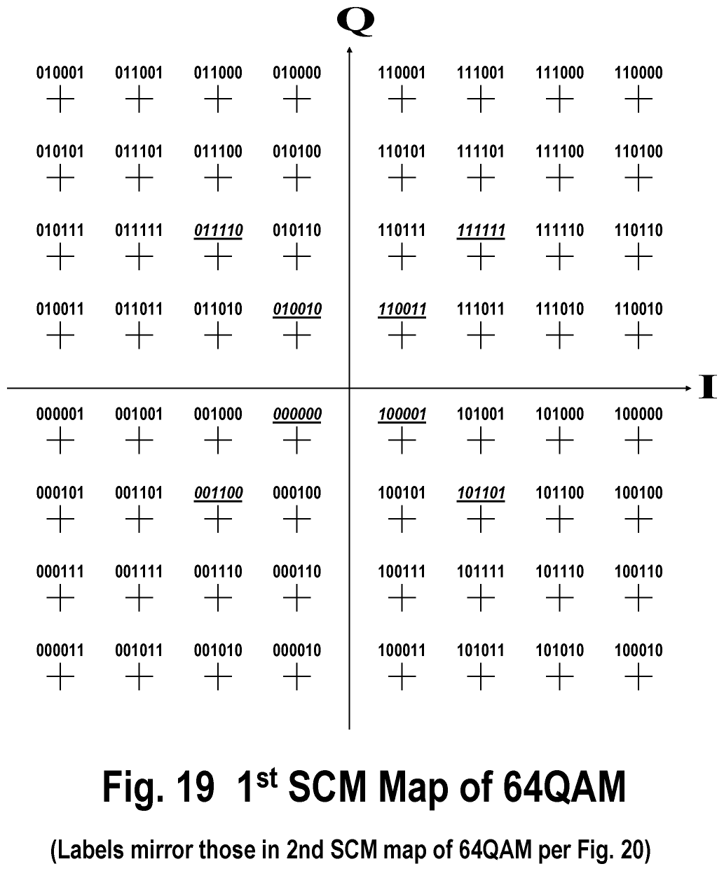

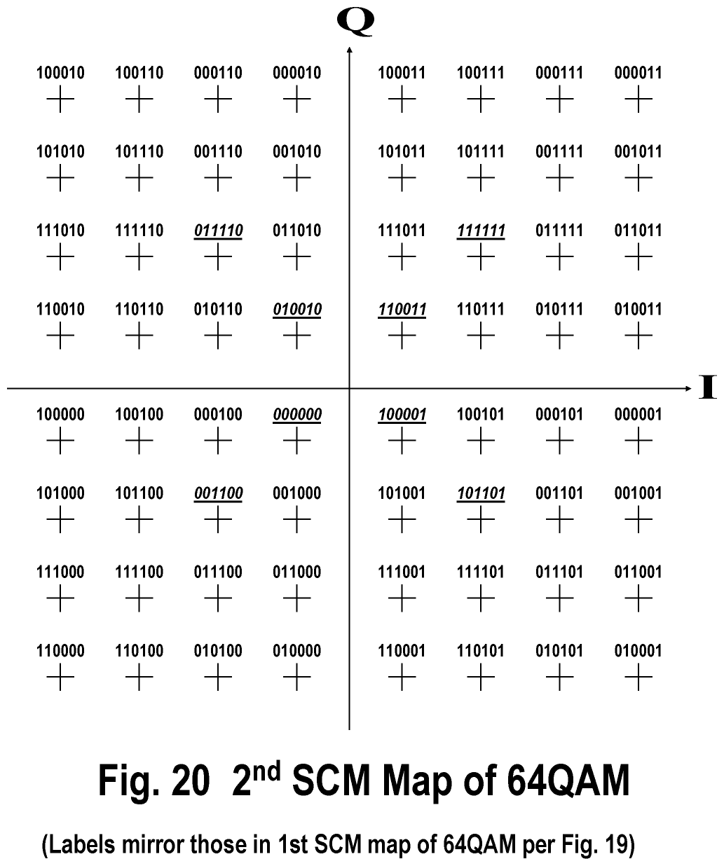

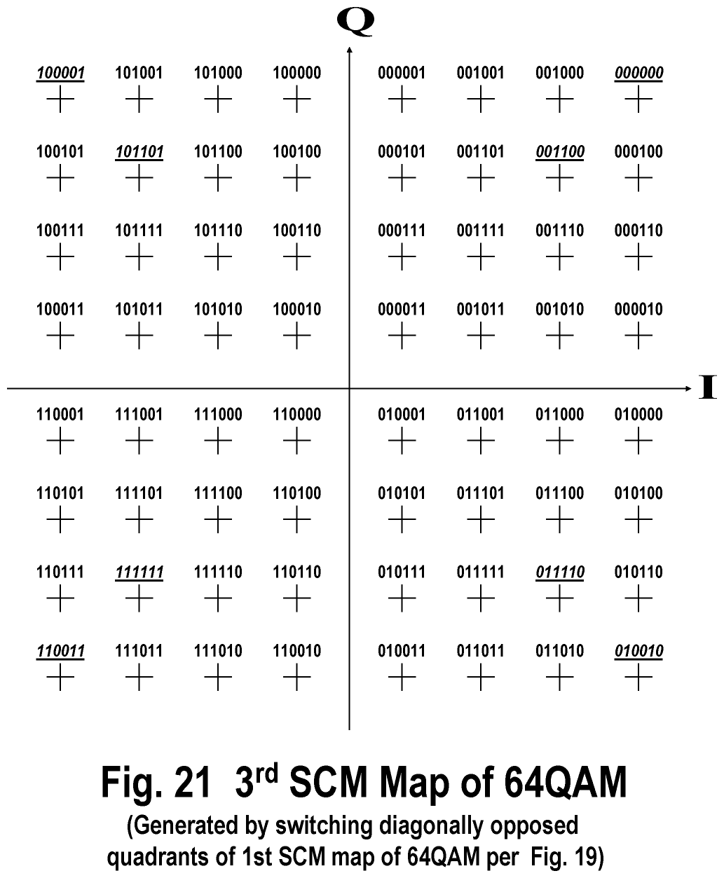

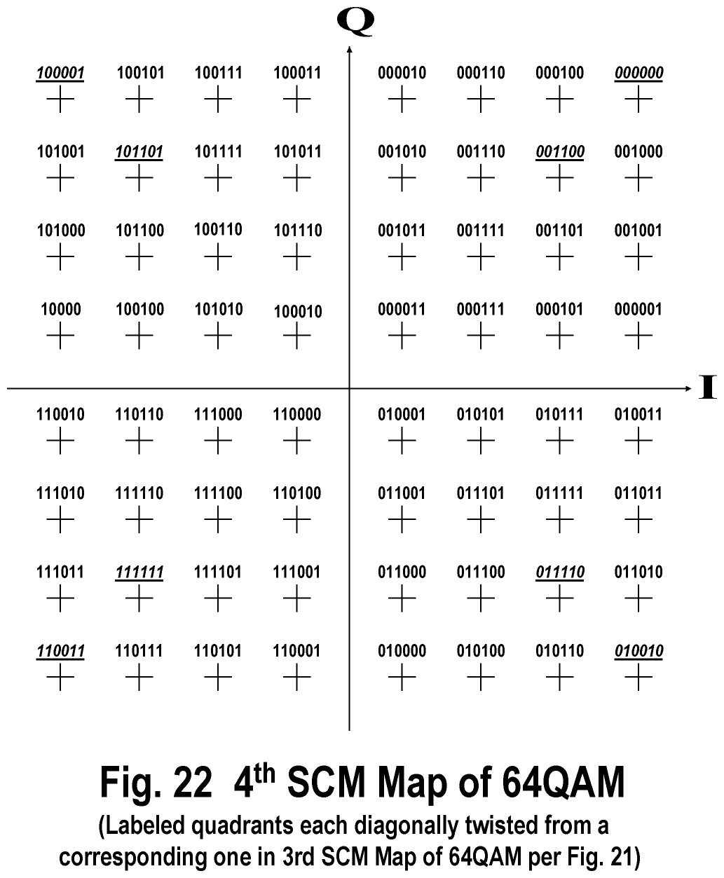

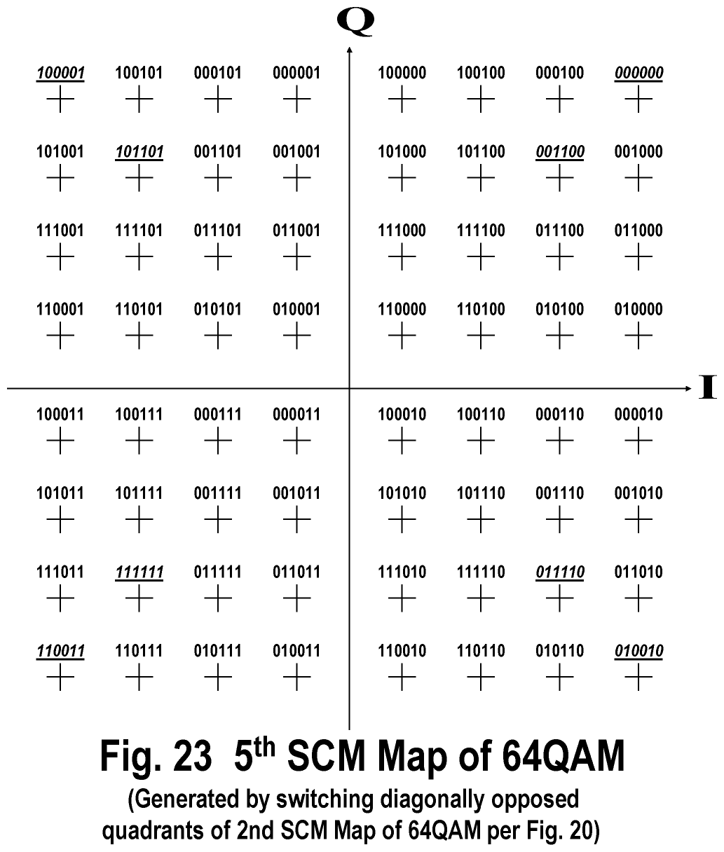

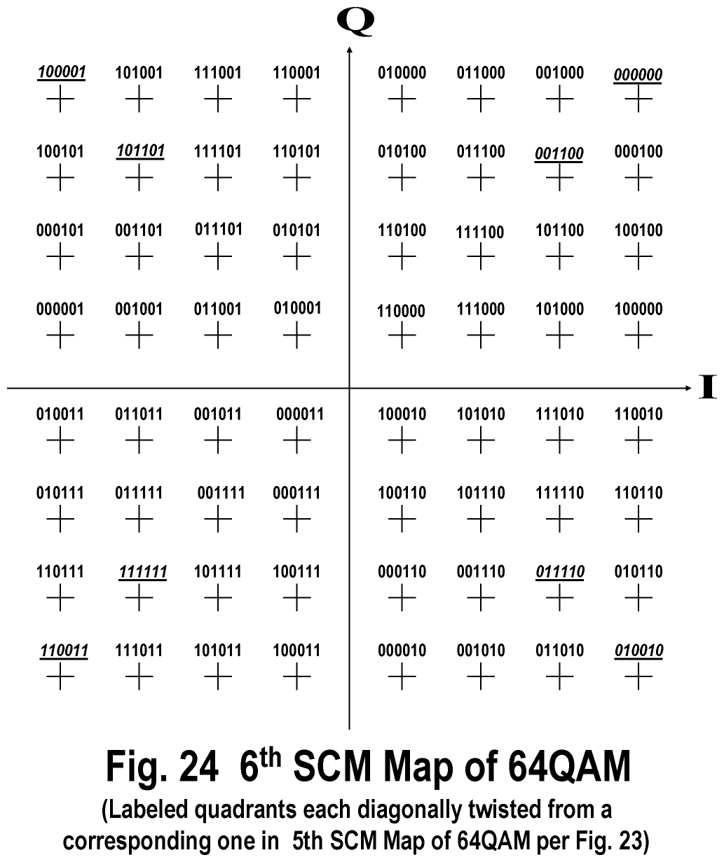

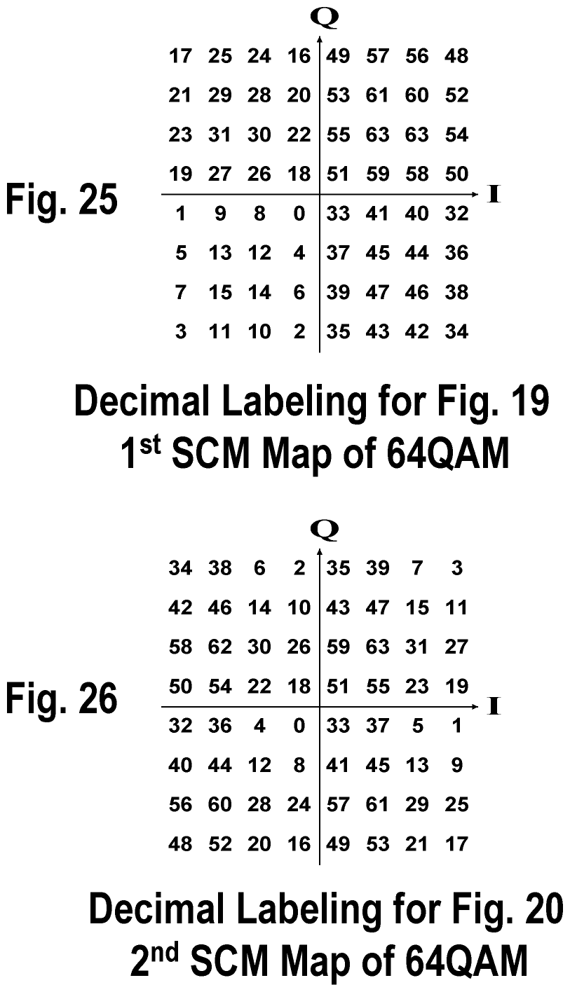

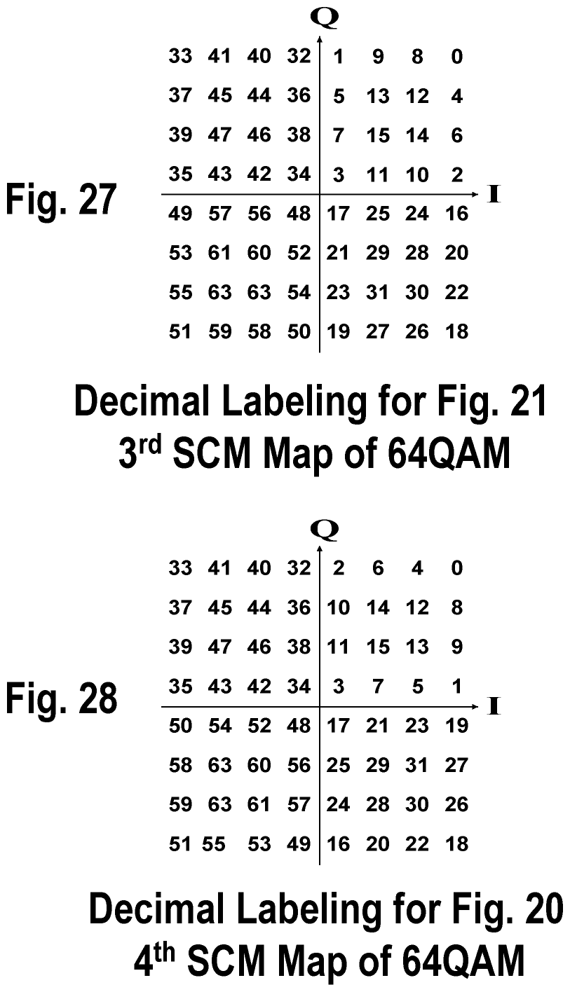

FIGS. 19 and 20 respectively depict first and second SCM maps of lattice points in square 64QAM symbol constellations. One of these first and second SCM maps of 64QAM is directly employed by one of the QAM mappers 71 and 72 in a physical layer pipe in some DCM COFDM transmitter apparatuses embodying aspects of the invention. The other of the first and second SCM maps of 64QAM is not directly employed by either of the QAM mappers 71 and 72 QAM mappers 71 and 72, but provides the basis from which a further SCM map of 16QAM is derived. This further SCM map of 64QAM is directly employed by the other of the QAM mappers 71 and 72, the QAM mapper that does not directly employ either of the first and second SCM maps of 64QAM.

The palindromic label 000000 is applied to the lattice point located in the innermost corner of the −I,−Q quadrant in the FIG. 19 first SCM map of 64QAM, and the palindromic label 001100 is applied to the lattice point located diagonally next within that quadrant. The 010010 label is applied to the lattice point located in the innermost corner of the −I,+Q quadrant in the FIG. 19 first SCM map of 64QAM, and the palindromic label 011110 is applied to the lattice point located diagonally next within that quadrant. The 110011 label is applied to the lattice point located in the innermost corner of the +I,+Q quadrant in the FIG. 19 first SCM map of 64QAM, and the palindromic label 111111 is applied to the lattice point located diagonally next within that quadrant. The 100001 label is applied to the lattice point located in the innermost corner of the +I,−Q quadrant in the FIG. 19 first SCM map of 64QAM, and the palindromic label 101101 is applied to the lattice point located diagonally next within that quadrant.

The palindromic label 000000 is applied to the lattice point located in the innermost corner of the −I,−Q quadrant in the FIG. 20 second SCM map of 64QAM, and the palindromic label 100001 is applied to the lattice point located diagonally next within that quadrant. The 010010 label is applied to the lattice point located in the innermost corner of the −I,+Q quadrant in the FIG. 20 second SCM map of 64QAM, and the palindromic label 110011 is applied to the lattice point located diagonally next within that quadrant. The 011110 label is applied to the lattice point located in the innermost corner of the +I,+Q quadrant in the FIG. 20 second SCM map of 64QAM, and the palindromic label 111111 is applied to the lattice point located diagonally next within that quadrant. The 001100 label is applied to the lattice point located in the innermost corner of the +I,−Q quadrant in the FIG. 20 second SCM map of 64QAM, and the palindromic label 101101 is applied to the lattice point located diagonally next within that quadrant.

In the Gray mapping of each quadrant of the FIG. 13 first SCM map of 64QAM, the leftmost two bits of LPLs identify that particular quadrant within which the lattice points are located, and the rightmost two bits of LPLs specify which of four sub-quadrants within that particular quadrant each lattice point is located within. The quadrant considered as a bin for LPLs has four columns and four rows of them, twice the number of columns and twice the number of rows as a sub-quadrant. However, owing to the arrangement of sub-quadrants in adjoining quadrants of an SCM map of a square QAM symbol constellation, the rightmost two bits of each of the LPLs from the FIG. 19 first SCM map of 64QAM tend to be about the same robustness as the leftmost two bits of those labels during BRA in a COFDM signal receiver that uses soft-bit maximal-ratio combining (SBMRC) of the demapping results from DCM. The central two bits of LPLs from the FIG. 19 first SCM map of 64QAM tend to be less robust than the leftmost two bits and rightmost two bits of those labels during BRA in such a receiver.

The LPLs of the FIG. 20 second SCM map of 64QAM can be generated by the following procedures, beginning from the LPLs of the FIG. 19 first SCM map of 64QAM. The order of the initial three bits of each LPL in the FIG. 19 first SCM map is reversed to generate the initial three bits of the correspondingly positioned LPL in the FIG. 20 second SCM map. The order of the final three bits of each LPL in the FIG. 19 first SCM map is reversed to generate the final three bits of the correspondingly positioned LPL in the FIG. 20 second SCM map. These procedures generate palindromic LPLs in the FIG. 20 second SCM map from palindromic LPLs in the FIG. 19 first SCM map. The 000000, 010010, 101101 and 111111 LPLs are similarly positioned in the FIG. 19 and FIG. 20 SCM maps.

These procedures for generating the FIG. 20 SCM map cause the initial and final bits of its LPLs to tend to be less robust than the central four bits of those labels during BRA in a COFDM signal receiver that uses SBMRC of the demapping results from DCM. On average, the BRA results from the first, third, fourth and sixth consecutive bits of each segment of coded digital data used for lattice-point labeling will exhibit similar likelihood of being correct, but somewhat smaller likelihood of being correct than the second and fifth consecutive bits of that segment of CDD. When using DCM with 64QAM the overall likelihood of two 6-bit segments of CDD being correct should be about as good, if not better, than for three 4-bit segments of the same CDD using 16QAM of OFDM carriers without DCM. So, using DCM COFDM with 64QAM of carriers to maintain the same data throughput as with COFDM using 16QAM of carriers without DCM should not cause anywhere near as much as 6 dB reduction in SNR of reception over an AWGN channel.

An aspect of the invention is embodied in the physical layer pipe of a DCM COFDM transmitter apparatus in which QAM mappers 71 and 72 respectively employ different ones of the FIG. 20 second SCM map of 64QAM and the FIG. 21 third SCM map of 64QAM. The FIG. 21 third SCM map of square 64QAM symbol constellations results from modifying the FIG. 19 first SCM map of 64QAM symbol constellations by (a) exchanging the positions of −I,+Q and +I,−Q quadrants going from the FIG. 19 map to the FIG. 21 map and (b) exchanging the positions of +I,+Q and −I, −Q quadrants going from the FIG. 19 map to the FIG. 21 map.

COFDM employing square 64 QAM symbols, but no DCM, exhibits a peak voltage proportional to seven times the square root of two times the voltage between adjoining lattice points of a square 64QAM symbol constellation—i. e., 9.900 times that voltage. The map labels in the outermost corners of the quadrants of the FIG. 21 third SCM map correspond to map labels diagonally next from the map labels in the inner corners of the FIG. 20 second SCM map. This constrains the peak voltage of the DCM COFDM signal for any of these map labels to being proportional to five times the square root of two times the voltage between adjoining lattice points of a square 64QAM symbol constellation—i. e., 7.701 times that voltage. This voltage is representative of a 2.92 dB reduction in PAPR over COFDM with square 64QAM symbols and without DCM. (The peak voltage of the DCM COFDM signal for any of the remaining map labels in the FIG. 20 second SCM map and the FIG. 21 third SCM map is constrained to being less than five times the voltage between adjoining lattice points of a square 64QAM symbol constellation.) The PAPR of DCM COFDM signal using square 64QAM symbols is 0.757 dB, which compares favorably against the 2.553 dB PAPR of COFDM with square 16QAM symbols and without DCM.

The FIG. 22 fourth SCM map of square 64QAM symbol constellations results from diagonally twisting the pattern of map labels in each quadrant of the FIG. 21 third SCM map of 64QAM symbol constellations. An aspect of the invention is embodied in the physical layer pipe of a DCM COFDM transmitter apparatus in which QAM mappers 71 and 72 respectively employ different ones of the FIG. 20 second SCM map of 64QAM and the FIG. 22 fourth SCM map of 64QAM. Employing different ones of the FIG. 20 second SCM map of 64QAM and the FIG. 22 fourth SCM map of 64QAM in the QAM mappers 71 and 72 respectively apparently provides no appreciable advantage nor disadvantage compared to employing different ones of the FIG. 20 second SCM map of 64QAM and the FIG. 21 third SCM map of 64QAM in the QAM mappers 71 and 72.

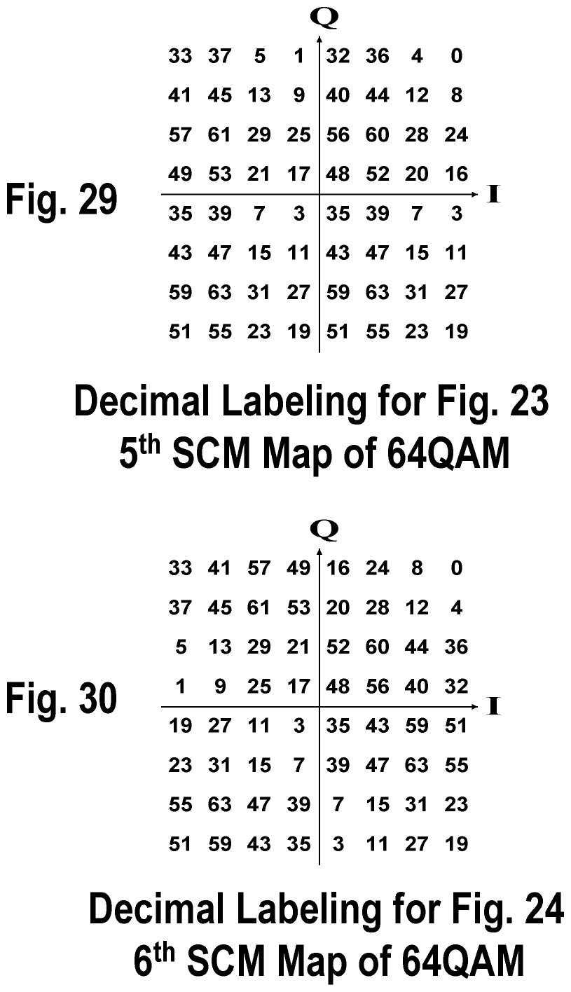

An aspect of the invention is embodied in the physical layer pipe of a DCM COFDM transmitter apparatus in which QAM mappers 71 and 72 respectively employ different ones of the FIG. 19 first SCM map of 64QAM and the FIG. 23 fifth SCM map of 64QAM. FIG. 23 is a fifth SCM map of square 64QAM symbol constellations modifying the FIG. 20 second SCM map of 64QAM symbol constellations by (a) exchanging the positions of −I,+Q and +I,−Q quadrants going from the FIG. 20 map to the FIG. 23 map and (b) exchanging the positions of +I,+Q and −I,−Q quadrants going from the FIG. 20 map to the FIG. 23 map. The constraints on the peak voltage of the DCM COFDM signal when the QAM mappers 71 and 72 employ different ones of the FIG. 19 first SCM map of 64QAM and the FIG. 23 fifth SCM map of 64QAM in the QAM mappers 71 and 72 are similar to the constraints when those demappers those employ different ones of the FIG. 20 second SCM map of 64QAM and the FIG. 21 third SCM map of 64QAM. I. e., there is a 2.93 dB reduction in PAPR over conventional COFDM employing square 64 QAM symbols.

The FIG. 24 sixth SCM map of square 64QAM symbol constellations results from diagonally twisting the pattern of map labels in each quadrant of the FIG. 23 fifth SCM map of 64QAM symbol constellations. An aspect of the invention is embodied in the physical layer pipe of a DCM COFDM transmitter apparatus in which QAM mappers 71 and 72 respectively employ different ones of the FIG. 19 first SCM map of 64QAM and the FIG. 24 sixth SCM map of 64QAM. Employing different ones of the FIG. 19 first SCM map of 64QAM and the FIG. 24 sixth SCM map of 64QAM in the QAM mappers 71 and 72 respectively apparently provides no appreciable advantage nor disadvantage compared to employing different ones of the FIG. 19 first SCM map of 64QAM and the FIG. 23 fifth SCM map of 64QAM in the QAM mappers 71 and 72.

FIGS. 25 and 29 present decimal labeling for the first and fifth SCM maps of 64QAM symbol constellations depicted in FIGS. 19 and 23, respectively, which maps can be used to provide advantageous labeling diversity for DCM in a COFDM signal. The LPLs 0, 4, 8 and 12 in the outermost sub-quadrant of the +I,+Q quadrant of the FIG. 29 fifth SCM map have high energies that average with low energies of the LPLs 0, 4, 8 and 12 in the innermost sub-quadrant of the −I,−Q quadrant of the FIG. 25 first SCM map. The LPLs 18, 22, 26 and 30 in the outermost sub-quadrant of the +I,−Q quadrant of the FIG. 29 fifth SCM map have high energies that average with low energies of the LPLs 18, 22, 26 and 30 in the innermost sub-quadrant of the −I,+Q quadrant of the FIG. 25 first SCM map. The LPLs 33, 37, 41 and 45 in the outermost sub-quadrant of the −I,+Q quadrant of the FIG. 29 fifth SCM map have high energies that average with low energies of the LPLs 33, 37, 41 and 45 in the innermost sub-quadrant of the +I,−Q quadrant of the FIG. 25 first SCM map. The LPLs 51, 55, 59 and 63 LPLs in the outermost sub-quadrant of the −I,−Q quadrant of the FIG. 29 fifth SCM map have high energies that average with low energies of the LPLs 51, 55, 59 and 63 in the innermost sub-quadrant of the +I,+Q quadrant of the FIG. 25 first SCM map. These Averaging of high energies of LPLs in the four outermost sub-quadrants of the FIG. 29 fifth SCM map with low energies of similar LPLs in the four innermost sub-quadrants of the FIG. 25 first SCM map contributes to keeping PAPR low in the DCM COFDM signal.

Averaging of high energies of LPLs in the four outermost sub-quadrants of the FIG. 25 first SCM map with low energies of similar LPLs in the four innermost sub-quadrants of the FIG. 29 fifth SCM map also contributes to keeping PAPR low in the DCM COFDM signal. The LPLs 48, 52, 56 and 60 in the outermost sub-quadrant of the +I,+Q quadrant of the FIG. 25 first SCM map have high energies that average with low energies of the LPLs 48, 52, 56 and 60 in the innermost sub-quadrant of the −I,−Q quadrant of the FIG. 29 fifth SCM map. The LPLs 34, 38, 42 and 46 in the outermost sub-quadrant of the +I,−Q quadrant of the FIG. 25 first SCM map have high energies that average with low energies of the LPLs 34, 38, 42 and 46 in the innermost sub-quadrant of the −I,+Q quadrant of the FIG. 29 fifth SCM map. The LPLs 17, 21, 25 and 29 in the outermost sub-quadrant of the −I,+Q quadrant of the FIG. 25 first SCM map have high energies that average with low energies of the LPLs 17, 21, 25 and 29 in the innermost sub-quadrant of the +I,−Q quadrant of the FIG. 29 fifth SCM map. The LPLs 3, 7, 11 and 15 in the outermost sub-quadrant of the −I,−Q quadrant of the FIG. 25 first SCM map have high energies that average with low energies of the LPLs 3. 7, 11 and 15 in the innermost sub-quadrant of the +I,+Q quadrant of the FIG. 29 fifth SCM map. The energies in the eight flanking sub-quadrants of the FIG. 25 first SCM map and the energies in the eight flanking sub-quadrants of the FIG. 29 fifth SCM map all tend toward the average. So, these energies do not boost the PAPR of the DCM COFDM signal significantly, if at all.

FIGS. 25 and 30 present decimal labeling for the first and sixth SCM maps of 64QAM symbol constellations depicted in FIGS. 19 and 24, respectively, which maps can be used to provide advantageous labeling diversity for DCM in a COFDM signal. Averaging of high energies of LPLs in the four outermost sub-quadrants of the FIG. 30 sixth SCM map with low energies of similar LPLs in the four innermost sub-quadrants of the FIG. 25 first SCM map contributes to keeping PAPR low in the DCM COFDM signal. Averaging of high energies of LPLs in the four outermost sub-quadrants of the FIG. 25 first SCM map with low energies of similar LPLs in the four innermost sub-quadrants of the FIG. 30 sixth SCM map also contributes to keeping PAPR low in the DCM COFDM signal. The energies in the eight flanking sub-quadrants of the FIG. 25 first SCM map and the energies in the eight flanking sub-quadrants of the FIG. 30 sixth SCM map all tend toward the average. So, these energies do not boost the PAPR of the DCM COFDM signal significantly, if at all.

FIGS. 26 and 27 present decimal labeling for the second and third SCM maps of 64QAM symbol constellations depicted in FIGS. 20 and 21, respectively, which maps can be used to provide advantageous labeling diversity for DCM in a COFDM signal. Averaging of high energies of LPLs in the four outermost sub-quadrants of the FIG. 27 third SCM map with low energies of similar LPLs in the four innermost sub-quadrants of the FIG. 26 second SCM map contributes to keeping PAPR low in the DCM COFDM signal. Averaging of high energies of LPLs in the four outermost sub-quadrants of the FIG. 26 second SCM map with low energies of similar LPLs in the four innermost sub-quadrants of the FIG. 27 third SCM map also contributes to keeping PAPR low in the DCM COFDM signal.

The energies in the eight flanking sub-quadrants of the FIG. 26 second SCM map and the energies in the eight flanking sub-quadrants of the FIG. 27 third SCM map all tend toward the average. So, these energies do not boost the PAPR of the DCM COFDM signal significantly, if at all.

FIGS. 26 and 28 present decimal labeling for the second and fourth SCM maps of 64QAM symbol constellations depicted in FIGS. 20 and 22, respectively, which maps can be used to provide advantageous labeling diversity for DCM in a COFDM signal. Averaging of high energies of LPLs in the four outermost sub-quadrants of the FIG. 28 fourth SCM map with low energies of similar LPLs in the four innermost sub-quadrants of the FIG. 26 second SCM map contributes to keeping PAPR low in the DCM COFDM signal. Averaging of high energies of LPLs in the four outermost sub-quadrants of the FIG. 26 second SCM map with low energies of similar LPLs in the four innermost sub-quadrants of the FIG. 28 fourth SCM map also contributes to keeping PAPR low in the DCM COFDM signal. The energies in the eight flanking sub-quadrants of the FIG. 26 second SCM map and the energies in the eight flanking sub-quadrants of the FIG. 28 fourth SCM map all tend toward the average. So, these energies do not boost the PAPR of the DCM COFDM signal significantly, if at all.

Persons skilled in designing COFDM signals and acquainted with the foregoing disclosure are apt to discern that further modifications and variations can be made in the specifically described SCM mapping of square 64QAM symbol constellation without departing from the spirit or scope of the invention in certain broader ones of its aspects. A few of these variations will be specifically considered in the paragraphs next following. Similar variations are possible in the SCM mapping of square QAM symbol constellations of other sizes.

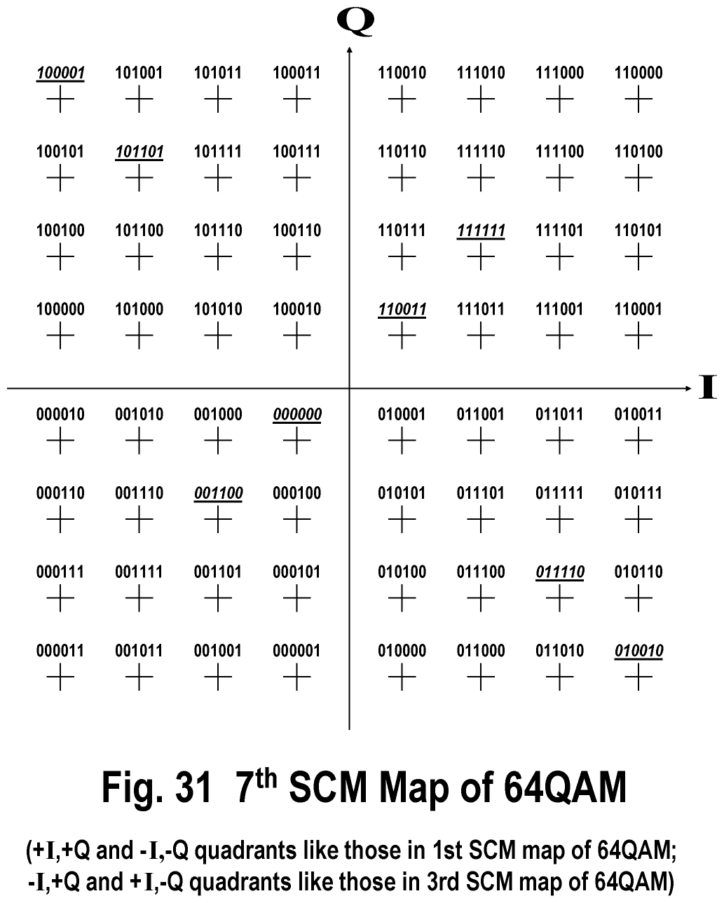

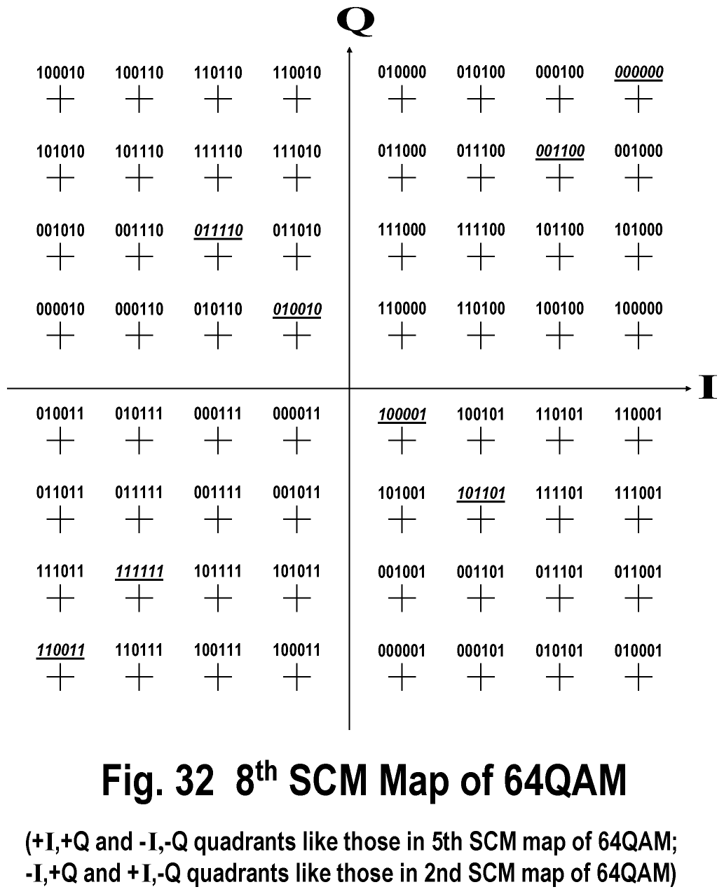

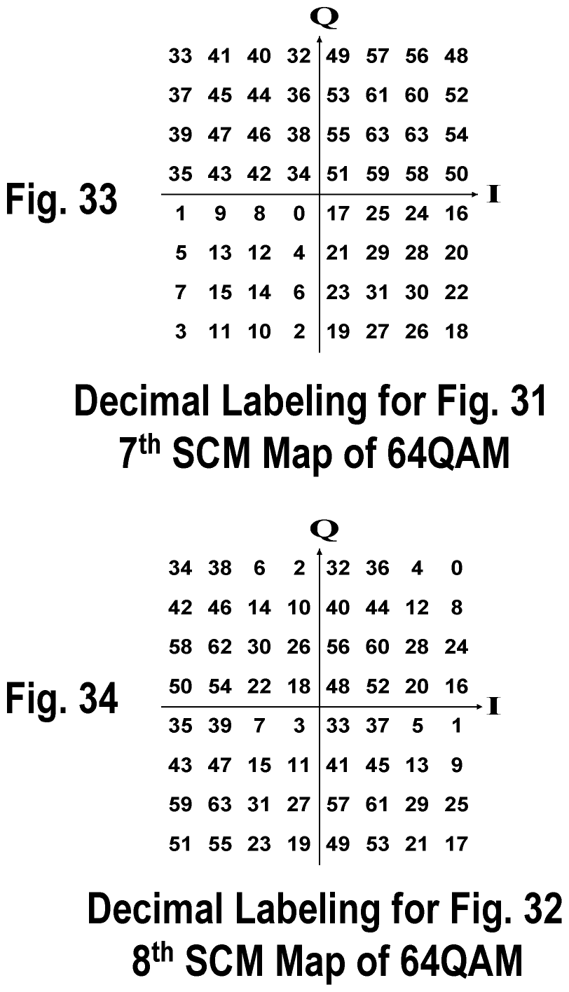

FIG. 31 and FIG. 32 are seventh and eighth SCM maps of 64QAM symbol constellations, respectively, which maps have preferred labeling diversity from each other. The FIG. 31 seventh SCM map of 64QAM is constructed by (a) using a −I,−Q quadrant and a +I,+Q quadrant similar to those in the FIG. 19 first SCM map of 64QAM and (b) using a −I,+Q quadrant and a +I, −Q quadrant similar to those in the FIG. 21 third SCM map of 64QAM. The FIG. 32 eighth SCM map of 64QAM is constructed by (a) using a −I,−Q quadrant and a +I,+Q quadrant similar to those in the FIG. 23 fifth SCM map of 64QAM and (b) using a −I,+Q quadrant and a +I, −Q quadrant similar to those in the FIG. 20 second SCM map of 64QAM. FIGS. 33 and 34 present decimal labeling for the FIG. 31 seventh SCM map of 64QAM and for the FIG. 32 eighth SCM map of 64QAM, respectively. Note that (a) the LPLs in the four outermost sub-quadrants of the FIG. 31 seventh SCM map of 64QAM appear in the four innermost sub-quadrants of the FIG. 32 eighth SCM map of 64QAM and (b) the LPLs in the four outermost sub-quadrants of the FIG. 32 eighth SCM map of 64QAM appear in the four innermost sub-quadrants of the FIG. 31 seventh SCM map of 64QAM. Accordingly, these seventh and eighth SCM maps of 64QAM support low PAPR in a DCM COFDM signal employing them.

Variants of the seventh and eighth SCM maps of 64QAM depicted in FIG. 31 and FIG. 32 include quadrants similar to those in the FIG. 22 fourth and FIG. 24 sixth SCM maps of 64QAM symbol constellations, instead of quadrants similar to those in the FIG. 21 third and FIG. 23 fifth SCM maps of 64QAM symbol constellations. These variants of the seventh and eighth SCM maps of 64QAM also support low PAPR in a DCM COFDM signal employing them.

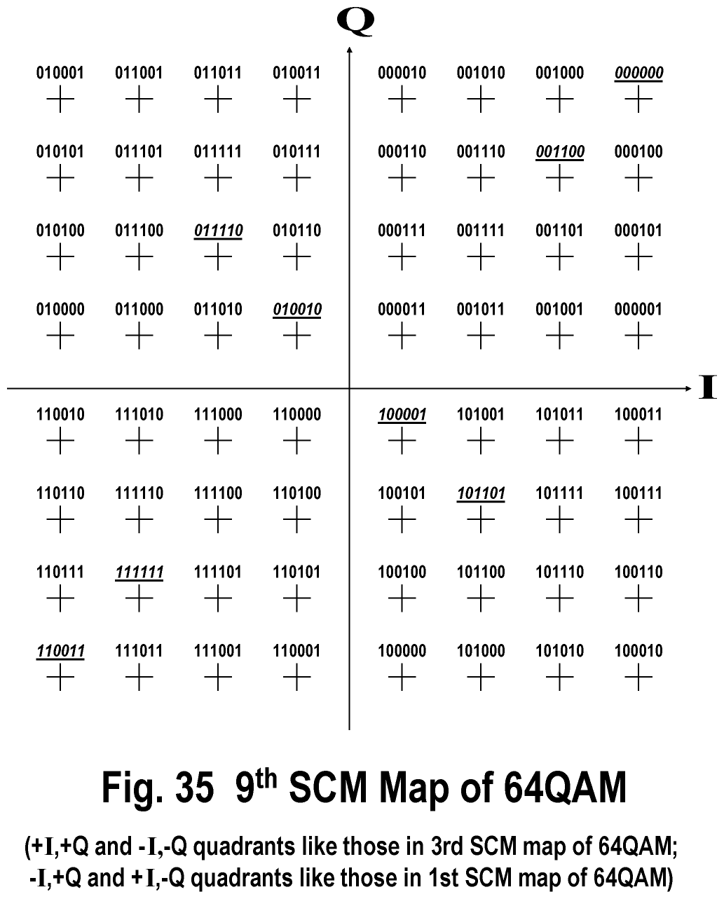

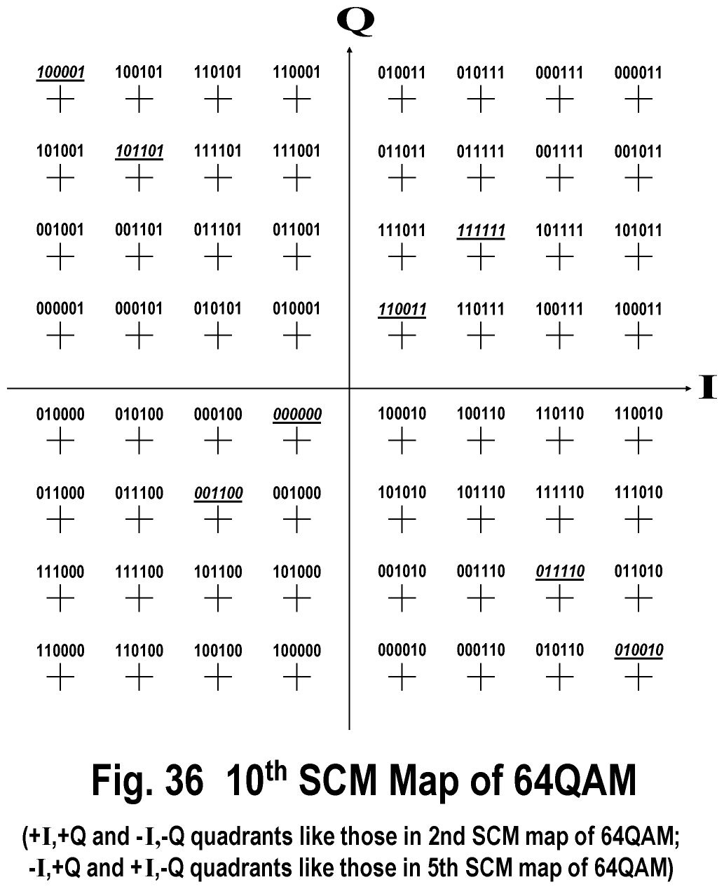

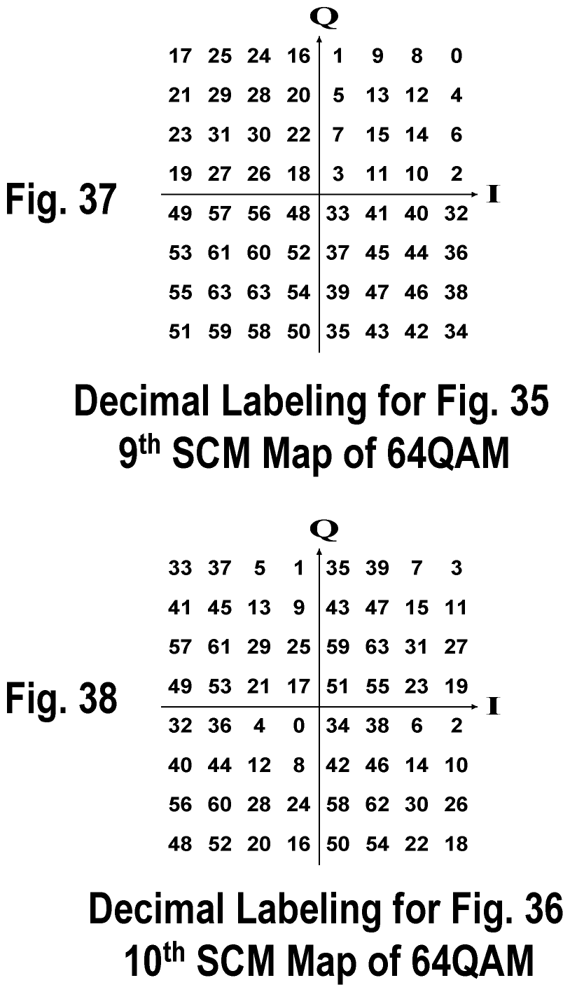

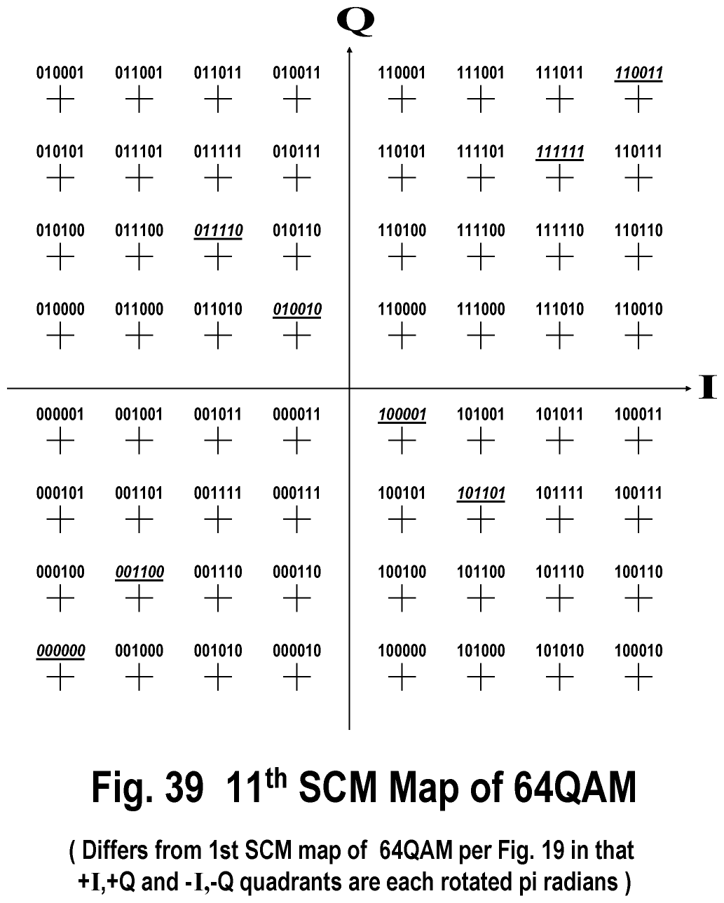

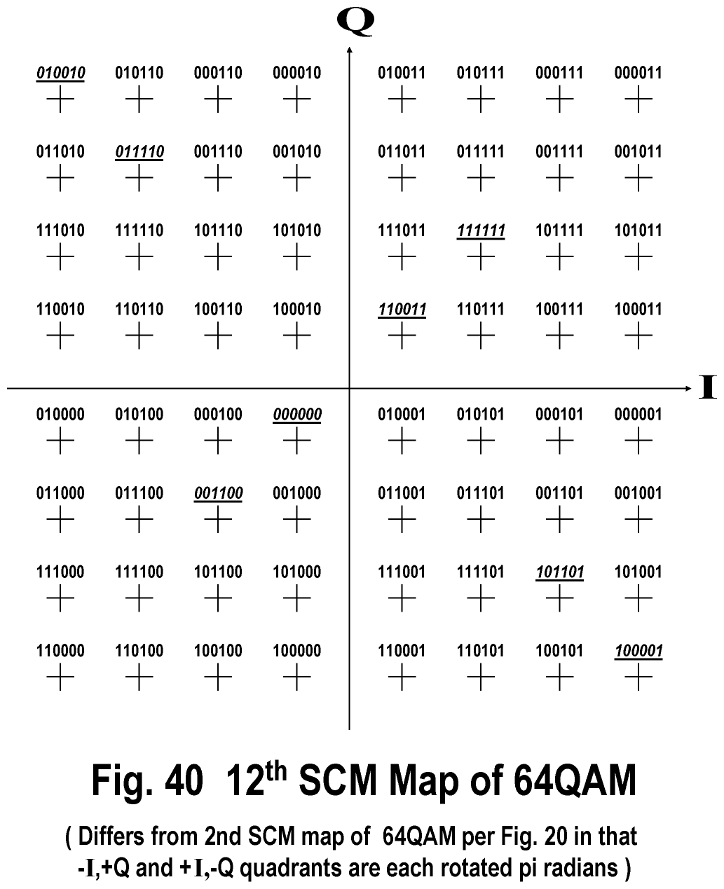

FIG. 35 and FIG. 36 are ninth and tenth SCM maps of 64QAM symbol constellations, respectively, which maps have preferred labeling diversity from each other. The FIG. 35 ninth SCM map of 64QAM is constructed by (a) using a −I,−Q quadrant and a +I,+Q quadrant similar to those in the FIG. 21 third SCM map of 64QAM and (b) using a −I,+Q quadrant and a +I, −Q quadrant similar to those in the FIG. 19 first SCM map of 64QAM. The FIG. 36 tenth SCM map of 64QAM is constructed by (a) using a −I,−Q quadrant and a +I,+Q quadrant similar to those in the FIG. 20 second SCM map of 64QAM and (b) using a −I,+Q quadrant and a +I, −Q quadrant similar to those in the FIG. 23 fifth SCM map of 64QAM. FIGS. 37 and 38 present decimal labeling for the FIG. 35 ninth SCM map of 64QAM and for the FIG. 36 tenth SCM map of 64QAM, respectively. Note that (a) the LPLs in the four outermost sub-quadrants of the FIG. 35 ninth SCM map of 64QAM appear in the four innermost sub-quadrants of the FIG. 36 tenth SCM map of 64QAM and (b) the LPLs in the four outermost sub-quadrants of the FIG. 36 tenth SCM map of 64QAM appear in the four innermost sub-quadrants of the FIG. 35 ninth SCM map of 64QAM. Accordingly, these ninth and tenth SCM maps of 64QAM support lower PAPR in a DCM COFDM signal employing them.

Variants of the ninth and tenth SCM maps of 64QAM depicted in FIG. 35 and FIG. 36 include quadrants similar to those in the FIG. 22 fourth and FIG. 24 sixth SCM maps of 64QAM symbol constellations, instead of quadrants similar to those in the FIG. 21 third and FIG. 23 fifth SCM maps of 64QAM symbol constellations. These variants of the ninth and tenth SCM maps of 64QAM also support low PAPR in a DCM COFDM signal employing them.

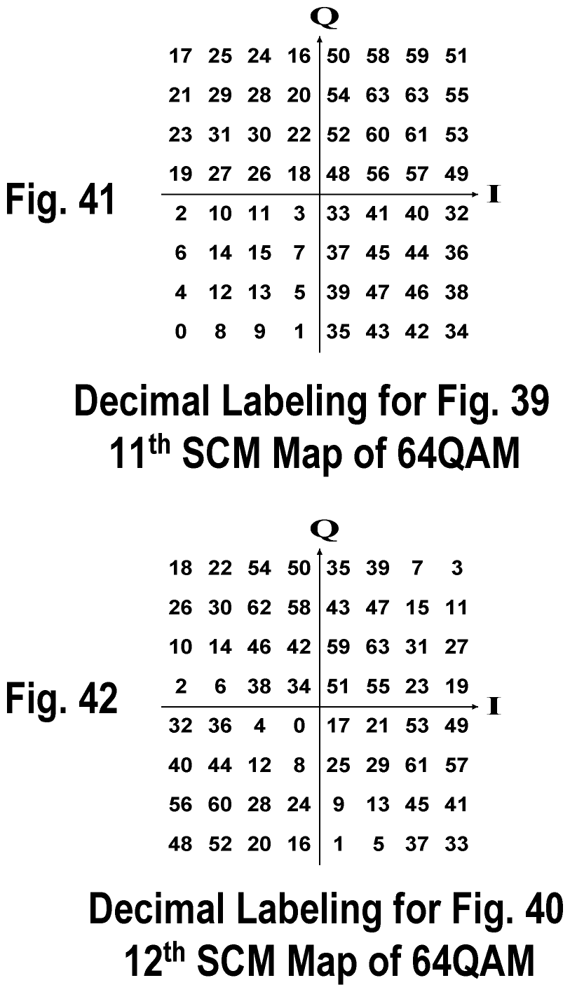

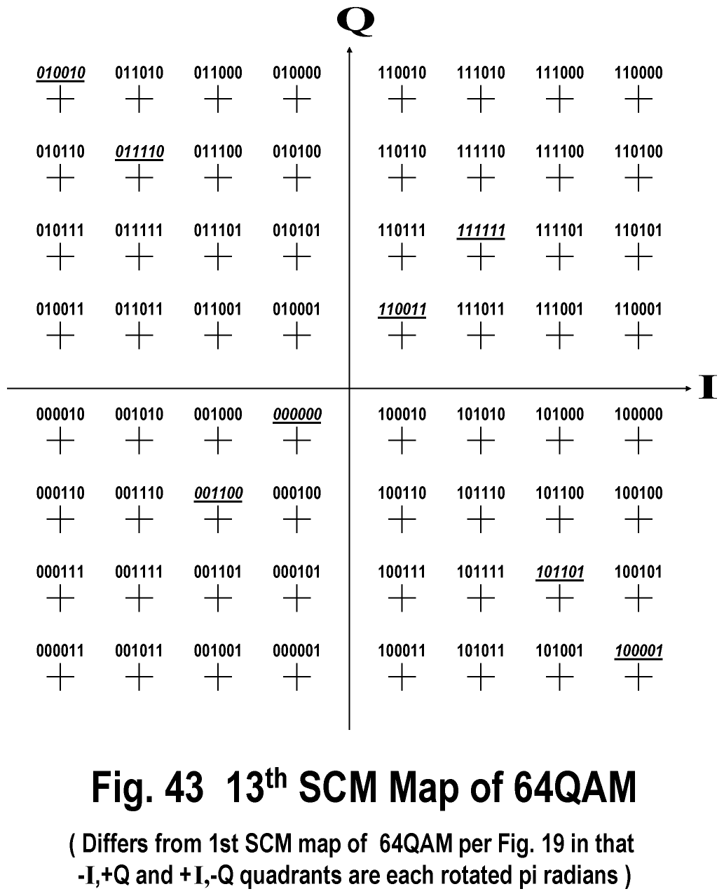

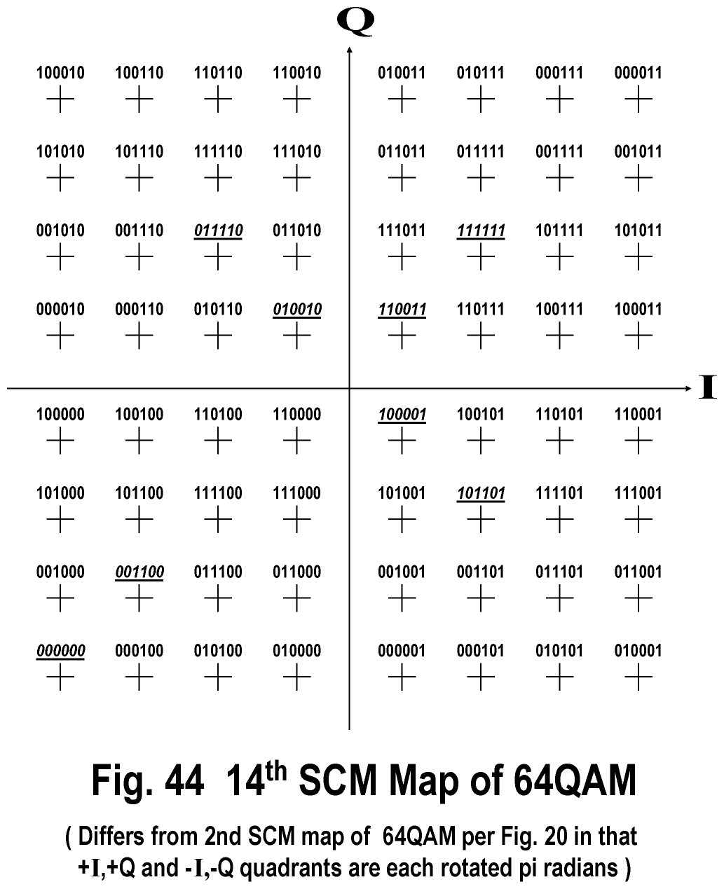

FIG. 39 and FIG. 40 are eleventh and twelfth SCM maps of 64QAM symbol constellations, respectively, which maps have preferred labeling diversity from each other. The FIG. 39 eleventh SCM map of 64QAM is constructed by (a) rotating the −I,−Q quadrant pi radians from that in the FIG. 19 first SCM map of 64QAM, (b) rotating the +I,+Q quadrant rotated pi radians from that in the FIG. 19 first SCM map of 64QAM, and (c) using a −I,+Q quadrant and a +I, −Q quadrant similar to those in the FIG. 19 first SCM map of 64QAM. The FIG. 40 twelfth SCM map of 64QAM is constructed by (a) using a −I,−Q quadrant and a +I,+Q quadrant similar to those in the FIG. 20 second SCM map of 64QAM, (b) rotating the −I,+Q quadrant from that in the FIG. 20 second SCM map of 64QAM, and (c) rotating the +I, −Q quadrant pi radians from that in the FIG. 20 second SCM map of 64QAM. FIGS. 41 and 42 present decimal labeling for the FIG. 39 eleventh SCM map of 64QAM and for the FIG. 40 twelfth SCM map of 64QAM, respectively. Note that (a) the LPLs in the four outermost sub-quadrants of the FIG. 39 eleventh SCM map of 64QAM appear in the four innermost sub-quadrants of the FIG. 40 twelfth SCM map of 64QAM and (b) the LPLs in the four outermost sub-quadrants of the FIG. 40 twelfth SCM map of 64QAM appear in the four innermost sub-quadrants of the FIG. 39 eleventh SCM map of 64QAM. Accordingly, these eleventh and twelfth SCM maps of 64QAM support low PAPR in a DCM COFDM signal employing them.

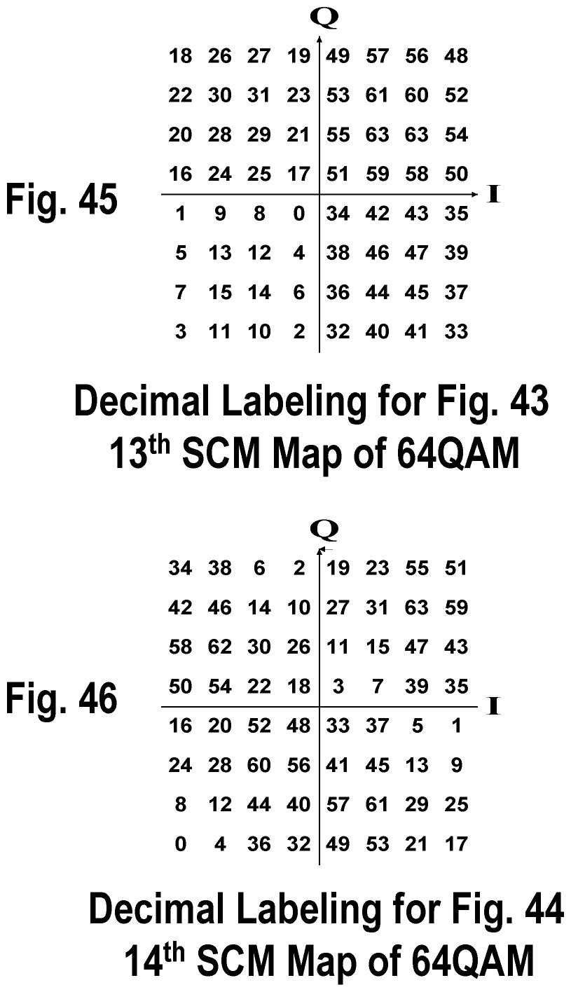

FIG. 43 and FIG. 44 are thirteenth and fourteenth SCM maps of 64QAM symbol constellations, respectively, which maps have preferred labeling diversity from each other. The FIG. 43 thirteenth SCM map of 64QAM is constructed by (a) rotating the −I,+Q quadrant pi radians from that in the FIG. 19 first SCM map of 64QAM, (b) rotating the +I,−Q quadrant rotated pi radians from that in the FIG. 19 first SCM map of 64QAM, and (c) using a +I,+Q quadrant and a −I, −Q quadrant similar to those in the FIG. 19 first SCM map of 64QAM. The FIG. 44 fourteenth SCM map of 64QAM is constructed by (a) using a +I,+Q quadrant and a −I,−Q quadrant similar to those in the FIG. 20 second SCM map of 64QAM, (b) rotating the −I,+Q quadrant from that in the FIG. 20 second SCM map of 64QAM, and (c) rotating the +I, −Q quadrant pi radians from that in the FIG. 20 second SCM map of 64QAM. FIGS. 45 and 46 present decimal labeling for the FIG. 43 thirteenth SCM map of 64QAM and for the FIG. 44 fourteenth SCM map of 64QAM, respectively. Note that (a) the LPLs in the four outermost sub-quadrants of the FIG. 43 thirteenth SCM map of 64QAM appear in the four innermost sub-quadrants of the FIG. 44 fourteenth SCM map of 64QAM and (b) the LPLs in the four outermost sub-quadrants of the FIG. 44 fourteenth SCM map of 64QAM appear in the four innermost sub-quadrants of the FIG. 43 thirteenth SCM map of 64QAM. Accordingly, these thirteenth and fourteenth SCM maps of 64QAM support low PAPR in a DCM COFDM signal employing them.

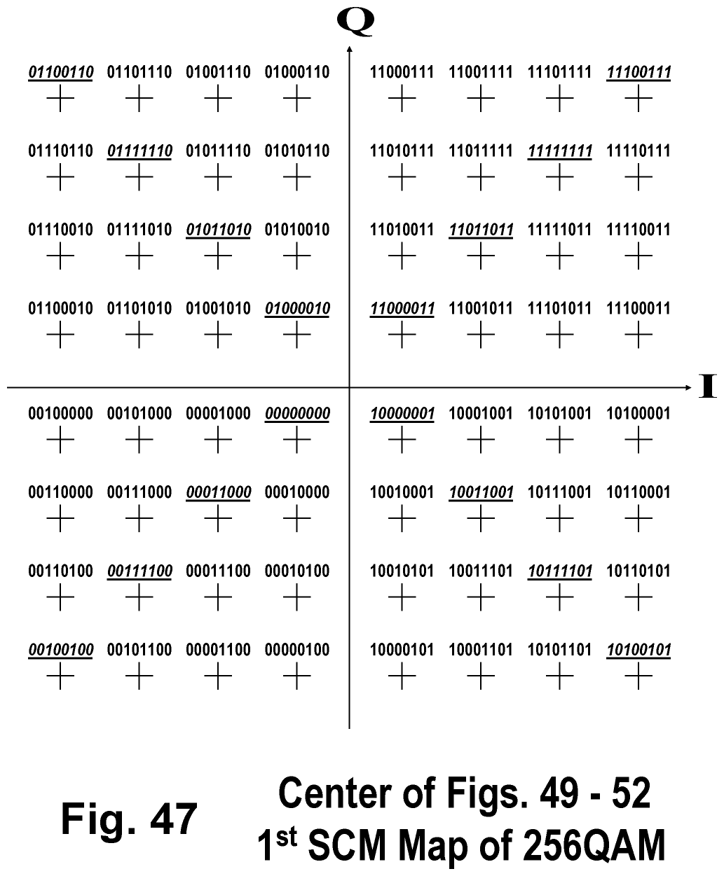

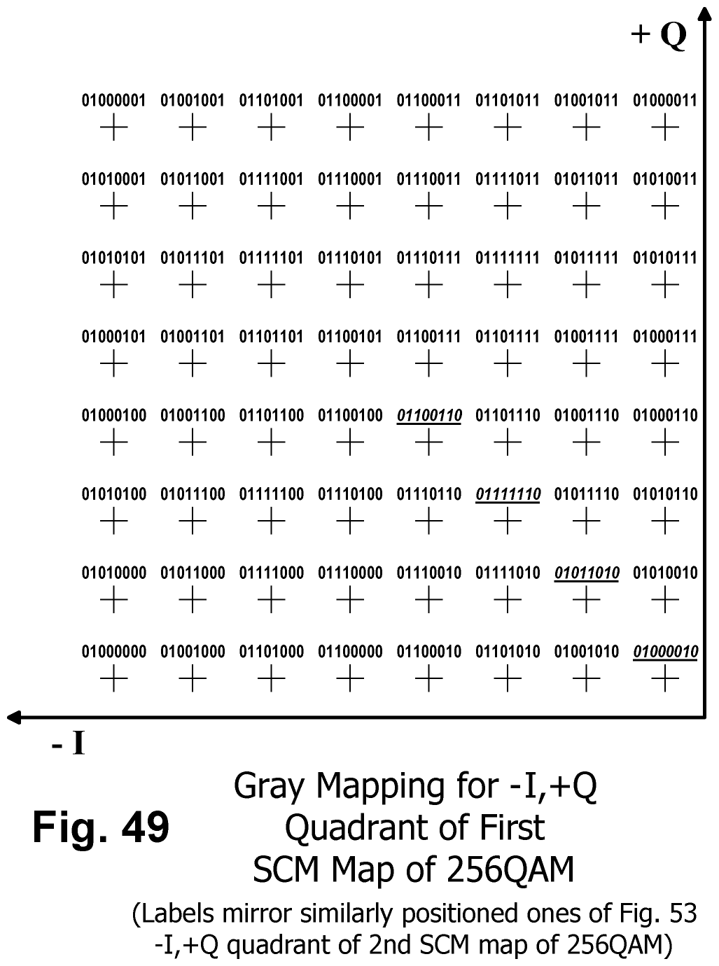

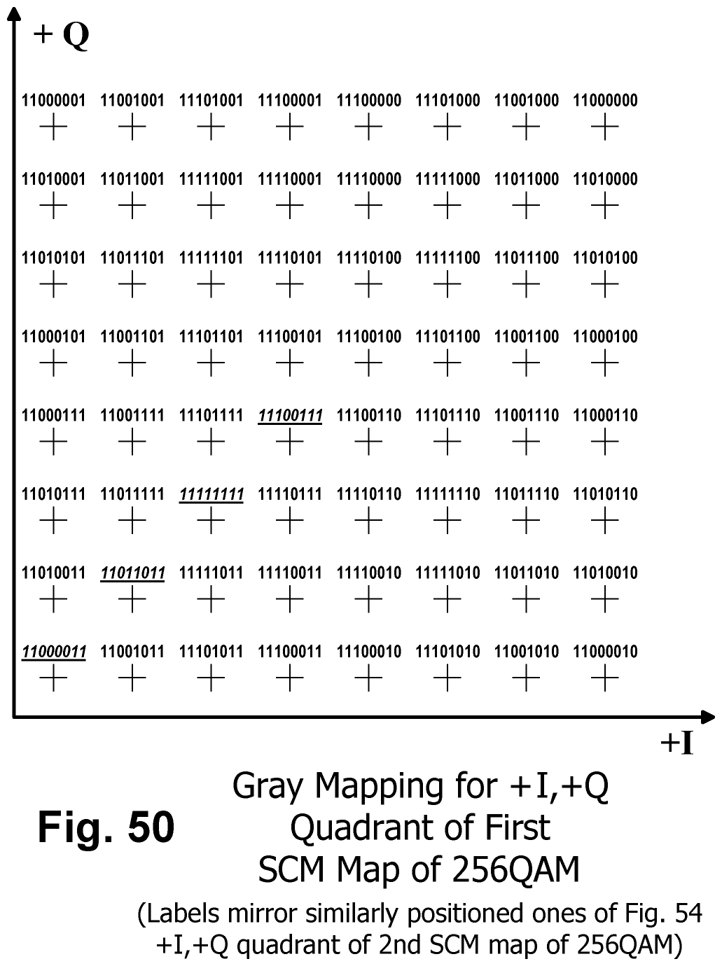

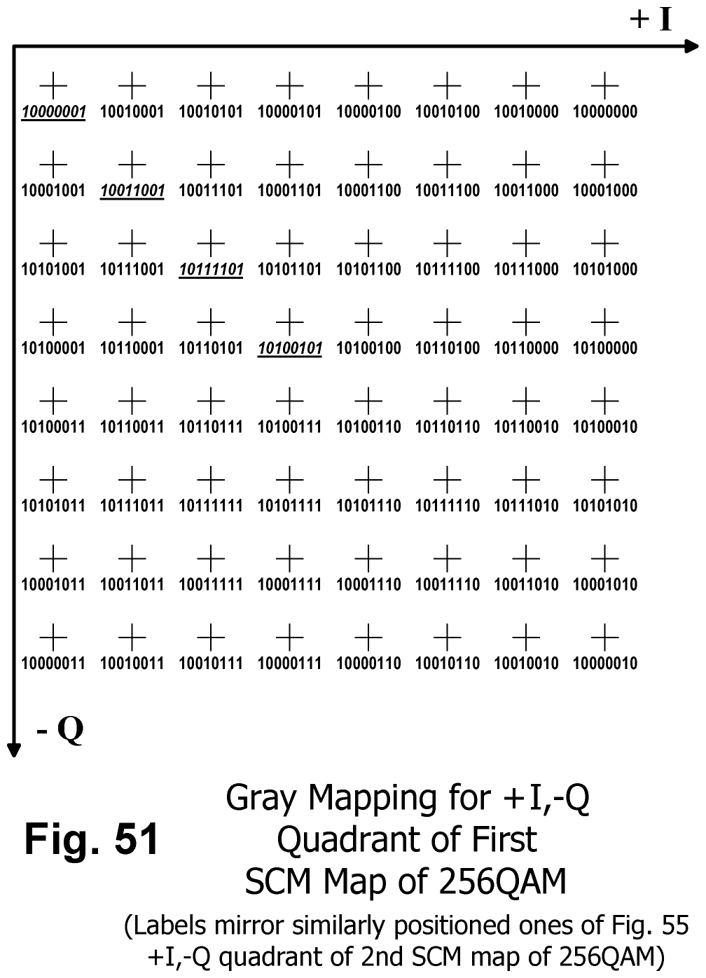

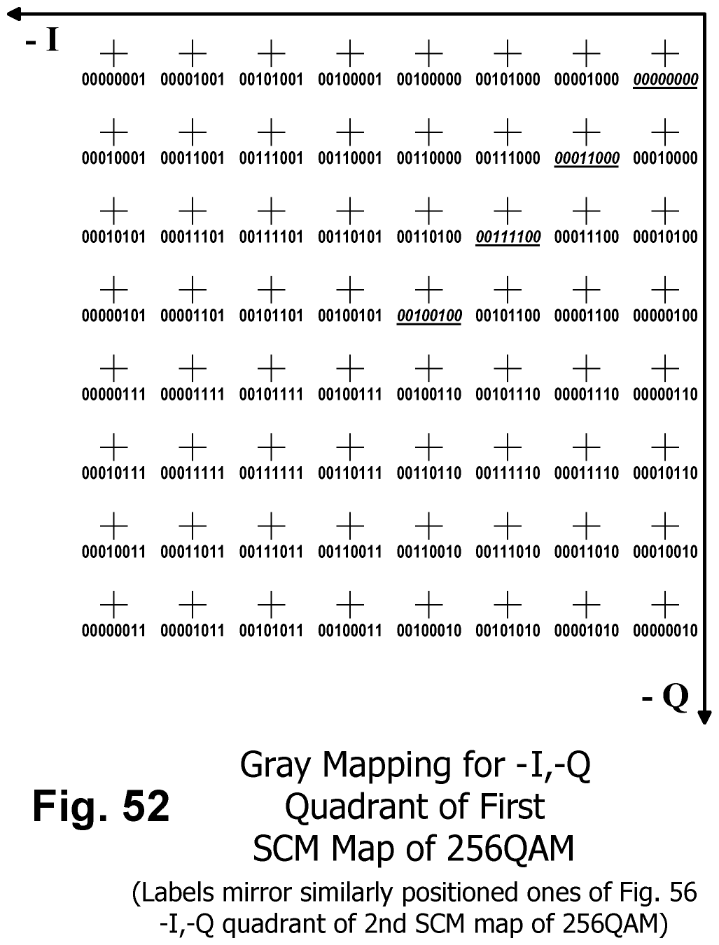

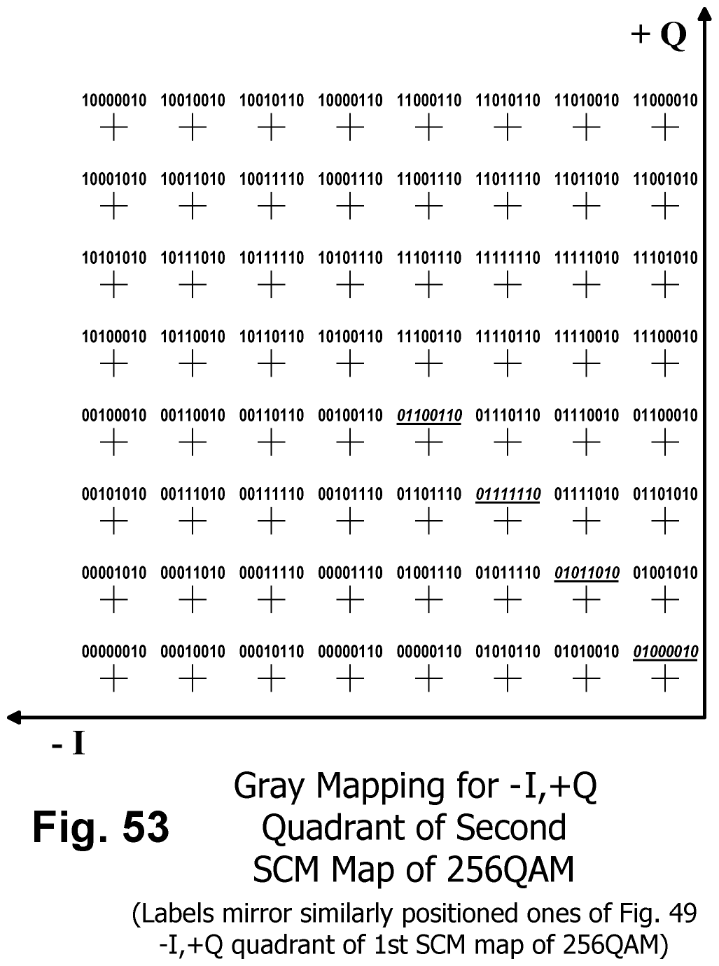

FIG. 47 depicts the central portion of a first SCM map of square 256QAM symbol constellations depicted in full in FIGS. 49, 50, 51 and 52. The palindromic label 00000000 is applied to the lattice point located in the innermost corner of the −I,−Q quadrant in the FIG. 47 first SCM map of 256QAM. The palindromic labels 00100100, 00111100 and 00011000 are applied sequentially to successive lattice points located diagonally next within that −I,−Q quadrant. The 01000010 label is applied to the lattice point located in the innermost corner of the −I,+Q quadrant in the FIG. 47 first SCM map of 256QAM. The palindromic labels 01100110, 01111110 and 01011010 are applied sequentially to successive lattice points located diagonally next within that −I,+Q quadrant. The 11000011 label is applied to the lattice point located in the innermost corner of the +I,+Q quadrant in the FIG. 47 first SCM map of 256QAM. The palindromic labels 11100111, 11111111 and 11011011 are applied sequentially to successive lattice points located diagonally next within that +I,+Q quadrant. The 10000001 label is applied to the lattice point located in the innermost corner of the +I,−Q quadrant in the FIG. 47 first SCM map of 256QAM. The palindromic labels 10100101, 10111101 and 10011001 are applied sequentially to successive lattice points located diagonally next within that +I,−Q quadrant.

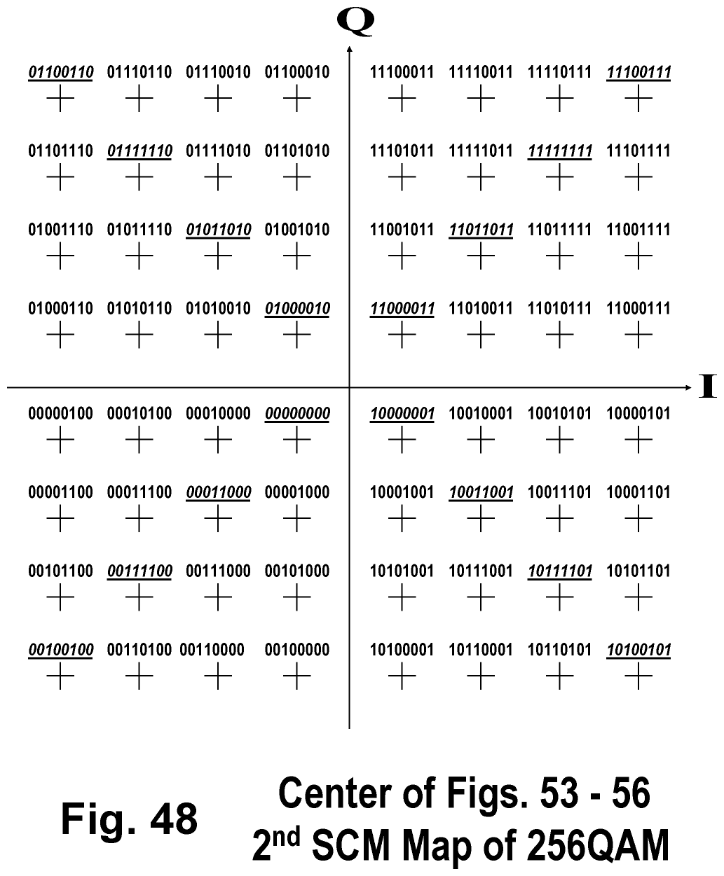

FIG. 48 depicts the central portion of a second SCM map of square 256QAM symbol constellations depicted in full in FIGS. 53, 54, 55 and 56. The labels of correspondingly positioned lattice points in the first and second SCM maps of square 256QAM symbol constellations have opposite orders of bits in their respective initial halves and have opposite orders of bits in their respective final halves. The palindromic label 00000000 is applied to the lattice point located in the innermost corner of the −I,−Q quadrant in the FIG. 48 second SCM map of 256QAM. The palindromic labels 01000010, 11000011 and 10000001 are applied sequentially to successive lattice points located diagonally next within that −I,−Q quadrant. The 00100100 label is applied to the lattice point located in the innermost corner of the −I,+Q quadrant in the FIG. 48 second SCM map of 256QAM. The palindromic labels 01100110, 11100111 and 10100101 are applied sequentially to successive lattice points located diagonally next within that −I,+Q quadrant. The 00111100 label is applied to the lattice point located in the innermost corner of the +I,+Q quadrant in the FIG. 48 second SCM map of 256QAM. The palindromic labels 01111110, 11111111 and 10111101 are applied sequentially to successive lattice points located diagonally next within that +I,+Q quadrant. The 00011000 label is applied to the lattice point located in the innermost corner of the +I,−Q quadrant in the FIG. 48 second SCM map of 256QAM. The palindromic labels 01011010, 11011011 and 10011001 are applied sequentially to successive lattice points located diagonally next within that +I,−Q quadrant.

FIGS. 49, 50, 51 and 52 depict respective quadrants of the first SCM map of square 256QAM symbol constellations. When reading the LPLs of the first SCM map of 256QAM from left to right, the odd-occurring bits describe columns in the lattice and the even-occurring bits describe rows in the lattice. In the Gray mapping of each quadrant of the first SCM map of 256QAM, the leftmost two bits of LPLs identify that particular quadrant within which the lattice points are located, and the rightmost two bits of LPLs specify which of four sub-quadrants within that particular quadrant each lattice point is located within. In an SCM map of 256QAM there are 64 lattice points in each quadrant and 16 lattice points in each of the four sub-quadrants within a quadrant. I. e., the quadrant considered as a bin for LPLs has four columns and four rows of them, twice the number of columns and twice the number of rows as a sub-quadrant. However, owing to the arrangement of sub-quadrants in adjoining quadrants, the rightmost two bits of each of the LPLs from the first SCM map of 256QAM tend to be about the same robustness as the leftmost two bits of those labels during BRA in a receiver for DCM COFDM signals.

The bits three-in-from-left within the LPLs of the first SCM map of 256QAM describe bins four columns wide, so during BRA in a receiver for DCM COFDM signals these bits tend to be less robust than the initial bits in the leftmost and rightmost pairs of bits in those labels. The bits four-in-from-left within the LPLs of the first SCM map of 256QAM describe bins four rows deep, so during BRA these bits tend to be less robust than the final bits in the leftmost and rightmost pairs of bits in those labels. The bits five-in-from-left within the LPLs of the first SCM map of 256QAM describe bins two columns wide, so during BRA these bits tend to be still less robust than the bits three-in-from-left within those labels. The bits six-in-from-left within the LPLs of the first SCM map of 256QAM describe bins two rows deep, so during BRA these bits tend to be still less robust than the bits four-in-from-left within those labels.

FIGS. 53, 54, 55 and 56 depict respective quadrants of a second SCM map of square 256QAM symbol constellations derived in the following manner from the first SCM map of square 256QAM symbol constellations depicted in FIGS. 49, 50, 51 and 52. The initial four bits of each LPL in the second SCM map of 256QAM are the same as the final four bits of the corresponding LPL in the first SCM map of 256QAM, and these four bits are otherwise in similar order in both maps. The final four bits of each LPL in the second SCM map of 256QAM are the same as the initial four bits of the corresponding LPL in the first SCM map of 256QAM, and these four bits are otherwise in similar order in both maps. When reading the LPLs of this second SCM map of 256QAM from left to right, the odd-occurring bits describe columns in the lattice and the even-occurring bits describe rows in the lattice, just as is the case when reading the LPLs of the first SCM map of 256QAM from left to right.

However, during BRA in a receiver for DCM COFDM signals the central four bits in the LPLs of the second SCM map of 256QAM tend to be more robust than the two leftmost bits and the two rightmost bits. The fifth and sixth bits from left in each of these LPLs identifies the quadrant of the second SCM map of 256QAM in which the lattice point is located, and the third and fourth bits from left in each of these LPLs identifies the sub-quadrant of that quadrant in which the lattice point is located. Accordingly, the likelihood of error in the bits of coded digital data recovered from 256QAM symbols in a COFDM receiver using SBMRC of demapping results of DCM will be no larger than the likelihood of error in the bits of coded digital data (CCD) recovered from 16QAM symbols without benefit of DCM. Data throughput of two sets of 256QAM symbols in DCM COFDM signal is the same as data throughput of one set of 16QAM symbols in COFDM signal without DCM. The described technique for improving bit reliability of the CCD recovered from SBMRC of the demapping results of DCM will reduce the amount of PAPR reduction that can be obtained, however.

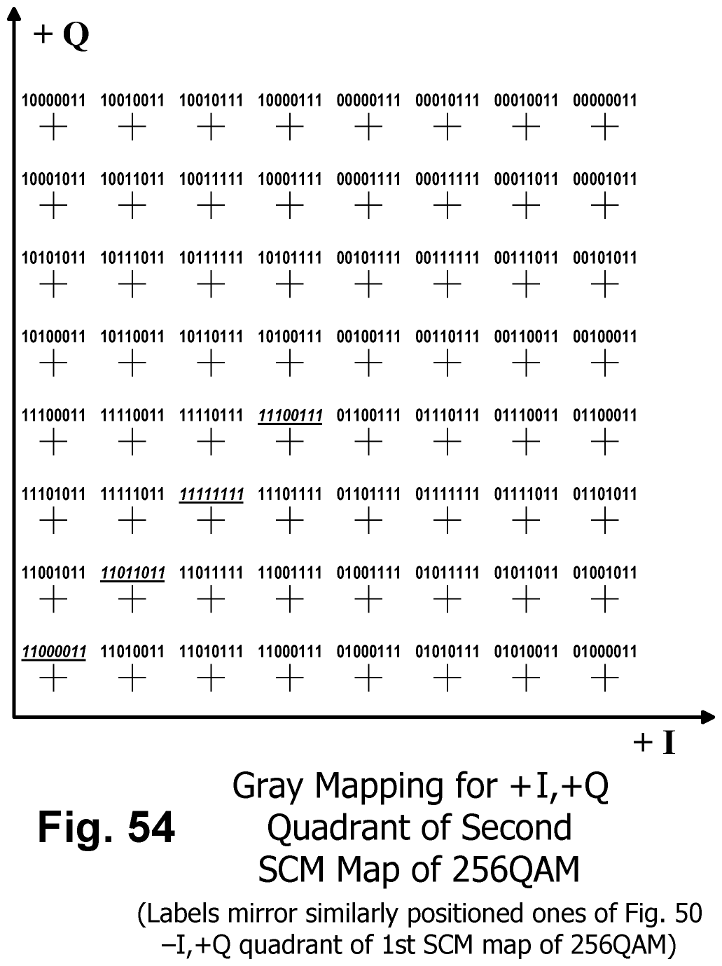

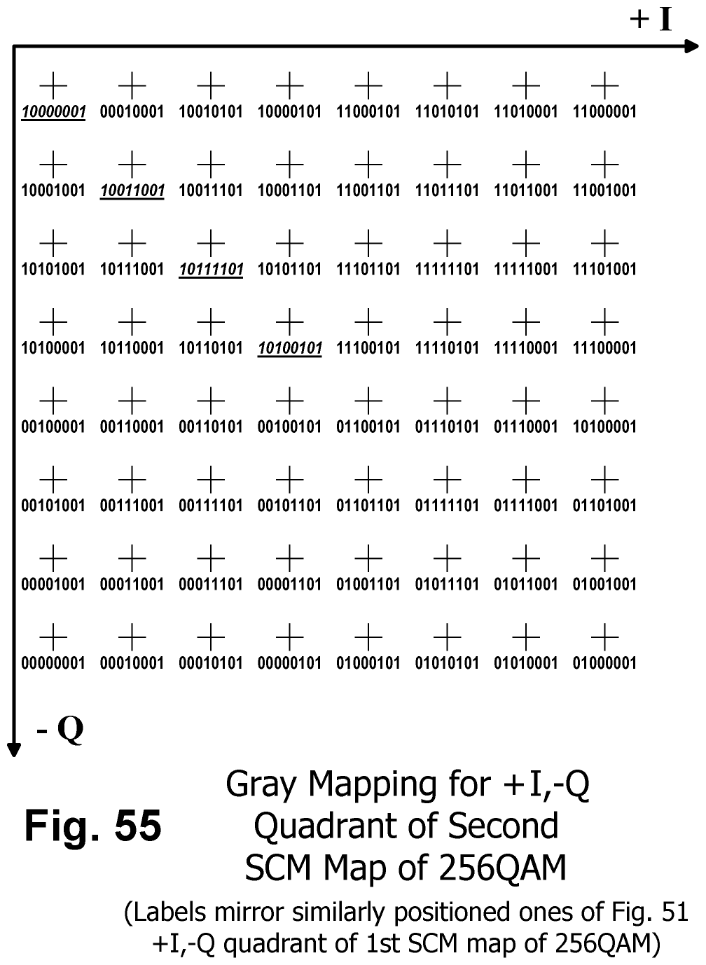

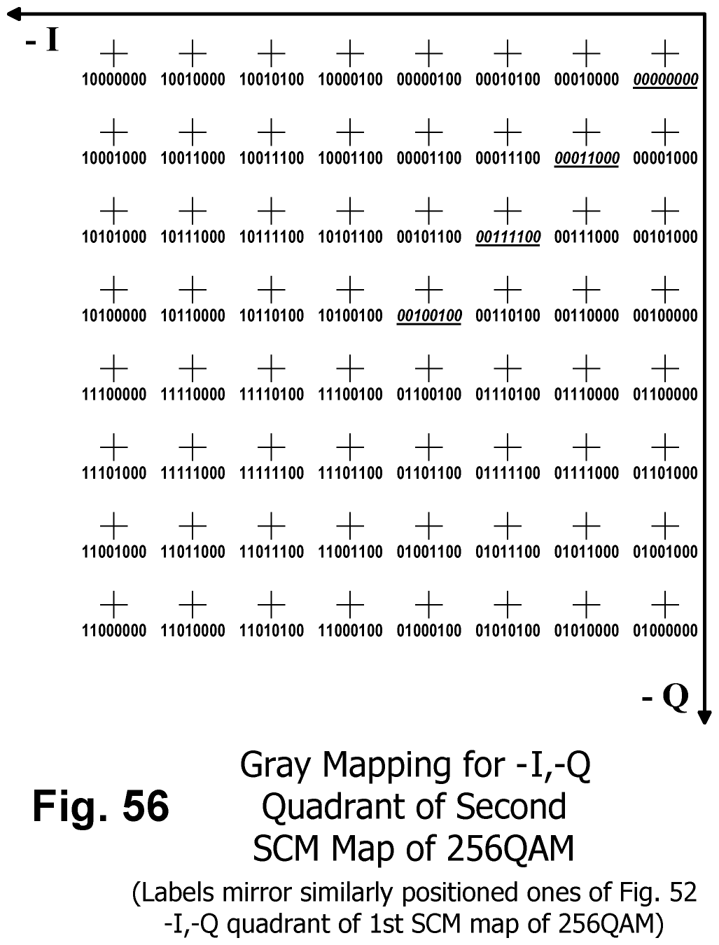

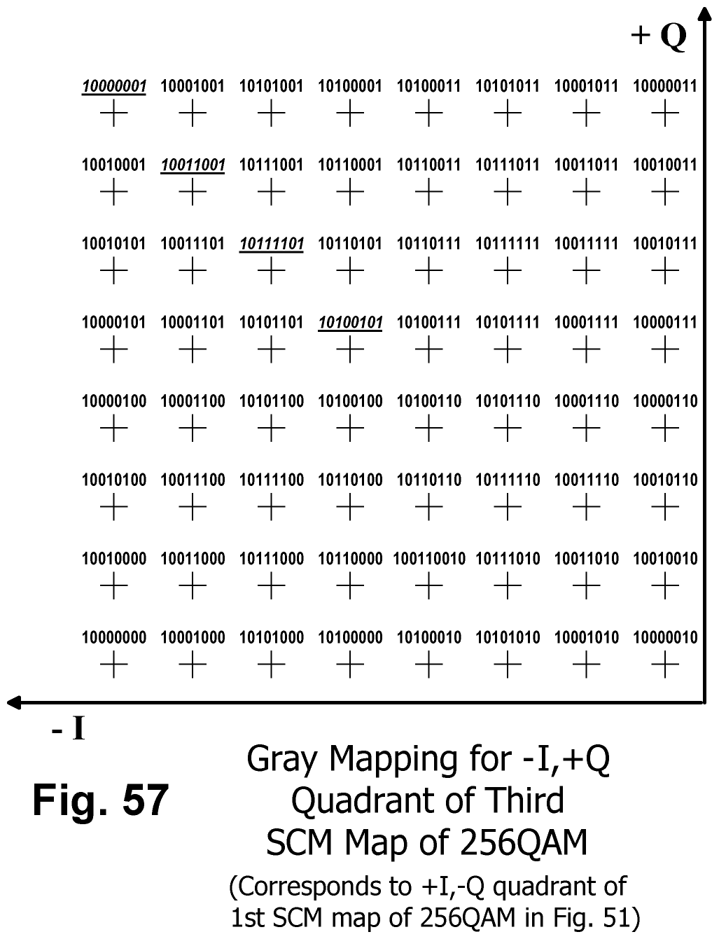

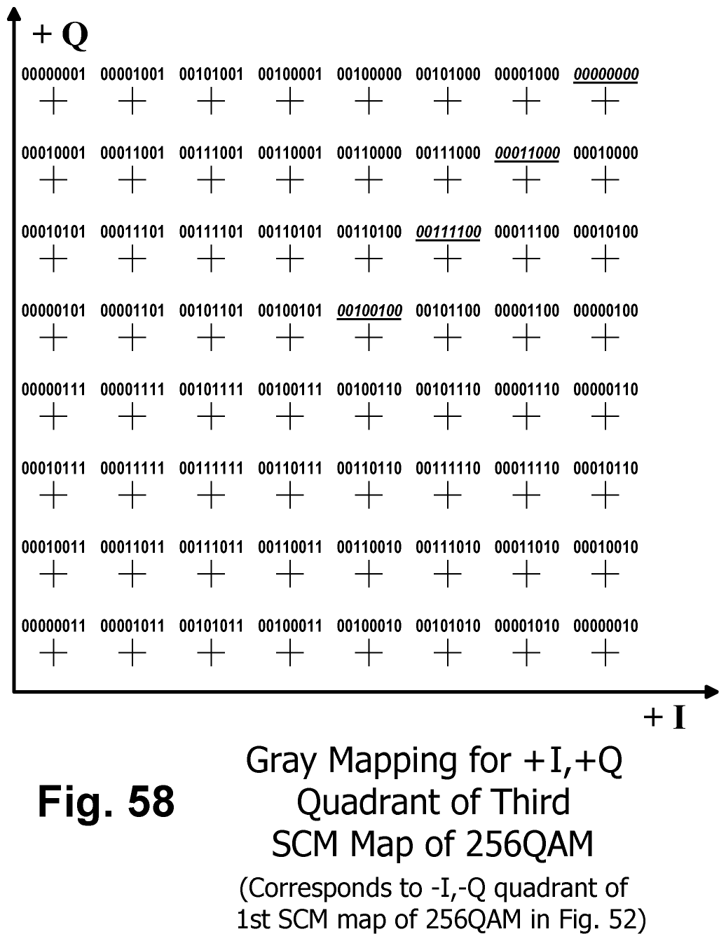

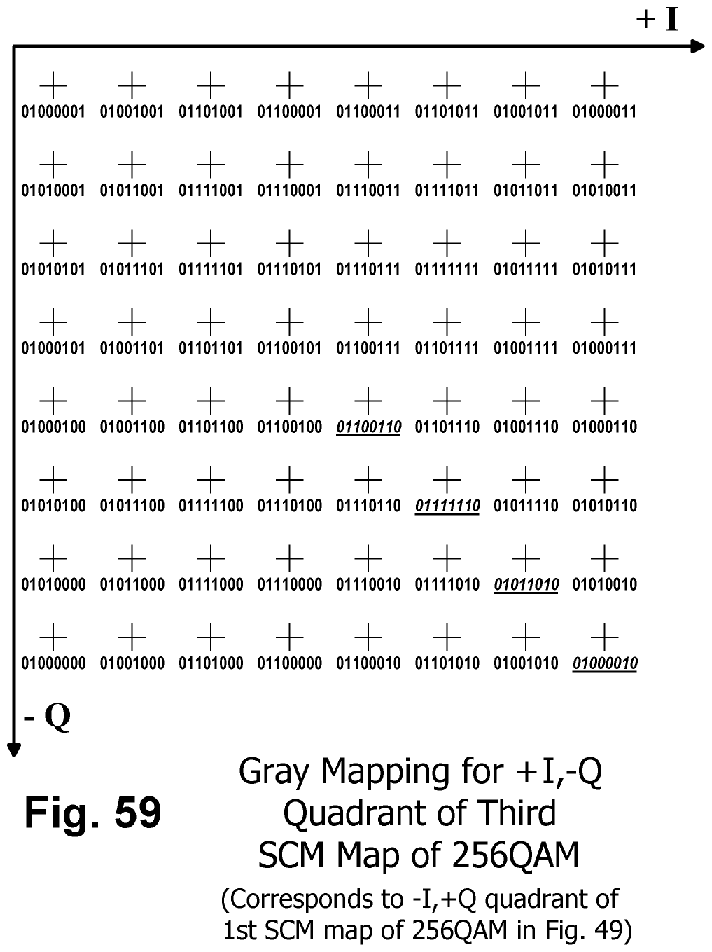

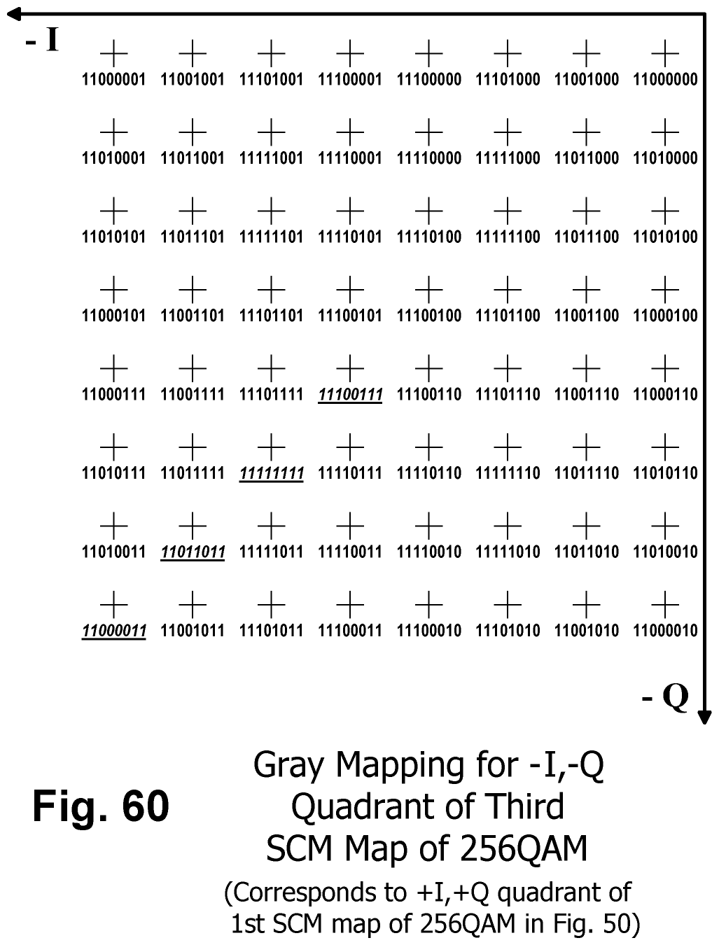

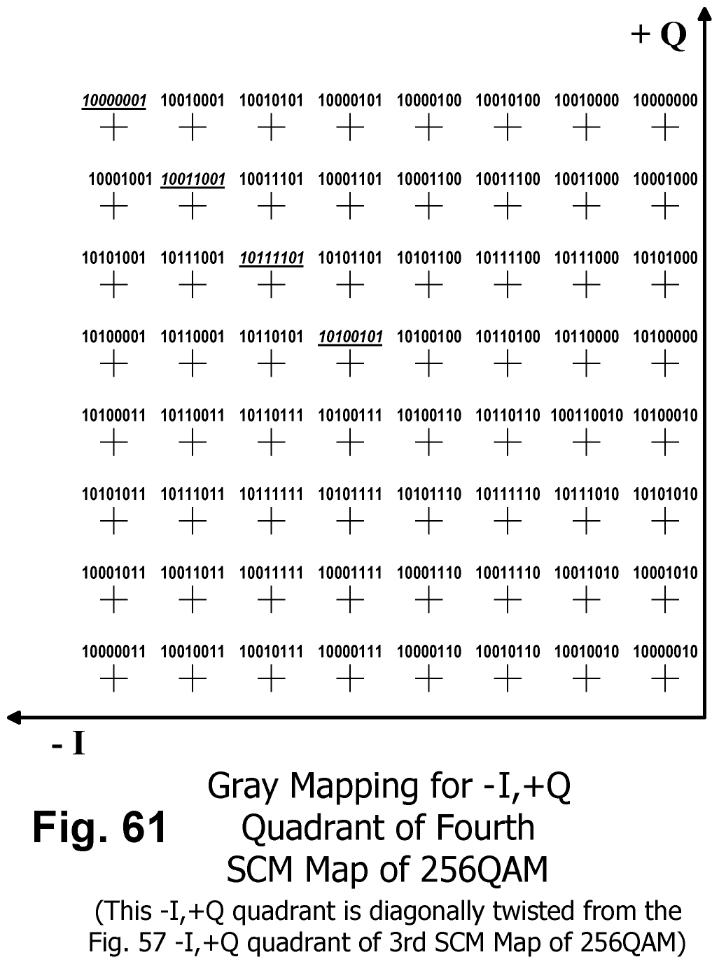

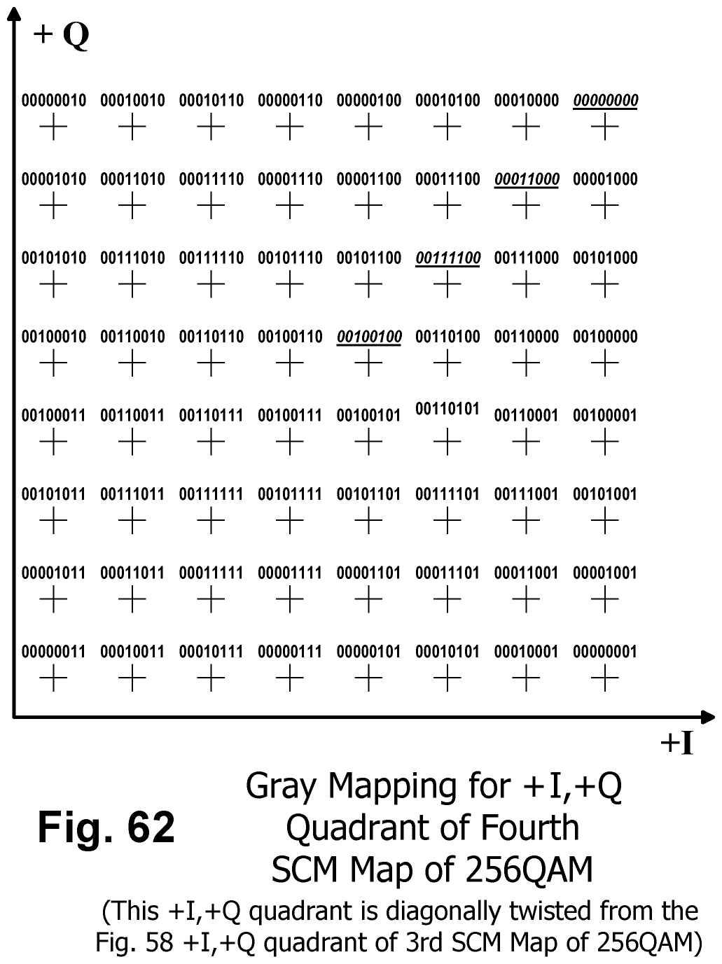

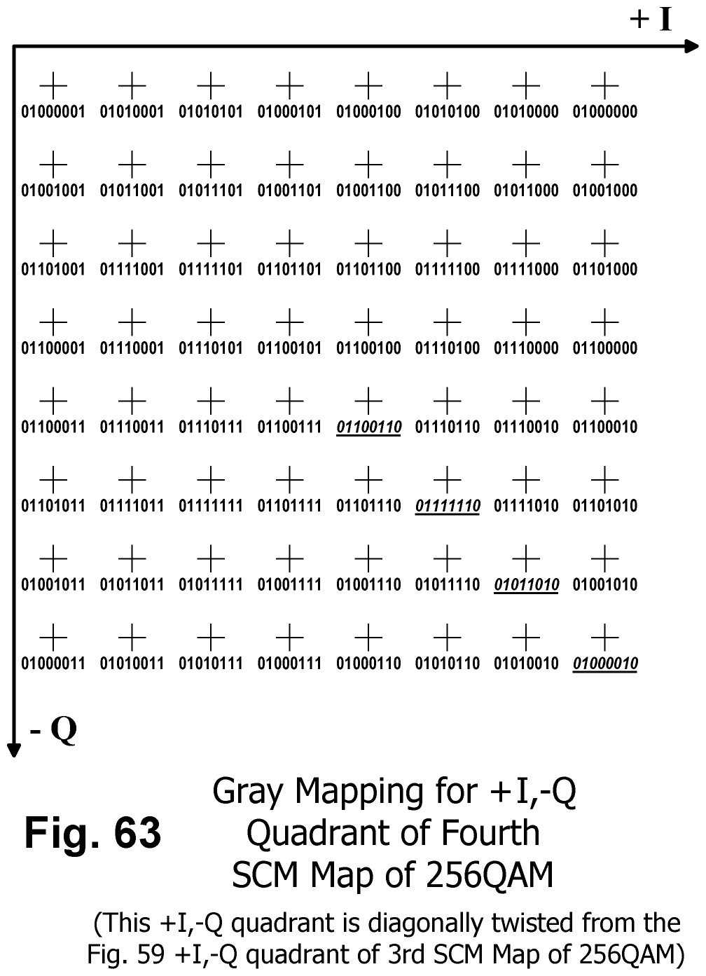

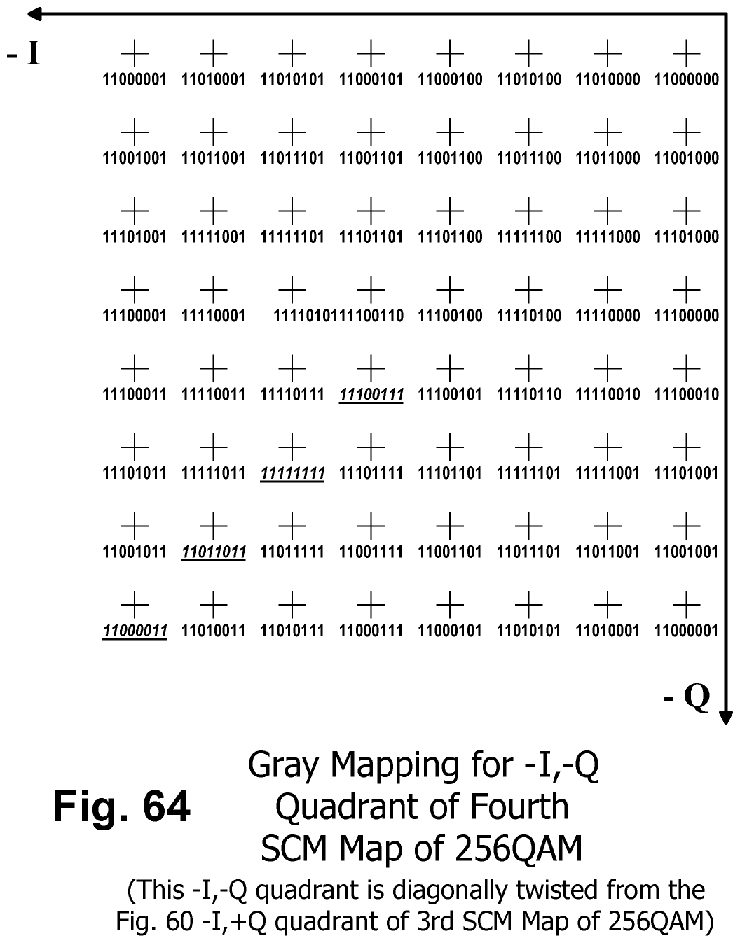

FIGS. 57, 58, 59 and 60 depict respective quadrants of a third SCM map of square 256QAM symbol constellations. The lattice points in the FIG. 57 −I,+Q quadrant of the third SCM map of 256QAM are labeled like correspondingly positioned lattice points in the FIG. 51 +I, −Q quadrant of the first SCM map of 256QAM. The lattice points in the FIG. 58 +I,+Q quadrant of the third SCM map of 256QAM are labeled like correspondingly positioned lattice points in the FIG. 52 −I,−Q quadrant of the first SCM map of 256QAM. The lattice points in the FIG. 59 +I, −Q quadrant of the third SCM map of 256QAM are labeled like correspondingly positioned lattice points in the FIG. 49 −I,+Q quadrant of the first SCM map of 256QAM. The lattice points in the FIG. 58 −I,−Q quadrant of the third SCM map of 256QAM are labeled like correspondingly positioned lattice points in the FIG. 50 +I,+Q quadrant of the first SCM map of 256QAM.

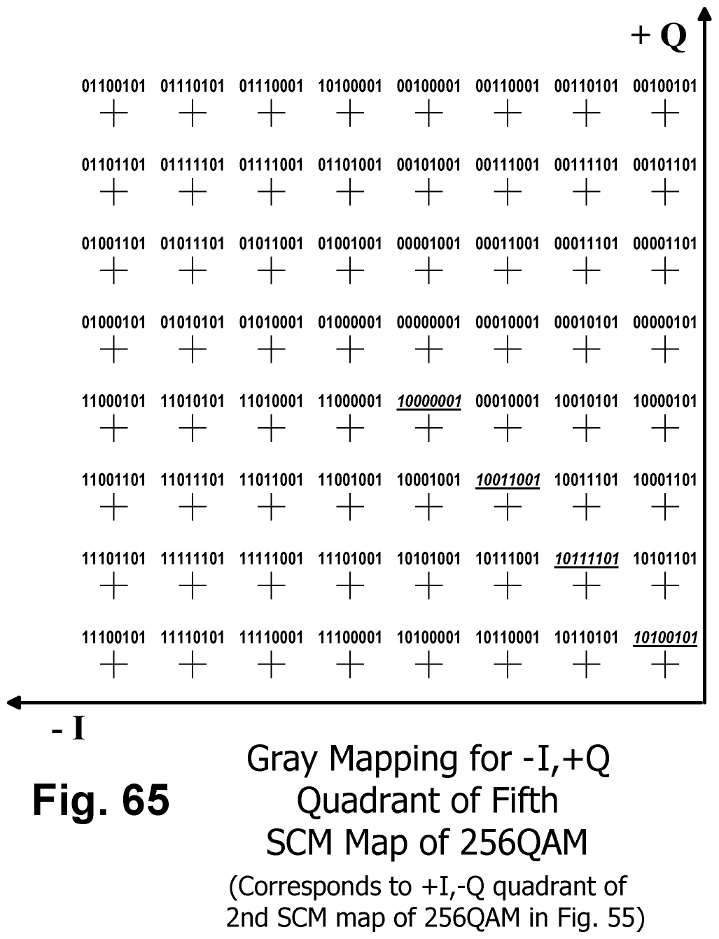

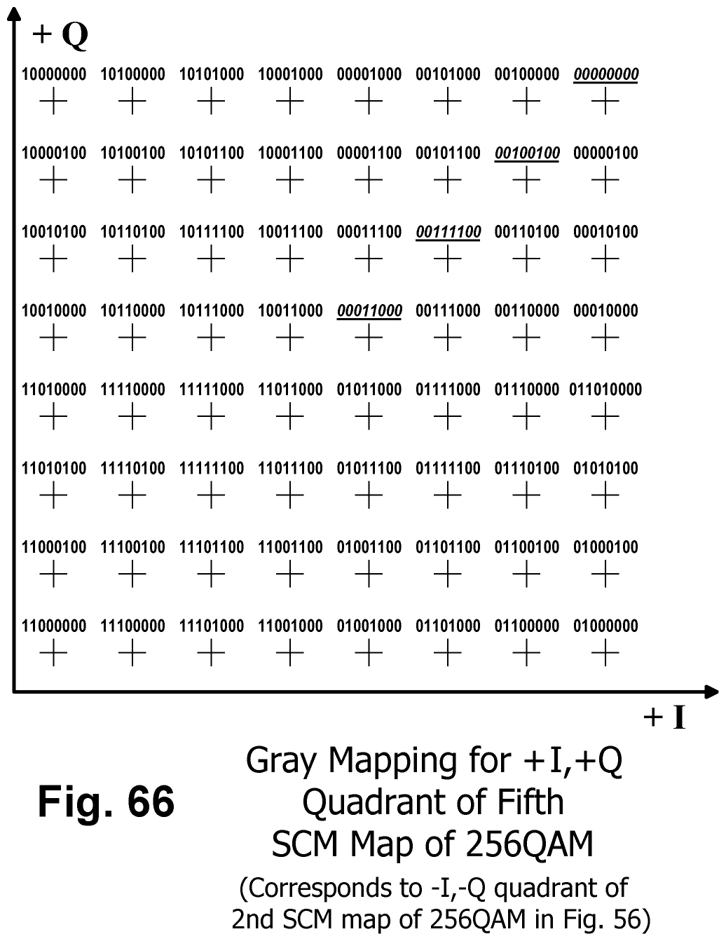

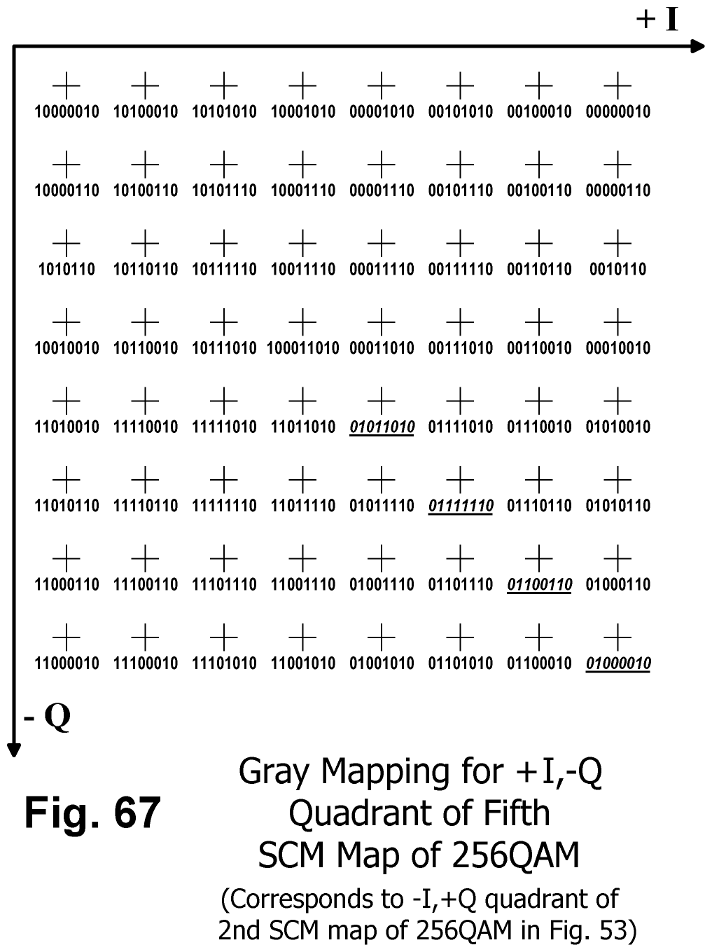

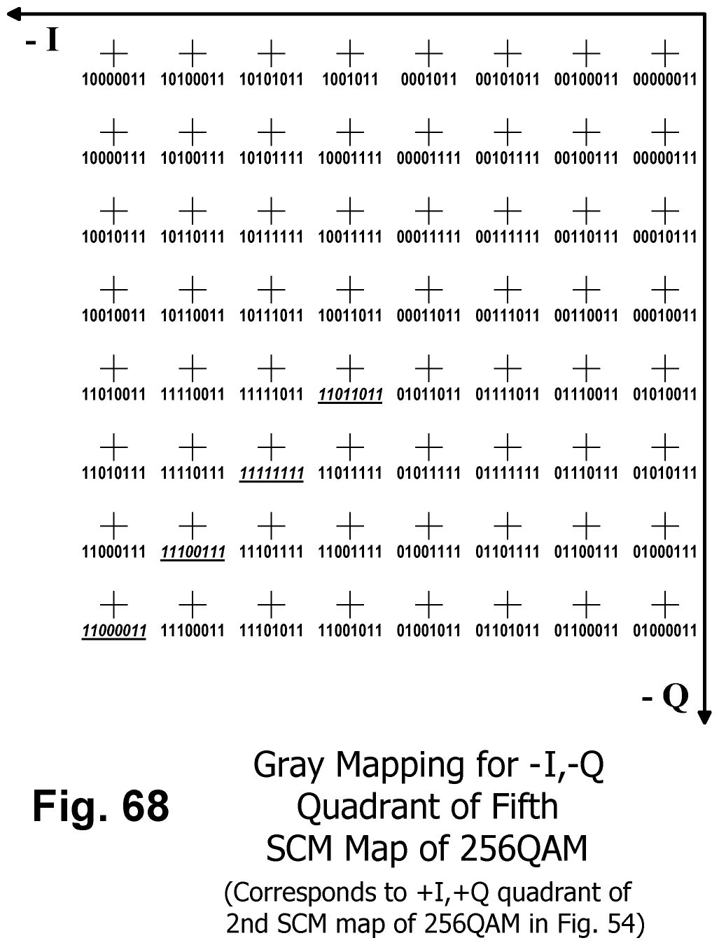

FIGS. 61, 62, 63 and 64 depict respective quadrants of a fourth SCM map of square 256QAM symbol constellations. The LPLs in the quadrants of FIGS. 61, 62, 63 and 64 are diagonally twisted from the LPLs in the quadrants of the third SCM map of 256QAM respectively depicted in FIGS. 57, 58, 59 and 60.

Using either of the third or fourth SCM maps of 256QAM together with the first SCM map of 256QAM to provide labeling diversity for DCM supports a 4.56 dB reduction in PAPR. However, SNR for reception over an AWGN channel will not be as good as for using the same SCM mapping of 16QAM for the DCM (though no more than 3 dB worse). Similar results obtain using either of the third or fourth SCM maps of 256QAM together with a seventh SCM map of 256QAM to provide labeling diversity for DCM, which seventh SCM map of 256QAM reverses the orders of palindromic LPLs in each quadrant from the orders of palindromic LPLs in corresponding quadrants of the first SCM map of 256QAM. Gray mapping of each of the quadrants in the seventh SCM map of 256QAM suits the reversed order of palindromic labels in its innermost sub-quadrant.

Using either of the third or fourth SCM maps of 256QAM together with the second map of 256QAM to provide labeling diversity for DCM supports just a 2.99 dB reduction in PAPR, but the SNR for reception over an AWGN channel will be significantly improved. Similar results obtain using either of the third or fourth SCM maps of 256QAM together with an eighth SCM map of 256QAM to provide labeling diversity for DCM, which eighth SCM map of 256QAM reverses the orders of palindromic LPLs in each quadrant from the orders of palindromic LPLs in corresponding quadrants of the second SCM map of 256QAM. Gray mapping of each of the quadrants in the eighth SCM map of 256QAM suits the reversed order of palindromic labels in its innermost sub-quadrant.

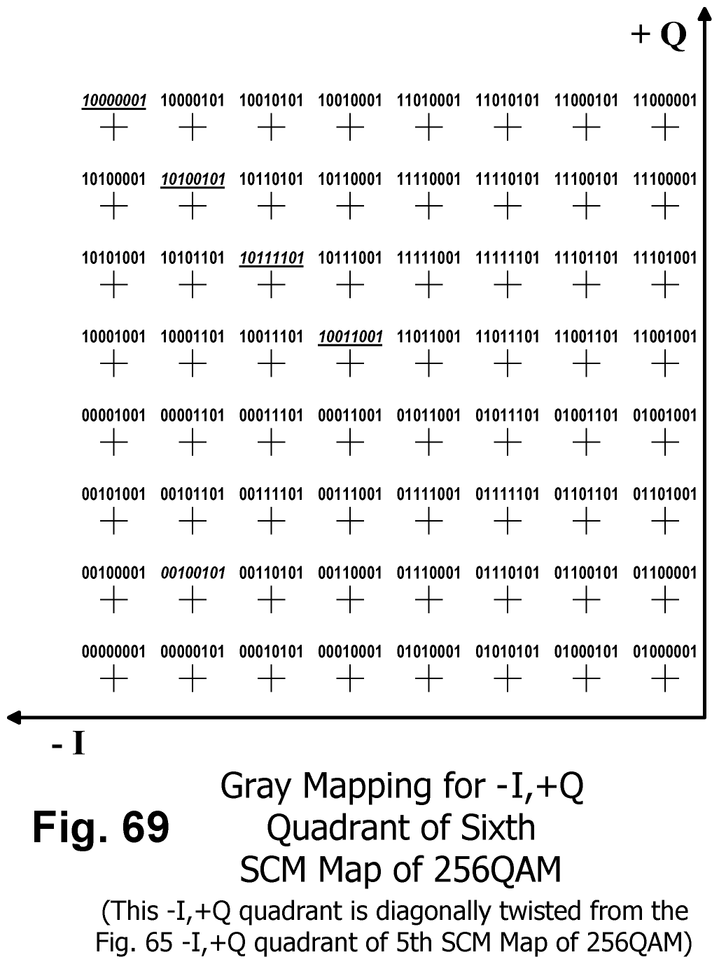

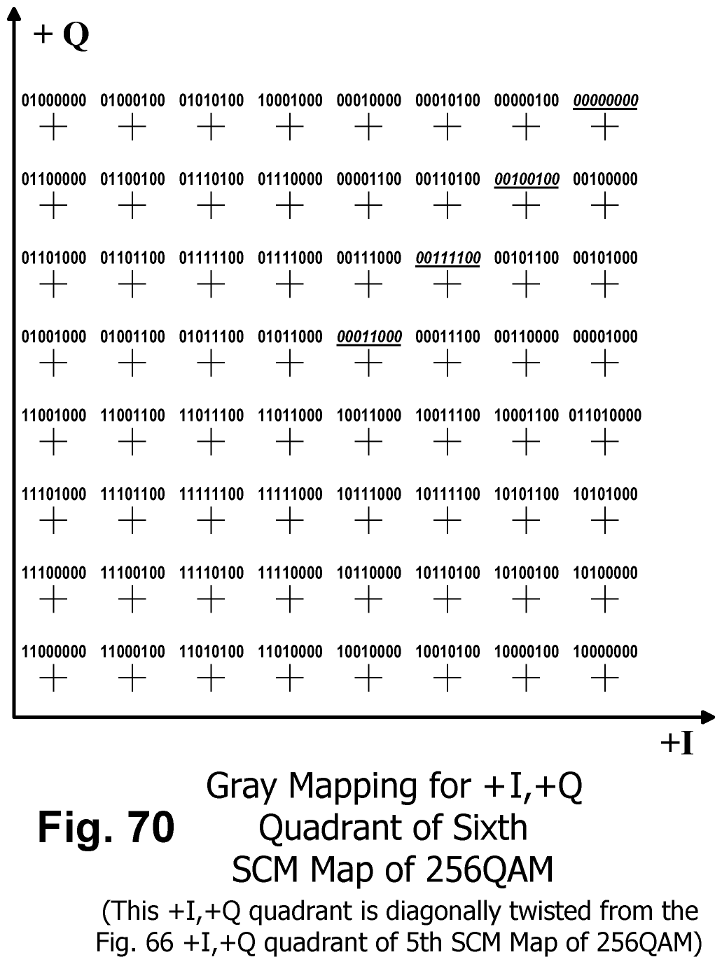

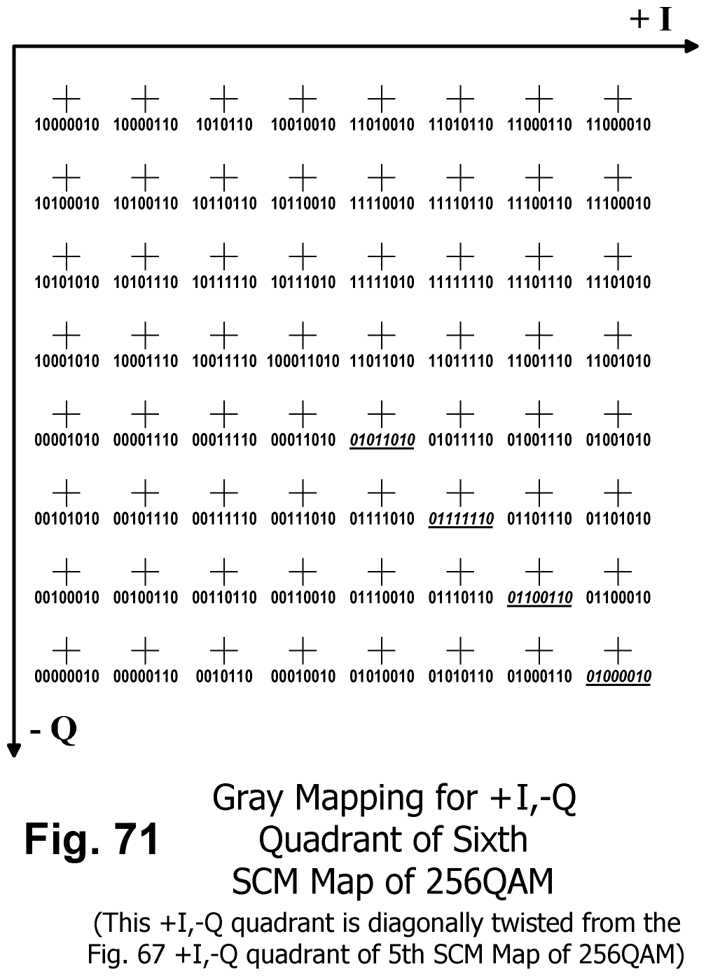

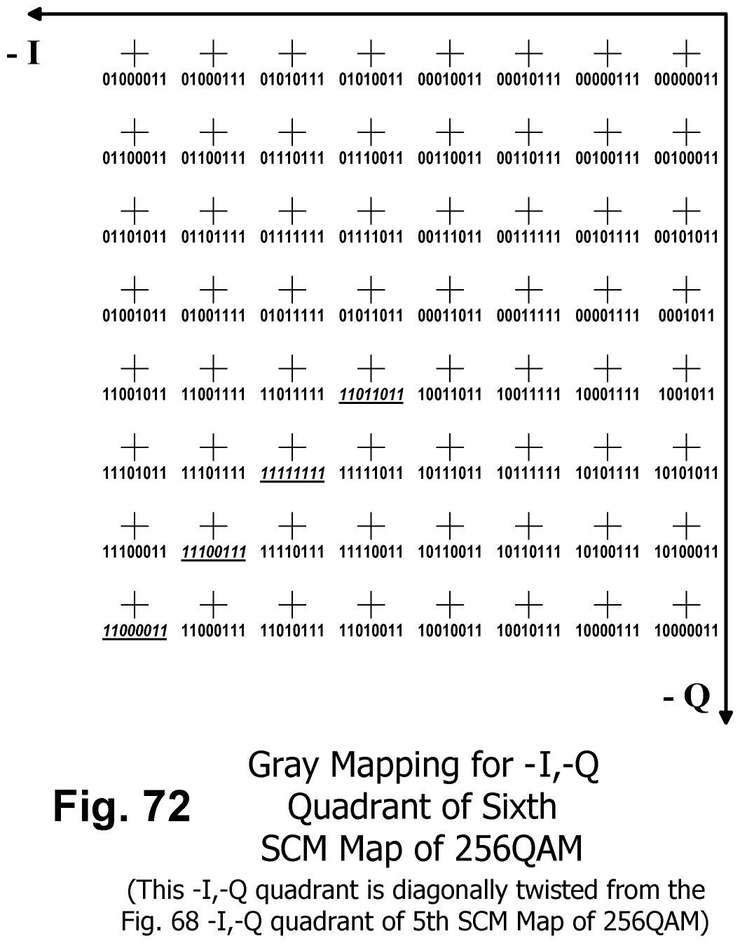

FIGS. 65, 66, 67 and 69 depict respective quadrants of a fifth SCM map of square 256QAM symbol constellations. The lattice points in the FIG. 65 −I,+Q quadrant of the SCM map of 256QAM are labeled like correspondingly positioned lattice points in the FIG. 55 +I, −Q quadrant of the second SCM map of 256QAM. The lattice points in the FIG. 66 +I,+Q quadrant of the fifth SCM map of 256QAM are labeled like correspondingly positioned lattice points in the FIG. 56 −I,−Q quadrant of the second SCM map of 256QAM. The lattice points in the FIG. 67 +I, −Q quadrant of the fifth SCM map of 256QAM are labeled like correspondingly positioned lattice points in the FIG. 53 −I,+Q quadrant of the second SCM map of 256QAM. The lattice points in the FIG. 68 −I,−Q quadrant of the fifth SCM map of 256QAM are labeled like correspondingly positioned lattice points in the FIG. 54 +I,+Q quadrant of the second SCM map of 256QAM.

FIGS. 69, 70, 71 and 72 depict respective quadrants of a sixth Gray map of square 256QAM symbol constellations. The LPLs in the quadrants of FIGS. 69, 70, 71 and 72 are diagonally twisted from the LPLs in the quadrants of the fifth Gray map of 256QAM respectively depicted in FIGS. 65, 66, 67 and 69.

Using either of the fifth or sixth SCM maps of 256QAM together with the second map of 256QAM to provide labeling diversity for DCM supports a 4.56 dB reduction in PAPR. However, SNR for reception over an AWGN channel will not be as good as for using the same SCM mapping of 16QAM for the DCM (though no more than 3 dB worse). Similar results obtain using either of the fifth or sixth SCM maps of 256QAM together with the above-postulated eighth map of 256QAM to provide labeling diversity for DCM.

Using either of the fifth or sixth SCM maps of 256QAM together with the first map of 256QAM to provide labeling diversity for DCM supports just a 2.99 dB reduction in PAPR, but the SNR for reception over an AWGN channel will be significantly improved. Similar results obtain using either of the fifth or sixth SCM maps of 256QAM together with the above-postulated seventh map of 256QAM to provide labeling diversity for DCM.

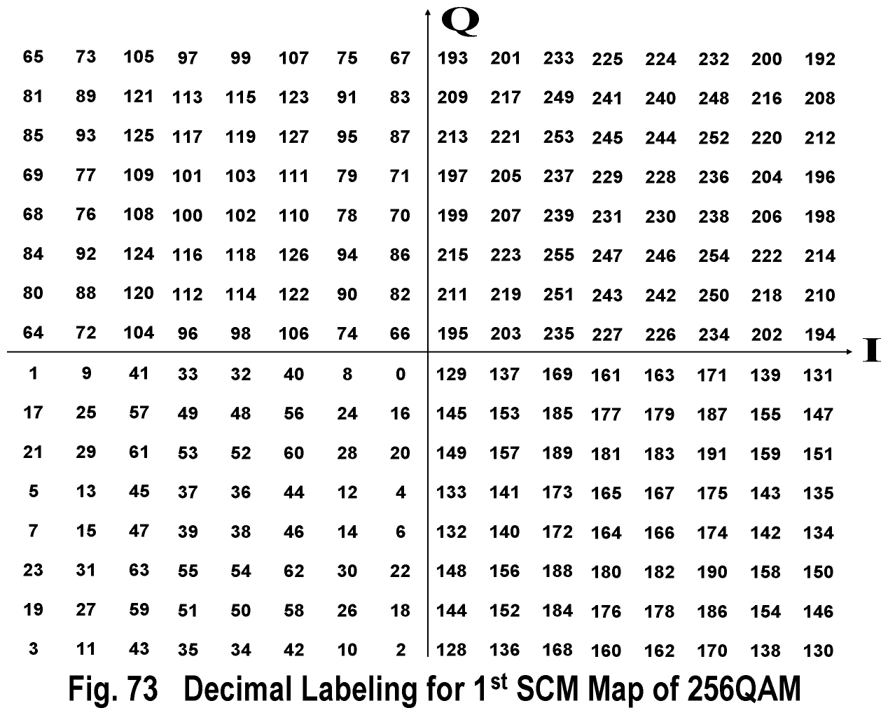

FIG. 73 presents decimal labeling for the first SCM map of 256QAM, the four quadrants of which mapare depicted in FIGS. 49, 50, 51 and 52 respectively. Each of the four quadrants of the FIG. 73 first SCM map of 256QAM symbol constellations can be subdivided into four sub-quadrants with 16 LPLs in each of those sub-quadrants.

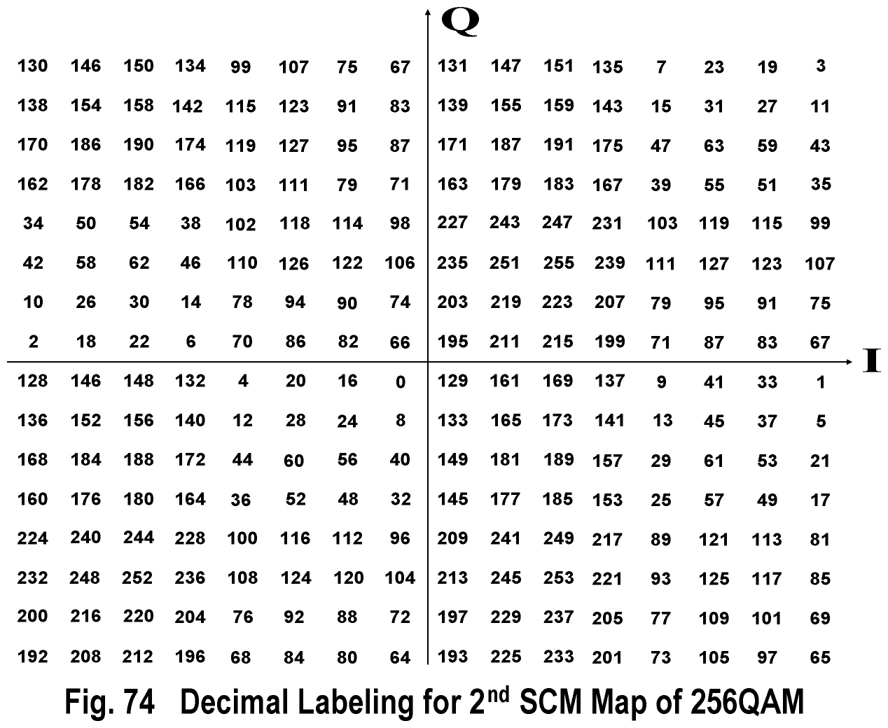

FIG. 74 presents decimal labeling for the second SCM map of 256QAM, the four quadrants of which map are depicted in FIGS. 53, 54, 55 and 56 respectively. Each of the four quadrants of the FIG. 74 second SCM map of 256QAM symbol constellations can be subdivided into four sub-quadrants with 16 LPLs in each of those sub-quadrants.

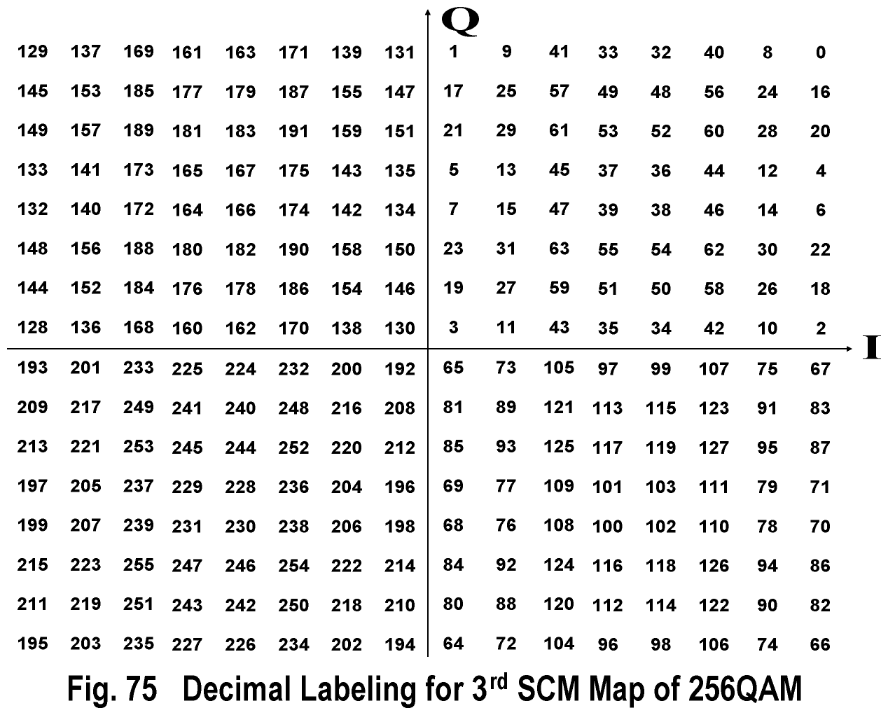

FIG. 75 presents decimal labeling for the third SCM map of 256QAM, the four quadrants of which map are depicted in FIGS. 57, 58, 59 and 60 respectively. Each of the four quadrants of the FIG. 75 third SCM map of 256QAM symbol constellations can be subdivided into four sub-quadrants with 16 LPLs in each of those sub-quadrants. Averaging of high energies of LPLs in the four outermost sub-quadrants of the FIG. 75 third SCM map with low energies of similar LPLs in the four innermost sub-quadrants of the FIG. 74 second SCM map contributes to keeping PAPR low in the DCM COFDM signal. Averaging of high energies of LPLs in the four outermost sub-quadrants of the FIG. 74 second SCM map with low energies of similar LPLs in the four innermost sub-quadrants of the FIG. 75 third SCM map also contributes to keeping PAPR low in the DCM COFDM signal. The energies in the eight flanking sub-quadrants of the FIG. 74 second SCM map and the energies in the eight flanking sub-quadrants of the FIG. 75 third SCM map all tend toward the average. So, these energies do not boost the PAPR of the DCM COFDM signal significantly, if at all.

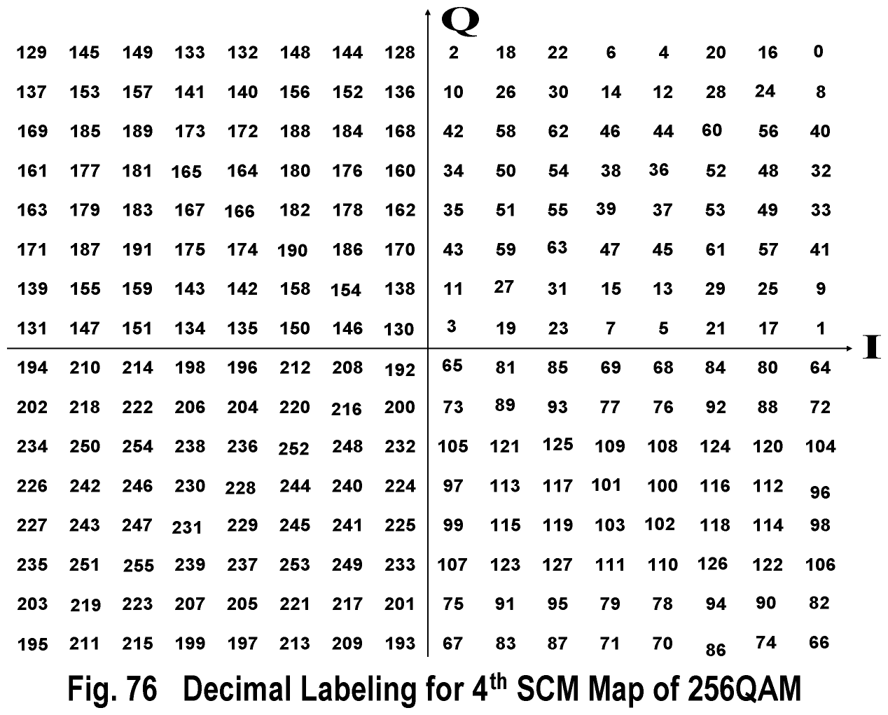

FIG. 76 presents decimal labeling for the fourth SCM map of 256QAM symbol constellations, the four quadrants of which are depicted in FIGS. 61, 62, 63 and 64 respectively. Each of the four quadrants of the FIG. 76 fourth SCM map of 256QAM can be subdivided into four sub-quadrants with 16 LPLs in each of those sub-quadrants. Averaging of high energies of LPLs in the four outermost sub-quadrants of the FIG. 76 fourth SCM map with low energies of similar LPLs in the four innermost sub-quadrants of the FIG. 74 second SCM map contributes to keeping PAPR low in the DCM COFDM signal. Averaging of high energies of LPLs in the four outermost sub-quadrants of the FIG. 74 second SCM map with low energies of similar LPLs in the four innermost sub-quadrants of the FIG. 76 fourth SCM map also contributes to keeping PAPR low in the DCM COFDM signal. The energies in the eight flanking sub-quadrants of the FIG. 74 second SCM map and the energies in the eight flanking sub-quadrants of the FIG. 76 fourth SCM map all tend toward the average. So, these energies do not boost the PAPR of the DCM COFDM signal significantly, if at all.

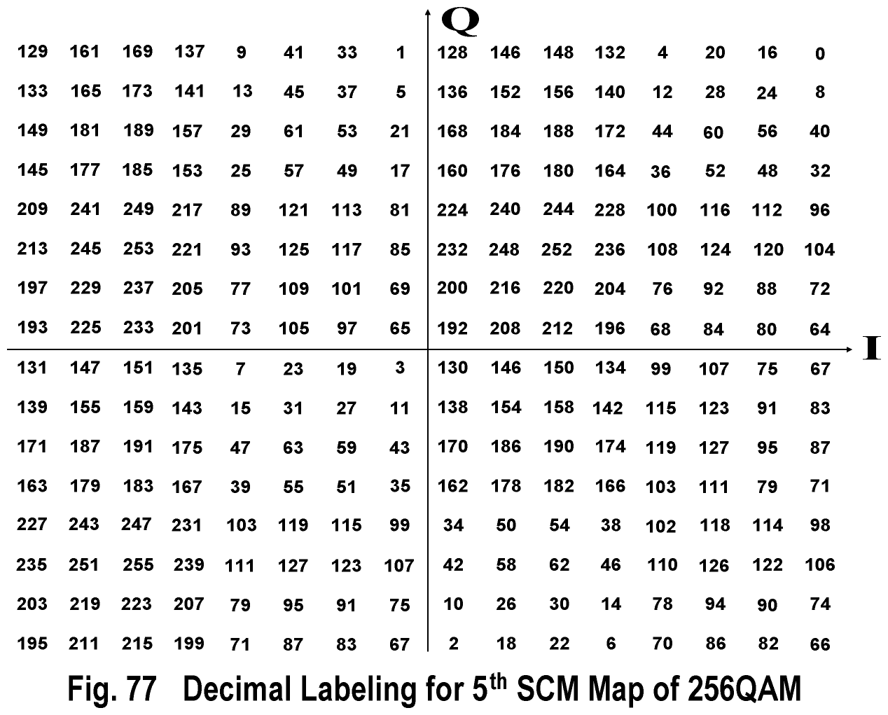

FIG. 77 presents decimal labeling for the fifth SCM map of 256QAM, the four quadrants of which map are depicted in FIGS. 65, 66, 67 and 68 respectively. Each of the four quadrants of the FIG. 77 fifth SCM map of 256QAM can be subdivided into four sub-quadrants with 16 LPLs in each of those sub-quadrants. Averaging of high energies of LPLs in the four outermost sub-quadrants of the FIG. 77 fifth SCM map with low energies of similar LPLs in the four innermost sub-quadrants of the FIG. 73 first SCM map contributes to keeping PAPR low in the DCM COFDM signal. Averaging of high energies of LPLs in the four outermost sub-quadrants of the FIG. 77 fifth SCM map with low energies of similar LPLs in the four innermost sub-quadrants of the FIG. 77 fifth SCM map also contributes to keeping PAPR low in the DCM COFDM signal. The energies in the eight flanking sub-quadrants of the FIG. 73 first SCM map and the energies in the eight flanking sub-quadrants of the FIG. 77 fifth SCM map all tend toward the average. So, these energies do not boost the PAPR of the DCM COFDM signal significantly, if at all.

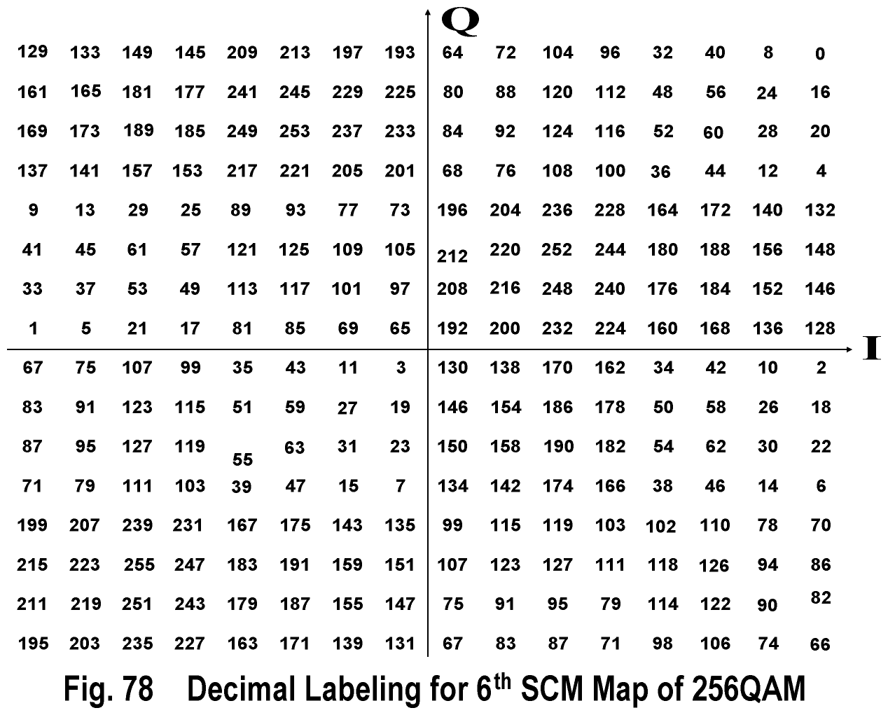

FIG. 78 presents decimal labeling for the sixth SCM map of 256QAM, the four quadrants of which map are depicted in FIGS. 69, 70, 71 and 72 respectively. Each of the four quadrants of the FIG. 78 sixth SCM map of 256QAM can be subdivided into four sub-quadrants with 16 LPLs in each of those sub-quadrants. Averaging of high energies of LPLs in the four outermost sub-quadrants of the FIG. 78 sixth SCM map with low energies of similar LPLs in the four innermost sub-quadrants of the FIG. 73 first SCM map contributes to keeping PAPR low in the DCM COFDM signal. Averaging of high energies of LPLs in the four outermost sub-quadrants of the FIG. 73 first SCM map with low energies of similar LPLs in the four innermost sub-quadrants of the FIG. 78 sixth SCM map also contributes to keeping PAPR low in the DCM COFDM signal. The energies in the eight flanking sub-quadrants of the FIG. 73 first SCM map and the energies in the eight flanking sub-quadrants of the FIG. 78 sixth SCM map all tend toward the average. So, these energies do not boost the PAPR of the DCM COFDM signal significantly, if at all.

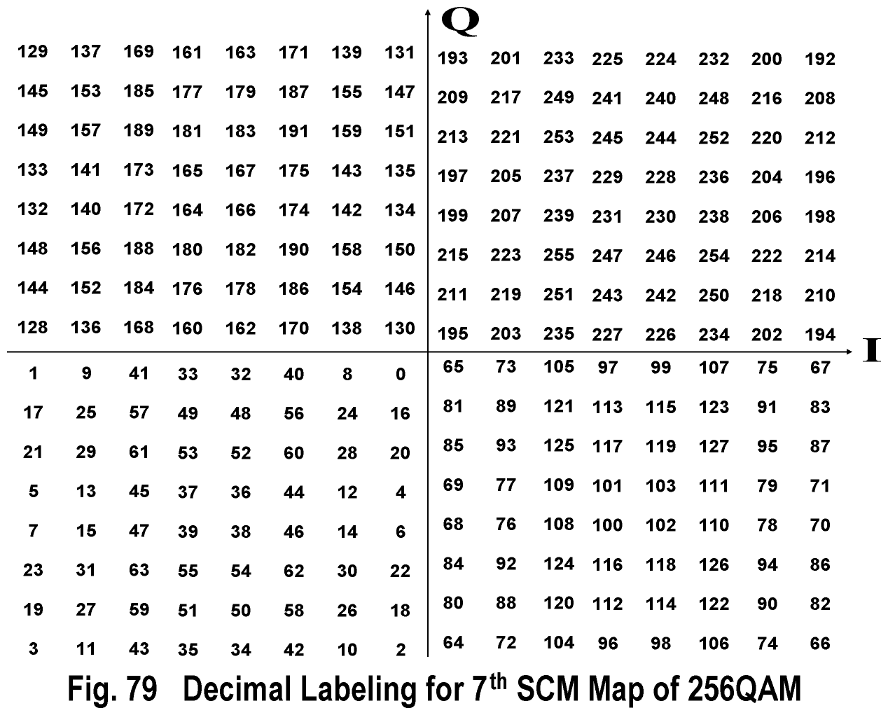

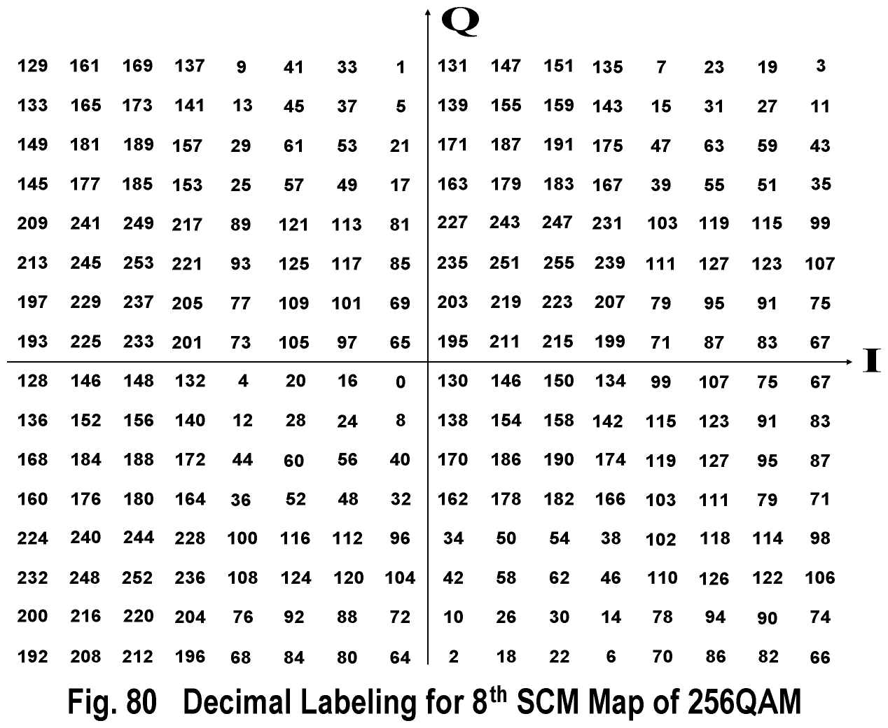

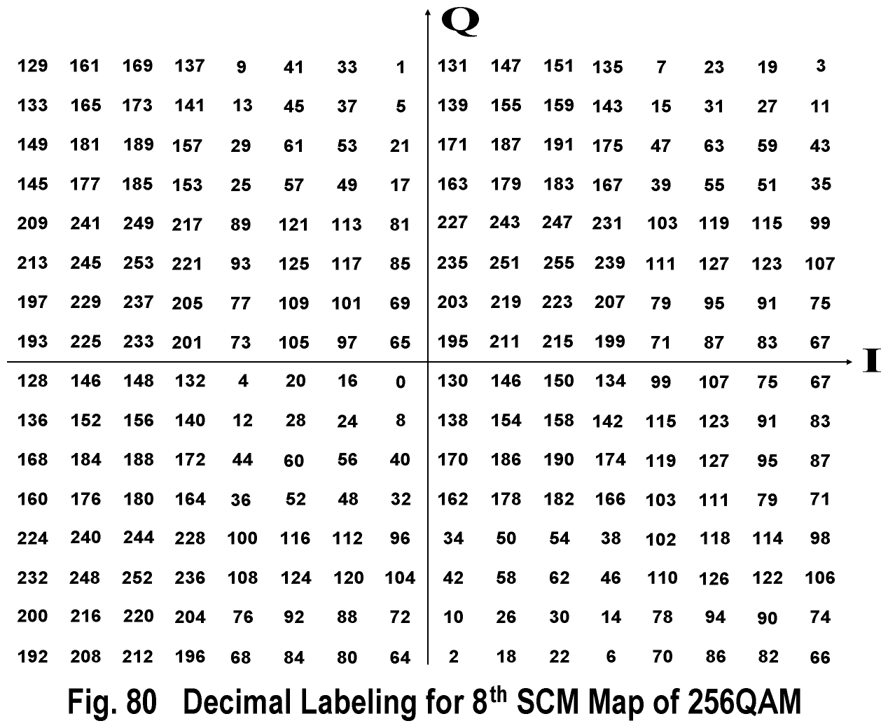

FIGS. 79 and 80 present respective decimal labeling for seventh and eighth SCM maps of 256QAM, which maps have preferred labeling diversity from each other. The four quadrants of each of these seventh and eighth SCM maps of 256QAM can be subdivided into four sub-quadrants with 16 LPLs in each of those sub-quadrants. Averaging of high energies of LPLs in the four outermost sub-quadrants of the FIG. 79 seventh SCM map with low energies of similar LPLs in the four innermost sub-quadrants of the FIG. 80 eighth SCM map contributes to keeping PAPR low in the DCM COFDM signal. Averaging of high energies of LPLs in the four outermost sub-quadrants of the FIG. 80 eighth SCM map with low energies of similar LPLs in the four innermost sub-quadrants of the FIG. 79 seventh SCM map also contributes to keeping PAPR low in the DCM COFDM signal. The energies in the eight flanking sub-quadrants of the FIG. 79 seventh SCM map and the energies in the eight flanking sub-quadrants of the FIG. 80 eighth SCM map all tend toward the average. So, these energies do not boost the PAPR of the DCM COFDM signal significantly, if at all.

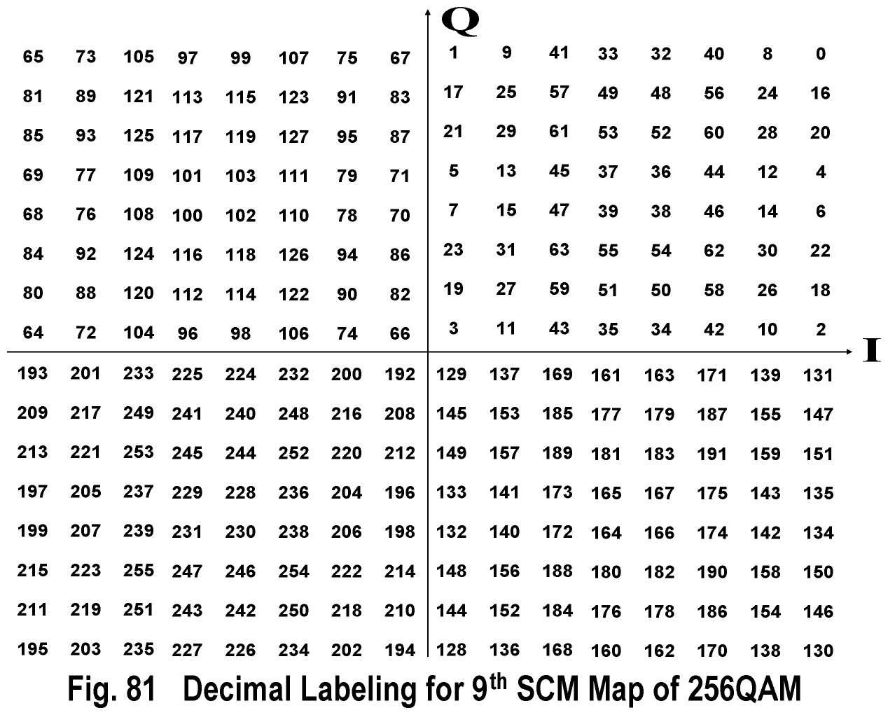

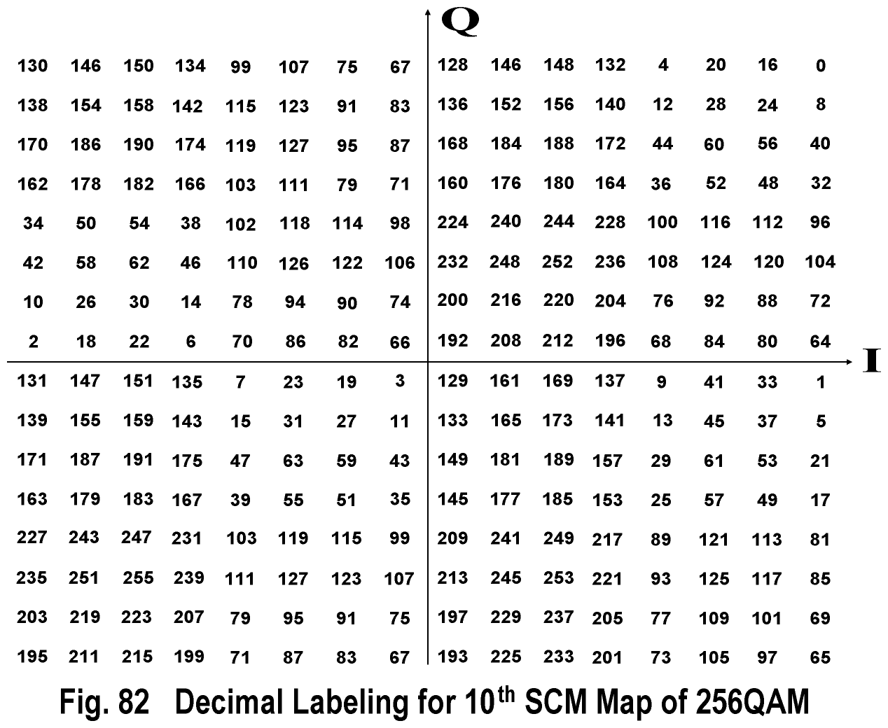

FIGS. 81 and 82 present respective decimal labeling for ninth and tenth SCM maps of 256QAM, which maps have preferred labeling diversity from each other. The four quadrants of each of these ninth and tenth SCM maps of 256QAM can be subdivided into four sub-quadrants with 16 LPLs in each of those sub-quadrants. Averaging of high energies of LPLs in the four outermost sub-quadrants of the FIG. 81 ninth SCM map with low energies of similar LPLs in the four innermost sub-quadrants of the FIG. 82 tenth SCM map contributes to keeping PAPR low in the DCM COFDM signal. Averaging of high energies of LPLs in the four outermost sub-quadrants of the FIG. 82 tenth SCM map with low energies of similar LPLs in the four innermost sub-quadrants of the FIG. 81 ninth SCM map also contributes to keeping PAPR low in the DCM COFDM signal. The energies in the eight flanking sub-quadrants of the FIG. 81 ninth SCM map and the energies in the eight flanking sub-quadrants of the FIG. 82 tenth SCM map all tend toward the average. So, these energies do not boost the PAPR of the DCM COFDM signal significantly, if at all.

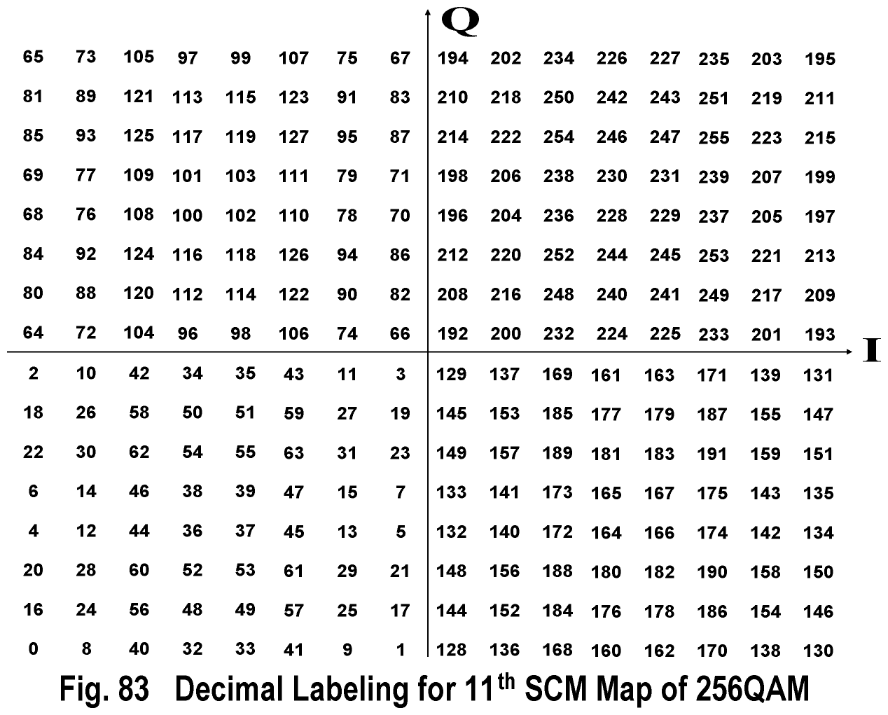

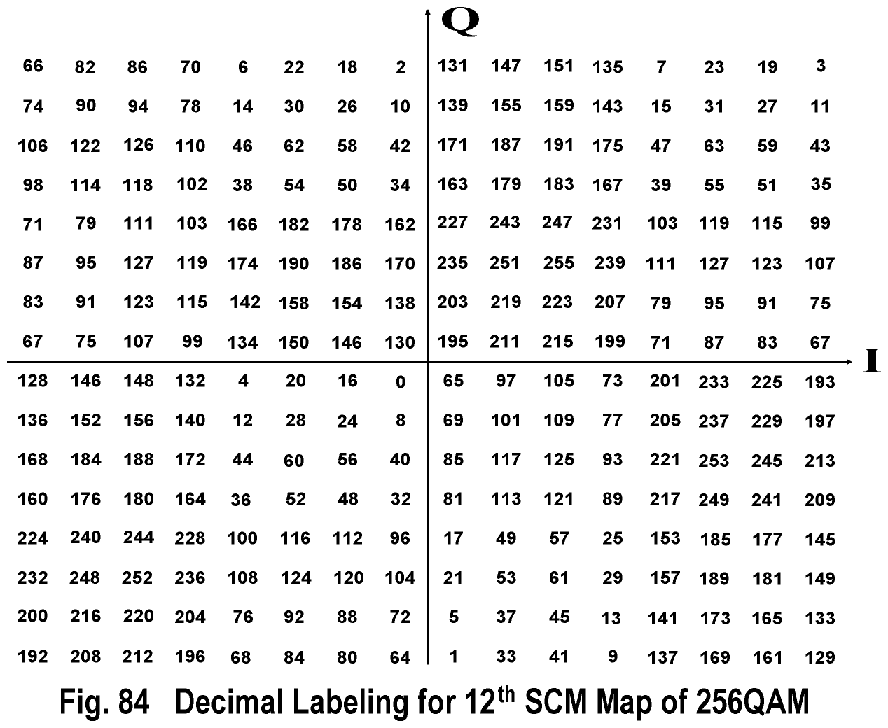

FIGS. 83 and 84 present respective decimal labeling for eleventh and twelfth SCM maps of 256QAM, which maps have preferred labeling diversity from each other. The four quadrants of each of these eleventh and twelfth SCM maps of 256QAM can be subdivided into four sub-quadrants with 16 LPLs in each of those sub-quadrants. Averaging of high energies of LPLs in the four outermost sub-quadrants of the FIG. 83 eleventh SCM map with low energies of similar LPLs in the four innermost sub-quadrants of the FIG. 84 twelfth SCM map contributes to keeping PAPR low in the DCM COFDM signal. Averaging of high energies of LPLs in the four outermost sub-quadrants of the FIG. 84 twelfth SCM map with low energies of similar LPLs in the four innermost sub-quadrants of the FIG. 83 eleventh SCM map also contributes to keeping PAPR low in the DCM COFDM signal. The energies in the eight flanking sub-quadrants of the FIG. 83 eleventh SCM map and the energies in the eight flanking sub-quadrants of the FIG. 84 twelfth SCM map all tend toward the average. So, these energies do not boost the PAPR of the DCM COFDM signal significantly, if at all.

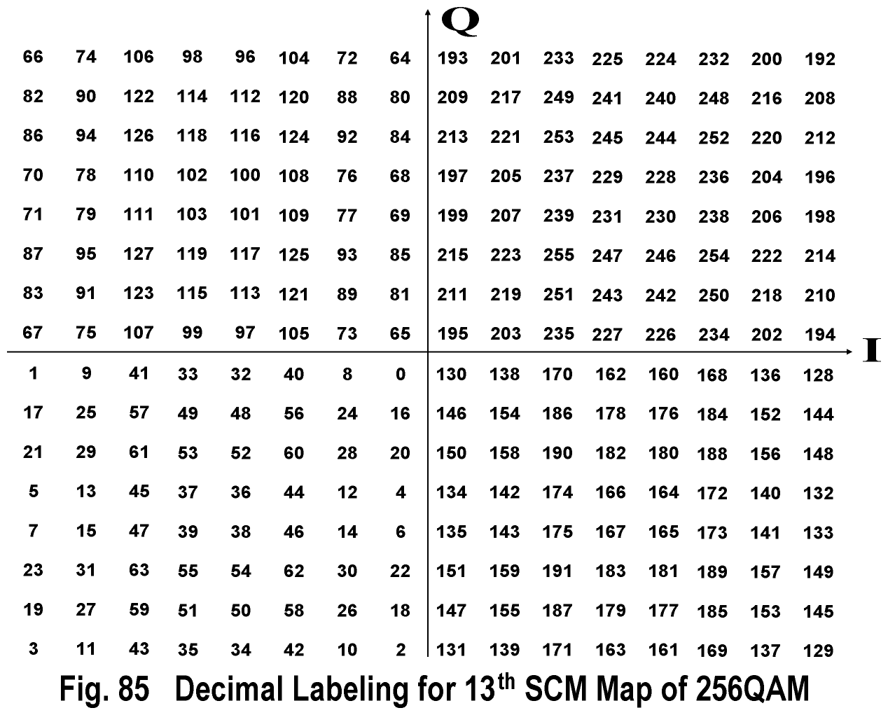

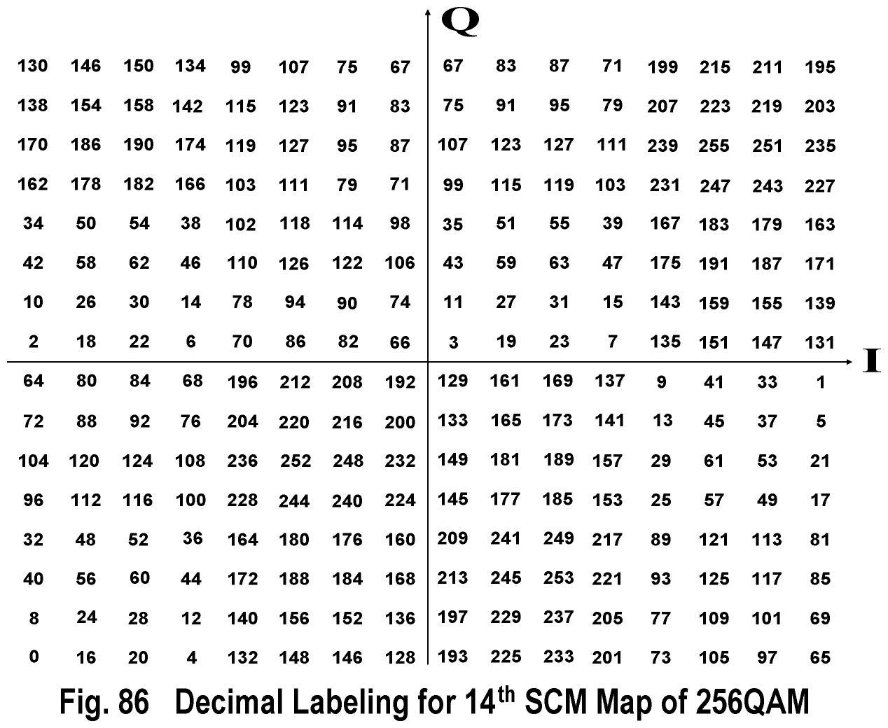

FIGS. 85 and 86 present respective decimal labeling for thirteenth and fourteenth SCM maps of 256QAM, which maps have preferred labeling diversity from each other. The four quadrants of each of these thirteenth and fourteenth SCM maps of 256QAM can be subdivided into four sub-quadrants with 16 LPLs in each of those sub-quadrants. Averaging of high energies of LPLs in the four outermost sub-quadrants of the FIG. 85 thirteenth SCM map with low energies of similar LPLs in the four innermost sub-quadrants of the FIG. 86 fourteenth SCM map contributes to keeping PAPR low in the DCM COFDM signal. Averaging of high energies of LPLs in the four outermost sub-quadrants of the FIG. 86 fourteenth SCM map with low energies of similar LPLs in the four innermost sub-quadrants of the FIG. 85 thirteenth SCM map also contributes to keeping PAPR low in the DCM COFDM signal. The energies in the eight flanking sub-quadrants of the FIG. 85 thirteenth SCM map and the energies in the eight flanking sub-quadrants of the FIG. 86 fourteenth SCM map all tend toward the average. So, these energies do not boost the PAPR of the DCM COFDM signal significantly, if at all.

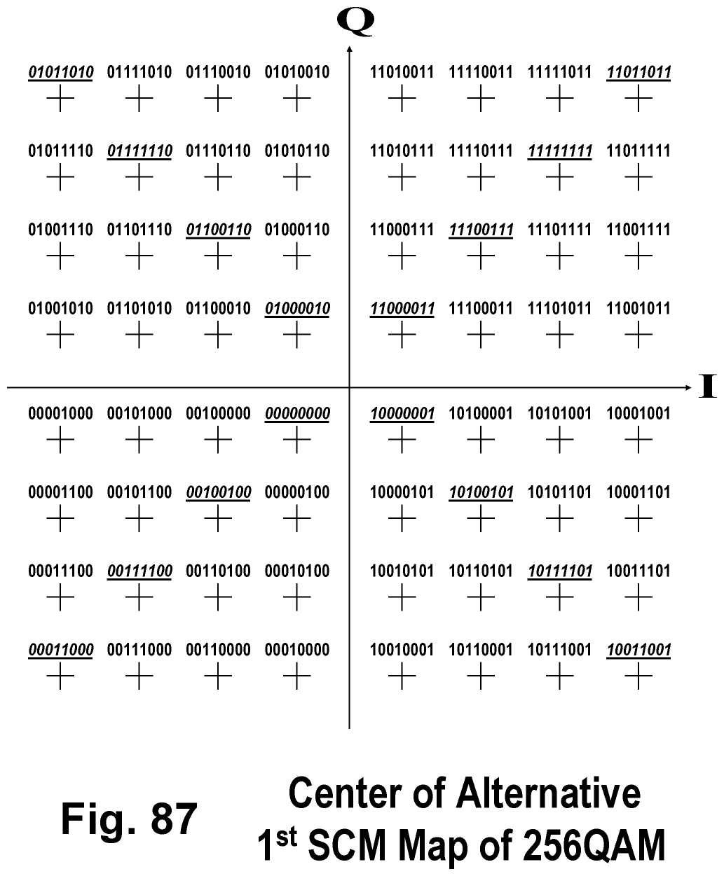

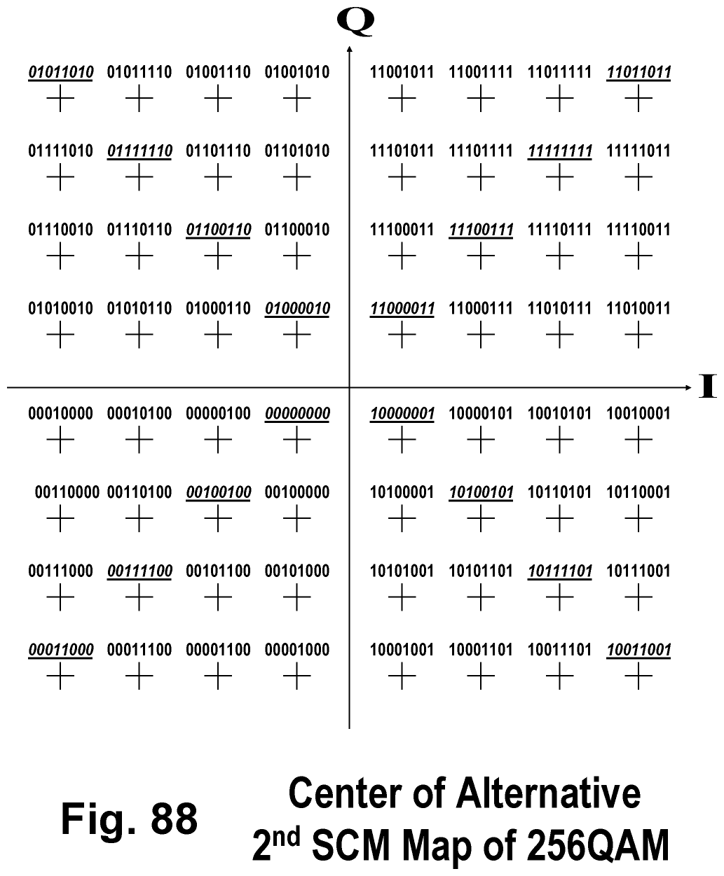

FIG. 87 depicts the central portion of another first SCM map of square 256QAM alternative to the FIG. 47 first SCM map of square 256QAM. FIG. 88 depicts the central portion of another second SCM map of square 256QAM symbol constellations alternative to the FIG. 48 second SCM map of square 256QAM symbol constellations. The innermost sub-quadrants of the −I, +Q quadrants of the alternative first and second SCM maps of 256QAM depicted in FIGS. 87 and 88 contain a palindromic LPLs sequence 01000010, 01100110, 01111110 and 01011010 instead of the LPLs sequence 01000010, 01011010, 01111110 and 01100110 contained in the innermost sub-quadrants of the −I, +Q quadrants of the first and second SCM maps of square 256QAM depicted in FIGS. 47 and 48. The innermost sub-quadrants of the +I, +Q quadrants of the alternative first and second SCM maps of 256QAM depicted in FIGS. 87 and 88 contain a palindromic LPLs sequence 11000011, 11100111, 11111111 and 11011011 instead of the LPLs sequence 11000011, 11011011, 11111111 and 11100111 contained in the innermost sub-quadrants of the +I, +Q quadrants of the first and second SCM maps of square 256QAM depicted in FIGS. 47 and 48. The innermost sub-quadrants of the +I, −Q quadrants of the alternative first and second SCM maps of 256QAM depicted in FIGS. 87 and 88 contain a palindromic LPLs sequence 10000001, 10100101, 10111101 and 1001100 1 instead of the LPLs sequence 10000001, 10011001, 10111101 and 10100101 contained in the innermost sub-quadrants of the +I, −Q quadrants of the first and second SCM maps of square 256QAM depicted in FIGS. 47 and 48. The innermost sub-quadrants of the −I, −Q quadrants of the alternative first and second SCM maps of 256QAM depicted in FIGS. 87 and 88 contain a palindromic LPLs sequence 00000000, 00100100, 00111100 and 00011000 instead of the LPLs sequence 00000000, 00011000, 00111100 and 00100100 contained in the innermost sub-quadrants of the −I, −Q quadrants of the first and second SCM maps of square 256QAM depicted in FIGS. 47 and 48.

In accordance with the invention, the design of first and second SCM maps of square QAM symbol constellations of any size having 2^{(N+1)} LPLs, N being an integer greater than unity, proceeds as follows. Each of the 2^{(N+1)} LPLs will have 2N bits. There will be 2^{N} palindromic LPLS to be arranged in four sequences, for mapping into respective innermost sub-quadrants of the four quadrants of each of those first and second SCM maps of square QAM symbol constellations having 2^{(N+1)} LPLs. A respective sequence of 2N-bit palindromic LPLS is mapped along a diagonal axis of each of the four innermost sub-quadrants of each SCM map, which diagonal axis reaches from a point of origin between the four quadrants of that SCM map. The 2N-bit palindromic LPLS closest to the point of origin central to the four quadrants of each of those first and second SCM maps will differ in two of its bits from the 2N-bit palindromic LPLs closest to the point of origin in the same map, to conform to the characteristics of SCM mapping.

Each sequence of palindromic LPLS in an innermost sub-quadrant of one of the quadrants of of each of the first and second SCM maps of square 2^{(N+1)}QAM must support Gray mapping of LPLs within that innermost sub-quadrant. The Gray maps of the four innermost sub-quadrants of each of the first and second SCM maps should support SCM map requirements of only two bits differing between adjoining LPLs in adjoining quadrants. This requirement imposes restrictions on the ordering of palindromic LPLS in adjoining sub-quadrants of those adjoining quadrants. Bits other than the pair that change between adjoining sub-quadrants need to be similarly arranged in the four innermost sub-quadrants of each of the first and second SCM maps, with regard to departure from the central point of the group of those four innermost sub-quadrants. To support SCM map requirements of only two bits differing between adjoining LPLs in adjoining quadrants, the Gray maps of the four innermost sub-quadrants of each of the first and second SCM maps need to be twisted properly around their diagonal axes reaching from the point of origin central to the group of those four innermost sub-quadrants. The mapping of the innermost sub-quadrant of each quadrant of each of the first and second SCM maps provides a basis for mapping the other sub-quadrants of that quadrant, as detailed in the four paragraphs following, thereby to Gray map that quadrant.

The −I,+Q quadrant as depicted in the upper left corner of the SCM map has its innermost sub-quadrant mirrored upwards and also mirrored to its left as initial steps in generating respective flanking sub-quadrants of that −I,+Q quadrant. As an initial step in generating the outermost sub-quadrant of that −I,+Q quadrant, either its upper flanking sub-quadrant is mirrored to its left, or the left flanking sub-quadrant in that −I,+Q quadrant is mirrored upwards. (The results of the foregoing two alternatives are identical.) As the final step in generating the outermost sub-quadrant of that −I,+Q quadrant, the two bits in LPLs that identify its innermost sub-quadrant are each ones complemented so as to identify its outermost sub-quadrant. As the final step in generating the sub-quadrant flanking the outermost sub-quadrant of that −I,+Q quadrant on the right, one and only one of the two bits in LPLs that identify its innermost sub-quadrant is ones complemented, so as to identify that flanking sub-quadrant uniquely. As the final step in generating the sub-quadrant in that flanking its innermost sub-quadrant on the left, the other of the two bits in LPLs that identify its innermost sub-quadrant is ones complemented, so as to identify that flanking sub-quadrant uniquely.

The +I,+Q quadrant as depicted in the upper right corner of the SCM map has its innermost sub-quadrant mirrored upwards and also mirrored to its right as initial steps in generating respective flanking sub-quadrants of that +I,+Q quadrant. As an initial step in generating the outermost sub-quadrant of that +I,+Q quadrant, either its upper flanking sub-quadrant is mirrored to its right, or the right flanking sub-quadrant in that +I,+Q quadrant is mirrored upward. (The results of the foregoing two alternatives are identical.) As the final step in generating the outermost sub-quadrant of that +I,+Q quadrant, the two bits in LPLs that identify its innermost sub-quadrant are each ones complemented so as to identify its outermost sub-quadrant. As the final step in generating the sub-quadrant flanking the outermost sub-quadrant of that +I,+Q quadrant on the left, one and only one of the two bits in LPLs that identify its innermost sub-quadrant is ones complemented, so as to identify that flanking sub-quadrant uniquely. This bit is chosen so as not to cause dissimilarity in the bits of a row of bits shared with the −I,+Q quadrant. As the final step in generating the sub-quadrant in that +I,+Q quadrant flanking its innermost sub-quadrant on the right, the other of the two bits in LPLs that identify its innermost sub-quadrant is ones complemented, so as to identify that flanking sub-quadrant uniquely.

The +I,−Q quadrant as depicted in the lower right corner of the SCM map has its innermost sub-quadrant mirrored downwards and also mirrored to its right as initial steps in generating respective flanking sub-quadrants of that +I,−Q quadrant. As an initial step in generating the outermost sub-quadrant of that +I,−Q quadrant, either its lower flanking sub-quadrant is mirrored to its right, or its right flanking sub-quadrant is mirrored downwards. (The results of the foregoing two alternatives are identical.) As the final step in generating the outermost sub-quadrant of that +I,−Q quadrant, the two bits in LPLs that identify the innermost sub-quadrant of that +I,−Q quadrant are each ones complemented so as to identify the outermost sub-quadrant of that +I,−Q quadrant. As the final step in generating the sub-quadrant in that +I,−Q quadrant flanking its innermost sub-quadrant on the right, the other of the two bits in LPLs that identify its innermost sub-quadrant is ones complemented, so as to identify that flanking sub-quadrant uniquely. This bit is chosen so as not to cause dissimilarity in the bits of a column of bits shared with the +I,+Q quadrant. As the final step in generating the sub-quadrant flanking the outermost sub-quadrant of that +I,−Q quadrant on its left, one and only one of the two bits in LPLs that identify its innermost sub-quadrant is ones complemented, so as to identify that flanking sub-quadrant uniquely.

The −I,−Q quadrant as depicted in the lower left corner of the SCM map has its innermost sub-quadrant mirrored downwards and also mirrored to its left as initial steps in generating respective flanking sub-quadrants of that −I,−Q quadrant. As an initial step in generating the outermost sub-quadrant of that −I,−Q quadrant, either the lower flanking sub-quadrant in that −I,−Q quadrant is mirrored to its left, or the left flanking sub-quadrant in that −I,−Q quadrant is mirrored downwards. (The results of the foregoing two alternatives are identical.) As the final step in generating the outermost sub-quadrant of that −I,−Q quadrant, the two bits in LPLs that identify its innermost sub-quadrant are each ones complemented so as to identify its outermost sub-quadrant. As the final step in generating the sub-quadrant flanking the outermost sub-quadrant of that −I,−Q quadrant at the right, one and only one of the two bits in LPLs that identify its innermost sub-quadrant is ones complemented, so as to identify that flanking sub-quadrant uniquely. This bit is chosen so as not to cause dissimilarity in the bits of a row of bits shared with the +I,−Q quadrant. As the final step in generating the sub-quadrant in that −I,−Q quadrant flanking its innermost sub-quadrant on the left, the other of the two bits in LPLs that identify the innermost sub-quadrant of that −I,+Q quadrant is ones complemented, so as to identify that flanking sub-quadrant uniquely.

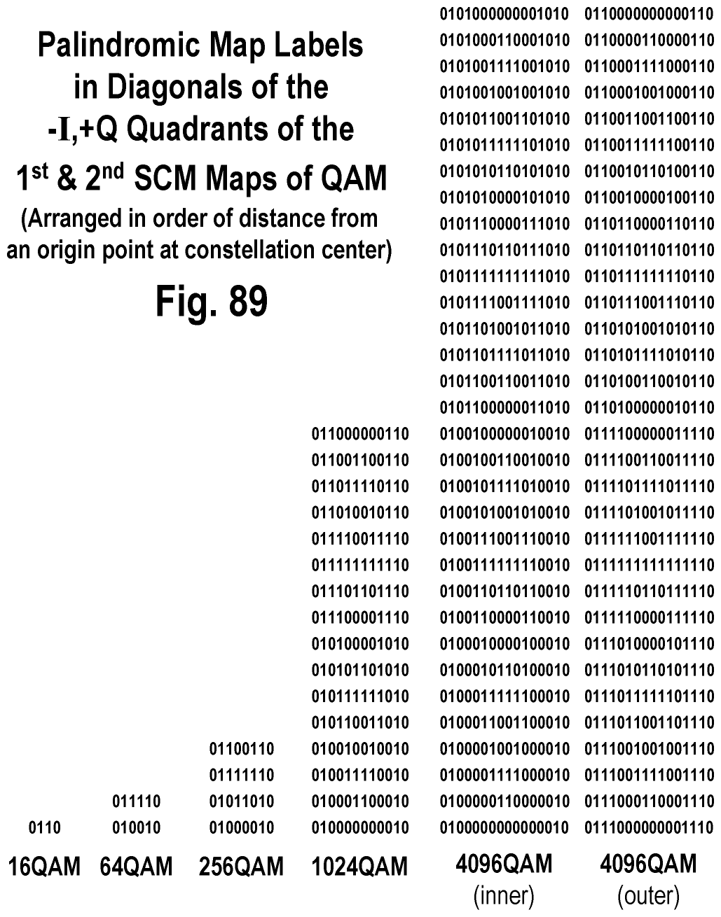

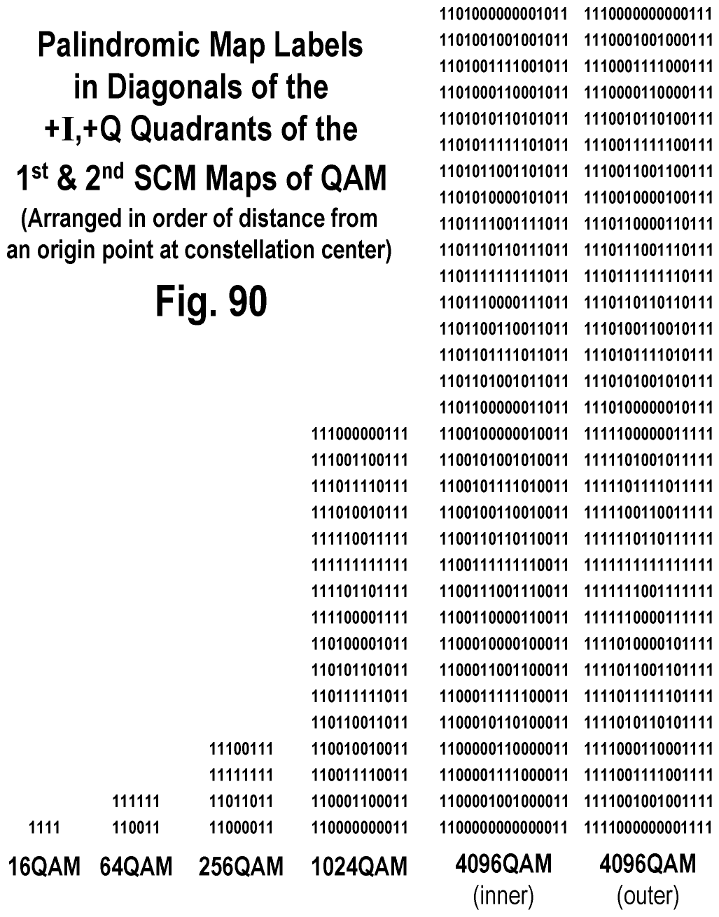

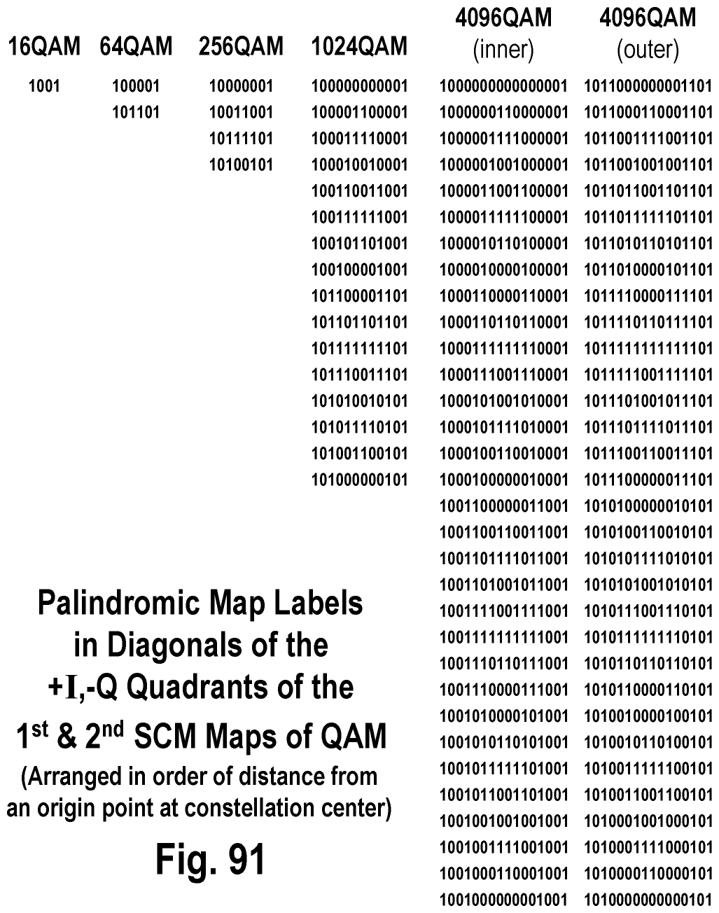

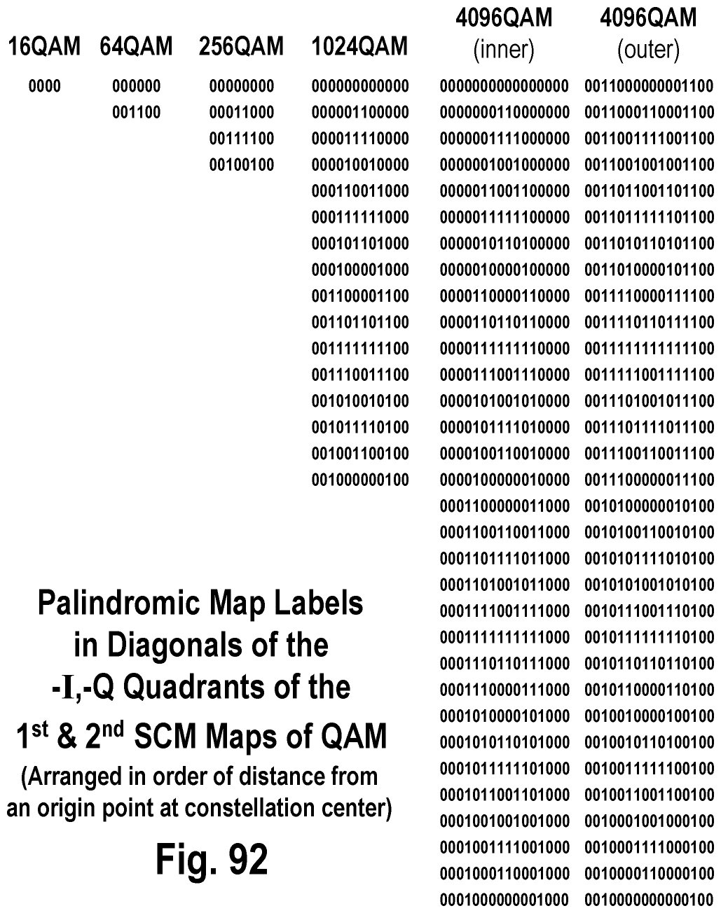

FIG. 89 lists sequences of palindromic map labels in diagonals of the −I,+Q quadrants of first and second SCM maps of 16QAM, 64QAM, 256QAM, 1024QAM and 4096QAM. FIG. 90 lists sequences of palindromic map labels in diagonals of the +I,+Q quadrants of first and second SCM maps of 16QAM, 64QAM, 256QAM, 1024QAM and 4096QAM. FIG. 91 lists sequences of palindromic map labels in diagonals of the +I,−Q quadrants of first and second SCM maps of 16QAM, 64QAM, 256QAM, 1024QAM and 4096QAM. FIG. 92 lists sequences of palindromic map labels in diagonals of the −I,−Q quadrants of first and second SCM maps of 16QAM, 64QAM, 256QAM, 1024QAM and 4096QAM. These sequences of palindromic map labels FIGS. 89, 90, 91 and 93 list for the innermost sub-quadrants of first and second SCM maps of any one of these sizes of QAM symbol constellation are compatible with each other. In accordance the teaching supra with regard to 256QAM, other compatible sequences of palindromic map labels for diagonals of the innermost sub-quadrants of first and second SCM maps of QAM symbol constellations exist.

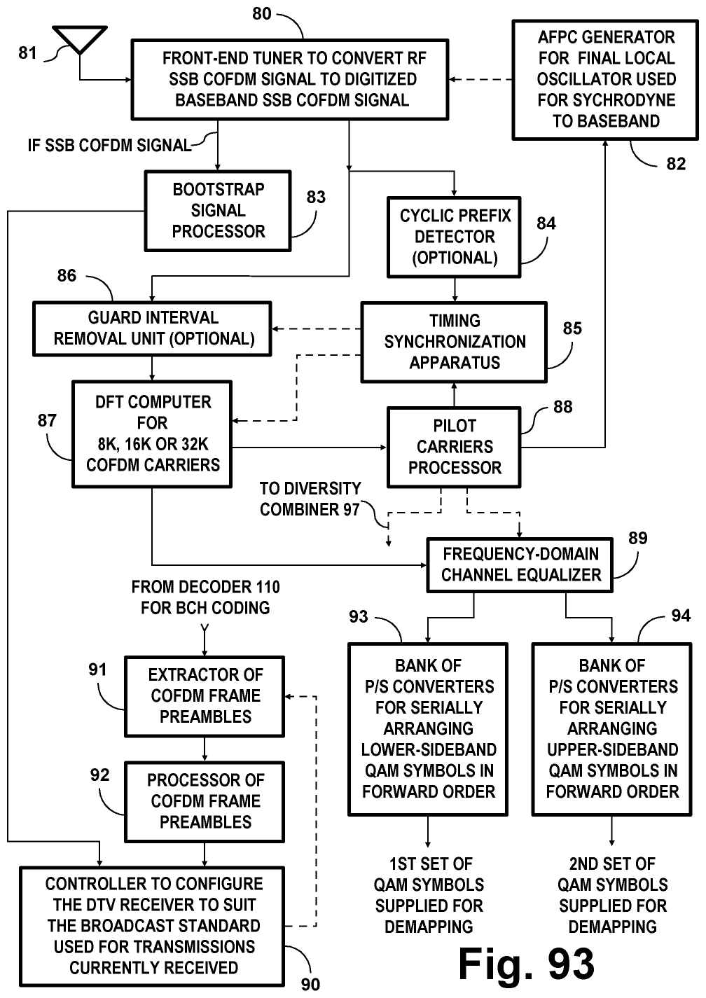

FIG. 93 shows the initial portion of a receiver designed for iterative-diversity reception of COFDM signals as transmitted at VHF or UHF by a DTV transmitter, such as the one depicted in FIGS. 2, 3 and 4. A front-end tuner 80 of the receiver selects its input signal from one of the radio-frequency (RF) signals captured by a reception antenna 81. The front-end tuner 80 can be of a double-conversion type composed of initial single-conversion super-heterodyne receiver circuitry for converting the selected RF single-sideband COFDM signal to an intermediate-frequency (IF) single-sideband COFDM signal followed by circuitry for performing a final conversion of that IF COFDM signal to baseband single-sideband COFDM signal. The initial conversion circuitry typically comprises a tunable RF amplifier for RF single-sideband COFDM signal incoming from the reception antenna, a tunable first local oscillator, a first mixer for heterodyning the amplified RF single-sideband COFDM signal with local oscillations from the first local oscillator to obtain the IF single-sideband COFDM signal, and an intermediate-frequency (IF) amplifier for the IF single-sideband COFDM signal. Typically, the front-end tuner 80 further includes a synchronous demodulator for performing the final conversion from IF single-sideband COFDM signal to baseband single-sideband COFDM signal and an analog-to-digital converter for digitizing that baseband signal. Synchronous demodulation circuitry typically comprises a final local oscillator with automatic frequency and phase control (AFPC) of its oscillations, a second mixer for synchrodyning amplified IF single-sideband COFDM signal with local oscillations from the final local oscillator to obtain the baseband single-sideband COFDM signal, and a low-pass filter for suppressing image signal accompanying the baseband single-sideband COFDM signal. In some designs of the front-end tuner 80, synchronous demodulation is performed in the analog regime before subsequent analog-to-digital conversion of the resulting complex baseband single-sideband COFDM signal. In other designs of the front-end tuner 80, analog-to-digital conversion is performed before synchronous demodulation is performed in the digital regime.

Simply stated, the front-end tuner 80 converts radio-frequency single-sideband COFDM signal received at its input port to digitized samples of baseband single-sideband COFDM signal supplied from its output port. Typically, the digitized samples of the real component of the baseband single-sideband COFDM signal are alternated with digitized samples of the imaginary component of that baseband signal for arranging the complex baseband single-sideband COFDM signal in a single stream of digital samples. FIG. 93 depicts an AFPC generator 82 for generating the automatic frequency and phase control (AFPC) signal for controlling the final local oscillator within the front-end tuner 80.

The output port of the front-end tuner 80 is connected for supplying digitized samples of baseband single-sideband COFDM signal to the respective input ports of a bootstrap signal processor 83 and a cyclic prefix detector 84. The cyclic prefix detector 84 differentially combines the digitized samples of baseband single-sideband COFDM signal with those samples as delayed by the duration of an effective COFDM symbol. Nulls in the difference signal so generated should occur, marking the guard intervals of the baseband single-sideband COFDM signal. The nulls are processed to reduce any corruption caused by noise and to generate better-defined indications of the phasing of COFDM symbols. The output port of the cyclic prefix detector 84 is connected to supply these indications to a first of two input ports of timing synchronization apparatus 85.

A first of two output ports of the timing synchronization apparatus 85 is connected for supplying gating control signal to the control input port of a guard-interval-removal unit 86, the signal input port of which is connected for receiving digitized samples of baseband COFDM signal from the output port of the front-end tuner 80. The output port of the guard-interval-removal unit 86 is connected for supplying the input port of discrete-Fourier-transform computer 87 with windowed portions of the baseband single-sideband COFDM signal that contain effective COFDM samples. A second of the output ports of the timing synchronization apparatus 85 is connected for supplying the DFT computer 87 with synchronizing information concerning the effective COFDM samples.

The indications concerning the phasing of COFDM symbols that the cyclic prefix detector 84 supplies to the timing synchronization apparatus 85 are sufficiently accurate for initial windowing of a baseband single-sideband COFDM signal that the guard-interval-removal unit 86 supplies to the DFT computer 87. A first output port of the DFT computer 87 is connected for supplying demodulation results for at least all of the pilot carriers in parallel to the input port of a pilot carriers processor 88, and a second output port of the DFT computer 87 is connected for supplying demodulation results for each of the COFDM carriers to the input port of a frequency-domain channel equalizer 89. The processor 88 selects the demodulation results concerning pilot carriers for processing, part of which processing generates weighting coefficients for channel equalization filtering in the frequency domain. A first of four output ports of the processor 88 that are explicitly shown in FIG. 93 is connected for supplying these weighting coefficients (via wiring depicted as a dashed-line connection) to the frequency-domain channel equalizer 89, which uses those weighting coefficients for adjusting its responses to the demodulation results for each of the COFDM carriers.

A second of the output ports of the pilot carriers processor 88 that are explicitly shown in FIG. 93 is connected for supplying more accurate window-positioning information to the second input port of the timing synchronization apparatus 85. This window-positioning information is an adjustment generated by a feedback loop that seeks to minimize the noise accompanying pilot carriers, which noise increases owing to intercarrier interference from adjoining modulated carriers when window positioning is not optimal.

A third of the output ports of the pilot carriers processor 88 explicitly shown in FIG. 93 is connected for forwarding unmodulated pilot carriers to the input port of the AFPC generator 82. The real components of the unmodulated pilot carriers are multiplied by their respective imaginary components in the AFPC generator 82. The resulting products are summed and low-pass filtered to develop the AFPC signal that the AFPC generator 82 supplies to the front-end tuner 80 for controlling the final local oscillator therein. Other methods to develop AFPC signals for the final local oscillator in the front-end tuner 80 are also known, variants of which can replace or supplement the method described above.

E.g., the complex digital samples from the tail of each half OFDM symbol are multiplied by the conjugates of corresponding digital samples from the cyclic prefix of the half OFDM symbol. The resulting products are summed and low-pass filtered to develop the AFPC signal that the AFPC generator 82 supplies to the front-end tuner 80 for controlling the final local oscillator therein. This method is a variant of a known method to develop AFPC signals in receivers for double-sideband COFDM signals described in U.S. Pat. No. 5,687,165 titled “Transmission system and receiver for orthogonal frequency-division multiplexing signals, having a frequency-synchronization circuit”, which was granted to Flavio Daffara and Ottavio Adami on 11 Nov. 1997.

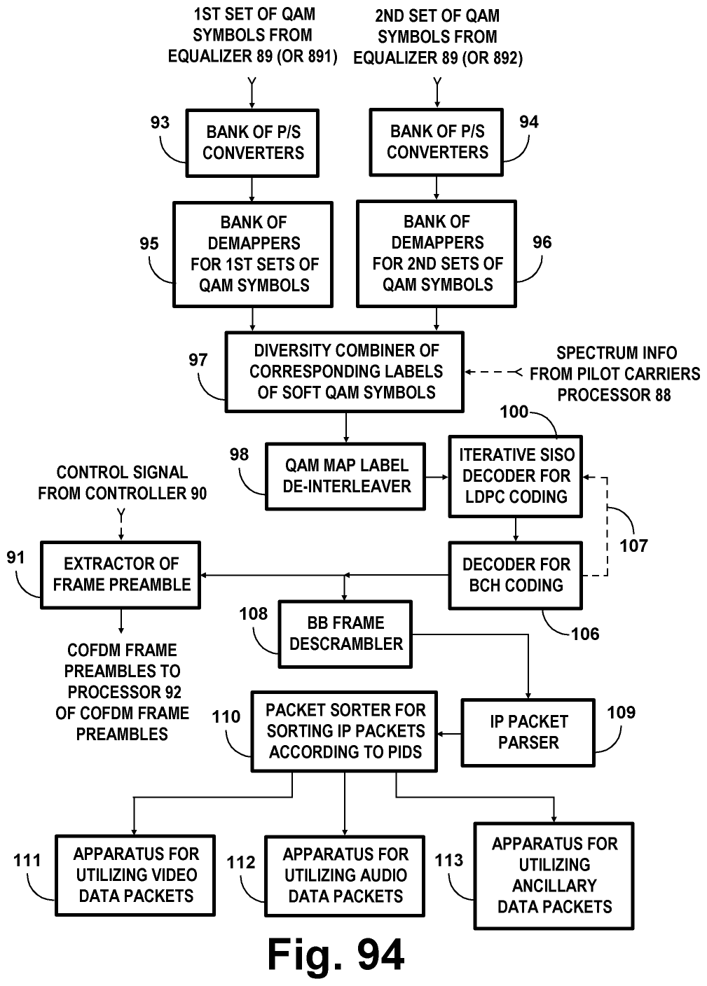

FIG. 93 indicates that a fourth of the output ports of the pilot carriers processor 88 is connected to a diversity combiner 97 (depicted in FIG. 94). Through such connection the pilot carriers processor 88 furnishes information concerning the frequency spectrum of each successive COFDM symbol, which the diversity combiner 97 can use to determine how it will combine its input signals to generate its output signal.

The DFT computer 87 is configured so it can demodulate any one of 8K, 16K and 32K options as to the number of OFDM carriers. The correct option is chosen responsive to an instruction from a controller 90 that generates a number of instructions used to configure the COFDM receiver to suit the broadcast standard used transmissions currently received. To keep the drawings from being too cluttered to be easily understood, they do not explicitly illustrate the multitudinous connections from the controller 90 to the elements of the receiver controlled by respective instructions from the controller 90.

As noted supra, the second output port of the DFT computer 87 is connected to supply demodulated complex digital samples of the complex coordinates of QAM symbol constellations in parallel to the input port of the frequency-domain channel equalizer 89. To implement a simple form of frequency-domain channel equalization, the pilot carriers processor 88 measures the amplitudes of the demodulated pilot carriers to determine basic weighting coefficients for various portions of the frequency spectrum. The pilot carriers processor 88 then interpolates among the basic weighting coefficients to generate respective weighting coefficients supplied to the frequency-domain channel equalizer 89 with which to multiply the complex coordinates of QAM symbol constellations supplied from the DFT computer 87. Various alternative types of frequency-domain channel equalizer are also known.

An extractor 91 of COFDM frame preambles selects them from COFDM frames of decoded data supplied from a decoder 106 for BCH coding, which decoder 106 is depicted in FIG. 53. The output port of the extractor 91 of COFDM frame preambles connects to the input port of a processor 92 of the COFDM frame preambles. The controller 90 is connected for responding to elements of COFDM frame preambles forwarded to a second of its input ports from an output port of the COFDM frame preambles processor 92.

The controller 90 is connected for responding to elements of the bootstrap signal forwarded to a first of its input ports from an output port of the bootstrap signal processor 83. The controller 90 supplies COFDM data frame information to the pilot carriers processor 88, which data frame information can be generated responsive to baseband bootstrap signal that the bootstrap signal processor supplies to the controller 90. Since the bootstrap signal is not always received acceptably free of error, it is good design to provide a source alternative to the bootstrap signal processor 83 for supplying the controller 90 back-up information as to the nature of received DTV signal. Such a source is necessary if bootstrap signal is not transmitted or if the receiver does not include a bootstrap signal processor. Accordingly the response of a decoder 106 for BCH coding, which decoder 106 is depicted in FIG. 94, is supplied to input port of an extractor 91 of FEC frame preambles from the decoder 106 response. If the frame preamble at the beginning of each COFDM data frame is repeated, the extractor 91 readily detects when frame preambles occur by correlating successive COFDM symbols in the response from the decoder 106 in accordance with the well-known Schmidl-Cox method. The output port of the extractor 91 of FEC frame preambles is connected for supplying them to the input port of a processor 92 of COFDM frame preambles. The output port of the processor 92 of COFDM frame preambles is connected for supplying an input port of the controller 90 with information as to the nature of received DTV signal, the interconnection between which ports may comprise a plurality of separate connections. FIG. 93 shows a connection from the controller 90 to the extractor 91 of FEC frame preambles through which connection the controller 90 can supply the extractor 91 a control signal including predictions of when FEC frame preambles are expected to occur.

The DFT computer 87 computes larger DFTs than is the case in COFDM receivers for double-sideband COFDM signals transmitted in accordance with the DVB-T2 standard for terrestrial television broadcasting, since the front-end tuner 80 does not combine lower-sideband OFDM carriers and upper-sideband OFDM carriers conveying similar coded digital data before computing DFT. There is no synchrodyne of double-sideband RF signal to baseband, as halves the sizes of DFTs to be computed in a receiver for DTV signals transmitted in accordance with the DVB-T2 broadcast standard. Responsive to information supplied from the bootstrap signal processor 83 or from the processor 92 of COFDM frame preambles, the controller 90 prescribes the basic sample rate and the size of I-FFT that the controller 90 instructs the DFT computer 87 to use in its operation regarding DTV signal. The controller 90 instructs the channel equalizer 89 and the banks 93 and 94 of parallel-input/serial-output converters to configure themselves to suit the size of DFT that the controller 90 instructs the DFT computer 87 to generate.

The frequency-domain channel equalizer 89 is connected for supplying complex coordinates of the QAM symbol constellations from the lower-frequency half COFDM symbol, in parallel and in forward spectral order, to the bank 93 of parallel-to-serial (P/S) converters. One of these P/S converters as selected by the controller 90 supplies the complex coordinates of a first set of QAM symbol constellations extracted from the lower-frequency halves of successive COFDM symbols. The frequency-domain channel equalizer 89 is further connected for supplying complex coordinates of the QAM symbol constellations from the higher-frequency half COFDM symbol, in parallel and in forward spectral order, to the bank 94 of parallel-to-serial (P/S) converters. One of these P/S converters as selected by the controller 90 supplies the complex coordinates of a second set of QAM symbol constellations extracted from the higher-frequency halves of successive COFDM symbols. “Forward spectral order” refers to the complex coordinates of each successive QAM symbol constellation from a half COFDM symbol having been conveyed by the COFDM carrier next higher in frequency than that having conveyed its predecessor QAM symbol. Each of the banks 93 and 94 of P/S converters comprises respective P/S converters that are appropriate for half the number of OFDM carriers that can convey data in a COFDM symbol of prescribed size. The pair of P/S converters selected for current reception is determined by a control signal that the controller 90 supplies in common to each of the banks 93 and 94 of P/S converters.

The first sets of QAM symbol constellations are those that originate from the first mapping procedures in the COFDM transmitter apparatus and are supplied from the output port of the bank 93 of P/S converters to the input port of a bank 95 of demappers for the first sets of QAM symbol constellations, as depicted in FIG. 94. The second sets of QAM symbol constellations are those that originate from the second mapping procedures in the COFDM transmitter apparatus and are supplied from the output port of the bank 94 of P/S converters to the input port of a bank 96 of demappers for the second sets of QAM symbol constellations, as depicted in FIG. 94. Each of the banks 95 and 96 of demappers comprises a respective set of QAM demappers for different sizes of QAM symbol constellations—e.g., one for square 16QAM, one for square 64QAM, one for square 256QAM, and possibly one for larger-size square QAM or for APSK. The pair of demappers selected for current reception is determined by a control signal that the controller 90 supplies in common to each of the banks 95 and 96 of QAM demappers.

The pairs of QAM demappers in the banks 95 and 96 of demappers could be paired Gray demappers, paired SCM demappers, paired natural demappers, paired anti-Gray demappers, paired “optimal” demappers of various types or some mixture of those types of paired demappers. However, if the demapping results from the antiphase-energy QAM demappers are to be maximal-ratio combined at bit level to improve effective SNR for AWGN reception, it is strongly recommended that QAM symbol constellations be Gray mapped or SCM mapped. It is practical for each of the QAM demappers to constitute a plurality of read-only memories (ROMs), one for each bit of map labeling, addressed by the complex coordinates descriptive of the current QAM symbol. Each ROM is read to provide a “hard” bit followed by a confidence factor indicating how likely that bit is to be correct. Customarily these confidence factors are expressed as logarithm of likelihood ratios (LLRs).

The confidence factors are usually based, at least in substantial part, on judgments of the distance of the complex coordinates descriptive of the current QAM symbol from the edges of the bin containing the “hard” bit. The confidence factors can be further based on whether or not the bin containing the “hard” bit is at an edge of the current QAM symbol constellation and, if so, whether the complex coordinates descriptive of that current QAM symbol closely approach that edge or even pass beyond it. The confidence factor that the “hard” bit is correct is increased if the complex coordinates descriptive of that current QAM symbol closely approach a symbol constellation edge or even pass beyond it. This increase applies to all bits in the map label. This effect obtains if mapping of QAM symbol constellations is Gray mapping or is SCM mapping.

FIG. 94 shows connections from the output ports of the banks 95 and 96 of demappers to respective input ports of a diversity combiner 97 of corresponding soft QAM labels operative at bit level. Each soft QAM label is composed of a plurality of “soft” bits. Each of these “soft” bits constitutes a “hard” bit and a confidence factor that that “hard” bit has been correctly decided; this confidence factor is conventionally expressed as a logarithm of likelihood ratio (LLR). This information is utilized in subsequent soft decoding procedures of the FEC coding reproduced in interleaved form from the diversity combiner 97. The output port of the diversity combiner 97 serially supplies soft bits of successive QAM labels to the input port of a bit de-interleaver 98 as soft bits of interleaved LDPC coding.

FIG. 94 shows the read-output port of the QAM map label de-interleaver 98 connected to the input port of an iterative soft-input/soft-output (SISO) decoder 100 for LDPC coding. FIG. 94 further shows the output port of the decoder 100 connected for supplying the results of its decoding LDPC coding to the input port of a decoder 106 of BCH coding. FIG. 94 shows a control connection 107 from the decoder 106 of BCH coding back to the decoder 100 of LDPC coding, through which connection 107 the decoder 106 sends an indication of when it has decoded a correct BCH codeword. This indication signals the decoder 100 of LDPC coding that it can discontinue iterative decoding before reaching a limit on the maximum number of iterations permitted, which early discontinuation of iterative decoding conserves power consumption by the receiver. The output port of the decoder 106 is connected for supplying the results of its decoding BCH coding to the input port of a BB Frame descrambler 108, which includes a de-jitter buffer and null-packet re-inserter that are not explicitly shown in FIG. 94.

FIG. 94 shows the output port of the BB Frame descrambler 108 connected to supply IP packets to the input port of an internet-protocol packet parser 109. The output port of the IP packet parser 109 is connected to supply IP packets to a packet sorter 110 for sorting IP packets according to their respective packet identifiers (PIDs) to one of the respective input ports of apparatus 111 for utilizing video data packets, apparatus 112 for utilizing audio data packets, and apparatus 113 for utilizing ancillary data packets.

FIG. 94 depicts a single SISO decoder 100 for LDPC coding in cascade connection with a single decoder 106 for BCH coding thereafter. In actual practice there are apt to be at least two such cascade connections available, suitable to respective different sizes of FEC code blocks, with one of these cascade connections selected for supplying decoded data to the input port of the BB frame descrambler 108 in accordance with instructions from the controller 90. Alternatively, decoders for other types of FEC coding replace the decoders 100 and 106 in other receiver apparatus embodying aspects of the invention. For example, a cascade connection of decoders for concatenated RS and turbo coding is used instead of the cascade connection of decoders 100 and 106.

Not all COFDM communication systems will concatenate BCH coding and LDPC coding. Cyclic redundancy check (CRC) coding can be used instead of BCH coding for detecting the successful conclusion of LDPC decoding. In such case, the general structure of COFDM receiver apparatus depicted in FIGS. 93 and 94 is modified to replace the decoder 106 for BCH coding with a decoder for CRC coding. However, unlike the decoder 106 for BCH coding, the decoder for CRC coding will be in capable of correcting remnant errors from iterative decoding of LDPC coding. LDPC coding that lends itself to being successfully decoded in a few iterations will allow the decoder 106 to be replaced by direct connection from the SISO decoder 100 to the input port of the BB Frame descrambler 108. The LDPC block coding that has customarily been used in DTV broadcasting can be replaced with LDPC convolutional coding. Forward-error-correction coding can be used that does not incorporate LDPC coding at all. The techniques for PAPR reduction using single-time retransmission can be applied if multi-level coding (MLC) is used, rather than bit-interleaved coded modulation (BICM). If MLC is used, there is less reason to consider replacing uniform QAM of OFDM carriers with non-uniform QAM than there is for BICM. (Incidentally, convolutional LDPC coding is better adapted to MLC than is block LDPC coding.)

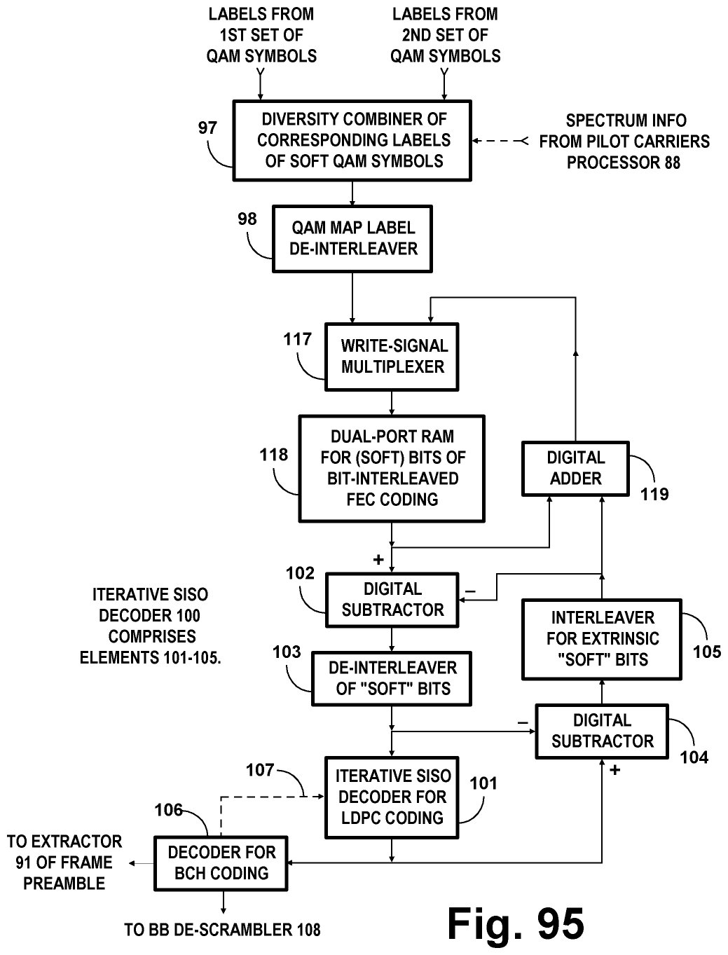

FIG. 95 is a detailed schematic diagram of modifications made to the receiver apparatus shown in FIG. 94. FIG. 95 depicts the iterative SISO decoder 100 for bit-interleaved LDPC coding in further detail as comprising an iterative SISO decoder 101 for LDPC coding, a digital subtractor 102, a de-interleaver 103 of “soft” bits, a digital subtractor 104 and an interleaver 105 for extrinsic “soft” bits. FIG. 95 further depicts a write-signal multiplexer 117, a dual-port random-access memory 118 and a digital adder 119 arranged to cooperate with demappers of QAM symbols to perform soft-demapping and soft-decoding procedures iteratively in accordance with the “turbo” principle. U.S. Pat. No. 6,353,911 titled “Iterative demapping” granted 5 Mar. 2002 to Stefan ten Brink provides generic description of an arrangement for performing such soft-demapping and soft-decoding procedures, which arrangement includes an adaptive QAM demapper. A question that arises with regard to a receiver which includes two QAM demappers, one for the lower sideband of an DCM COFDM signal and the other for its upper sideband, concerns how adaptive demapping can be implemented.

FIG. 95 shows the output port of the diversity combiner 97 connected via the QAM map label de-interleaver 98 to a first of two input ports of the write-signal multiplexer 117. The output port of the multiplexer 117 connects to the write-input port of the dual-port random-access memory 118. The diversity combiner 97 periodically supplies soft bits of time-interleaved LDPC-coded data to the input port of the QAM map label de-interleaver 98. The de-interleaver 98 response is supplied to a first input port of the write-signal multiplexer 117, thence to be written into the dual-port RAM 118 via its write-input port. The read-output port of the dual-port RAM 118 connects to a first addend-input port of the digital adder 119, the second addend-input port of which adder 119 is connected for receiving a bit-interleaved extrinsic error signal. The sum output port of the adder 119 connects to the second of the two input ports of the write-signal multiplexer 117.

The read-output port of the dual-port RAM 118 is further connected for supplying a posteriori soft demapping results to the minuend-input port of the digital subtractor 102. The subtrahend-input port of the digital subtractor 102 is connected for receiving the bit-interleaved extrinsic error signal from the output port of the interleaver 105 for extrinsic “soft” bits. The difference output port of the digital subtractor 102 connects to the input port of the de-interleaver 103 for bit-interleaved soft bits. The output port of the de-interleaver 103 connects to the input port of the soft-input/soft-output (SISO) decoder 101 for LDPC coding and further connects to the subtrahend input port of the digital subtractor 104. The minuend input port of the subtractor 104 is connected to receive the soft bits of decoding results from the output port of the SISO decoder 101. The subtractor 104 generates soft extrinsic data bits by comparing the soft output bits supplied from the SISO decoder 101 with soft input bits supplied to the SISO decoder 101. The output port of the subtractor 104 is connected to supply these soft extrinsic data bits to the input port of the bit-interleaver 105, which is complementary to the de-interleaver 103. The output port of the bit-interleaver 105 is connected for feeding back bit-interleaved soft extrinsic data bits to the second addend-input port of the digital adder 119, therein to be additively combined with previous a posteriori soft demapping results read from the dual-port RAM 118 to generate updated a priori soft demapping results to write over the previous ones temporarily stored within that memory 118.

More specifically, the RAM 118 is read concurrently with memory within the bit-interleaver 105, and the soft bits read out in LLR form from the memory 118 are supplied to the first input port of the digital adder 119. The adder 119 adds the interleaved soft extrinsic bits fed back via the interleaver 105 to respective ones of the soft bits of a posteriori soft demapping results read from the RAM 118 to generate updated a priori soft demapping results supplied from the sum output port of the adder 119 to the write-input port of the RAM 118 via the write signal multiplexer 117. The soft bits of previous a posteriori demapping results temporarily stored in the RAM 118 are each written over after its being read and before another soft bit is read.

The output port of the bit-interleaver 105 is also further connected for feeding back bit-interleaved soft extrinsic data bits to the subtrahend input port of the subtractor 102. The subtractor 102 differentially combines the bit-interleaved soft extrinsic data bits fed back to it with respective ones of soft bits of the a posteriori demapping results read from the RAM 118, to generate soft extrinsic data bits for the adaptive soft demapper from the difference-output port of the subtractor 102 for application to the input port of the de-interleaver 103. As thus far described, the SISO decoder 101 and the adaptive soft demapper (comprising elements 97, 98 and 117-119) are in a turbo loop connection with each other, and the turbo cycle of demapping QAM constellations and decoding LDPC can be iterated many times to reduce bit errors in the BCH coding that the SISO decoder 101 finally supplies from its output port to the input port of the decoder 106 for BCH coding. Successful correction of BCH codewords can be used for terminating iterative demapping and decoding of LDPC coding after fewer turbo cycles than the maximum number permitted.

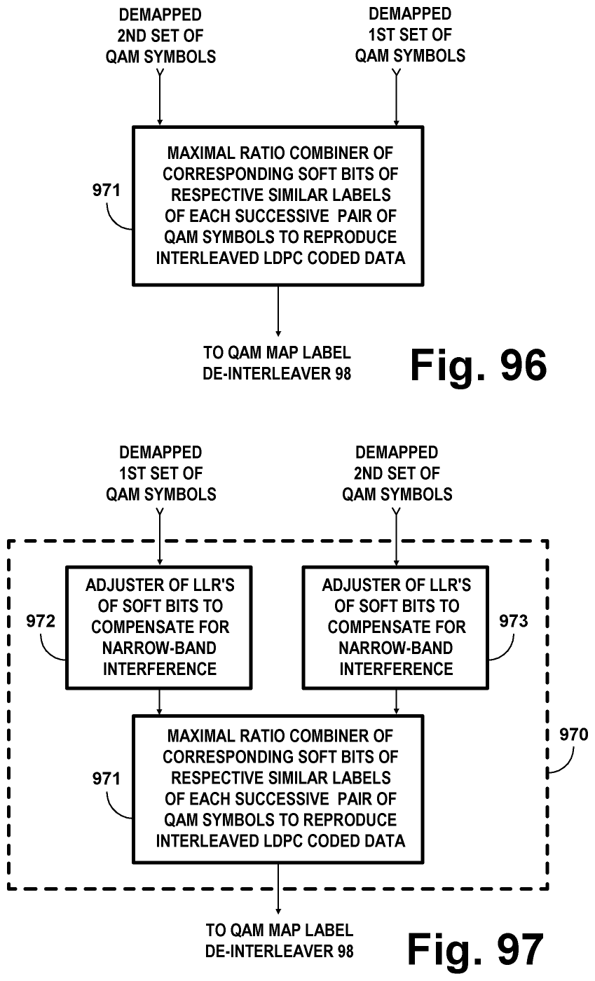

FIG. 96 depicts a soft-bit maximal ratio combiner 971 that is a representative specific structure for the diversity combiner 97. The output port of the soft-bit maximal ratio combiner 971 corresponds to the output port of diversity combiner 97, connecting to the input port of the QAM map label de-interleaver 98. A first of the two input ports of the maximal-ratio combiner 971 is connected to receive the demapped first set of QAM symbols, and the second of the two input ports of the maximal-ratio combiner 971 is connected to receive the demapped second set of QAM symbols. Thus, soft-bit maximal-ratio combining at bit level is performed after QAM demapping, rather than before. Maximal-ratio combining soft bits of corresponding QAM-lattice-point labels improves SNR of reception over an AWGN channel by at least 5.5 dB.

Each of the banks 95 and 96 of demappers of QAM symbols comprises a plurality of read-only memories (ROMs), one ROM for each bit of a particular size of QAM map label, which ROMs each receive as input address thereto the complex coordinates descriptive of a current one of a succession of QAM symbols. Each ROM considers the QAM modulation to range over a square arrangement of square “bins”, each of which bins has a respective map label associated therewith. Each ROM generates a respective “soft” bit, a bit metric composed of the more likely one of the “hard” bits 1 and 0 accompanied by a confidence factor. Customarily, the confidence factor is expressed in digitized numerical form as a logarithm of likelihood ratio (LLR) indicating how likely the accompanying decision as to the “hard” bit is correct. The soft-bit maximal-ratio combiner 971 considers 1 and 0 “hard” bits as sign bits when combining the LLRs of each successive pair of “soft” bits in a signed addition. The sign bit of the resultant sum determines the “hard” bit in the “soft” bit response from the maximal-ratio combiner 971 and the rest of this resultant sum determines the LLR of the correctness of this “hard” bit in the “soft” bit response from the maximal-ratio combiner 971.

Each ROM in a demapper of QAM symbols, which ROM is associated with a particular bit of map labeling, can support soft-bit maximal-ratio combining (SBMRC) in the following manner. When the result from demodulating the QAM modulation addresses the center point of the square bin identified by a particular map label, LLR of the particular bit is a value associated with a high level of confidence that the bit is correct. The LLR of the particular bit is reduced from that value when the result from demodulating QAM modulation addresses a point in that square bin approaching a boundary between that square bin and an adjoining square bin associated with opposite hard-bit value. When such boundary is reached the level of confidence in the particular bit being correct is reduced to no more than half its level at the center point of the bin. The level of confidence in the particular bit being correct at the center point of a bin increases is proportional to bin size.

Maximal-ratio combining of frequency-diverse QAM signals is superior to other well-known types of diversity combining when those signals are afflicted by AWGN, atmospheric noise, Johnson noise within the receiver, or imperfect filtering of power from an alternating-current power source. However, maximal-ratio combining of frequency-diverse QAM signals performs less satisfactorily when one QAM signal is corrupted by burst noise or in-channel interfering signal and the other is not. These various conditions of unsatisfactory reception will cause errors in the reproduction of soft bits of FEC-coded data from the maximal-ratio combiner 971. The erroneous bits are dispersed by the QAM map label de-interleaver 98 and by a de-interleaver of soft “bits” within the iterative SISO decoder 100 for LDPC coding, which improves the chances for those erroneous bits to be corrected during the decoding of the forward-error-correction (FEC) coding by the decoders 100 and 106.

FIG. 97 depicts a more complex representative specific structure 970 for the diversity combiner 97, which structure 970 includes the maximal-ratio combiner 971. The structure 970 further includes an adjuster 972 of the LLRs of soft bits of the demapped first set of QAM symbols before their application to the first input port of the maximal-ratio combiner 971. The structure 970 also further includes an adjuster 973 of the LLRs of soft bits of the demapped second set of QAM symbols before their application to the second input port of the maximal-ratio combiner 971. The adjuster 972 reduces the LLRs of soft bits of the demapped first set of QAM symbols supplied to the maximal-ratio combiner 971 when the hard bit portions of those soft bits are well out of normal mapping range, so as to compensate for narrow-band interference or drop-outs in received signal strength. The adjuster 973 reduces the LLRs of soft bits of the demapped second set of QAM symbols supplied to the maximal-ratio combiner 971 when the hard bit portions of those soft bits are well out of normal mapping range, so as to compensate for narrow-band interference and/or for drop-outs in received signal strength. Designs for the adjusters 972 and 973 can, for example, employ techniques similar to those described by Pertti Alapuranen in U.S. Pat. No. 8,775,907 granted to him 8 Jul. 2014 and titled “Orthogonal frequency division multiplexing symbol diversity combiner for burst interference mitigation”.

When dual QAM mapping procedures are applied to a single-sideband COFDM signal, so its frequency spectrum is as illustrated in FIG. 5, the lower and upper half spectra can be detected by heterodyning them with beat-frequency oscillations of nominally the same frequency as a pilot tone at the juncture of those half spectra. These procedures treat the SSB amplitude-modulation signal as an independent-sideband (ISB) signal. These procedures are appreciably less likely to be affected by adjacent-channel interference than the previously described procedures that heterodyne the single-sideband COFDM signal with beat-frequency oscillations of nominally the same frequency as a pilot tone at an edge of the RF channel.

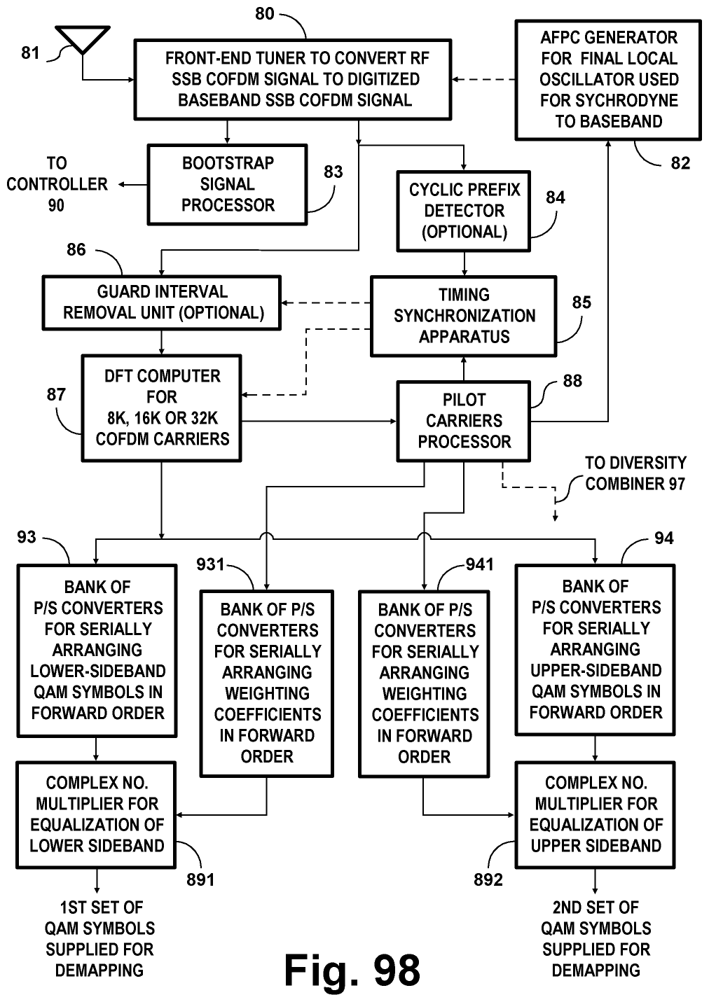

FIG. 98 depicts a variant of the FIG. 93 receiver structure. The channel equalizer 89 that performed multiplications on each of the QAM symbols supplied in parallel from the DFT computer 87 is omitted. A complex-number multiplier 891 performs frequency-domain channel equalization on each of the QAM symbols extracted from the lower sideband of the DCM COFDM signal by the DFT computer 87 after their serialization by a selected one of the parallel-to-serial (P/S) converters in the bank 93 of them. Another complex-number multiplier 892 performs frequency-domain channel equalization on each of the QAM symbols extracted from the upper sideband of the DCM COFDM signal by the DFT computer 87 after their serialization by a selected one of the parallel-to-serial (P/S) converters in the bank 94 of them. The first and second sets of QAM symbols supplied from the respective product output ports of the multipliers 891 and 892 are suitable input signals for subsequent demapping apparatus depicted in FIG. 94.

More particularly, the QAM symbols that the DFT computer 87 extracts from the lower sideband of the DCM COFDM signal are supplied, in parallel and in forward spectral order, directly to the parallel input ports of the selected one of the P/S converters in the bank 93 of them. The output port of that selected P/S converter responds to supply serialized QAM symbols from the lower sideband of the DCM COFDM signal to the multiplicand input port of the multiplier 891. The parallel input ports of a selected one of the parallel-to-serial (P/S) converters in a bank 931 of them receives, in parallel from the pilot carriers processor 88, the weighting coefficients for frequency-domain channel equalization of the lower sideband of the DCM COFDM signal. The output port of that selected P/S converter responds to supply serialized weighting coefficients for the lower sideband of the DCM COFDM signal to the multiplier input port of the complex-number multiplier 891. The multiplier 891 responds to its multiplicand and multiplier input signals to supply from its product output port an equalized first set of QAM symbols, suitable for subsequent demapping.

More particularly, the QAM symbols that the DFT computer 87 extracts from the upper sideband of the DCM COFDM signal are supplied, in parallel and in forward spectral order, directly to the parallel input ports of the selected one of the P/S converters in the bank 94 of them. The output port of that selected P/S converter responds to supply serialized QAM symbols from the upper sideband of the DCM COFDM signal to the multiplicand input port of the multiplier 892. The parallel input ports of a selected one of the parallel-to-serial (P/S) converters in a bank 941 of them receives, in parallel from the pilot carriers processor 88, the weighting coefficients for frequency-domain channel equalization of the upper sideband of the DCM COFDM signal. The output port of that selected P/S converter responds to supply serialized weighting coefficients for the lower sideband of the DCM COFDM signal to the multiplier input port of the complex-number multiplier 892. The multiplier 892 responds to its multiplicand and multiplier input signals to supply from its product output port an equalized second set of QAM symbols, suitable for subsequent demapping.

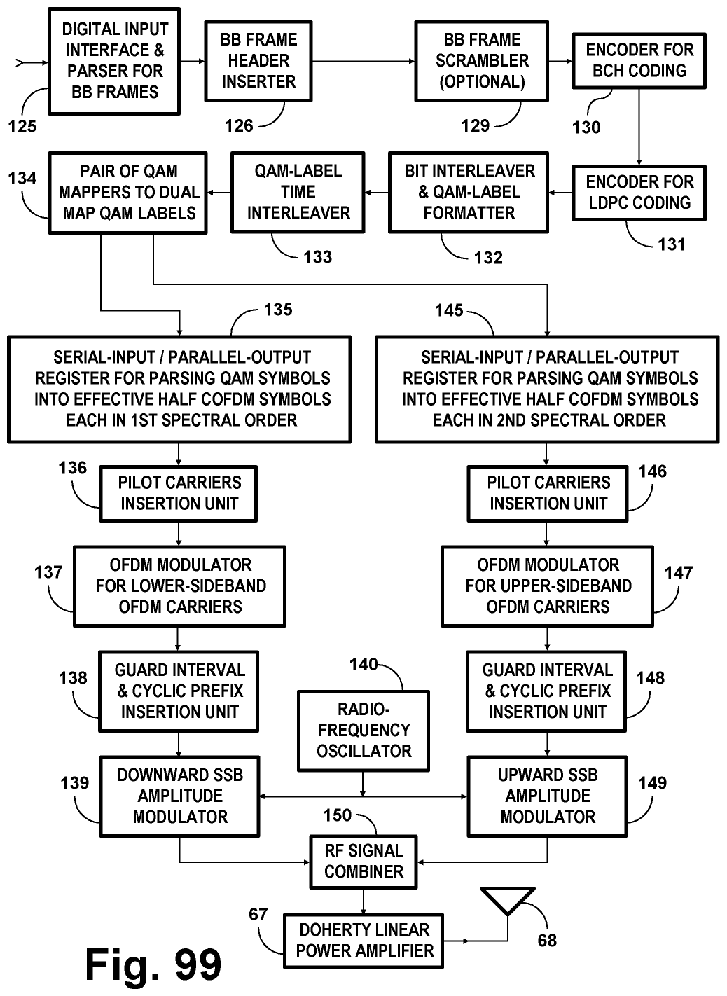

FIG. 99 depicts a transmitter structure for transmitting coded data twice, once in the lower sideband of an independent-sideband COFDM signal and once in its upper sideband. A digital input interface and parser for baseband frames 125 responds to a digital data stream supplied to its input port for supplying baseband data frames to a baseband frame header inserter 126. FIG. 99 shows the output port of the BB FRAME header inserter 126 connected to the input port of a BBFRAME scrambler 129, which data randomizes the BBFRAME supplied from the output port of the BBFRAME scrambler 129 to the input port of an encoder 130 for BCH coding. If the BBFRAME scrambler 129 is omitted, which omission is optional, the output port of the BBFRAME header inserter 126 can connect directly to the input port of an encoder 130 for BCH coding. FIG. 99 shows the output port of the encoder 130 connected to the input port of an encoder 131 for LDPC coding. FIG. 99 shows the output port of the encoder 131 connected to the input port of a bit-interleaver and QAM label formatter 132. The cascade connection of the encoder 130 for BCH coding and the encoder 131 for LDPC coding is apt to be replaced by means for implementing other forms of forward error-correction coding in some variants of the FIG. 99 structure.

FIG. 99 shows the output port of the bit-interleaver and QAM label formatter 132 connected to the input port of a QAM-label time interleaver 133 and the output port of the QAM-label time interleaver 133 connected to the input port(s) of a pair 134 of QAM mappers that map QAM labels differently, thereby to dual map those QAM labels. The QAM-label time interleaver 133 is omitted in some variants of the FIG. 99 structure in which the output port of the bit-interleaver and QAM label formatter 132 connects directly to the input port(s) of the pair 134 of QAM mappers.

A first of the pair 134 of QAM mappers supplies a first stream of complex coordinates of QAM symbols to a serial-input/parallel-output register 135. The SIPO register 135 parses the QAM symbols into effective half COFDM symbols, arranging the QAM symbols therein in a first spectral order following a cyclic prefix. The parallel output ports of the SIPO register 135 are connected to the parallel input ports of a pilot-carrier symbols insertion unit 136, which introduces pilot symbols for the lower- and upper-frequency edges of the complete half COFDM symbol and introduces pilot carrier symbols at suitable intervals between QAM symbols in each effective half COFDM symbol to generate the rest of a respective complete half COFDM symbol. The parallel output ports of the pilot-carrier symbols insertion unit 136 are connected to the parallel input ports of an OFDM modulator 137 for lower-sideband OFDM carriers. The OFDM modulator 137 performs an I-FFT and supplies the results from its output port as amplitude-modulating signal to the modulating-signal input port of a downward single-sideband amplitude modulator 138, there to modulate radio-frequency carrier supplied from the output port of a radio-frequency oscillator 140 to a principal-carrier input port of the SSB amplitude modulator 138.

A second of the pair 134 of QAM mappers supplies a second stream of complex coordinates of QAM symbols to a serial-input/parallel-output register 145. The SIPO register 145 parses the QAM symbols into effective half COFDM symbols, arranging the QAM symbols therein in a second spectral order following a cyclic prefix. The parallel output ports of the SIPO register 145 are connected to the parallel input ports of a pilot-carrier symbols insertion unit 146, which introduces pilot symbols for the lower- and upper-frequency edges of the complete half COFDM symbol and introduces pilot carrier symbols at suitable intervals between QAM symbols in each effective half COFDM symbol to generate the rest of a respective complete half COFDM symbol. The parallel output ports of the pilot insertion unit 146 are connected to the parallel input ports of an OFDM modulator 147 for upper-sideband OFDM carriers. The OFDM modulator 147 performs an I-FFT and supplies the results from its output port as amplitude-modulating signal to the modulating-signal input port of an upward single-sideband amplitude modulator 148, there to modulate radio-frequency carrier supplied from the output port of the radio-frequency oscillator 140 to a principal-carrier input port of the SSB amplitude modulator 148.

The pilot-carrier symbols insertion units 136 and 146 combine with the SIPO registers 135 and 145 so as to constitute a COFDM symbol generator for supplying respective halves of COFDM symbols to the OFDM modulators 137 and 147, which halves of COFDM symbols are respectively responsive to first and second sets of QAM symbols supplied from respective ones of the pair 134 of QAM mappers. First and second input ports of a radio-frequency signal combiner 150 are respectively connected for receiving the lower-frequency SSB amplitude-modulated RF signal from the output port of the amplitude modulator 138 and for receiving the upper-frequency SSB amplitude-modulated RF signal from the output port of the amplitude modulator 148. The RF oscillator 140, SSB amplitude modulator 138, SSB amplitude modulator 148 and RF signal combiner 150 combine to constitute a generator of DCM COFDM radio-frequency signal. Owing to arrangements of first and second sets of successive QAM symbols in the frequency spectrum carried out by the preceding generator of COFDM symbols, the lower-frequency sideband of this RF signal conveys the first set of successive QAM symbols and the upper-frequency sideband of this RF signal conveys a second set of successive QAM symbols.” The output port of the RF signal combiner 150 is connected for supplying ISB signal to the input port of the linear power amplifier 67, which is preferably of Doherty type. The output port of the linear power amplifier 67 is connected for driving RF analog COFDM signal power to the transmission antenna 68. The effective COFDM symbols are caused to have spectral response as shown in FIG. 5 by (a) arranging the SIPO register 135 to parse QAM symbols in descending spectral order in each effective half COFDM symbol for the lower sideband and (b) arranging the SIPO register 145 to parse QAM symbols in ascending spectral order in each effective half COFDM symbol for the upper sideband.

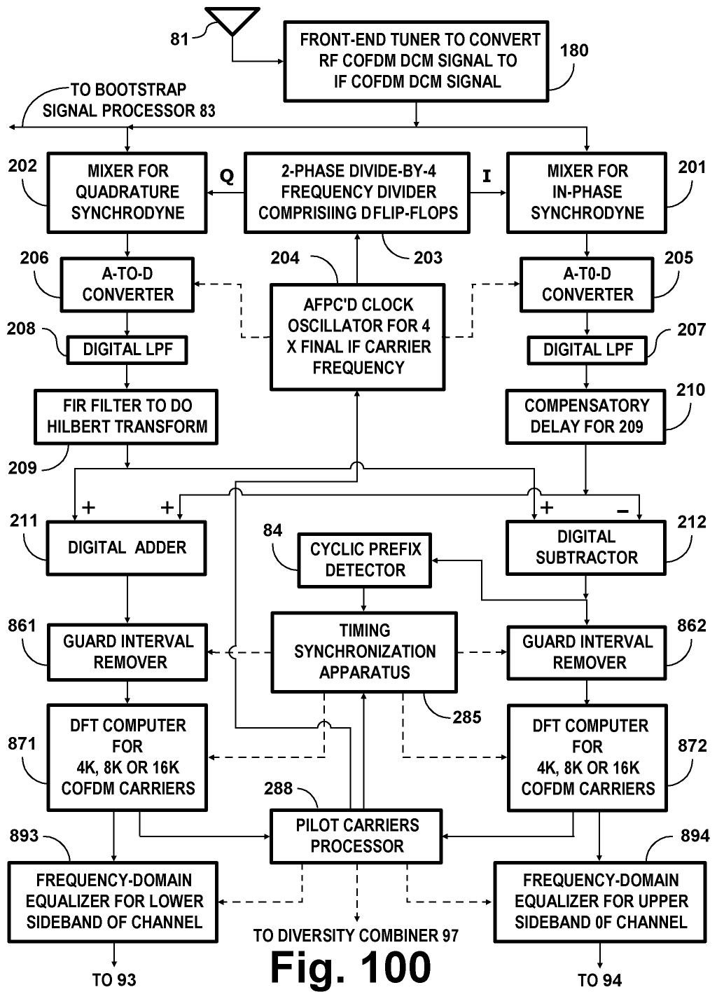

FIGS. 100 and 94 together depict receiver apparatus for independent-sideband (ISB) demodulation of COFDM signals using respective phase-shift methods to respond separately to the concurrent lower and upper sidebands of DCM COFDM signals. The receiver apparatus depicted in FIG. 101 applies the well-known phase-shift methods for demodulating SSB amplitude-modulation signals to demodulating the lower and upper sidebands of DCM COFDM signals to certain extent separately from each other. A reception antenna 81 captures the radio-frequency DCM COFDM signal for application as input signal to a front-end tuner 180 of the receiver. The front-end tuner 180 converts a selected radio-frequency DCM COFDM signal to an intermediate-frequency DCM COFDM signal, which is supplied to the respective signal input ports of mixers 201 and 202.

U.S. provisional Pat. App. 62/488,793 filed 23 Apr. 2017 by A. L. R. Limberg and titled “Double-sideband COFDM signal receivers that demodulate unfolded frequency spectrum” illustrates a beat-frequency oscillator (BFO) supplying in-phase (I) and quadrature-phase (Q) beat-frequency oscillations to the respective carrier input ports of analog mixers and via a direct connection and via a −90° phase-shifter, respectively. Such practice is problematic in the following two respects. It is difficult to realize a phase-shifter with analog circuitry, which phase-shifter provides exact −90° phase shift despite change in BFO frequency. Also, maintaining the amplitudes of the beat-frequency oscillations to the respective carrier input ports of the two analog mixers the same is rather difficult.

The latter of these difficulties is avoided by mixers 201 and 202 being of switching type receiving I and Q square waves at their respective carrier input ports. Fundamental-frequency components of the I and Q square waves that are at quite exactly at 0° and −90° relative phasings, despite change in frequency, are supplied from a 2-phase divide-by-4 frequency divider 203 in response to rising edges of pulses from a clock oscillator 204. The frequency divider 203 can be constructed from two gated D flip flop-flops (or data latches) suitably connected as depicted in FIG. 101. The clock oscillator 204 is subject to automatic frequency and phase control (AFPC) that adjusts the frequency of clock pulses to be four times the final intermediate-frequency (IF) carrier of the COFDM signals. A voltage-controlled crystal oscillator (VCXO) supplying oscillations nominally at 44 MHz is perhaps the optimal choice for the clock oscillator 204. The mixer 201 is conditioned to perform an in-phase synchrodyne of intermediate-frequency DCM COFDM signal to baseband, responsive to its carrier input port receiving leading in-phase (I) square wave from the frequency divider 203. The mixer 202 is conditioned to perform a quadrature-phase synchrodyne of intermediate-frequency DCM COFDM signal to baseband, responsive to its carrier input port receiving lagging quadrature-phase (Q) square wave from the frequency divider 203.

An analog-to-digital converter 205 performs analog-to-digital conversion of baseband signal supplied from the output port of the mixer 201. The sampling of the mixer 201 output signal by the A-to-D converter 205 is timed by a first set of alternate clock pulses received from the clock oscillator 204. An analog-to-digital converter 206 performs analog-to-digital conversion of the baseband signal supplied from the output port of the mixer 202. The sampling of the mixer 202 output signal by the A-to-D converter 206 is timed by a second set of alternate clock pulses received from the clock oscillator 204. The digitized in-phase baseband signal supplied from the output port of the A-to-D converter 205 is supplied to the input port of a digital lowpass filter 207. The digitized quadrature-phase baseband signal supplied from the output port of the A-to-D converter 206 is supplied to the input port of a digital lowpass filter 208. The digital lowpass filters 207 and 208 are of similar design, each to supply a response to a respective sideband which response is free of components of image signal remnant from the synchrodyning procedures. Preferably, that is, the design of the digital lowpass filters 207 and 208 provides a rapid roll-off of their higher-frequency responses, so as to suppress adjacent-channel interference (ACI).

The response of the digital lowpass filter 208 to quadrature-phase baseband signal is supplied to the input port of a finite-impulse-response digital filter 209 for Hilbert transformation. The response of the digital lowpass filter 207 to in-phase baseband signal is supplied to the input port of a clocked digital delay line 210 that affords delay to compensate for the latent delay through the FIR filter 209. The Hilbert transform response of the FIR filter 209 and the response of the digital delay line 210 are supplied to respective addend input ports of a digital adder 211 operative to recover, at baseband, the lower sideband of the DCM COFDM signal at its sum output port. The Hilbert transform response of the FIR filter 209 and the response of the digital delay line 210 are supplied respectively to the minuend input port and the subtrahend input port of a digital subtractor 212 operative to recover, at baseband, the upper sideband of the DCM COFDM signal at its difference output port.

The sum output port of the digital adder 211 connects to the input port of a guard interval remover 861. The output port of the guard interval remover 861 is connected for supplying the input port of a discrete-Fourier-transform (DFT) computer 871 with windowed portions of the baseband digitized lower sideband of the DCM COFDM signal that span respective COFDM symbol intervals. The complex coordinates of QAM symbols the DFT computer 871 extracts from lower sideband carriers in each COFDM symbol sampling interval that convey coded data are supplied as parallel input signal to a frequency-domain channel equalizer 893 for just those QAM symbols connected for supplying equalized QAM symbols to the parallel inputs of the P/S converter 93 in the FIG. 94 portion of the television receiver.

Subsequent to the recovery of the digitized upper sideband of the DCM COFDM signal at baseband by phase shift method, it is supplied from the difference output port of the digital subtractor 212 to the input port of a guard interval remover 862. The output port of the guard interval remover 862 is connected for supplying the input port of a DFT computer 872 with windowed portions of the baseband digitized upper sideband of the DCM COFDM signal that span respective COFDM symbol intervals. The complex coordinates of QAM symbols the DFT computer 872 extracts from upper sideband carriers in each COFDM symbol sampling interval that convey coded data are supplied as parallel input signal to a frequency-domain channel equalizer 894 just for those QAM symbols. Parallel output ports of the channel equalizer 894 are connected for supplying equalized QAM symbols to the parallel inputs of the P/S converter 94 in the FIG. 94 portion of the television receiver.

The DFT computers 871 and 872 are similar in construction, each configured so it can demodulate any one of 4K, 8K or 16K options as to half the nominal number of OFDM carriers. The correct option is chosen responsive to an instruction from a controller 90 that generates a number of instructions used to configure the COFDM receiver to suit the broadcast standard used transmissions currently received. The bootstrap signal processor 83, the controller 90, the extractor 91 of FEC frame preambles, and the processor 92 of COFDM frame preambles are not explicitly depicted in any of the FIGS. 100, 103, 104, 105, 107 and 108, but such elements are implicitly included in the structure of each of the DCM COFDM receivers shown in part in these figures of the drawing.

The guard interval removers 861 and 862 are each constructed similarly to the guard interval remover 86 in the FIG. 93 receiver apparatus, removing guard intervals responsive to the occurrences of cyclic prefixes having been detected by a cyclic prefix detector 84. FIG. 101 shows the input port of the cyclic prefix detector 84 connected for detecting the occurrences of cyclic prefixes in the digitized upper sideband of the DCM COFDM signal supplied at baseband from the output port of the digital subtractor 212. Alternatively, the input port of the cyclic prefix detector 84 can instead be connected for detecting the occurrences of cyclic prefixes in the digitized lower sideband of the DCM COFDM signal supplied at baseband from the output port of the digital adder 211. The cyclic prefix detector 84 differentially combines the digitized samples of baseband COFDM signal with those samples as delayed by the duration of an effective COFDM symbol. Nulls in the difference signal so generated should occur, marking the guard intervals of the baseband COFDM signal. The nulls are processed to reduce any corruption caused by noise and to generate better-defined indications of the phasing of COFDM symbols. The output port of the cyclic prefix detector 84 is connected to supply these indications to a first of two input ports of timing synchronization apparatus 285. First and second output ports of the timing synchronization apparatus 285 are connected for supplying similar gating control signals to the control input ports of the guard interval removers 861 and 862. Third and fourth output ports of the timing synchronization apparatus 285 are connected for supplying indications of the phasing of COFDM symbols to the DFT computers 871 and 872 respectively.

The complex coordinates of QAM symbols extracted from pilot carriers in each COFDM symbol sampling interval are supplied as parallel input signal to a pilot carriers processor 288. The pilot carriers processor 288 responds to complex coordinates of QAM symbols extracted from lower-sideband pilot carriers to generate weighting coefficients for the frequency-domain channel equalizer 893 to apply to QAM symbols extracted from the upper sideband of the DCM COFDM signal. A first of five output ports of the processor 288 that are explicitly shown in FIG. 101 is connected for supplying these weighting coefficients (via wiring depicted as a dashed-line connection) to the frequency-domain channel equalizer 893, which uses those weighting coefficients for adjusting its responses to the demodulation results for each of the lower-sideband COFDM carriers that convey data. The pilot carriers processor 288 responds to complex coordinates of QAM symbols extracted from upper-sideband pilot carriers to generate weighting coefficients for the frequency-domain channel equalizer 894 to apply to QAM symbols extracted from the upper sideband of the DCM COFDM signal. A second of the five output ports of the processor 288 that are explicitly shown in FIG. 101 is connected for supplying these weighting coefficients (via wiring depicted as a dashed-line connection) to the frequency-domain channel equalizer 894, which uses them for adjusting its responses to the demodulation results for each of the upper-sideband COFDM carriers that convey data.

A third of the output ports of the pilot carriers processor 288 that are explicitly shown in FIG. 101 is connected for supplying more accurate window-positioning information to the second input port of the timing synchronization apparatus 285. This window-positioning information is an adjustment generated by a feedback loop that seeks to minimize the noise accompanying pilot carriers, which noise increases owing to intercarrier interference from adjoining modulated carriers when window positioning is not optimal. A fourth of the output ports of the pilot carriers processor 288 explicitly shown in FIG. 101 is connected for forwarding automatic frequency and phase control (AFPC) developed from unmodulated pilot carriers to the AFPC input port of the clock oscillator 204. The real components of the unmodulated pilot carriers are multiplied by their respective imaginary components in the pilot carriers processor 288. The processor 288 sums and low-pass filters the resulting products to develop the AFPC signal that the processor 288 supplies to the clock oscillator 204. Responsive to this AFPC signal, the clock oscillator 204 regulates the frequency of its oscillations to be four times the carrier frequency of the final IF signal that the front-end tuner 180 supplies to the input ports of the mixers 201 and 202. This AFPC signal controls the frequency and phase of the clock pulses that the clock oscillator 204 supplies to the 2-phase divide-by-4 frequency divider 203.

A fifth of the output ports of the pilot carriers processor 288 explicitly shown in FIG. 101 is connected for supplying a diversity combiner 97 (depicted in FIG. 94 and in FIG. 95) with information concerning the frequency spectrum of each successive COFDM symbol.

FIG. 101 depicts two data latches—i.e., gated D flip-flops—connected to provide a two-phase divide-by-four frequency divider, such as the frequency divider 203 depicted in FIG. 100. The respective clock (C) input connections of the two data latches are each connected for receiving an original clock signal of frequency f, which clock signal is received from the clock oscillator 204 for the frequency divider 203 depicted in FIG. 101. Each of the two data latches has its own normal (Q) output connection and its own complementary (Q̅) output connection. There is wire connection from the complementary (Q̅) output connection of the data latch at left to the data (D) input connection of the data latch at right, and there is wire connection from the normal (Q) output connection of the data latch at right to the data (D) input connection of the data latch at left. The normal (Q) output connection of the data latch at right supplies a leading square wave having an “in-phase” fundamental frequency f/4, and the normal (Q) output connection of the data latch at left supplies a lagging square wave having a “quadrature-phase” fundamental frequency f/4 that lags the “in-phase” fundamental frequency by 90°.

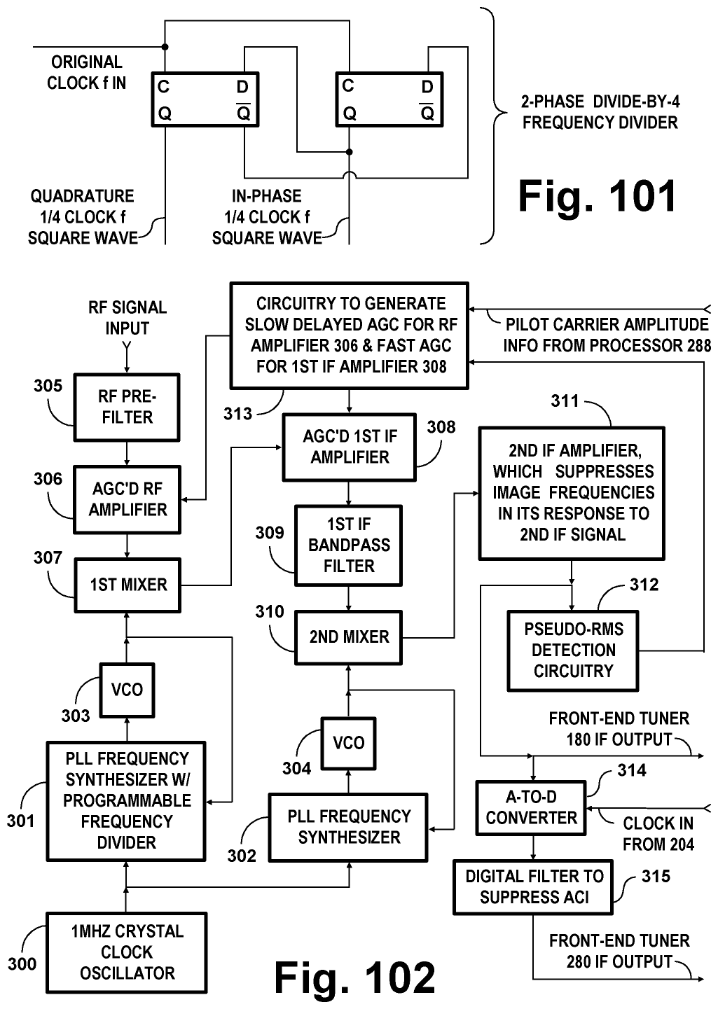

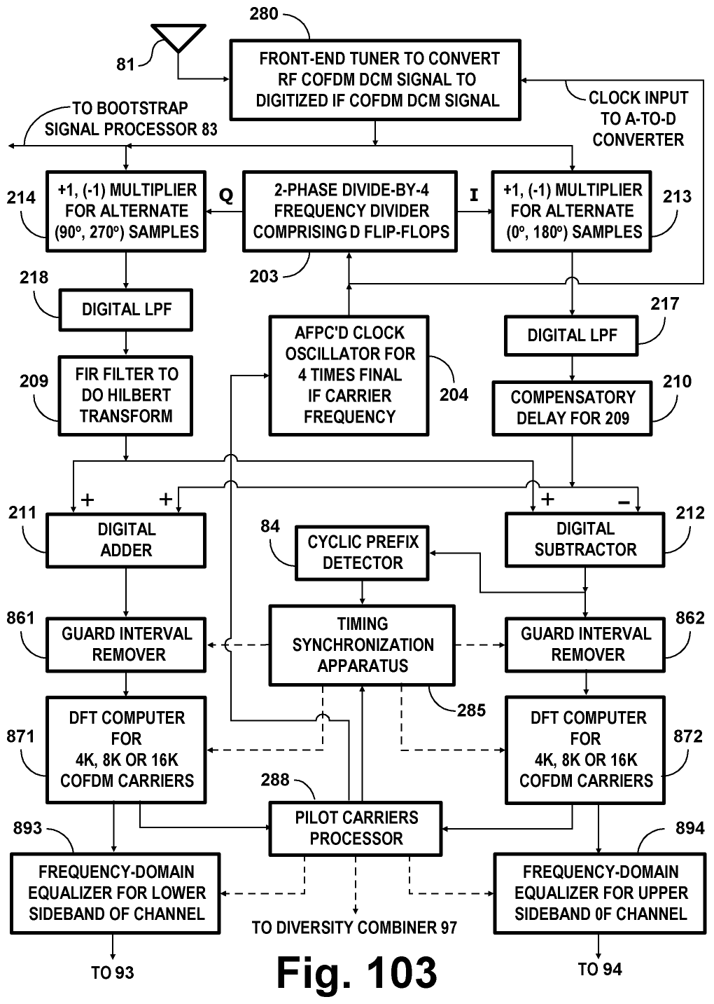

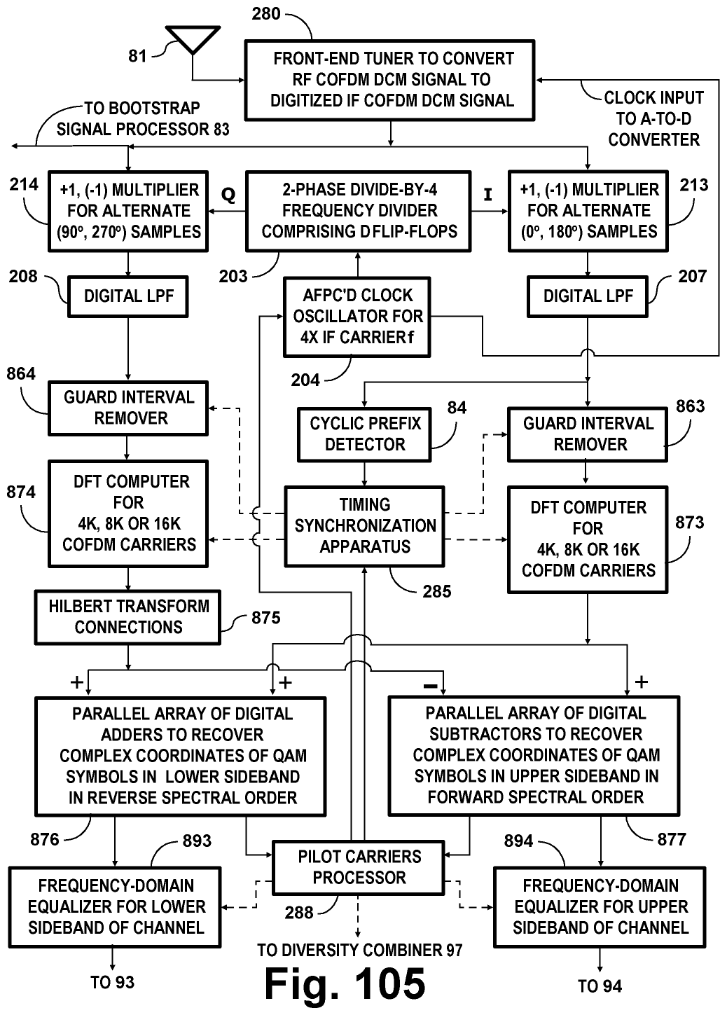

FIG. 102 depicts double-conversion front-end tuner structure suitable for the front-end tuner 180 depicted in FIGS. 100 and 101, and for the front-end tuner 280 depicted in FIGS. 103 and 105. Double-conversion front-end tuners are particularly advantageous over single-conversion front-end tuners when more television channels are more closely packed within the allocated television frequency spectrum. The structure is quite similar in general aspects to that described in U.S. Pat. No. 6,118,499 titled “Digital television signal receiver” granted to George Fang on 12 Sep. 2000. In a first frequency-conversion a selected radio-frequency DCM COFDM signal is up-converted in frequency to first-intermediate-frequency DCM COFDM signal at frequencies above the UHF television broadcasting band. The first-IF DCM COFDM signal is suitable for surface-acoustic-wave (SAW) bandpass filtering. In a second frequency-conversion the bandpass-filtered first-IF DCM COFDM signal is down-converted to second-intermediate-frequency DCM COFDM signal at frequencies substantially below the conventional “final intermediate frequency” (e.g., 41 to 47 MHz in U.S. television receivers). The second-IF DCM COFDM signal is at a sufficiently low frequency such that it can be directly sampled by an analog-to-digital converter after lowpass filtering to suppress image signal.

In FIG. 102 a crystal oscillator 300 is connected for supplying 1 MHz reference oscillations to phase-lock-loop frequency synthesizers 301 and 302. The PLL frequency synthesizer 301 is connected for supplying automatic frequency and phase control (AFPC) voltage to a voltage-controlled oscillator 303, which VCO 303 generates the first local oscillations used in the upward conversion of radio-frequency DCM COFDM signal to first-IF DCM COFDM signal. The PLL frequency synthesizer 302 is connected for supplying AFPC voltage to a voltage-controlled oscillator 304, which VCO 304 generates the second local oscillations used in the downward conversion of first-IF DCM COFDM signal to second-IF DCM COFDM signal.

The PLL frequency synthesizer 301 includes a programmable frequency divider, a clocked counter that counts the first local oscillations supplied to its counter input connection from the VCO 303. When the count reaches a selected large positive integer, the counter resets to zero count and generates a carry pulse supplied to an AFPC detector within the PLL frequency synthesizer 301. Responsive to carry pulses from the counter, that AFPC detector samples the 1 MHz oscillations from the crystal oscillator and integrates the response of such sampling to generate the AFPC voltage applied to the VCO 303. The crystal oscillator 300 is designed for supplying 1 MHz reference oscillations since it is the largest common submultiple of the central carrier frequencies of all the allocated TV broadcast channels in the U.S.A.

The PLL frequency synthesizer 302 includes a fixed frequency divider, a clocked counter that counts the second local oscillations supplied to its counter input connection from the VCO 304. When the count reaches a prescribed large positive integer, the counter resets to zero count and generates a carry pulse supplied to an AFPC detector within the PLL frequency synthesizer 302. Responsive to carry pulses from the counter, that AFPC detector samples the 1 MHz oscillations from the crystal oscillator and integrates the response of such sampling to generate the AFPC voltage applied to the VCO 304. Choosing the prescribed large positive integer at which the counter in the PLL frequency synthesizer 302 resets to zero count is preferably done so as to position the central carrier frequency of the second-IF DCM COFDM signal at 11 MHz. This frequency is low enough that analog-to-digital conversion of the second-IF DCM COFDM signal is practical. Also, the fourth harmonic of the central carrier frequency of the second-IF signal is at 44 MHZ, which is at the center of the 41-47 megahertz final IF signals commonly used in prior-art television receivers. Since these frequencies are not allocated for high-power RF transmissions, this reduces the possibility of strong interference with operation of the clock oscillator 204 depicted in FIGS. 100, 103, 104, 105, 107 and 108.

The input port of a pre-filter 305 is connected for receiving radio-frequency (RF) COFDM signal supplied by an antenna or a cable distribution system. (The pre-filter 305 is typically constructed either as a group of fixed frequency band pass filters, or as a tracking type of filter.) The pre-filter 305 reduces the bandwidth of the signal entering the subsequent radio-frequency amplifier 306, which RF amplifier 306 is subject to automatic gain control (AGC). The pre-filter 305 reduces the number of channels amplified by the AGC′d RF amplifier 306, thereby reducing the intermodulation interference generated by the amplifier 306 and subsequent circuits. In a pre-filter 305 comprising a group of fixed-frequency bandpass filters, the proper band is selected according to channel selection information supplied from a controller not explicitly depicted in FIG. 102. Alternatively, in a tracking type pre-filter, an analog control voltage is generated responsive to channel selection information supplied from the controller. The controller also supplies the channel selection information to the PLL frequency synthesizer 301 for determining the frequency division its programmable frequency divider affords to oscillations supplied thereto from the VCO 303.

The RF output of the pre-filter 305 is amplified or attenuated to a desired level by the AGC′d RF amplifier 306 and then supplied to a first mixer 307, there to be mixed with first local oscillations from the VCO 303. The signal at the output port of first mixer 307, resulting from the desired TV channel signal being multiplied by the VCO 303 oscillations, is defined as the first intermediate frequency signal. The frequency of this first-IF signal is the difference between the frequency of the VCO 303 first local oscillations and the frequency of the DCM COFDM signal to be received. Since the mixer 307 shifts the spectrum of the desired TV channel to a frequency higher than the TV broadcast frequency, this operation is referred to as an up-conversion. The first-IF is chosen to be above all of the spectrum used by terrestrial or cable distribution TV broadcasting in the particular environment in which the tuner operates in. By this choice, the image frequency (the frequency which is the numerical sum of the VCO 303 signal and the first-IF frequency) generated in the up-conversion process can be rejected by the pre-filter 305. This choice of first intermediate frequencies also requires the frequency of the VCO 304 to be above the spectrum used by TV broadcasting, thereby avoiding other possible interference.

The first-IF output signal supplied from the mixer 307 is amplified by a narrow-band amplifier 308 and then supplied to a first-IF bandpass filter 309 such as a dielectric resonance filter, a strip-line filter or a SAW filter. The characteristics of the first-IF BPF 309 are designed, with consideration to the characteristics of subsequent digital filtering that will be used to suppress ACI (adjacent-channel interference). I.e., the bandwidth of the first-IF BPF 309 is no less than that of a single digital TV channel, and the passband group delay response is sufficiently linear so as not to cause adverse effects on subsequent demodulation of a second-intermediate-frequency (second-IF) DCM COFDM signal. Furthermore, the first-IF BPF 309 is designed to have sufficient out-of-band attenuation at the image frequency range of the subsequent down-conversion process by a second mixer 310 so as not to introduce excessive image frequency interference to degrade the performance of the subsequent demodulation of the second-IF DCM COFDM signal. (In alternative front-end tuner designs the positions of the first-IF amplifier 308 and the first-IF BPF 309 within their cascade connection are interchanged.)

The output signal from the first-IF BPF 309 principally consists of just the desired TV channel signal as up-converted, possibly accompanied by small amounts of up-converted adjacent-channel signals that have not been completely attenuated owing to the band-edge roll-off characteristics of BPF 309. This signal is supplied to a second mixer 310 to be mixed with second local oscillations, which are supplied from the VCO 304. The signal supplied from the output port of the mixer 310, resulting from the first-IF DCM COFDM signal being multiplied by second local oscillations from the VCO 304, is defined as the second-intermediate-frequency (second-IF) DCM COFDM signal. The frequency of this second-IF DCM COFDM signal is the numerical difference between the frequency of second local oscillations from the VCO 304 and the somewhat lower frequencies of the first-IF DCM COFDM signal. The second-IF DCM COFDM signal supplied from the output port of the mixer 310 is amplified by a second IF amplifier 311 of such design as to suppress image signals that have frequencies almost twice that of the frequency of the second local oscillations above the UHF TV band. Since the mixer 310 shifts the first-IF signal to a lower frequency, this operation is referred to as a down-conversion.

The amplified second-IF DCM COFDM signal supplied from the output port of the second IF amplifier 311 is applied to the input port of pseudo-RMS detection circuitry 312. The output port of the pseudo-RMS detection circuitry 312 is connected for supplying an approximation of the RMS (root-mean-square) voltage of the response from the second IF amplifier 311 to a first input port of circuitry 313 for generating respective automatic gain control (AGC) signals for the RF amplifier 306 and for the first-IF amplifier 308. The peak-to-average ratio (PAPR) of COFDM signals is very high, and occasional peak clipping of them is better design. Detecting the peak voltage of the response from the second-IF amplifier 311 would not provide a good basis from which to develop AGC signals.

A second port of the circuitry 313 for generating AGC signals is connected for receiving pilot carrier amplitude information from the pilot carriers processor 288 depicted in FIG. 100 or any of FIGS. 103, 104 and 105. The pilot carrier amplitude information provides a more precise basis for assuring that the level of response from the second IF amplifier 311 is adjusted to suit subsequent analog-to-digital conversion and QAM demapping procedures.

Designs of circuitry for generating AGC signals in double-conversion radio receivers are known in the prior art. The circuitry 313 generates delayed AGC signal for the RF amplifier 306, avoiding reduction of the RF amplifier 306 gain as long as RF signal strength is not so strong that RF amplifier 306 response consistently drives the first mixer 307 outside its range of acceptably linear response. During the reception of such weaker strength RF signals, the circuitry 313 generates AGC signal for the first-IF amplifier 308 that regulates its gain control to maintain desired value of the approximate RMS value of the second IF amplifier 311 response. This maintains the second mixer 310 within its range of acceptably linear response. The circuitry 313 generates the delayed AGC signal for the RF amplifier 306 so as to exhibit slower response to second IF amplifier 311 output signal than the AGC signal for the first-IF amplifier 308. This accommodates clipping of occasional extraordinarily large peaks of received COFDM signal in the first mixer 307 and the RF amplifier 306. The AGC signal for the first-IF amplifier 308 that circuitry 313 generates no longer reduces the gain of the first-IF amplifier 308 when circuitry 313 supplies delayed AGC signal to the RF amplifier 306 for reducing its gain.

In a front-end tuner 280 configuration as used in FIGS. 103 and 105, the amplified second-IF DCM COFDM signal supplied from the output port of the second IF amplifier 311 is supplied to the input port of an analog-to-digital converter 314. The A-to-D converter 314 samples the amplified second-IF DCM COFDM signal at a clock rate determined by the clock oscillator 204 depicted in FIG. 103 or 105. The output port of the A-to-D converter 314 is connected for supplying the resulting digitized second-IF DCM COFDM signal to the input port of a digital bandpass filter 315. Both the lower- and higher-frequency roll-offs of the bandpass response at the output port of the filter 315 are very steep, better to suppress adjacent-channel interference (ACI). The bandpass-filtered digital second-IF DCM COFDM signal supplied from the output port of the filter 315 is suitable to provide the intermediate-frequency DCM COFDM output signal for a front-end tuner 280 configuration.

The amplified second-IF DCM COFDM signal supplied from the output port of the second IF amplifier 311 is suitable to provide the intermediate-frequency DCM COFDM output signal for a front-end tuner 180 configuration. In such front-end tuner 180 configuration the A-to-D converter 314 and the digital bandpass filter 315 are unnecessary and can be omitted.

FIGS. 103 and 94 together depict a variant of the receiver apparatus for independent-sideband (ISB) demodulation of DCM COFDM depicted in FIGS. 100 and 94, digital circuitry shown in FIG. 103 replacing some of the analog circuitry shown in FIG. 100. The front-end tuner 180 of FIG. 100 that converts a selected radio-frequency DCM COFDM signal to an analog intermediate-frequency DCM COFDM signal is replaced in FIG. 103 by a front-end tuner 280 that converts a selected RF DCM COFDM signal to a digitized intermediate-frequency DCM COFDM signal. This digitized DCM COFDM signal is supplied from the output port of the front-end tuner 280 to respective signal input ports of +1, (−1) multipliers 213 and 214. A 2-phase divide-by-4 frequency divider 203 responds to rising edges of pulses from a clock oscillator 204, by supplying I and Q square waves to respective carrier input ports of the +1, (−1) multipliers 213 and 214. The clock oscillator 204 is subject to automatic frequency and phase control (AFPC) that adjusts the frequency of clock pulses to be four times the final intermediate-frequency (IF) carrier of the COFDM signals. The clock oscillator 204 is connected for supplying the clock pulses to an analog-to-digital converter in the front-end tuner 280, which A-to-D converter digitizes the intermediate-frequency DCM COFDM signal supplied to respective signal input ports of the +1, (−1) multipliers 213 and 214.

The leading I square wave that the frequency divider 203 supplies to the control input port of the +1, (−1) multiplier 213 conditions the +1, (−1) multiplier 213 to perform a 2-to-1 decimation of the 0°, 90°, 180° and 270° digital samples of DCM COFDM signal supplied to its input port, selecting the 0° digital samples for multiplication by +1 responsive to positive half cycles of I square wave, and selecting the 180° digital samples for multiplication by −1 responsive to negative half cycles of I square wave. The output port of the +1, (−1) multiplier 213 is connected for supplying the in-phase synchrodyne results to the input port of a digital lowpass filter 207. The lowpass filter 207 responds to the baseband portion of the in-phase synchrodyne results, but not to image signal. FIG. 103 shows the output port of the lowpass filter 207 connected for supplying its response the input port of the clocked digital delay line 210 providing compensatory delay for the latent delay of the digital FIR filter 209 used to perform Hilbert transformation.

The lagging Q square wave that the frequency divider 203 supplies to the control input port of the +1, (−1) multiplier 214 conditions the +1, (−1) multiplier 214 to perform a 2-to-1 decimation of the 0°, 90°, 180° and 270° digital samples of DCM COFDM signal supplied to its input port, selecting the 90° digital samples for multiplication by −1 responsive to negative half cycles of Q square wave, and selecting the 270° digital samples for multiplication by +1 responsive to positive half cycles of Q square wave. The output port of the +1, (−1) multiplier 214 is connected for supplying quadrature-phase synchrodyne results to the input port of to the input port of a digital lowpass filter 208. The lowpass filter 208 responds to the baseband portion of the quadrature-phase synchrodyne results, but not to image signal. FIG. 103 shows the output port of the lowpass filter 208 connected for supplying its response the input port of the FIR filter 209 for performing Hilbert transformation.

If the front-end tuner 280 contains digital lowpass filtering of the digitized IF DCM COFDM signal with rapid roll-off to suppress ACI, there is no reason for the digital lowpass filters 207 and 208 necessarily having to have sharp roll-offs of higher frequencies to suppress ACI. The Hilbert transform response of the FIR filter 209 and the response from digital delay line 210 are utilized in the subsequent portions of the FIG. 103 and FIG. 94 receiver apparatus in the same way as in the corresponding portions of the FIG. 101 and FIG. 94 receiver apparatus.

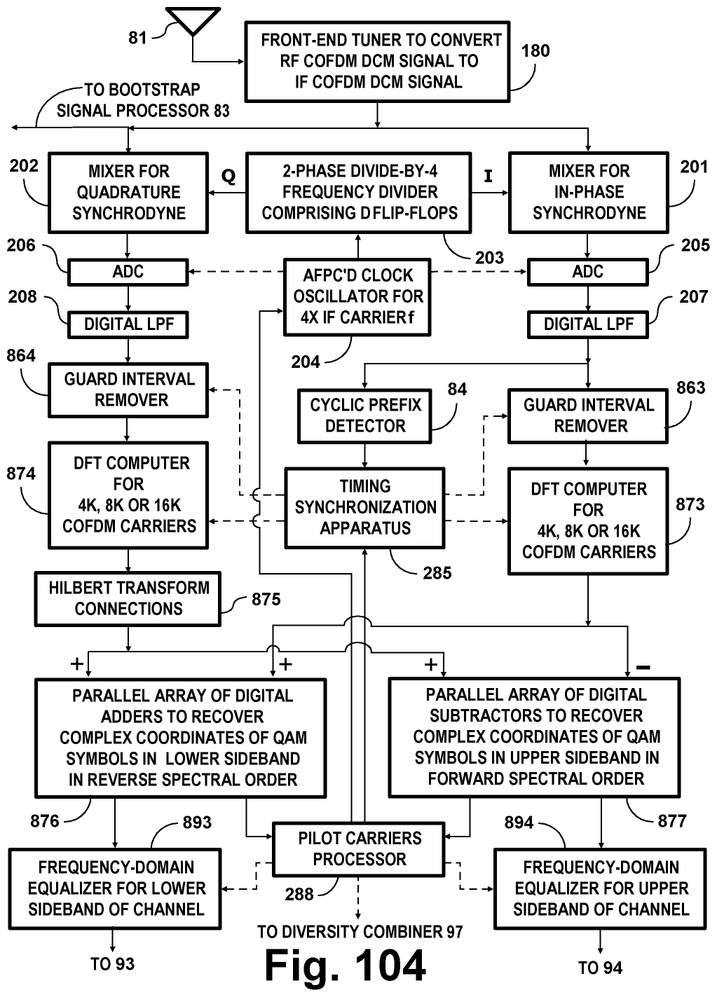

FIGS. 104 and 94 together depict another general structure of receiver apparatus for ISB demodulation of DCM COFDM signals. In accordance with further aspects of the invention, the FIG. 104 portion of this receiver apparatus employs phase-shift methods of ISB demodulation modified in a novel first manner particularly well suited for DCM COFDM signals. However, initial portions of the FIG. 104 apparatus are similar to the initial portions of the FIG. 100 apparatus.

As with the FIG. 100 apparatus, a reception antenna 81 captures the radio-frequency DCM COFDM signal for application as input signal to a front-end tuner 180 of the receiver. The front-end tuner 180 converts a selected radio-frequency DCM COFDM signal to an intermediate-frequency DCM COFDM signal, which is supplied to the respective signal input ports of mixers 201 and 202. The mixers 201 and 202 are of switching type connected for receiving I and Q square waves at their respective carrier input ports, as supplied from a 2-phase divide-by-4 frequency divider 203 in response to rising edges of pulses from a clock oscillator 204. The clock oscillator 204 is subject to AFPC that adjusts the frequency of clock pulses to be four times the final IF carrier of the COFDM signals. The leading in-phase (I) square wave, which the frequency divider 203 supplies to the carrier input port of the mixer 201, conditions the mixer 201 to provide an in-phase synchrodyning of intermediate-frequency DCM COFDM signal to baseband. The lagging quadrature-phase (Q) square wave, which the frequency divider 203 supplies to the carrier input port of the mixer 202, conditions the mixer 202 to provide a quadrature-phase synchrodyning of intermediate-frequency DCM COFDM signal to baseband.

As with the FIG. 100 apparatus, an A-to-D converter 205 performs analog-to-digital conversion of the baseband signal supplied from the output port of the mixer 201. The digitized in-phase baseband signal supplied from the output port of the A-to-D converter 205 is supplied to the input port of a digital lowpass filter 208. An A-to-D converter 206 performs analog-to-digital conversion of the baseband signal supplied from the output port of the mixer 202. The digitized quadrature-phase baseband signal supplied from the output port of the A-to-D converter 206 is supplied to the input port of a digital lowpass filter 208.

Subsequent portions of the FIG. 104 apparatus differ from subsequent portions of the FIG. 100 apparatus. The digital FIR filter 209 that the FIG. 100 apparatus includes for performing Hilbert transform is complex in nature and takes up considerable area on the silicon die in a monolithic integrated circuit construction. The FIG. 104 apparatus dispenses with the digital FIR filter 209, the digital delay line 210, the digital adder 211, and the digital subtractor 212.

The digital lowpass filter 207 is connected for supplying digitized samples of baseband folded DCM COFDM signal to the input port of the cyclic prefix detector 84. (Alternatively, the digital lowpass filter 208 is connected for supplying digitized samples of baseband folded DCM COFDM signal to the input port of the cyclic prefix detector 84 instead). The cyclic prefix detector 84 differentially combines the digitized samples of baseband folded DCM COFDM signal with those samples as delayed by the duration of an effective COFDM symbol. Nulls in the difference signal so generated should occur, marking the guard intervals of the baseband folded DCM COFDM signal. The nulls are processed to reduce any corruption caused by noise and to generate better-defined indications of the phasing of COFDM symbols. The output port of the cyclic prefix detector 84 is connected to supply these indications to the first of two input ports of the timing synchronization apparatus 285.

The signal input port of a guard interval remover 863 is connected for receiving digitized samples of an in-phase baseband COFDM signal from the output port of the digital lowpass filter 207. The output port of the guard interval remover 863 is connected for supplying the input port of a discrete-Fourier-transform (DFT) computer 873 with windowed portions of the quadrature-phase baseband signal that span respective COFDM symbol intervals. The signal input port of the guard interval remover 864 is connected for receiving digitized samples of a quadrature-phase baseband COFDM signal from the output port of the digital lowpass filter 208. The output port of the guard interval remover 864 is connected for supplying the input port of a discrete-Fourier-transform (DFT) computer 874 with windowed portions of the in-phase baseband signal that span respective COFDM symbol intervals. The DFT computers 873 and 874 are similar in construction, each having the capability of transforming a respective half of the COFDM carriers nominally 4K, 8K or 16K in number to the complex coordinates of respective QAM symbols. The DFT computers 873 and 874 perform bandpass filtering of individual OFDM carriers which bandpass filtering should be unresponsive to frequencies outside baseband. This bandpass filtering may allow digital lowpass filters 207 and 208 to be replaced by respective direct connections in modified FIG. 104 structure.

The timing synchronization apparatus 285 is connected for supplying gating control signals to respective control input ports of the guard interval removers 863 and 864. The timing synchronization apparatus 285 is further connected for supplying COFDM symbol timing information to the DFT computers 873 and 874. The indications concerning the phasing of COFDM symbols that the cyclic prefix detector 84 supplies to the timing synchronization apparatus 285 are sufficiently accurate for (a) initial windowing of the in-phase baseband folded COFDM signal that the guard interval remover 863 supplies to the DFT computer 873 and (b) initial windowing of the quadrature-phase baseband folded COFDM signal that the guard interval remover 862 supplies to the DFT computer 874.

The output port of the DFT computer 874 is connected via Hilbert transformation connections 875 for supplying complex coordinates of QAM symbols conveyed by respective ones of the received COFDM carriers to first addend input ports of a parallel array 876 of digital complex-number adders and to minuend input ports of a parallel array 877 of digital complex-number subtractors. These connections 875 are such as to perform Hilbert transform of the complex coordinates of QAM symbols, which procedure is explained in greater detail in the remaining portion of this paragraph. The real coordinates of the complex coordinates of QAM symbols are applied as imaginary components of input signals to the first addend input ports of the parallel array 876 of digital adders and to the minuend input ports of the parallel array 877 of digital subtractors. The imaginary coordinates of the complex coordinates of QAM symbols are applied as real components of input signals to the first addend input ports of the parallel array 876 of digital adders and to the minuend input ports of the parallel array 877 of digital subtractors. There is essentially no delay in this Hilbert transformation procedure, and it takes up little (if any) extra area on the silicon die in a monolithic integrated circuit construction. The output port of the DFT computer 873 is connected for supplying complex coordinates of QAM symbols conveyed by respective ones of the received COFDM carriers to second addend input ports of the parallel array 876 of digital complex-number adders and to subtrahend input ports of the parallel array 877 of digital complex-number subtractors.

The parallel array 876 of digital adders additively combines the complex coordinates of QAM symbols the DFT computer 873 generates, as transformed by the Hilbert transformation connections 875, with the complex coordinates of corresponding QAM symbols the DFT computer 874 generates. The sum output ports of the parallel array 876 of digital adders recover at baseband the complex coordinates of QAM symbols from the lower sideband of the DCM COFDM signal. The complex coordinates of QAM symbols extracted from pilot carriers in each COFDM symbol sampling interval are supplied as parallel input signal to the pilot carriers processor 288. The complex coordinates of QAM symbols extracted from carriers in each COFDM symbol sampling interval that convey coded data are supplied as parallel input signal to the frequency-domain channel equalizer 893 for QAM symbols extracted from the lower sideband of the DCM COFDM signal.

The parallel array 877 of digital subtractors differentially combines the complex coordinates of QAM symbols the DFT computer 874 generates, as transformed by the Hilbert transformation connections 875, with the complex coordinates of corresponding QAM symbols the DFT computer 873 generates. The difference output ports of the parallel array 877 of digital subtractors recover at baseband the complex coordinates of QAM symbols from the upper sideband of the DCM COFDM signal. The complex coordinates of QAM symbols extracted from pilot carriers in each COFDM symbol sampling interval are supplied as parallel input signal to the pilot carriers processor 288. The complex coordinates of QAM symbols extracted from carriers in each COFDM symbol sampling interval that convey coded data are supplied as parallel input signal to the frequency-domain channel equalizer 894 for QAM symbols extracted from the upper sideband of the DCM COFDM signal.

FIGS. 105 and 94 together depict a variant of the receiver apparatus for ISB demodulation of DCM COFDM depicted in FIGS. 104 and 94, digital circuitry depicted in FIG. 105 replacing some of the analog circuitry depicted in FIG. 104. FIG. 105 depicts modification of FIG. 104 morphologically and operationally similar to the modification of FIG. 100 depicted in FIG. 103. The components 180, 201, 202, 205 and 206 of FIG. 104 are replaced in FIG. 105 by components 280, 213 and 214 described supra in reference to FIG. 103. The DFT computers 873 and 874 perform bandpass filtering of individual OFDM carriers which bandpass filtering should be unresponsive to frequencies outside baseband. This bandpass filtering may allow digital lowpass filters 207 and 208 to be replaced by respective direct connections in modified FIG. 105 structure.

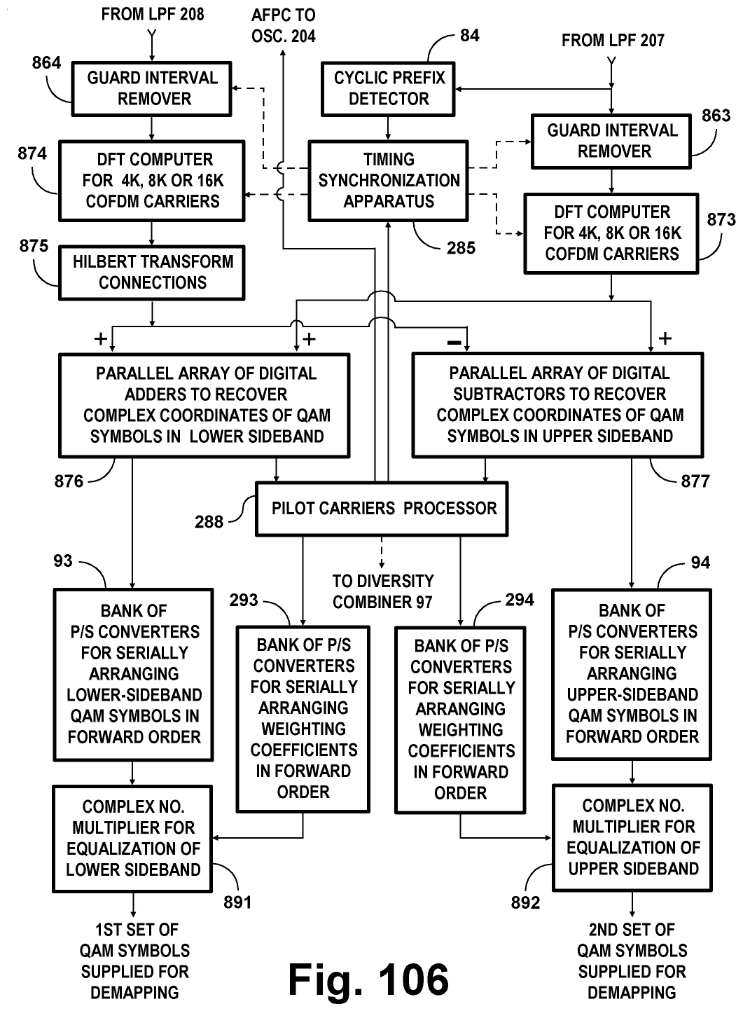

FIG. 106 depicts modifications of either of the receiver structures depicted in FIGS. 104 and 105, which modifications reduce the number of complex-number multipliers needed for frequency domain channel equalization. The channel equalizer 893 that performed multiplications on each of the QAM symbols supplied it in parallel from the parallel array 876 of digital adders is omitted, and the channel equalizer 894 that performed multiplications on each of the QAM symbols supplied to it in parallel from the parallel array 877 of digital subtractors is also omitted. A complex-number multiplier 891 performs frequency-domain channel equalization on each of the QAM symbols from the lower sideband of the DCM COFDM signal furnished it by the parallel array 876 of digital adders after their serialization by a selected one of the parallel-to-serial (P/S) converters in the bank 93 of them. Another complex-number multiplier 892 performs frequency-domain channel equalization on each of the QAM symbols from the upper sideband of the DCM COFDM signal furnished it by the parallel array 877 of digital subtractors after their serialization by a selected one of the parallel-to-serial (P/S) converters in the bank 94 of them. The first and second sets of QAM symbols supplied from the respective product output ports of the multipliers 891 and 892 are suitable input signals for subsequent demapping apparatus—e.g., as depicted in FIG. 94 or 62.

More particularly, the QAM symbols from the lower sideband of the DCM COFDM signal that convey data are supplied by respective ones of the parallel array 876 of digital adders directly to respective ones of the parallel input ports of the selected one of the P/S converters in the bank 93 of them. The output port of that selected P/S converter responds to supply serialized QAM symbols from the lower sideband of the DCM COFDM signal to the multiplicand input port of the multiplier 891. The parallel input ports of a selected one of the parallel-to-serial (P/S) converters in a bank 931 of them receives, in parallel from the pilot carriers processor 288, the weighting coefficients for frequency-domain channel equalization of the lower sideband of the DCM COFDM signal. The output port of that selected P/S converter responds to supply serialized weighting coefficients for the lower sideband of the DCM COFDM signal to the multiplier input port of the complex-number multiplier 891. The multiplier 891 responds to its multiplicand and multiplier input signals to supply from its product output port an equalized first set of QAM symbols, suitable for subsequent demapping.

More particularly, the QAM symbols from the upper sideband of the DCM COFDM signal that convey data are supplied by respective ones of the parallel array 877 of digital subtractors directly to the parallel input ports of the selected one of the P/S converters in the bank 94 of them. The output port of that selected P/S converter responds to supply serialized QAM symbols from the upper sideband of the DCM COFDM signal to the multiplicand input port of the multiplier 892. The parallel input ports of a selected one of the parallel-to-serial (P/S) converters in a bank 941 of them receives, in parallel from the pilot carriers processor 288, the weighting coefficients for frequency-domain channel equalization of the upper sideband of the DCM COFDM signal. The output port of that selected P/S converter responds to supply serialized weighting coefficients for the lower sideband of the DCM COFDM signal to the multiplier input port of the complex-number multiplier 891. The multiplier 891 responds to its multiplicand and multiplier input signals to supply from its product output port an equalized second set of QAM symbols, suitable for subsequent demapping.

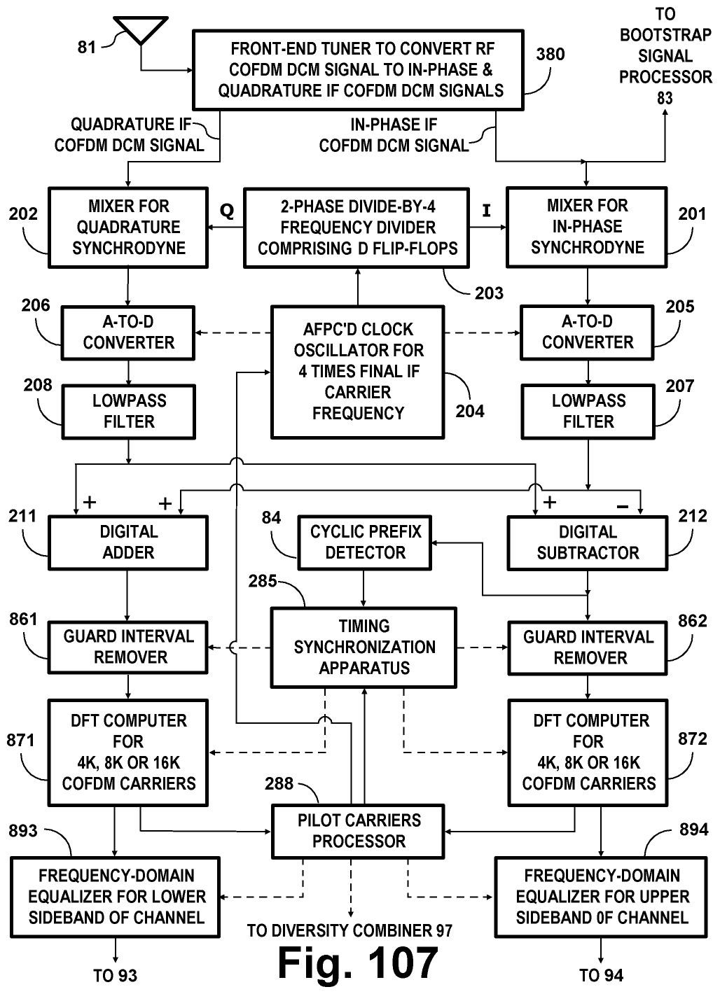

The modified phase shift method of ISB demodulation as described in connection with FIGS. 96, 97 and 98 avoids the need for a digital FIR filter to perform Hilbert transform, but introduces parallel arrays of digital adders and digital subtractors to separate the lower-sideband QAM symbols from the upper-sideband QAM symbols. Receiver apparatus using a Weaver method of ISB demodulation as described in connection with FIGS. 107 and 94 also avoids the need for a digital FIR filter to perform Hilbert transform, but the modified phase shift method of ISB demodulation is more practical to implement.

FIGS. 107 and 94 together depict the general structure of receiver apparatus for ISB demodulation of DCM COFDM signals using methods based on methods for demodulating SSB amplitude-modulation signals described by Donald K. Weaver, Jr. in his paper “A third method of generation and detection of single sideband signals”, Proceedings of the IRE, vol. 44, December 1956 issue, pp. 1203-1205. The FIG. 107 structure for ISB demodulation of DCM COFDM signals differs from the FIG. 101 structure for ISB demodulation of DCM COFDM signals in the following regards. The front-end tuner 180 to convert RF DCM COFDM signal to IF DCM COFDM signal for application to the multiplicand input ports of the mixers 201 and 202 is replaced by a front-end tuner 380 to convert RF DCM COFDM signal to (a) an in-phase IF DCM COFDM signal for application to the multiplicand input port of the mixer 201 and (b) a quadrature IF DCM COFDM signal for application to the multiplicand input port of the mixer 202. The application of quadrature-phase IF DCM COFDM signal, rather than in-phase IF DCM COFDM signal, to the multiplicand input port of the mixer 202 obviates the need for an FIR digital filter 209 for Hilbert transformation. Accordingly, there is no call for digital delay line 210 to compensate for latent delay through the filter 209.

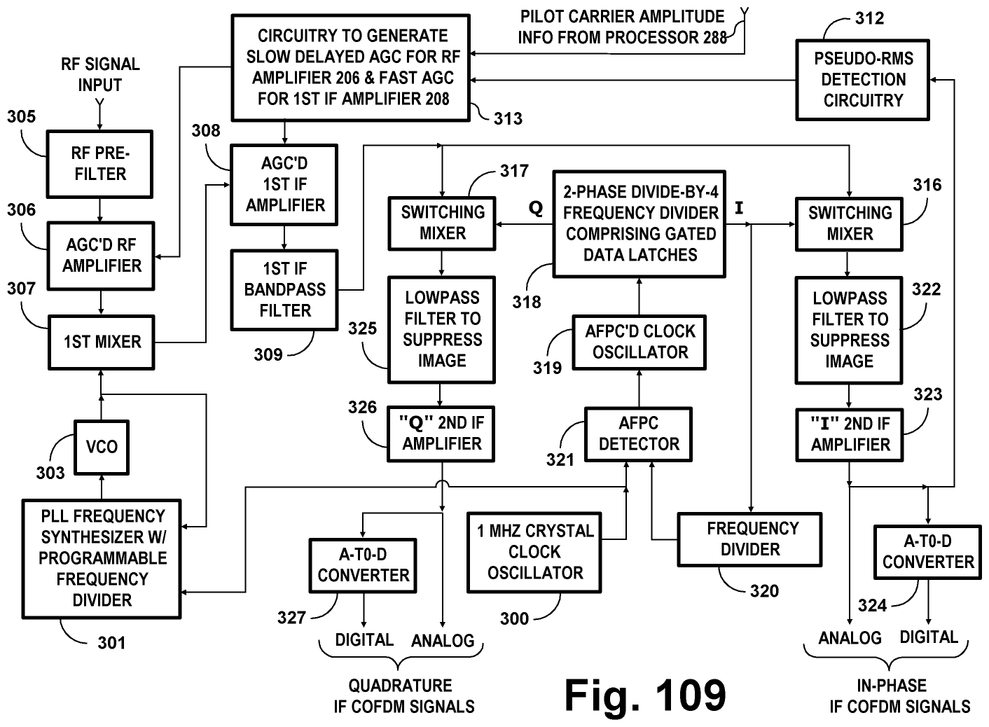

An A-to-D converter 205 performs analog-to-digital conversion of the in-phase and quadrature-phase components of the baseband signal supplied from the output port of the mixer 201. An A-to-D converter 206 performs analog-to-digital conversion of the in-phase and quadrature-phase components of the baseband signal supplied from the output port of the mixer 202. The digitized in-phase baseband signal supplied from the output port of the A-to-D converter 205 is supplied to the input port of a digital lowpass filter 207. The digitized quadrature-phase baseband signal supplied from the output port of the A-to-D converter 206 is supplied to the input port of a digital lowpass filter 208. Preferably, the design of the digital lowpass filters 207 and 208 provides a rapid roll-off in frequency response, so as to suppress adjacent-channel interference (ACI). The DFT computers 871 and 872 perform bandpass filtering of individual OFDM carriers which bandpass filtering should be unresponsive to frequencies outside baseband. This bandpass filtering may allow digital lowpass filters 207 and 208 to be replaced by respective direct connections in modified FIG. 109 structure.

The output port of the lowpass filter 207 and the output port of the lowpass filter 208 are connected to respective addend input ports of the digital adder 211, which is operative to recover at baseband the lower sideband of the DCM COFDM signal at its sum output port. The output ports of the lowpass filters 207 and 208 are respectively connected to the subtrahend input port and the minuend input port of the digital subtractor 212, which is operative to recover at baseband the upper sideband of the DCM COFDM signal at its difference output port. The responses from the sum output port of the digital adder 211 and from the difference output port of the digital subtractor 212 are utilized in the subsequent portions of the FIG. 107 and FIG. 94 receiver apparatus in the same way as in the corresponding portions of the FIG. 101 and FIG. 94 receiver apparatus.

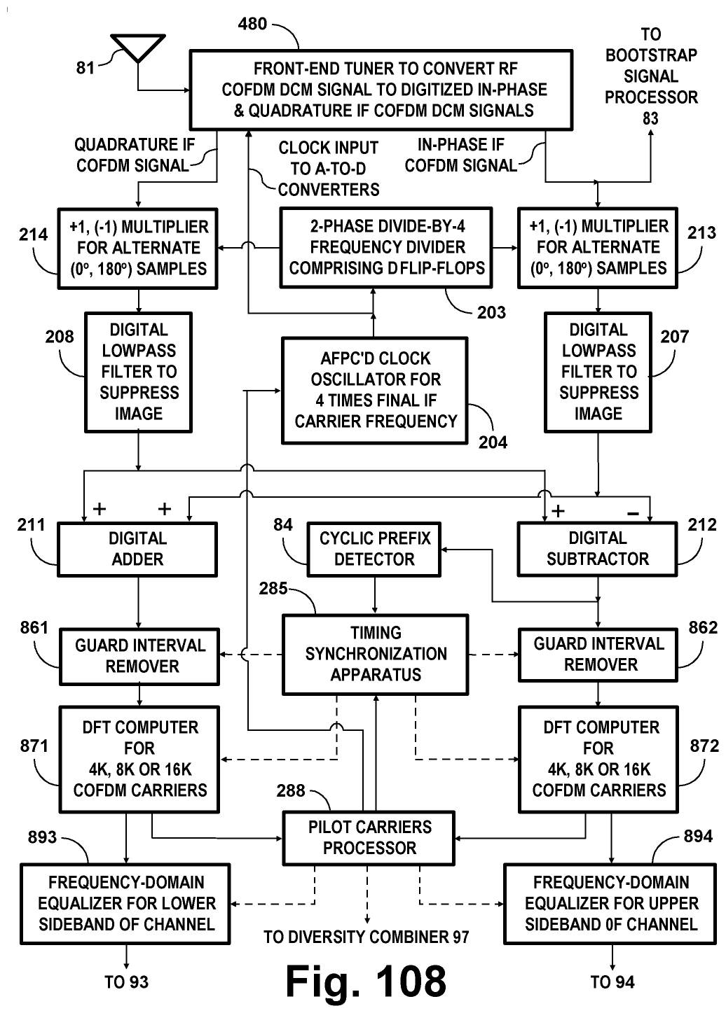

FIGS. 108 and 94 together form a schematic diagram of a variant of the receiver apparatus for ISB demodulation of DCM COFDM depicted in FIGS. 107 and 94, digital circuitry depicted in FIG. 108 replacing some of the analog circuitry depicted in FIG. 107. The front-end tuner 380 depicted in FIG. 107 that is operable to convert RF COFDM signal to both in-phase and quadrature-phase analog IF COFDM signals is replaced in FIG. 108 by a front-end tuner 480 operable to convert RF COFDM signal to both in-phase and quadrature-phase digital IF DCM COFDM signals. The front-end tuner 480 is connected to supply the in-phase digital IF DCM COFDM signals to the multiplicand input port of the +1, (−1) multiplier 213 for in-phase synchrodyne to baseband. The front-end tuner 480 is connected to supply the quadrature-phase digital IF DCM COFDM signals to the multiplicand input port of a +1, (−1) multiplier 214 for quadrature-phase synchrodyne to baseband. A 2-phase divide-by-4 frequency divider 203 responds to rising edges of pulses from a clock oscillator 204, by supplying I and Q square waves to respective carrier input ports of the +1, (−1) multipliers 213 and 214. The clock oscillator 204 is subject to automatic frequency and phase control (AFPC) that adjusts the frequency of clock pulses to be four times the final intermediate-frequency (IF) carrier of the COFDM signals.

The leading I square wave that the frequency divider 203 supplies to the control input port of the +1, (−1) multiplier 213 conditions the +1, (−1) multiplier 213 to select the 0° digital samples of the in-phase second-IF DCM COFDM signal for multiplication by +1 responsive to positive half cycles of I square wave, and selecting the 180° digital samples of the in-phase second-IF DCM COFDM signal for multiplication by −1 responsive to negative half cycles of I square wave. The output port of the +1, (−1) multiplier 213 is connected for supplying the in-phase synchrodyne results to the input port of a digital lowpass filter 207. The lowpass filter 207 responds to the baseband portion of the in-phase synchrodyne results, but not to image signal.

The lagging Q square wave that the frequency divider 203 supplies to the control input port of the +1, (−1) multiplier 214 conditions the +1, (−1) multiplier 214 to select the −90° digital samples of the quadrature-phase second-IF DCM COFDM signal for multiplication by +1 responsive to positive half cycles of Q square wave, and selecting the 90° digital samples of the quadrature-phase second-IF DCM COFDM signal for multiplication by −1 responsive to negative half cycles of Q square wave. The output port of the +1, (−1) multiplier 214 is connected for supplying quadrature-phase synchrodyne results to the input port of to the input port of a digital lowpass filter 208. The lowpass filter 208 responds to the baseband portion of the quadrature-phase synchrodyne results, but not to image signal.

If the front-end tuner 480 contains digital lowpass filtering of the digitized IF COFDM DCM signal with rapid roll-off in frequency response for suppressing ACI, there is no reason for the digital lowpass filters 207 and 208 necessarily having to have rapid roll-offs in frequency response to suppress ACI. The output port of the lowpass filter 207 and the output port of the lowpass filter 208 are connected to respective addend input ports of the digital adder 211, which is operative to recover at baseband the lower sideband of the DCM COFDM signal at its sum output port. The output ports of the lowpass filters 207 and 208 are respectively connected to the minuend input port and the subtrahend input port of the digital subtractor 212, which is operative to recover at baseband the upper sideband of the DCM COFDM signal at its difference output port. The responses from the sum output port of the digital adder 211 and from the difference output port of the digital subtractor 212 are utilized in the subsequent portions of the FIG. 108 and FIG. 94 receiver apparatus in the same way as in the corresponding portions of the FIG. 107 and FIG. 94 receiver apparatus. The bandpass filtering of individual OFDM carriers in DFT computers 871 and 872 may allow digital lowpass filters 207 and 208 to be replaced by respective direct connections in modified FIG. 101 structure.

FIG. 109 depicts plural superheterodyne front-end tuner structure suitable for implementing the front-end tuner 380 depicted in FIG. 107 or for implementing the front-end tuner 480 depicted in FIG. 108. Elements 300-309, 312 and 313 of the FIG. 105 structure are similar to the elements 300-309, 312 and 313 in the FIG. 102 double-superheterodyne front-end tuner structure. A crystal clock oscillator 300 is connected for supplying 1 MHz reference oscillations to a PLL frequency synthesizer 301 that supplies AFPC voltage to a voltage-controlled oscillator 303. VCO 303 generates the first local oscillations used in the upward conversion of radio-frequency DCM COFDM signal to first-IF DCM COFDM signal. The input port of a pre-filter 305 is connected for receiving RF DCM COFDM signal supplied by an antenna or a cable distribution system. The RF output of the pre-filter 305 is amplified or attenuated to a desired level by an AGC′d RF amplifier 306 and then supplied to a first mixer 307, there to be mixed with oscillations from the first local oscillator 303 to generate first-IF signal. The first-IF output signal supplied from the mixer 307 is amplified by a narrow-band amplifier 308 and then supplied to a first-IF bandpass filter 309 such as a dielectric resonance filter, a strip-line filter or a SAW filter. The input port of pseudo-RMS detection circuitry 312 is connected for receiving amplified second-IF DCM COFDM signal supplied from the output port of a second IF amplifier. The output port of the pseudo-RMS detection circuitry 312 is connected for supplying an approximation of the root-mean-square RMS voltage of the amplified second-IF DCM COFDM signal to a first input port of circuitry 313 for generating respective automatic gain control (AGC) signals for the RF amplifier 306 and for the first-IF amplifier 308. A second port of the circuitry 313 for generating AGC signals is connected for receiving pilot carrier amplitude information from the pilot carriers processor 288 depicted in FIG. 107 or in FIG. 108.

The single second mixer 310 of the FIG. 102 front-end tuner structure is replaced by two switching mixers 316 and 317 in the front-end tuner structure depicted in FIG. 109. A 2-phase divide-by-4 frequency divider 318 responds to rising edges of pulses from a clock oscillator 319, by supplying I and Q square waves to respective carrier input ports of the switching mixers 316 and 317. The fundamental frequency of the Q square wave lags the fundamental frequency of the Q square wave by 90° (it/4 radians). The clock oscillator 319 is subject to automatic frequency and phase control (AFPC) responsive to voltage supplied from a PLL frequency synthesizer comprising the divide-by-4 frequency divider 318, a further frequency divider 320 and an AFPC detector 321. The input port of the frequency divider 320 is connected to receive the I square wave applied to the carrier input port of the switching mixer 316. The output port of the frequency divider 230 is connected to a first input port of the AFPC detector 321. A second input port of the AFPC detector 321 is connected for receiving reference-frequency oscillations from the crystal oscillator 300. The output port of the AFPC detector 321 is connected for supplying voltage to the clock oscillator 319 to implement automatic frequency and phase control (AFPC) thereof.

The output port of the switching mixer 316 connects to the input port of a lowpass filter 322 that suppresses image signal in the response supplied from its output port to the input port of an amplifier 323 of the in-phase (“I”) second-IF signal. The output port of the “I” second-IF amplifier 323 is connected to supply analog amplified in-phase second-IF signal that is suitable for an output signal from the FIG. 107 front-end tuner 380. FIG. 105 shows this amplified in-phase second-IF signal applied to the input port of an analog-to-digital converter 324 that responds to supply digital amplified in-phase second-IF signal suitable for a digital output signal from the FIG. 108 front-end tuner 480.

The output port of the switching mixer 317 connects to the input port of a lowpass filter 325 that suppresses image signal in the response supplied from its output port to the input port of an amplifier 326 of the quadrature-phase (“Q”) second-IF signal. The output port of the “Q” second-IF amplifier 326 is connected to supply analog amplified quadrature-phase second-IF signal that is suitable for an output signal from the FIG. 107 front-end tuner 380. FIG. 109 shows this amplified quadrature-phase second-IF signal applied to the input port of an analog-to-digital converter 327 that responds to supply digital amplified quadrature-phase second-IF signal that is suitable for an output signal from the FIG. 108 front-end tuner 480.

FIG. 109 shows the input port of the pseudo-RMS detection circuitry 312 connected for receiving amplified in-phase second-IF signal from the output port of the “I” second-IF amplifier 323. With such connection the measurement of second-IF signal amplitude by the pseudo-RMS detection circuitry 312 takes into account the amplitudes of the pilot carriers in the DCM COFDM signal. Alternatively, the pseudo-RMS detection circuitry 312 is connected instead for receiving amplified quadrature-phase second-IF signal from the output port of the “Q” second-IF amplifier 326. With such connection the measurement of second-IF signal amplitude by the pseudo-RMS detection circuitry 312 is nonresponsive to the amplitudes of the pilot carriers in the DCM COFDM signal.

Each of the FIG. 107 and the FIG. 108 COFDM demodulation apparatuses obviates the need for an FIR digital filter to perform Hilbert transformation. However, in order for a Weaver method of demodulation to perform well, these front-end tuners 380 and 480 each need to convert RF DCM COFDM signal to both in-phase and quadrature-phase IF DCM COFDM signals subject to the same amplification. The orthogonal relationship between the in-phase and quadrature-phase IF DCM COFDM signals that either of these front-end tuners 380 and 480 supplies has to be scrupulously maintained, if a Weaver method of ISB demodulation is to perform well. Also, the respective gains of the in-phase and quadrature-phase IF DCM COFDM signals that the front-end tuner supplies have to match closely, if a Weaver method of ISB demodulation is to perform well. The FIG. 109 structure for front-end tuners addresses these problems by using the 2-phase divide-by-4 frequency divider 318 responsive to output signal from the clock oscillator 319. However, the frequency of oscillations supplied from the clock oscillator 319 will approach 3 GHz, in order to position the fundamental frequencies of the I and Q square waves from the frequency divider 318 above the UHF band for television broadcasting.

The structures depicted in FIGS. 100, 103, 104 and 105 are preferred over variants of them that defer lowpass digital filtering to suppress unwanted image frequencies until after the digital adder 211 and the digital subtractor 212.

Rather than operating two DFT computers in parallel in the in-phase and quadrature-phase branches of the receiver apparatus shown in any of FIGS. 100 and 103-108, it is possible to use a single DFT computer in time-division multiplex to serve both branches. While this can reduce “hardware” requirements, higher operating speeds will be required to implement such multiplex.

The improved methods of demodulating independent-sideband digital amplitude-modulation signals described supra can be broadly applied in a number of digital communications systems. Such methods can be utilized by the bootstrap signal processor 83 depicted in FIG. 94, by way of specific example.

Various other modifications and variations can be made in the specifically described apparatuses without departing from the spirit or scope of the invention in certain broader ones of its aspects. For example, in variations of the structures depicted in FIGS. 100, 103, 104, 105, 107 and 108 the AFPC′d clock oscillator 204 is replaced by a fixed-frequency clock oscillator, such as a crystal-controlled oscillator. AFPC signals from the pilot carriers processor 288 are supplied to the front-end tuner for fine-tuning a local oscillator therein, so that the principal carrier of intermediate-frequency DCM COFDM signal(s) supplied from the front end tuner is appropriate for in-phase and quadrature-phase synchrodynes to baseband in those variations of the structures depicted in FIGS. 100, 103, 104, 105, 107 and 108.

Persons skilled in the art of designing DTV systems and acquainted with this disclosure are apt to discern that various modifications and variations can be made in the specifically described apparatuses without departing from the spirit or scope of the invention in certain broader ones of its aspects. Accordingly, it is intended that such modifications and variations of the specifically described apparatuses be considered to result in further embodiments of the invention, to be included within the scope of the appended claims and their equivalents in accordance with the doctrine of equivalents.

In the appended claims, the word “said” rather than the word “the” is used to indicate the existence of an antecedent basis for a term being provided earlier in the claims. The word “the” is used for purposes other than to indicate the existence of an antecedent basis for a term appearing earlier in the claims, the usage of the word “the” for other purposes being consistent with customary grammar in the American English language.

What is claimed is:

1. A method of employing dual-subcarrier-modulation (DCM) coded orthogonal frequency-division multiplexed (COFDM) signal in a communication system, each of a number of pairs of which subcarriers convey parallelly in time the same coded digital data in each of its two subcarriers in respective formats designed to reduce the peak-to-average-power ratio (PAPR) of said COFDM DCM signal, said method comprising successive steps of:
parsing said coded digital data into a succession of digital map labels each having 2N bits therein, N being a positive integer greater than two;
generating a first set of square quadrature-amplitude-modulation (QAM) symbols constellations in accordance with a first pattern of SCM mapping said succession of said digital map labels to respective lattice points of a first set of square QAM symbol constellations to be associated with quadrature amplitude modulation of first subcarriers of each said pair of subcarriers, said first pattern of SCM mapping digital map labels to QAM symbol constellations having a respective −I,+Q quadrant and a respective +I,+Q quadrant and a respective +I,−Q quadrant and a respective −I,−Q quadrant, each of said quadrants in said first pattern of SCM mapping digital map labels to QAM symbol constellations being composed of an innermost sub-quadrant thereof and an outermost sub-quadrant thereof and two flanking sub-quadrants thereof, each of said quadrants in said first pattern of SCM mapping digital map labels to QAM symbol constellations having arranged along a diagonal thereof a respective sequence of one-quarter of all the palindromic ones of said digital map labels that are more particularly arranged to be solely within one of said innermost and outermost sub-quadrants of that said quadrant;
generating a second set of square QAM symbols in accordance with a second pattern of SCM mapping said succession of said digital map labels to respective lattice points of a second set of square QAM symbol constellations to be associated with quadrature amplitude modulation of second subcarriers of each said pair of subcarriers, said second pattern of SCM mapping having a respective −I,+Q quadrant including the same digital map labels as the +I,−Q quadrant of said first pattern of SCM mapping with the map labels associated with higher than average energy in each of these two quadrants being associated with lower than average energy in the other quadrant, said second pattern of SCM mapping having a respective +I,+Q quadrant including the same digital map labels as the −I,−Q quadrant of said first pattern of SCM mapping with the map labels associated with higher than average energy in each of these two quadrants being associated with lower than average energy in the other quadrant, said second pattern of SCM mapping having a respective +I,−Q quadrant including the same digital map labels as the −I,+Q quadrant of said first pattern of SCM mapping with the map labels associated with higher than average energy in each of these two quadrants being associated with lower than average energy in the other quadrant, said second pattern of SCM mapping having a respective −I,−Q quadrant including the same digital map labels as the +I,+Q quadrant of said first pattern of SCM mapping with the map labels associated with higher than average energy in each of these two quadrants being associated with lower than average energy in the other quadrant, each of said quadrants in said second pattern of SCM mapping digital map labels to QAM symbol constellations being composed of an innermost sub-quadrant thereof and an outermost sub-quadrant thereof and two flanking sub-quadrants thereof, each of said quadrants in said second pattern of SCM mapping digital map labels to QAM symbol constellations having arranged along a diagonal thereof a respective sequence of one-quarter of all palindromic ones of said digital map labels that are more particularly arranged to be solely within one of said innermost and outermost sub-quadrants of that said quadrant;
employing inverse Fourier transform technique to generate quadrature amplitude modulation of a first set of subcarriers for inclusion in said COFDM DCM signal, thus to convey said succession of said digital map labels via said first set of successive QAM symbol constellations which employ said first pattern of SCM mapping digital map labels;
employing inverse Fourier transform technique to generate quadrature amplitude modulation of a second set of subcarriers for inclusion in said COFDM DCM signal, thus to convey said succession of said digital map labels via said second set of successive QAM symbol constellations which employ said second pattern of SCM mapping digital map labels;
up-converting said COFDM DCM signal to higher frequencies;
amplifying the power of the resulting higher-frequency COFDM DCM signal; and
transmitting said resulting higher-frequency COFDM DCM signal via a transmission medium.

2. The method of claim 1, wherein:
said COFDM DCM signal is separable into a lower-frequency subband and a higher-frequency subband, said lower-frequency subband and said higher-frequency subband having equal numbers of subcarriers in them;
said first set of subcarriers are positioned within said lower-frequency subband of said COFDM DCM signal; and
said second set of subcarriers are positioned within said higher-frequency subband of said COFDM DCM signal.

3. The method of claim 2, wherein:
ones of said first set of subcarriers for inclusion in said lower-frequency subband of said COFDM DCM signal are progressively higher in frequency responsive to successive ones of said first succession of said digital map labels; and
ones of said second set of subcarriers for inclusion in said higher-frequency subband of said COFDM DCM signal are progressively higher in frequency responsive to successive ones of said second succession of said digital map labels.

4. The method of claim 2, wherein:
ones of said first set of subcarriers for inclusion in said lower-frequency subband of said COFDM DCM signal are progressively lower in frequency responsive to successive ones of said first succession of said digital map labels; and
ones of said second set of subcarriers for inclusion in said higher-frequency subband of said COFDM DCM signal are progressively lower in frequency responsive to successive ones of said second succession of said digital map labels.

5. The method of claim 2, comprising further steps of:
inserting pilot-carrier symbols at regular intervals into said first set of QAM symbols before said step of employing inverse Fourier transform technique to generate quadrature amplitude modulation of said first set of subcarriers for inclusion in said lower-frequency subband of said COFDM DCM signal, thus to generate pilot subcarriers in said lower-frequency subband responsive to said pilot carrier symbols inserted into said first set of QAM symbols; and
inserting pilot-carrier symbols at regular intervals into said second set of QAM symbols before said step of employing inverse Fourier transform technique to generate quadrature amplitude modulation of said second set of subcarriers for inclusion in said higher-frequency subband of said COFDM DCM signal, thus to generate pilot subcarriers in said higher-frequency subband responsive to said pilot carrier symbols inserted into said second set of QAM symbols.

6. The method of claim 5, wherein:
each of said quadrants in said first pattern of SCM mapping digital map labels to QAM symbol constellations has said respective sequence of one-quarter of all the palindromic ones of said digital map labels arranged to be solely within said innermost sub-quadrant of that said quadrant; and
each of said quadrants in said second pattern of SCM mapping digital map labels to QAM symbol constellations has said respective sequence of one-quarter of all the palindromic ones of said digital map labels arranged to be solely within said outermost sub-quadrant of that said quadrant.

7. The method of claim 5, wherein:
each of said quadrants in said first pattern of SCM mapping digital map labels to QAM symbol constellations has said respective sequence of one-quarter of all the palindromic ones of said digital map labels arranged to be solely within said outermost sub-quadrant of that said quadrant; and
each of said quadrants in said second pattern of SCM mapping digital map labels to QAM symbol constellations has said respective sequence of one-quarter of all the palindromic ones of said digital map labels arranged to be solely within said innermost sub-quadrant of that said quadrant.

8. The method of claim 1, wherein:
ones of said first set of subcarriers for inclusion in said lower-frequency subband of said COFDM DCM signal are progressively higher in frequency responsive to successive ones of said first succession of said digital map labels; and
ones of said second set of subcarriers for inclusion in said higher-frequency subband of said COFDM DCM signal are progressively higher in frequency responsive to successive ones of said second succession of said digital map labels.

9. The method of claim 1, wherein:
each of said quadrants in said first pattern of SCM mapping digital map labels to QAM symbol constellations has said respective sequence of one-quarter of all the palindromic ones of said digital map labels arranged to be solely within said innermost sub-quadrant of that said quadrant; and
each of said quadrants in said second pattern of SCM mapping digital map labels to QAM symbol constellations has said respective sequence of one-quarter of all the palindromic ones of said digital map labels arranged to be solely within said outermost sub-quadrant of that said quadrant.

10. Receiver apparatus for usefully receiving said higher-frequency COFDM DCM signal transmitted via a transmission medium in accordance with the method of claim 5, said receiver apparatus comprising:
means for selectively receiving said higher-frequency COFDM DCM signal transmitted via said transmission medium;
means for regenerating said first and said second sets of QAM symbols, said regenerated first set of QAM symbols descriptive of the discrete Fourier transform of COFDM carriers from the lower-frequency subband of the selectively received higher-frequency COFDM DCM signal, and said regenerated second set of QAM symbols descriptive of the discrete Fourier transform of COFDM carriers from the higher-frequency subband of the selectively received higher-frequency COFDM DCM signal;
means for serially arranging said regenerated first set of QAM symbols in each successive COFDM symbol in a first prescribed spectral order;
means for serially arranging said regenerated second set of QAM symbols in a second prescribed spectral order, such that each successive QAM symbol in said second prescribed spectral order conveys FEC-coded data related to FEC-coded data conveyed by a contemporaneous QAM symbol in said regenerated first set of QAM symbols as serially arranged in said first prescribed spectral order;
means for demapping, in accordance with said first pattern of SCM mapping, said regenerated first set of QAM symbols as thus serially arranged in said first prescribed spectral order to recover a first succession of lattice-point labels in soft-bit format;
means for demapping, in accordance with said second pattern of SCM mapping, said regenerated second set of QAM symbols as thus serially arranged in said second prescribed spectral order to recover a second succession of lattice-point labels in soft-bit format; and
a diversity combiner for combining soft bits of contemporaneous lattice-point labels in said first and second successions thereof as received by said diversity combiner as first and second input signals thereto, thereby to reproduce soft bits of said coded data as response from said diversity combiner.

11. The receiver apparatus of claim 10, wherein said means for selectively receiving a higher-frequency COFDM signal comprises:
a front-end tuner for selectively receiving said higher-frequency COFDM signal as transmitted in analog form and down-converting said higher-frequency COFDM signal to a baseband COFDM signal; and
means for digitizing successive samples of said baseband COFDM signal.

12. The receiver apparatus of claim 11, comprising:
a computer connected for computing the discrete Fourier transform of said successive samples of said baseband COFDM signal, said computer constituting said means for regenerating said first and said second sets of QAM symbols;
a frequency-domain channel equalizer for said regenerated first and second sets of QAM symbols that said computer computes from each of said successive samples of said baseband COFDM signal;
a first parallel-to-serial converter connected for receiving in parallel each equalized said first set of QAM symbols and for supplying each equalized said first set of QAM symbols seriatim to said means for demapping said regenerated first set of QAM symbols as thus serially arranged, said first parallel-to-serial converter constituting said means for serially arranging said regenerated first set of QAM symbols in each COFDM symbol in said first prescribed spectral order; and
a second parallel-to-serial converter connected for receiving in parallel each equalized said second set of QAM symbols and for supplying each equalized said second set of QAM symbols seriatim to said means for demapping said second set of QAM symbols as thus serially arranged, said second parallel-to-serial converter constituting said means for serially arranging said regenerated second set of QAM symbols in each COFDM symbol in said second prescribed spectral order.

13. The receiver apparatus of claim 11, comprising:
a computer connected for computing the discrete Fourier transform of said successive samples of said baseband COFDM signal, said computer constituting said means for regenerating said first and said second sets of QAM symbols;
a first parallel-to-serial converter connected for receiving in parallel each said regenerated first set of QAM symbols said computer computes from a respective one of said successive samples of said baseband COFDM signal, said first parallel-to-serial converter further connected for supplying each said first set of QAM symbols seriatim, said first parallel-to-serial converter constituting said means for serially arranging said regenerated first set of QAM symbols in each COFDM symbol in said first prescribed spectral order;
a first frequency-domain channel equalizer for equalizing said regenerated first sets of QAM symbols supplied seriatim from said first parallel-to-serial converter to generate equalized first sets of QAM symbols supplied to said means for demapping said regenerated first set of QAM symbols;
a second parallel-to-serial converter connected for receiving in parallel each said regenerated second set of QAM symbols said computer computes from a respective one of said successive samples of said baseband COFDM signal, said second parallel-to-serial converter further connected for supplying each said regenerated second set of QAM symbols seriatim, said second parallel-to-serial converter constituting said means for serially arranging said regenerated second set of QAM symbols in each COFDM symbol in said second prescribed spectral order, and
a second frequency-domain channel equalizer for equalizing said regenerated second sets of QAM symbols supplied seriatim from said second parallel-to-serial converter to generate equalized second sets of QAM symbols supplied to said means for demapping said regenerated second set of QAM symbols.

14. The receiver apparatus of claim 10, wherein said means for selectively receiving a higher-frequency COFDM signal comprises:
a front-end tuner for selectively receiving said higher-frequency COFDM signal as transmitted in analog form and down-converting said higher-frequency COFDM signal to an intermediate-frequency COFDM signal; and
an independent-sideband demodulator for demodulating said intermediate-frequency COFDM signal to recover first and second baseband signals, said first baseband signal resulting from digitized demodulation of the lower-frequency subband of said intermediate-frequency COFDM signal, and said second baseband signal resulting from digitized demodulation of the higher-frequency subband of said intermediate-frequency COFDM signal.

15. The receiver apparatus of claim 14, wherein said independent-sideband demodulator is configured for (a) demodulating the lower-frequency subband of said intermediate-frequency COFDM signal in accordance with a first phase-shift method to recover a first baseband signal and (b) demodulating the higher-frequency subband of said intermediate-frequency COFDM signal in accordance with a second phase-shift method to recover a second baseband signal.

16. The receiver apparatus of claim 14, wherein said independent-sideband demodulator is configured for demodulating said intermediate-frequency COFDM signal to recover first and second baseband signals in accordance with a Weaver method.

17. The receiver apparatus of claim 14, comprising:
a first computer included in said means for regenerating said first and said second sets of QAM symbols, said first computer connected for computing the discrete Fourier transform of successive samples of said first baseband signal to regenerate said first set of QAM symbols descriptive of the discrete Fourier transform of COFDM carriers from the lower half spectrum of the selectively received COFDM higher-frequency signal;
a first frequency-domain channel equalizer for said regenerated first set of QAM symbols said first computer computes from successive samples of said first baseband signal;
a first parallel-to-serial converter connected for receiving in parallel equalized said regenerated first set of QAM symbols from each successive sample of said first baseband signal and for supplying the equalized generated first set of QAM symbols seriatim to said means for demapping said regenerated first set of QAM symbols as thus serially arranged, said first parallel-to-serial converter constituting said means for serially arranging said regenerated first set of QAM symbols in each COFDM symbol in said first prescribed spectral order;
a second computer included in said means for regenerating said first and said second sets of QAM symbols, said second computer connected for computing the discrete Fourier transform of successive samples of said second baseband signal to regenerate said second set of QAM symbols descriptive of the discrete Fourier transform of COFDM carriers from the higher half spectrum of the selectively received COFDM higher-frequency signal;
a second frequency-domain channel equalizer for said regenerated second set of QAM symbols said second computer computes from said successive samples of said second baseband signal; and
a second parallel-to-serial converter connected for receiving in parallel each equalized said second set of QAM symbols and for supplying each equalized said second set of QAM symbols seriatim to said means for demapping said regenerated second set of QAM symbols as thus serially arranged, said second parallel-to-serial converter constituting said means for serially arranging the regenerated said second set of QAM symbols in each COFDM symbol in said second prescribed spectral order.

18. The receiver apparatus of claim 10, comprising:
a first computer included in said means for regenerating said first and said second sets of QAM symbols, said first computer connected for computing the discrete Fourier transform of successive samples of said first baseband signal to regenerate said first set of QAM symbols descriptive of the discrete Fourier transform of COFDM carriers from the lower half spectrum of the selectively received COFDM higher-frequency signal;
a first parallel-to-serial converter connected for receiving in parallel each regenerated said first set of QAM symbols and for supplying each regenerated said first set of QAM symbols seriatim, said first parallel-to-serial converter constituting said means for serially arranging said regenerated first set of QAM symbols in each COFDM symbol in said first prescribed spectral order;
a first frequency-domain channel equalizer for equalizing said regenerated first sets of QAM symbols supplied seriatim from said first parallel-to-serial converter to generate equalized first sets of QAM symbols supplied to said means for demapping said first set of QAM symbols;
a second computer included in said means for regenerating said first and said second sets of QAM symbols, said second computer connected for computing the discrete Fourier transform of successive samples of said second baseband signal to regenerate said second set of QAM symbols descriptive of the discrete Fourier transform of COFDM carriers from the higher half spectrum of the selectively received COFDM higher-frequency signal;
a second parallel-to-serial converter connected for receiving in parallel each equalized said second set of QAM symbols and for supplying each equalized said second set of QAM symbols seriatim, said second parallel-to-serial converter constituting said means for serially arranging said regenerated second set of QAM symbols in each COFDM symbol in said second prescribed spectral order; and
a second frequency-domain channel equalizer for equalizing said regenerated second set of QAM symbols supplied seriatim from said second parallel-to-serial converter to generate equalized second sets of QAM symbols supplied to said means for demapping said regenerated second set of QAM symbols.

19. Receiver apparatus for usefully receiving said higher-frequency COFDM DCM signal transmitted via a transmission medium in accordance with the claim 1 method, said receiver apparatus comprising:
a front-end tuner for selectively receiving said higher-frequency COFDM DCM signal as transmitted in analog form and down-converting said higher-frequency COFDM DCM signal to an intermediate-frequency COFDM DCM signal;
apparatus for performing an in-phase synchrodyne and a quadrature-phase synchrodyne of said intermediate-frequency COFDM DCM signal to recover first and second baseband signals respectively;
a first computer connected for computing the discrete Fourier transform of said first baseband signal in digital form, as successively sampled during prescribed sampling intervals;
a second computer connected for computing the discrete Fourier transform of said second baseband signal in digital form, as successively sampled during prescribed sampling intervals;
a parallel array of digital adders for regenerating increments of said first set of QAM symbols responsive to respective sums of (a) the complex coordinates of respective components of the discrete Fourier transform of successive samples of said first baseband signal supplied through respective Hilbert transform connections to respective first addend connections of said digital adders and (b) the complex coordinates of respective components of the discrete Fourier transform of successive samples of said second baseband signal supplied through respective connections to respective second addend connections of said digital adders;
a parallel array of digital subtractors for regenerating increments of said second set of QAM symbols responsive to respective differences between (a) the complex coordinates of respective components of the discrete Fourier transform of successive samples of said first baseband signal supplied through respective Hilbert transform connections to respective subtrahend connections of said digital adders and (b) the complex coordinates of respective components of the discrete Fourier transform of successive samples of said second baseband signal supplied through respective connections to respective minuend connections of said digital subtractors;
a first frequency-domain channel equalizer for each successive one of said increments of said regenerated first set of QAM symbols supplied from sum output connections of said parallel array of digital adders;
a second frequency-domain channel equalizer for each successive one of said increments of said regenerated second set of QAM symbols supplied from difference output connections of said parallel array of digital subtractors;
a first parallel-to-serial converter connected for receiving in parallel each equalized successive increment of said regenerated first set of QAM symbols and for supplying equalized said regenerated first set of QAM symbols seriatim, said first parallel-to-serial converter serially arranging said regenerated first set of QAM symbols in each COFDM symbol in said first prescribed spectral order;
means for demapping said regenerated first set of QAM symbols as thus serially arranged in said first prescribed spectral order, thereby to recover a first succession of QAM symbol map labels in soft-bit format;
a second parallel-to-serial converter connected for receiving in parallel each equalized successive increment of said regenerated second set of QAM symbols and for supplying equalized said regenerated second set of QAM symbols seriatim, said second parallel-to-serial converter serially arranging said regenerated second set of QAM symbols in each COFDM symbol in said second prescribed spectral order;
means for demapping, in accordance with said second pattern of mapping, said regenerated second set of QAM symbols as thus serially arranged in said second prescribed spectral order to recover a second succession of QAM symbol map labels in soft-bit format; and
a diversity combiner for combining soft bits of corresponding QAM symbol map labels in said first and second successions thereof as received by said diversity combiner as first and second input signals thereto, thereby to reproduce soft bits of said coded data as response from said diversity combiner.

20. Receiver apparatus for usefully receiving said higher-frequency COFDM DCM signal transmitted via a transmission medium in accordance with the claim 1 method, said receiver apparatus comprising:
a front-end tuner for selectively receiving said higher-frequency COFDM DCM signal as transmitted in analog form and down-converting said higher-frequency COFDM DCM signal to an intermediate-frequency COFDM DCM signal;
apparatus for performing an in-phase synchrodyne and a quadrature-phase synchrodyne of said intermediate-frequency COFDM DCM signal to recover first and second baseband signals respectively;
a first computer connected for computing the discrete Fourier transform of successive samples of said first baseband signal in digital form;
a second computer connected for computing the discrete Fourier transform of successive samples of said second baseband signal in digital form;
a parallel array of digital adders for regenerating said first set of QAM symbols responsive to respective sums of (a) the complex coordinates of respective components of the discrete Fourier transform of successive samples of said first baseband signal supplied through respective Hilbert transform connections to respective first addend connections of said digital adders and (b) the complex coordinates of respective components of the discrete Fourier transform of successive samples of said second baseband signal supplied through respective connections to respective second addend connections of said digital adders;
a parallel array of digital subtractors for regenerating said second set of QAM symbols responsive to respective differences between (a) the complex coordinates of respective components of the discrete Fourier transform of successive samples of said first baseband signal supplied through respective Hilbert transform connections to respective subtrahend connections of said digital adders and (b) the complex coordinates of respective components of the discrete Fourier transform of successive samples of said second baseband signal supplied through respective connections to respective minuend connections of said digital subtractors;
a first parallel-to-serial converter connected for receiving in parallel each regenerated said first set of QAM symbols and for supplying each regenerated said first set of QAM symbols seriatim;
a first frequency-domain channel equalizer for equalizing said regenerated first sets of QAM symbols supplied seriatim from said first parallel-to-serial converter to generate equalized first sets of QAM symbols
means for demapping, in accordance with said first pattern of mapping, each said regenerated first set of QAM symbols after its equalization by said first frequency-domain channel equalizer, thereby to recover a first succession of QAM symbol map labels in soft-bit format;
a second parallel-to-serial converter connected for receiving in parallel each regenerated said second set of QAM symbols and for supplying each said second set of QAM symbols seriatim; and
a second frequency-domain channel equalizer for equalizing said regenerated second sets of QAM symbols supplied seriatim from said second parallel-to-serial converter to generate equalized second sets of QAM symbols
means for demapping, in accordance with said second pattern of mapping, each said regenerated second set of QAM symbols after its equalization by said second frequency-domain channel equalizer, thereby to recover a second succession of QAM symbol map labels in soft-bit format; and
a diversity combiner for combining soft bits of corresponding QAM symbol map labels in said first and second successions thereof as received by said diversity combiner as first and second input signals thereto, thereby to reproduce soft bits of said coded data as response from said diversity combiner.
